(19) United States
(12) Patent Application Publication
(10) Pub. No.: US 2024/0140882 A1
(43) Pub. Date: May 2, 2024

(54) AMORPHOUS AND GRAPHITIC CARBON AEROGELS FROM COMPRESSED XEROGEL POWDERS

(71) Applicant: THE CURATORS OF THE UNIVERSITY OF MISSOURI, Columbia, MO (US)

(72) Inventors: Chariklia Sotiriou-Leventis, Rolla, MO (US); Nicholas Leventis, Worcester, MA (US); Rushi Soni, Rolla, MO (US); Vaibhav Edlabadkar, Rolla, MO (US); Parwani Rewatkar, Hillsboro, OR (US); ABM Shaheen ud Doulah, Rolla, MO (US)

(73) Assignee: The Curators of the University of Missouri, Columbia, MO (US)

(21) Appl. No.: 18/554,074

(22) PCT Filed: Apr. 5, 2022
(86) PCT No.: PCT/US2022/023475

§ 371 Date: Oct. 5, 2023

Related U.S. Application Data
(60) Provisional application No. 63/170,827, filed on Apr. 5, 2021.

(51) Int. Cl. C04B 38/00; H01M 4/583

(52) U.S. Cl. CPC C04B 38/0022; H01M 4/583; C04B 2235/48; C04B 2235/5409; H01M 2004/027

(57) ABSTRACT

Novel methods of synthesizing amorphous carbon and graphitic carbon aerogels are provided. The carbon aerogels produced by these methods are highly porous, monolithic carbon aerogels and are extremely robust. Specifically, the amorphous carbon aerogels have high surface areas and large micropore volumes. Due to these extraordinary properties, these aerogels possess high carbon dioxide (CO2) sorption capacities and are highly selective towards CO2 versus other gases, such as H2 and N2. As a result, the amorphous carbon aerogels can be used to effectively capture or remove CO2 from the air and/or from flue gases. Furthermore, the graphitic carbon aerogels notably have high graphite content, crystallite size, and graphite quality, of which are comparable to those of commercial graphite.

### RELATED APPLICATIONS

The present application claims the priority benefit of U.S. Provisional Patent Application Ser. No. 63/170,827, filed Apr. 5, 2021, entitled AMORPHOUS AND GRAPHITIC CARBON AEROGELS FROM COMPRESSED XEROGEL POWDERS, incorporated by reference in its entirety herein.

### STATEMENT REGARDING FEDERALLY SPONSORED RESEARCH OR DEVELOPMENT

This invention was made with government support under Contract No. 1530603 awarded by the National Science Foundation, and under Contract No. W911NF-14-1-0369 awarded by Army Research Office. The government has certain rights in the invention.

### BACKGROUND

### Field

This invention relates generally to carbon aerogel and methods of forming those carbon aerogels.

### DESCRIPTION OF RELATED ART

Aerogels are bulk, lightweight, nanostructured, and nanoporous solids derived from wet gels. Typically, an aerogel is produced by extracting the pore-filling solvent of a gel using a supercritical drying process. During this process, the pore-filling solvent is replaced with liquid CO₂ in a pressure vessel, and the liquid CO₂ is subsequently converted to a supercritical fluid, which is then vented off as a gas. However, due to the number of solvent exchanges required and the use of a supercritical fluid, the supercritical drying process is time-consuming and energy-intensive. Furthermore, the process also negatively impacts the shape and yield of the resulting aerogels. For example, the size of the pressure vessel limits the size of the aerogel, and if it is desired to prepare an aerogel with a pre-determined form factor, molding and handling of a fragile wet gel and other aerogel precursors may lower the yield.

Thus, there is a need for a new time-, energy-, and materials-efficient method of synthesizing highly porous aerogels that eliminates the supercritical drying process.

### SUMMARY

In the present disclosure, carbon aerogels are prepared from xerogel powders, which allows increased speed of the solvent exchange process and bypasses the supercritical fluid drying step of the prior art, resulting in time-, energy-, and materials-efficient methodology for fabricating porous carbons. These methods comprise preparing nanoparticulate oxides of metals and/or metalloids preferably via a step of vigorous stirring to prevent gelation, preparing polymer-modified xerogel powder compositions by reacting the nanoparticulate oxides with one or more polyfunctional monomers, compressing the polymer-modified xerogel powder compositions into shaped compacts, and carbothermally converting the shaped xerogel compacts via pyrolysis to provide the highly porous carbon aerogel monolithic objects that have the same shapes as to their corresponding xerogel compact precursors.

For the preparation of amorphous carbon aerogels, polymer-coated silica xerogel powders were prepared via free-radical surface-initiated polymerization of acrylonitrile (AN) on the network of a silica suspension derived from tetramethoxysilane (TMOS) and (3-aminopropyl)triethoxysilane (APTES). Alternatively, polymer-coated silica xerogel powders were prepared with a carbonizable polyurea (PUA) derived from the reaction of an aromatic triisocyanate with the —OH and —NH₂ groups, and the adsorbed water on the surface of a TMOS/APTES-derived silica suspension. Wet-gel powders by either method were dried under vacuum to yield xerogel powders, which were compressed into pellets, discs, or doughnut-shaped objects. These objects were then aromatized, pyrolyzed and treated with HF and/or CO₂ to remove non-carbon material, creating porosity. These monolithic porous carbons have high BET surface areas (up to about 1934 m²/g) and porosities as high as 83% v/v, and can uptake as much as about 9.15 mmol g⁻¹ of CO₂ at 273 K, with high selectivity over other gases (H₂, N₂ and CH₄).

Graphitic carbon aerogels are prepared from polyacrylonitrile at lower temperatures (up to about 1,500° C.) compared to conventional graphitization (>2400° C.). In one embodiment, the process starts with preparation of polyacrylonitrile-coated iron and cobalt oxide xerogel powders via surface-initiated free-radical polymerization of acrylonitrile on the network of a sol-gel-derived suspension of the metal oxide. These wet-gel powders were dried under vacuum to yield xerogel powders that were compressed into pellets, discs, or doughnut-shaped objects. These objects were then aromatized (about 300° C., O₂), and subsequently they were pyrolyzed at temperatures varying from about 800° C. to about 1,500° C. under Ar to give eventually Fe- or Co-doped graphitized porous carbons. Treatment with aqua-regia removed the metal nanoparticles completely leaving behind pure graphite aerogels. High porosities, in the range of about 60% to about 70% v/v, were created during (a) the pyrolytic carbonization/graphitization of polyacrylonitrile, and (b) removal of the metal. Characterization of all intermediates and final aerogels was carried out with solid-state ¹³C NMR, powder-XRD, Raman, TEM, SEM, and N₂-sorption. Pure graphitic carbon aerogels had crystallite size in the range of about 30 Å to about 170 Å along the (111) plane, as calculated from powder-XRD data using the Scherrer equation. The crystallite width along the a-axis was in the range of about 20 to about 70 nm (from Raman data using Knight's formula). These graphitic carbon aerogels showed stacking of up to about 300 graphene layers with interlayer spacing of about 3.36 Å (by TEM), and different nanomorphologies ranging from nanorods, nano-worms, nanofibers, and platelets (by SEM).

In one embodiment, the disclosure broadly provides a method of forming a xerogel. The method comprises polymerizing a plurality of monomers on the surface of a support, so as to form a polymer layer on the surface. The monomers can be the same or different, and the stoichiometric ratio of monomers to support is from about 6:1 to about 14:1. The invention is also concerned with a gel formed by this method, as well as the use thereof.

In another embodiment, the disclosure is concerned with a method of forming a carbon aerogel. The method comprises heating a xerogel comprising carbon and non-carbon material at temperatures of about 700° C. to 1,600° C. so as to remove the majority of the non-carbon material and form the carbon aerogel. The invention is also concerned with a gel formed by this method, as well as the use thereof.

In a further embodiment, a graphitic carbon aerogel is provided. That graphitic carbon aerogel comprises at least about 80% by weight total carbon, less than about 10% by weight metal; and less than about 3% by weight silicon, with the percentages by weight being based on the total weight of the graphitic carbon aerogel taken as 100% by weight. The graphitic carbon aerogel also comprises at least about 55% by weight graphitic carbon, with this percentage by weight being based on the weight of total carbon in the graphitic carbon aerogel taken as 100% by weight. Finally, the graphitic carbon aerogel comprises a BET multipoint surface area of 25 m²/g to about 350 m²/g and an average micropore surface area of about 0.1 m²/g to about 120 m²/g.

The invention is also concerned with the use of such graphitic carbon aerogels, such as a battery anode comprising such a graphitic carbon aerogel.

In a further embodiment, an amorphous carbon aerogel is provided. The amorphous carbon aerogel comprises at least about 70% by weight carbon, less than about 10% by weight metal; and less than about 3% by weight silicon, with the percentages by weight being based on the total weight of the amorphous carbon aerogel taken as 100% by weight. Finally, the amorphous carbon aerogel has a BET surface area of 400 m²/g to about 2,500 m²/g and an average micropore surface area of about 200 m²/g to about 850 m²/g. The invention is also concerned with the use of such amorphous carbon aerogels, such as for sorbing CO₂.

The disclosure also provides a method of functionalizing the surfaces of particles, where the method comprises reacting a bidentate free radical initiator salt with the surfaces at a temperature of about −10° C. or greater so as to cause the bidentate free radical initiator salt to bond to the surfaces.

### BRIEF DESCRIPTION OF THE DRAWINGS

FIG. 1 shows an illustration of the functionalization of silica with —OH & —NH₂ moieties and an illustration of the crosslinking of PUA@silica with tris(4-isocyanatophenyl)methane;

FIG. 2 shows a flowchart overview of the synthesis method used for the PUA@silica compacts annotated with photographs of the APTES@silica suspension powder, PUA@silica powder, PUA@silica compact, and die utilized to create the PUA@silica compact;

FIG. 3A shows an illustration of the functionalization of silica with a free-radical initiator of the —N═N— type and the crosslinking of PAN@silica with acrylonitrile;

FIG. 3B shows an illustration of the preparation method of the free-radical initiator;

FIG. 4 shows a flowchart overview of the synthesis method used for the PAN@silica compacts annotated with photographs of the initiator@silica suspension powder, PAN@silica powder, PAN@silica compact, and die utilized to create the PAN@silica compact;

FIG. 5 is a graph showing the thermogravimetric analysis plot for APTES@silica and PUA-3×@silica (abbreviated as PUA@silica);

FIG. 6 is a graph showing the thermogravimetric analysis plot for initiator@silica and PAN-6×@silica-(9:1) (abbreviated as PAN@silica);

FIG. 7 is a graph showing the modulated differential scanning calorimetry plot for PAN-6×@silica(9:1);

FIG. 8A shows the solid-state cross-polarization magic angle spinning (CPMAS)¹³C nuclear magnetic resonance (NMR) spectra of PAN-6×@silica(9:1) and PAN-6×@silica(9:1) subjected to different oxidation conditions;

FIG. 8B shows the solid-state CPMAS ¹³C NMR spectra of PAN-6×@silica(7:3), PAN-2×@silica(7:3), PAN-6×@silica(9:1), and PAN-2×@silica(9:1);

FIG. 9A shows the solid-state CPMAS ²⁹Si NMR spectra of APTES@silica and PUA-4.5×@silica (abbreviated as PUA@silica);

FIG. 9B shows the solid-state CPMAS ¹³C NMR spectra of APTES@silica, PUA-4.5×@silica (abbreviated as PUA@silica), and TIPM-derived PUA;

FIG. 9C is a schematic depiction of the latching of TIPM-derived polyurea on the surface of silica;

FIG. 10A shows the solid-state CPMAS ²⁹Si NMR spectra of PUA-4.5×@silica, PUA-3×@silica, and PUA-1.5×@silica;

FIG. 10B shows the solid-state CPMAS ¹³C NMR spectra of PUA-4.5×@silica, PUA-3×@silica, and PUA-1.5×@silica;

FIG. 11A is a schematic depiction of the preparation of the 4,4′-azobis-4-cyanovaleric acid (ABCVA)-based free-radical initiator through an acid-base reaction of ABCVA and 3-aminopropyltriethoxysilane (APTES);

FIG. 11B shows the liquid ¹³C NMR spectra in THF-d₈ of ABCVA-based free-radical initiator, ABCVA, and APTES;

FIG. 12A shows the solid-state CPMAS ²⁹Si NMR spectra of PAN-6×@silica(9:1) (abbreviated as PAN@silica) and initiator@silica;

FIG. 12B shows the solid-state CPMAS ¹³C NMR spectra of PAN-6×@silica(9:1) (abbreviated as PAN@silica), initiator@silica, ABCVA, and APTES@silica;

FIG. 13A shows the solid-state CPMAS ²⁹Si NMR spectra of PAN-6×@silica(7:3), PAN-2×@silica(7:3), PAN-6×@silica(9:1), and PAN-2×@silica(9:1);

FIG. 13B shows the solid-state CPMAS ¹³C NMR spectra of PAN-6×@silica(7:3), PAN-2×@silica(7:3), PAN-6×@silica(9:1), and PAN-2×@silica(9:1);

FIG. 14 shows the solid-state CPMAS ²⁹Si NMR spectrum of A-PAN-6×@silica(9:1) (abbreviated as aromatized-PAN@silica) as compared to solid-state CPMAS ²⁹Si NMR spectra of PAN-6×@silica(9:1) (abbreviated as PAN@silica) and initiator@silica;

FIG. 15 shows the energy dispersive x-ray spectroscopy of the C-PUA-3×@silica, C-PUA-3×@silica-HF, C-PAN-6×@silica(9:1), and C-PAN-6×@silica(9:1)-HF aerogels;

FIG. 16A shows the X-ray photoelectron spectroscopy (XPS) spectrum of Si 2p from C-PUA-4.5×@silica;

FIG. 16B shows the XPS spectrum of Si 2p from the C-PAN-6×@silica(9:1) aerogel;

FIG. 17A shows the XPS spectrum of the O 1s peaks for the C-PUA-4.5×@silica aerogel;

FIG. 17B shows the XPS spectrum of the O 1s peaks for the C-PUA-4.5×@silica-HF—CO₂ aerogel;

FIG. 17C shows the XPS spectrum of the O 1s peaks for the C-PUA-4.5×@silica-CO₂—HF aerogel;

FIG. 17D shows the XPS spectrum of the O 1s peaks for the C-PAN-6×@silica(9:1) aerogel;

FIG. 17E shows the XPS spectrum of the O 1s peaks for the C-PAN-6×@silica(9:1)-HF—CO₂ aerogel;

FIG. 17F shows the XPS spectrum of the O 1s peaks for the C-PAN-6×@silica(9:1)-CO₂—HF aerogel;

FIG. 17G shows the XPS spectrum of the O is (Si—O, C═O) peaks for the C-PUA-4.5×@silica (abbreviated as C-PUA@silica) aerogel;

FIG. 17H shows the XPS spectrum of the O is (C═O) peak for the C-PUA-4.5×@silica-HF—CO₂ (abbreviated as C-PUA@silica)-HF—CO₂ aerogel;

FIG. 17I shows the XPS spectrum of the O 1s (C═O) peak for the C-PUA-4.5×@silica-CO₂—HF (abbreviated as C-PUA@silica)-CO₂—HF aerogel;

FIG. 18A shows the XPS spectrum of the N 1s peaks for the C-PUA-4.5×@silica aerogel;

FIG. 18B shows the XPS spectrum of the N 1s peaks for the C-PUA-4.5×@silica-HF—CO₂; aerogel

FIG. 18C shows the XPS spectrum of the N 1s peaks for the C-PUA-4.5×@silica-CO₂—HF aerogel;

FIG. 18D shows the XPS spectrum of the N 1s peaks for the C-PAN-6×@silica(9:1) aerogel;

FIG. 18E shows the XPS spectrum of the N 1s peaks for the C-PAN-6×@silica(9:1)-HF—CO₂ aerogel;

FIG. 18F shows the XPS spectrum of the N 1s peaks for the C-PAN-6×@silica(9:1)-CO₂—HF aerogel;

FIG. 19A shows the XPS spectrum of the C 1s peaks for the C-PUA-4.5×@silica aerogel;

FIG. 19B shows the XPS spectrum of the C 1s peaks for the C-PUA-4.5×@silica-HF—CO₂ aerogel;

FIG. 19C shows the XPS spectrum of the C 1s peaks for the C-PUA-4.5×@silica-CO₂—HF aerogel;

FIG. 19D shows the XPS spectrum of the C 1s peaks for the C-PAN-6×@silica(9:1) aerogel;

FIG. 19E shows the XPS spectrum of the C 1s peaks for the C-PAN-6×@silica(9:1)-HF—CO₂ aerogel;

FIG. 19F shows the XPS spectrum of the C 1s peaks for the C-PAN-6×@silica(9:1)-CO₂—HF aerogel;

FIG. 20 shows a photograph with an aerial view of the PUA-3×@silica compacts (abbreviated as PUA@silica) along carbonization (C-PUA@silica) and etching (C-PUA@silica-HF, C-PUA@silica-HF—CO₂, C-PUA@silica-CO₂, and C-PUA@silica-CO₂—HF) and a photograph with an aerial view of the PAN-6×@silica(9:1) compacts (abbreviated as PAN@silica) along aromatization (A-PAN@silica), carbonization (C-PAN@silica), and etching (C-PAN@silica-HF, C-PAN@silica-HF—CO₂, C-PAN@silica-CO₂, and C-PAN@silica-CO₂—HF);

FIG. 21 shows a series of scanning electron microscope (SEM) photographs of PUA-4.5×@silica compacts (abbreviated as PUA@silica) along carbonization (abbreviated as C-PUA@silica) and etching (abbreviated as C-PUA@silica-HF, C-PUA@silica-HF—CO₂, C-PUA@silica-CO₂, and C-PUA@silica-CO₂—HF);

FIG. 22 shows a series of SEM photographs of PAN-6×@silica(9:1) compacts (abbreviated as PAN@silica) along aromatization (abbreviated as A-PAN@silica), carbonization (abbreviated as C-PAN@silica), and etching (abbreviated as C-PAN@silica-HF, C-PAN@silica-HF—CO₂, C-PAN@silica-CO₂, and C-PAN@silica-CO₂—HF);

FIG. 23A is a graph showing the representative N₂-sorption isotherms at 77K of the carbonized and etched C-PUA-4.5×@silica aerogels (abbreviated as C-PUA@silica, C-PUA@silica-HF, C-PUA@silica-HF—CO₂, C-PUA@silica-CO₂, and C-PUA@silica-CO₂—HF) with an inset graph showing the pore size distribution data calculated using the Barrett, Joyner, and Halenda (BJH) method for the C-PUA@silica, C-PUA@silica-HF, and C-PUA@silica-CO₂ aerogels;

FIG. 23B is a graph showing the representative N₂-sorption isotherms at 77K of the carbonized and etched C-PAN-6×@silica-(9:1) aerogels (abbreviated as C-PAN@silica, C-PAN@silica-HF, C-PAN@silica-HF—CO₂, C-PAN@silica-CO₂, and C-PAN@silica-CO₂—HF) with an inset graph showing the pore size distribution data calculated using the BJH method for the C-PAN@silica, C-PAN@silica-HF, and C-PAN@silica-CO₂ aerogels;

FIG. 24A is a graph showing the pore size distribution data calculated using the BJH method for the C-PUA-4.5×@silica-HF—CO₂ and C-PUA-4.5×@silica-CO₂—HF aerogels (abbreviated as C-PUA@silica-HF—CO₂ and C-PUA@silica-CO₂—HF, respectively);

FIG. 24B is a graph showing the pore size distribution data calculated using the BJH method for the C-PAN-6×@silica(9:1)-HF—CO₂ and C-PAN-6×@silica(9:1)-CO₂—HF aerogels (abbreviated as C-PAN@silica-HF—CO₂ and C-PAN@silica-CO₂—HF, respectively);

FIG. 25 is a schematic model of C-PUA@silica and C-PAN@silica (abbreviated as C-poly@silica) etched with HF and CO₂ in either sequence;

FIG. 26A is a graph showing the representative CO₂ isotherms at 273K and 298K for the C-PUA-4.5×@silica-HF—CO₂ compact;

FIG. 26B is a graph showing the representative CO₂ isotherms at 273K and 298K for the C-PUA-4.5×@silica-CO₂—HF compact;

FIG. 27A is a graph showing the virial fitting of CO₂ adsorption isotherms at 273K and 298K for the C-PAN-2×@silica(7:3)-HF—CO₂ compact;

FIG. 27B is a graph showing the virial fitting of CO₂ adsorption isotherms at 273K and 298K for the C-PAN-2×@silica(7:3)-CO₂—HF compact;

FIG. 28A is a graph showing the CO₂ adsorption isotherms at 273K and 298K for the C-PUA@silica-HF—CO₂ aerogel (for clarity only the adsorption branches are shown);

FIG. 28B is a graph showing the CO₂ adsorption isotherms at 273K and 298K for the C-PUA@silica-CO₂—HF aerogel (for clarity only the adsorption branches are shown);

FIG. 28C is a graph showing the CO₂ adsorption isotherms at 273K and 298K for the C-PAN@silica-HF—CO₂ aerogel (for clarity only the adsorption branches are shown);

FIG. 28D is a graph showing the CO₂ adsorption isotherms at 273K and 298K for the C-PAN@silica-CO₂—HF aerogel (for clarity, only the adsorption branches are shown, but all isotherms were reversible without hysteresis);

FIG. 29A is a graph showing the porosity of the PUA-1.5×@silica, PUA-3×@silica, and PUA-4.5×@silica compacts as prepared (PUA@silica) and along carbonization (C-PUA@silica) and etching (C-PUA@silica-HF, C-PUA@silica-HF—CO₂, C-PUA@silica-CO₂, and C-PUA@silica-CO₂—HF);

FIG. 29B is a graph showing the Brunauer-Emmett-Teller (BET) multipoint surface area of the PUA-1.5×@silica, PUA-3×@silica, and PUA-4.5×@silica compacts as prepared (PUA@silica) and along carbonization (C-PUA@silica) and etching (C-PUA@silica-HF, C-PUA@silica-HF—CO₂, C-PUA@silica-CO₂, and C-PUA@silica-CO₂—HF);

FIG. 29C is a graph showing the porosity of the PAN-6×@silica(9:1), PAN-2×@silica(9:1), PAN-6×@silica(7:3), and PAN-2×@silica(7:3) compacts as prepared (PAN@silica) and along aromatization (A-PAN@silica), carbonization (C-PAN@silica), and etching (C-PAN@silica-HF, C-PAN@silica-HF—CO₂, C-PAN@silica-CO₂, and C-PAN@silica-CO₂—HF)

FIG. 29D is a graph showing the BET multipoint surface area of the PAN-6×@silica(9:1), PAN-2×@silica(9:1), PAN-6×@silica(7:3), and PAN-2×@silica(7:3) compacts as prepared (PAN@silica) and along aromatization (A-PAN@silica), carbonization (C-PAN@silica), and etching (C-PAN@silica-HF, C-PAN@silica-HF—CO₂, C-PAN@silica-CO₂, and C-PAN@silica-CO₂—HF);

FIG. 29E is a comparative graph showing the CO₂ adsorption by the C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF aerogels versus other sorbents at 273K;

FIG. 30A is a graph showing the micropore size distributions calculated using the density-functional theory (DFT) method as applied to CO₂ adsorption data at 273K for the C-PUA-4.5×@silica-HF—CO₂ aerogel;

FIG. 30B is a graph showing the micropore size distributions calculated using the DFT method as applied to CO₂ adsorption data at 273K for the C-PUA-4.5×@silica-CO₂—HF aerogel;

FIG. 30C is a graph showing the micropore size distributions calculated using the DFT method as applied to CO₂ adsorption data at 273K for the C-PAN-2×@silica(7:3)-HF—CO₂ aerogel;

FIG. 30D is a graph showing the micropore size distributions calculated using the DFT method as applied to CO₂ adsorption data at 273K for the C-PAN-2×@silica(7:3)-CO₂—HF aerogel;

FIG. 31 shows the differential (z) experimental data plot from expected CO₂ uptake versus average micropore diameter for all carbonized and double-etched PUA@silica and PAN@silica aerogels;

FIG. 32 is a graph showing the isosteric heats of CO₂ adsorption for the C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF aerogels;

FIG. 33A is a graph showing the representative CH₄ adsorption isotherms at 273K for C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF aerogels (for clarity, only adsorption is shown, but all isotherms are reversible without any hysteresis);

FIG. 33B is a graph showing the representative H₂ adsorption isotherms at 273K for C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF aerogels (for clarity, only adsorption is shown but all isotherms are reversible without any hysteresis);

FIG. 34A is a bar graph showing the selectivity of the C-PUA-4.5×@silica-HF—CO₂ and C-PUA-4.5×@silica-CO₂—HF aerogels toward CO₂ adsorption versus CH₄, N₂, and H₂;

FIG. 34B is a bar graph showing the selectivity of the C-PAN-2×@silica(7:3)-HF—CO₂ and C-PAN-2×@silica(7:3)-CO₂—HF aerogels toward CO₂ adsorption versus CH₄, N₂, and H₂;

FIG. 35A shows a flowchart overview of the synthesis method used for the FeOx gel suspension annotated with a photograph of the FeOx gel suspension powder;

FIG. 35B shows a flowchart overview of the synthesis method used for the CoOx gel suspension annotated with a photograph of the CoOx gel suspension powder;

FIG. 36 shows a flowchart overview of the synthesis method used for the PAN@FeOx and PAN@CoOx (abbreviated as PAN@MOx) compacts annotated with photographs of the initiator@FeOx and initiator@CoOx (abbreviated as initiator@MOx) powders, PAN@FeOx and PAN@CoOx powders, and PAN@FeOx and PAN@CoOx compacts;

FIG. 37 is a graph showing the thermogravimetric analysis plot for initiator@CoOx, initiator@FeOx, PAN@CoOx, and PAN@FeOx powders;

FIG. 38 is a graph showing the modulated differential scanning calorimetry plot for PAN@FeOx and PAN@CoOx;

FIG. 39A is a schematic depiction of the preparation of the ABCVA-based free-radical initiator through a reaction of ABCVA and ethyl chloroformate (EtOCOCl);

FIG. 39B shows the liquid ¹³C NMR spectra in THF-d₈ of ABCVA-based free-radical initiator, EtOCOCl, and ABCVA;

FIG. 40A shows the solid-state CPMAS ¹³C NMR spectrum of PAN@silica compared to the solid-state CPMAS ¹³C NMR spectra of PAN@FeOx, PAN@CoOx, A-PAN@FeOx and A-PAN@CoOx compacts after treatment with dilute HCl;

FIG. 40B is a schematic reaction equation for the surface-initiated polymerization of acrylonitrile;

FIG. 40C is a schematic reaction equation for the aromatization of the PAN@FeOx and PAN@CoOx compacts;

FIG. 41A shows the XPS spectra of the C 1s peaks (left), the N 1s peaks (middle) O is peaks (right) for the G-PAN₈₀₀_from_Fe aerogel;

FIG. 41B shows the XPS spectra of the C 1s peaks (left), the N 1s peaks (middle) O is peaks (right) for the G-PAN₁₅₀₀_from_Fe aerogel;

FIG. 42A shows the XPS spectrum of Fe 2p from the G-PAN₈₀₀@Fe aerogel;

FIG. 42B shows the XPS spectrum of Fe 2p from the G-PAN₁₁₀₀@Fe aerogel;

FIG. 42C shows the XPS spectrum of Fe 2p from the G-PAN₁₅₀₀@Fe aerogel;

FIG. 43A shows the XPS spectrum of the C 1s peaks for the G-PAN₈₀₀@Fe aerogel;

FIG. 43B shows the XPS spectrum of the C 1s peaks for the G-PAN₈₀₀_from_Fe aerogel;

FIG. 43C shows the XPS spectrum of the C 1s peaks for the G-PAN₁₁₀₀@Fe aerogel;

FIG. 43D shows the XPS spectrum of the C 1s peaks for the G-PAN₁₁₀₀_from_Fe aerogel;

FIG. 43E shows the XPS spectrum of the C 1s peaks for the G-PAN₁₅₀₀@Fe aerogel;

FIG. 43F shows the XPS spectrum of the C 1s peaks for the G-PAN₁₅₀₀_from_Fe aerogel;

FIG. 44A shows the XPS spectrum of the N 1s peaks for the G-PAN₈₀₀@Fe aerogel;

FIG. 44B shows the XPS spectrum of the N 1s peaks for the G-PAN₈₀₀_from_Fe aerogel;

FIG. 44C shows the XPS spectrum of the N 1s peaks for the G-PAN₁₁₀₀@Fe aerogel;

FIG. 44D shows the XPS spectrum of the N 1s peaks for the G-PAN₁₁₀₀_from_Fe aerogel;

FIG. 44E shows the XPS spectrum of the N 1s peaks for the G-PAN₁₅₀₀@Fe aerogel;

FIG. 44F shows the XPS spectrum of the N 1s peaks for the G-PAN₁₅₀₀_from_Fe aerogel;

FIG. 45A shows the XPS spectrum of the O 1s peaks for the G-PAN₈₀₀@Fe aerogel;

FIG. 45B shows the XPS spectrum of the O 1s peaks for the G-PAN₈₀₀_from_Fe aerogel;

FIG. 45C shows the XPS spectrum of the O 1s peaks for the G-PAN₁₁₀₀@Fe aerogel;

FIG. 45D shows the XPS spectrum of the O 1s peaks for the G-PAN₁₁₀₀_from_Fe aerogel;

FIG. 45E shows the XPS spectrum of the O 1s peaks for the G-PAN₁₅₀₀@Fe aerogel;

FIG. 45F shows the XPS spectrum of the O 1s peaks for the G-PAN₁₅₀₀_from_Fe aerogel;

FIG. 46A shows the XPS spectrum of Co 2p from the G-PAN₈₀₀@Co aerogel;

FIG. 46B shows the XPS spectrum of Co 2p from the G-PAN₁₁₀₀@Co aerogel;

FIG. 46C shows the XPS spectrum of Co 2p from the G-PAN₁₅₀₀@Co aerogel;

FIG. 47A shows the XPS spectrum of the C 1s peaks for the G-PAN₈₀₀@Co aerogel;

FIG. 47B shows the XPS spectrum of the C 1s peaks for the G-PAN₈₀₀_from_Co aerogel;

FIG. 47C shows the XPS spectrum of the C 1s peaks for the G-PAN₁₁₀₀@Co aerogel;

FIG. 47D shows the XPS spectrum of the C 1s peaks for the G-PAN₁₁₀₀_from_Co aerogel;

FIG. 47E shows the XPS spectrum of the C 1s peaks for the G-PAN₁₅₀₀@Co aerogel;

FIG. 47F shows the XPS spectrum of the C 1s peaks for the G-PAN₁₅₀₀_from_Co aerogel;

FIG. 48A shows the XPS spectrum of the N 1s peaks for the G-PAN₈₀₀@Co aerogel;

FIG. 48B shows the XPS spectrum of the N 1s peaks for the G-PAN₈₀₀_from_Co aerogel;

FIG. 48C shows the XPS spectrum of the N 1s peaks for the G-PAN₁₁₀₀@Co aerogel;

FIG. 48D shows the XPS spectrum of the N 1s peaks for the G-PAN₁₁₀₀_from_Co aerogel;

FIG. 48E shows the XPS spectrum of the N 1s peaks for the G-PAN₁₅₀₀@Co aerogel;

FIG. 48F shows the XPS spectrum of the N 1s peaks for the G-PAN₁₅₀₀_from_Co aerogel;

FIG. 49A shows the XPS spectrum of the O 1s peaks for the G-PAN₈₀₀@Co aerogel;

FIG. 49B shows the XPS spectrum of the O 1s peaks for the G-PAN₈₀₀_from_Co aerogel;

FIG. 49C shows the XPS spectrum of the O 1s peaks for the G-PAN₁₁₀₀@Co aerogel;

FIG. 49D shows the XPS spectrum of the O 1s peaks for the G-PAN₁₁₀₀_from_Co aerogel;

FIG. 49E shows the XPS spectrum of the O 1s peaks for the G-PAN₁₅₀₀@Co aerogel;

FIG. 49F shows the XPS spectrum of the O 1s peaks for the G-PAN₁₅₀₀_from_Co aerogel;

FIG. 50 shows the powder x-ray diffraction (XRD) spectra of the G-PAN_{800, 1000, 1100, 1200, 1400, 1500}@Co (top left), G-PAN_{800, 1000, 1100, 1200, 1400, 1500}@Fe (top right), G-PAN_{800, 1000, 1100, 1200, 1400, 1500}_from_Co (bottom left), and G-PAN_{800, 1000, 1100, 1200, 1400, 1500}_from_Fe (bottom right) aerogels;

FIG. 51A shows a transmission electron microscopy (TEM) photograph (left) of G-PAN₁₅₀₀@Fe and energy dispersive x-ray (EDX) mapping of G-PAN₁₅₀₀@Fe (middle—gray represents the presence of carbon; right—gray represents the presence of iron);

FIG. 51B shows a TEM photograph (left) of G-PAN₁₅₀₀@Co and EDX mapping of the G-PAN₁₅₀₀@Co aerogel (middle—gray represents the presence of carbon; right—gray represents the presence of cobalt);

FIG. 52 shows a graph of powder XRD spectra of carbon black and three control samples (left) and an expanded version of the graph (right);

FIG. 53 is a graph of the weight percent of graphitic carbon as a function of the pyrolysis temperature for the G-PAN_{800, 1000, 1100, 1200, 1400, 1500}_from_Co and G-PAN_{800, 1000, 1100, 1200, 1400, 1500}_from_Fe aerogels;

FIG. 54 is a graph of the crystallite domain size (calculated from powder XRD data (FIG. 50) using the Scherrer equation) as a function of the pyrolysis temperature for the G-PAN_{800, 1000, 1100, 1200, 1400, 1500}_from_Co and G-PAN_{800, 1000, 1100, 1200, 1400, 1500}_from_Fe aerogels;

FIG. 55 shows the Raman spectra of the G-PAN_{800, 1000, 1100, 1200, 1400, 1500}_from_Fe (left) and G-PAN_{800, 1000, 1100, 1200, 1400, 1500}_from_Co (left) aerogels;

FIG. 56 is a graph of the crystallite width (calculated from Raman data (FIG. 55) using the Knight's empirical formula) as a function of the pyrolysis temperature for the G-PAN_{800, 1000, 1100, 1200, 1400, 1500}_from_Co and G-PAN_{800, 1000, 1100, 1200, 1400, 1500}_from_Fe aerogels;

FIG. 57A is a representative TEM photograph with graphite interlayer spacing data of the G-PAN₈₀₀@Fe aerogel;

FIG. 57B is a representative TEM photograph with graphite interlayer spacing data of the G-PAN₈₀₀_from_Fe aerogel;

FIG. 57C is a representative TEM photograph with graphite interlayer spacing data of the G-PAN₁₀₀₀@Fe aerogel;

FIG. 57D is a representative TEM photograph with graphite interlayer spacing data of the G-PAN₁₀₀₀_from_Fe aerogel;

FIG. 57E is a representative TEM photograph with graphite interlayer spacing data of the G-PAN₁₁₀₀@Fe aerogel;

FIG. 57F is a representative TEM photograph with graphite interlayer spacing data of the G-PAN₁₁₀₀_from_Fe aerogel;

FIG. 57G is a representative TEM photograph with graphite interlayer spacing data of the G-PAN₁₂₀₀@Fe aerogel;

FIG. 57H is a representative TEM photograph with graphite interlayer spacing data of the G-PAN₁₂₀₀_from_Fe aerogel;

FIG. 571 is a representative TEM photograph with graphite interlayer spacing data of the G-PAN₁₄₀₀@Fe aerogel;

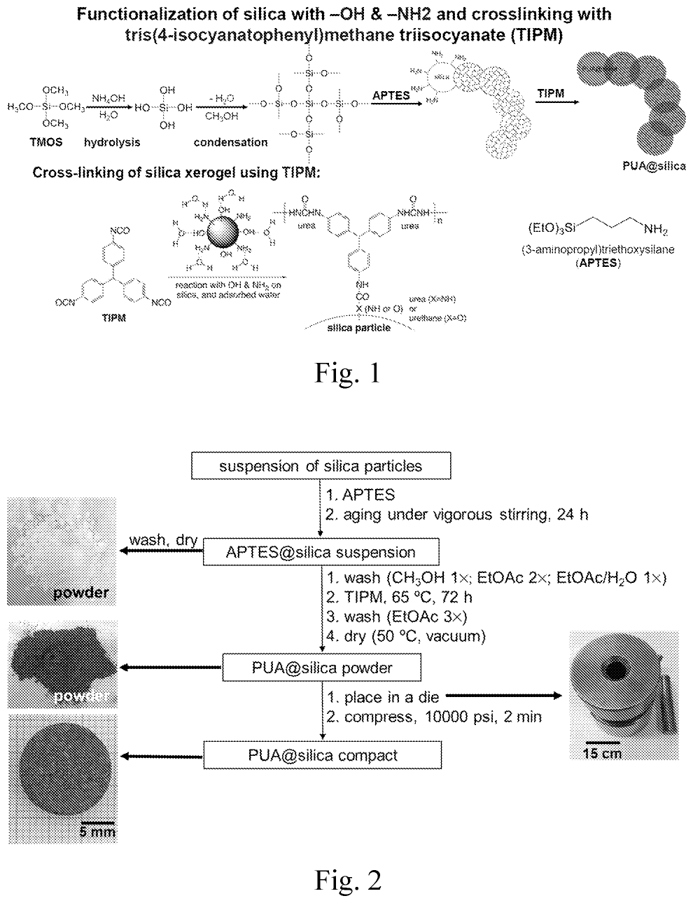

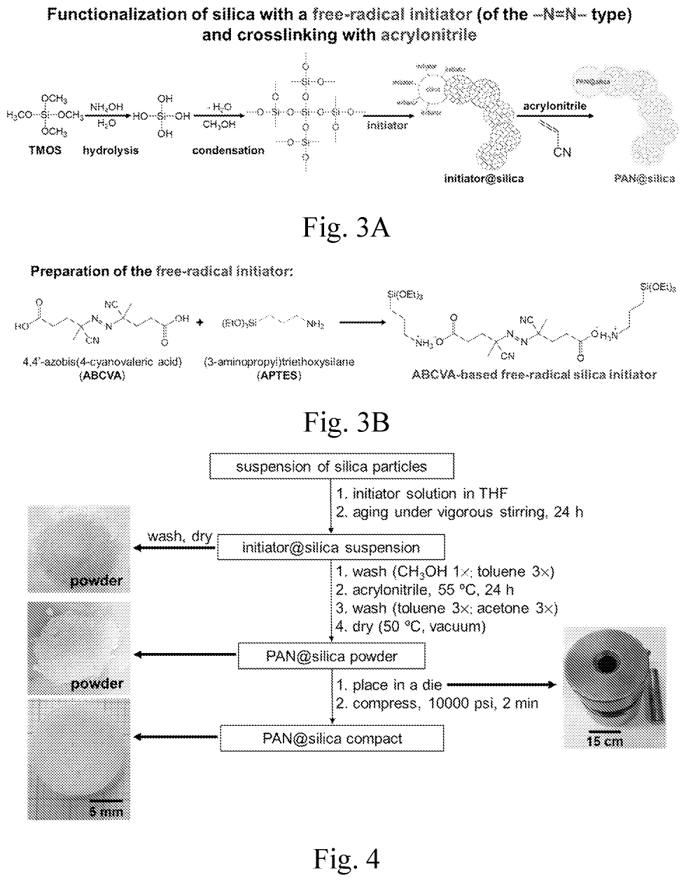

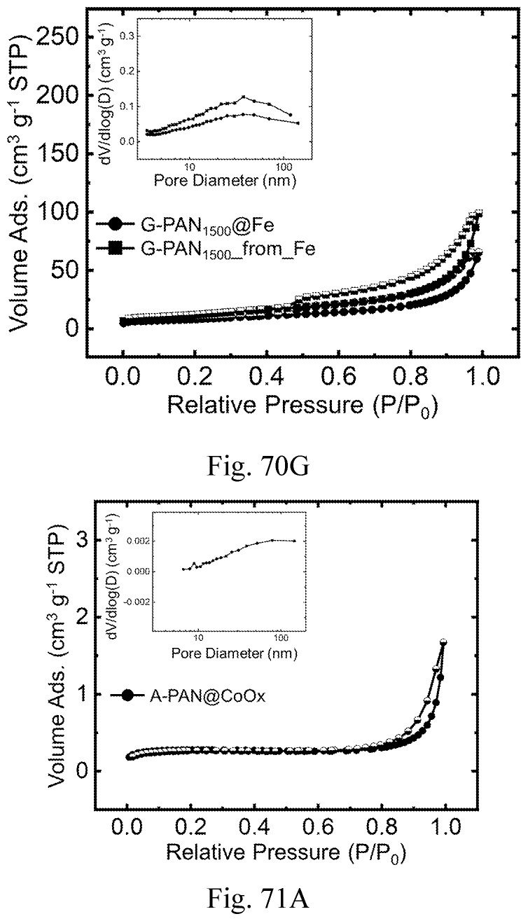

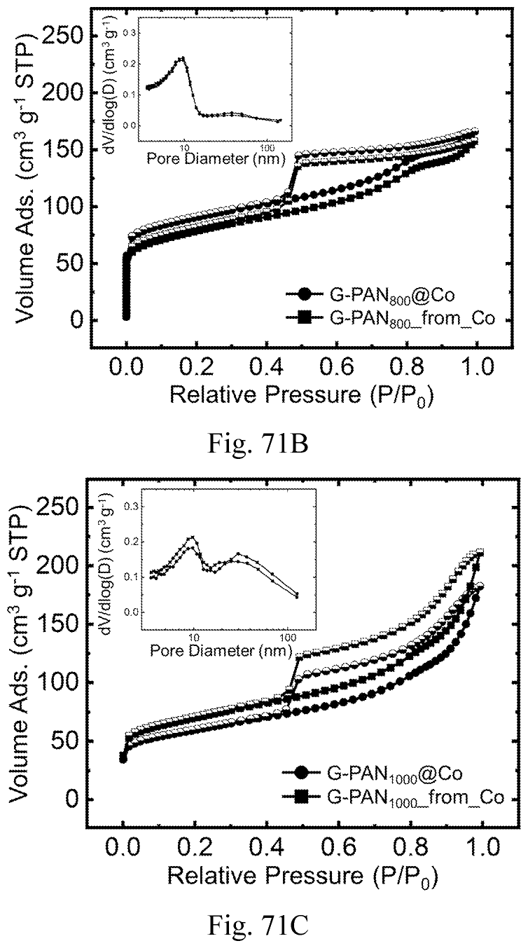

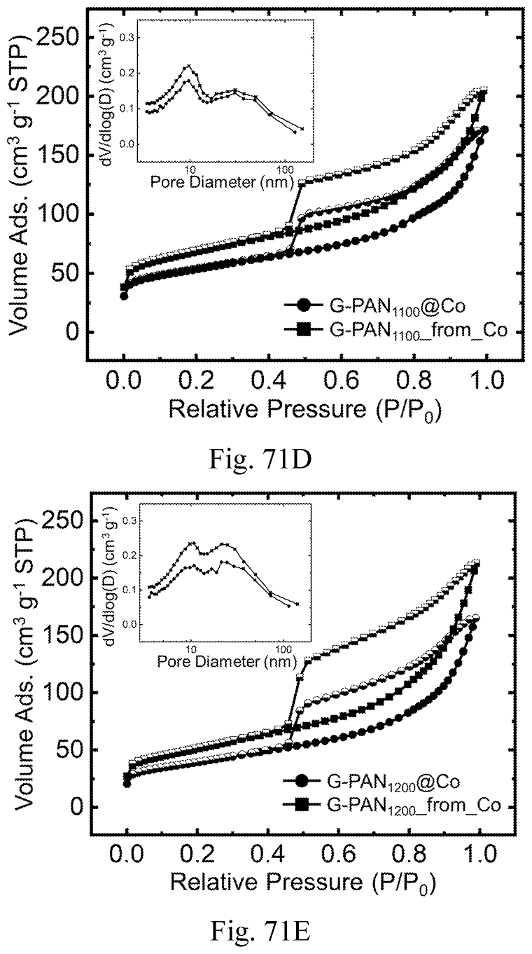

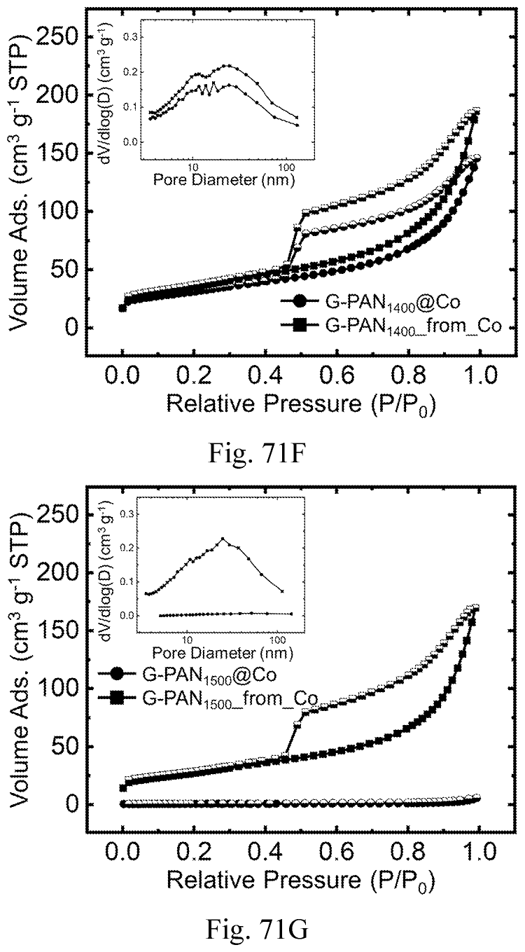

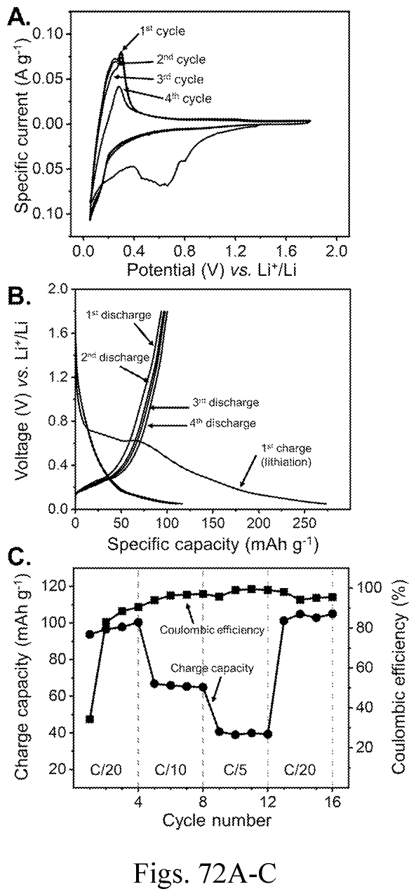

FIG. 57J is a representative TEM photograph with graphite interlayer spacing data of the G-PAN₁₄₀₀_from_Fe aerogel;

FIG. 57K is a representative TEM photograph with graphite interlayer spacing data of the G-PAN₁₅₀₀@Fe aerogel;

FIG. 57L is a representative TEM photograph with graphite interlayer spacing data of the G-PAN₁₅₀₀_from_Fe aerogel;

FIG. 58A is a representative TEM photograph with graphite interlayer spacing data of the G-PAN₈₀₀@Co aerogel;

FIG. 58B is a representative TEM photograph with graphite interlayer spacing data of the G-PAN₈₀₀_from_Co aerogel;

FIG. 58C is a representative TEM photograph with graphite interlayer spacing data of the G-PAN₁₀₀₀@Co aerogel;

FIG. 58D is a representative TEM photograph with graphite interlayer spacing data of the G-PAN₁₀₀₀_from_Co aerogel;

FIG. 58E is a representative TEM photograph with graphite interlayer spacing data of the G-PAN₁₁₀₀@Co aerogel;

FIG. 58F is a representative TEM photograph with graphite interlayer spacing data of the G-PAN₁₁₀₀_from_Co aerogel;

FIG. 58G is a representative TEM photograph with graphite interlayer spacing data of the G-PAN₁₂₀₀@Co aerogel;

FIG. 58H is a representative TEM photograph with graphite interlayer spacing data of the G-PAN₁₂₀₀_from_Co aerogel;

FIG. 581 is a representative TEM photograph with graphite interlayer spacing data of the G-PAN₁₄₀₀@Co aerogel;

FIG. 58J is a representative TEM photograph with graphite interlayer spacing data of the G-PAN₁₄₀₀_from_Co aerogel;

FIG. 58K is a representative TEM photograph with graphite interlayer spacing data of the G-PAN₁₅₀₀@Co aerogel;

FIG. 58L is a representative TEM photograph with graphite interlayer spacing data of the G-PAN₁₅₀₀_from_Co aerogel;

FIG. 59 is a representative TEM photograph with graphite interlayer spacing data of the G-PAN₈₀₀_from_Co aerogel;

FIG. 60A is a representative TEM photograph with graphite interlayer spacing data of the G-PAN₁₅₀₀@Fe aerogel;

FIG. 60B is a representative TEM photograph with graphite interlayer spacing data of the G-PAN₁₅₀₀_from_Fe aerogel and an inset photograph showing the representative electron diffraction pattern for the aerogel;

FIG. 60C is a representative TEM photograph with graphite interlayer spacing data of the G-PAN₁₅₀₀@Co aerogel;

FIG. 60D is a representative TEM photograph with graphite interlayer spacing data of the G-PAN₁₅₀₀_from_Co aerogel and an inset photograph showing the representative electron diffraction pattern for the aerogel;

FIG. 60E is a representative electron diffraction pattern for the G-PAN₁₅₀₀_from_Fe aerogel;

FIG. 60F is a representative electron diffraction pattern for the G-PAN₁₅₀₀_from_Co aerogel;

FIG. 61A is a representative TEM-EDX analysis at low-magnification of the G-PAN₁₅₀₀_from_Fe aerogel;

FIG. 61B is a representative TEM-EDX analysis at low-magnification of the G-PAN₁₅₀₀_from_Co aerogel;

FIG. 62A shows a photograph with an aerial view of the PAN@FeOx compacts as prepared (PAN@FeOx) and along aromatization (A-PAN@FeOx), graphitization (G-PAN_{800, 1000, 1100, 1200, 1400, 1500}@Fe), and etching (G-PAN_{800, 1000, 1100, 1200, 1400, 1500}_from_Fe);

FIG. 62B shows a photograph with an aerial view of the PAN@CoOx compacts as prepared (PAN@CoOx) and along aromatization (A-PAN@CoOx), graphitization (G-PAN_{800, 1000, 1100, 1200, 1400, 1500}@Co), and etching (G-PAN_{800, 1000, 1100, 1200, 1400, 15000}_from_Co);

FIG. 63 is a graph showing the mass loss of the G-PAN_{800, 1000, 1100, 1200, 1400, 1500}@Fe, G-PAN_{800, 1000, 1100, 1200, 1400, 1500}_from_Fe, G-PAN_{800, 1000, 1100, 1200, 1400, 1500}@Co, and G-PAN_{800, 1000, 1100, 1200, 1400, 1500}_from_Co aerogels;

FIG. 64A is a graph showing the mass yield of the G-PAN_{800, 1000, 1100, 1200, 1400, 1500}_from_Fe aerogels with respect to the initial PAN@FeOx compacts and of the G-PAN_{800, 1000, 1100, 1200, 1400, 1500}_from_Co aerogels with respect to the initial PAN@CoOx compacts;

FIG. 64B is a graph showing the linear shrinkage of the G-PAN_{800, 1000, 1100, 1200, 1400, 1500}_from_Fe aerogels with respect to the initial PAN@FeOx compacts and of the G-PAN_{800, 1000, 1100, 1200, 1400, 1500}_from_Co aerogels with respect to the initial PAN@CoOx compacts;

FIG. 64C is a graph showing the bulk density of the G-PAN_{800, 1000, 1100, 1200, 1400, 1500}_from_Fe and G-PAN_{800, 1000, 1100, 1200, 1400, 1500}_from_Co aerogels;

FIG. 64D is a graph showing the porosity (as a percent of empty space) of the G-PAN_{800, 1000, 1100, 1200, 1400, 1500}_from_Fe and G-PAN_{800, 1000, 1100, 1200, 1400, 1500}_from_Co aerogels;

FIG. 64E is a graph showing the BET multipoint surface area and the fraction of the BET multipoint surface area allocated to micropores of the G-PAN_{800, 1000, 1100, 1200, 1400, 1500}_from_Fe and G-PAN_{800, 1000, 1100, 1200, 1400, 1500}_from_Co aerogels;

FIG. 64F is a graph showing the specific pore volume ratio of the G-PAN_{800, 1000, 1100, 1200, 1400, 1500}_from_Fe and G-PAN_{800, 1000, 1100, 1200, 1400, 1500}_from_Co aerogels;

FIG. 65A are SEM photographs of the G-PAN₈₀₀@Fe and G-PAN₈₀₀_from_Fe aerogels;

FIG. 65B are SEM photographs of the G-PAN₁₀₀₀@Fe and G-PAN₁₀₀₀_from_Fe aerogels;

FIG. 65C are SEM photographs of the G-PAN₁₁₀₀@Fe and G-PAN₁₁₀₀_from_Fe aerogels;

FIG. 65D are SEM photographs of the G-PAN₁₂₀₀@Fe and G-PAN₁₂₀₀_from_Fe aerogels;

FIG. 65E are SEM photographs of the G-PAN₁₄₀₀@Fe and G-PAN₁₄₀₀_from_Fe aerogels;

FIG. 65F are SEM photographs of the G-PAN₁₅₀₀@Fe and G-PAN₁₅₀₀_from_Fe aerogels;

FIG. 66A are SEM photographs of the G-PAN₈₀₀@Co and G-PAN₈₀₀_from_Co aerogels;

FIG. 66B are SEM photographs of the G-PA₁₀₀₀@Co and G-PAN₁₀₀₀_from_Co aerogels;

FIG. 66C are SEM photographs of the G-PAN₁₁₀₀@Co and G-PAN₁₁₀₀_from_Co aerogels;

FIG. 66D are SEM photographs of the G-PAN₁₂₀₀@Co and G-PAN₁₂₀₀_from_Co aerogels;

FIG. 66E are SEM photographs of the G-PAN₁₄₀₀@Co and G-PAN₁₄₀₀_from_Co aerogels;

FIG. 66F are SEM photographs of the G-PAN₁₅₀₀@Co and G-PAN₁₅₀₀_from_Co aerogels;

FIG. 67 shows a series of representative SEM photographs for the G-PAN_{1000, 1000, 1200, 1500}_from_Fe and G-PAN_{1000, 1100, 1200, 1500}_from_Co aerogels;

FIG. 68 is a graph showing the compressive stress-strain data for the G-PAN₁₅₀₀@Fe, G-PAN₁₅₀₀_from_Fe, G-PAN₁₅₀₀@Co, and G-PAN₁₅₀₀_from_Co aerogels;

FIG. 69A is a graph showing the representative N₂-sorption isotherms at 77K of the A-PAN@FeOx compact and the G-PAN_{800, 1100, 1200, 1400, 1500@Fe aerogels;}

FIG. 69B is a graph showing the representative N₂-sorption isotherms at 77K of the G-PAN_{800, 1100, 1200, 1400, 1500}_from_Fe aerogels;

FIG. 69C is a graph showing the representative N₂-sorption isotherms at 77K of the A-PAN@CoOx compact and the G-PAN_{800, 1100, 1200, 1400, 1500@Co aerogels;}

FIG. 69D is a graph showing the representative N₂-sorption isotherms at 77K of the G-PAN_{800, 1100, 1200, 1400, 1500}_from_Co aerogels;

FIG. 69E is a graph showing the pore size distribution data calculated using the BJH method for the A-PAN@FeOx compacts and the G-PAN_{800, 1000, 1100, 1200, 1400, 1500}@Fe aerogels;

FIG. 69F is a graph showing the pore size distribution data calculated using the BJH method for the G-PAN_{800, 1000, 1100, 1200, 1400, 1500}_from_Fe aerogels;

FIG. 69G is a graph showing the pore size distribution data calculated using the BJH method for the G-PAN_{800, 1000, 1100, 1200, 1400, 1500}@Co aerogels;

FIG. 69H is a graph showing the pore size distribution data calculated using the BJH method for the G-PAN_{800, 1000, 1100, 1200, 1400, 1500}_from_Co aerogels;

FIG. 70A is a graph showing the representative N₂-sorption isotherm of the A-PAN@FeOx compact with an inset graph showing the pore size distribution data calculated using the BJH method for the compact;

FIG. 70B is a graph showing the representative N₂-sorption isotherms of the G-PAN₈₀₀@Fe and G-PAN₈₀₀_from_Fe aerogels with an inset graph showing the pore size distribution data calculated using the BJH method for the aerogels;

FIG. 70C is a graph showing the representative N₂-sorption isotherms of the G-PAN₁₀₀₀@Fe and G-PAN₁₀₀₀_from_Fe aerogels with an inset graph showing the pore size distribution data calculated using the BJH method for the aerogels;

FIG. 70D is a graph showing the representative N₂-sorption isotherms of the G-PAN₁₁₀₀@Fe and G-PAN₁₁₀₀_from_Fe aerogels with an inset graph showing the pore size distribution data calculated using the BJH method for the aerogels;

FIG. 70E is a graph showing the representative N₂-sorption isotherms of the G-PAN₁₂₀₀@Fe and G-PAN₁₂₀₀_from_Fe aerogels with an inset graph showing the pore size distribution data calculated using the BJH method for the aerogels;

FIG. 70F is a graph showing the representative N₂-sorption isotherms of the G-PAN₁₄₀₀@Fe and G-PAN₁₄₀₀_from_Fe aerogels with an inset graph showing the pore size distribution data calculated using the BJH method for the aerogels;

FIG. 70G is a graph showing the representative N₂-sorption isotherms of the G-PAN₁₅₀₀@Fe and G-PAN₁₅₀₀_from_Fe aerogels with an inset graph showing the pore size distribution data calculated using the BJH method for the aerogels;

FIG. 71A is a graph showing the representative N₂-sorption isotherm of the A-PAN@CoOx compact with an inset graph showing the pore size distribution data calculated using the BJH method for the compact;

FIG. 71B is a graph showing the representative N₂-sorption isotherms of the G-PAN₈₀₀@Co and G-PAN₈₀₀_from_Co aerogels with an inset graph showing the pore size distribution data calculated using the BJH method for the aerogels;

FIG. 71C is a graph showing the representative N₂-sorption isotherms of the G-PAN₁₀₀₀@Co and G-PAN₁₀₀₀_from_Co aerogels with an inset graph showing the pore size distribution data calculated using the BJH method for the aerogels;

FIG. 71D is a graph showing the representative N₂-sorption isotherms of the G-PAN₁₁₀₀@Co and G-PAN₁₁₀₀_from_Co aerogels with an inset graph showing the pore size distribution data calculated using the BJH method for the aerogels;

FIG. 71E is a graph showing the representative N₂-sorption isotherms of the G-PAN₁₂₀₀@Co and G-PAN₁₂₀₀_from_Co aerogels with an inset graph showing the pore size distribution data calculated using the BJH method for the aerogels;

FIG. 71F is a graph showing the representative N₂-sorption isotherms of the G-PAN₁₄₀₀@Co and G-PAN₁₄₀₀_from_Co aerogels with an inset graph showing the pore size distribution data calculated using the BJH method for the aerogels;

FIG. 71G is a graph showing the representative N₂-sorption isotherms of the G-PAN₁₅₀₀@Co and G-PAN₁₅₀₀_from_Co aerogels with an inset graph showing the pore size distribution data calculated using the BJH method for the aerogels;

FIG. 72A is a graph showing the cyclic voltammogram of G-PAN₁₅₀₀_from_Fe cycled between 1.8 V and 0.05 V at 0.05 mV s⁻¹ in the coin-cell prepared in Example 20;

FIG. 72B is a graph showing the charge/discharge curves of the coin-cell prepared in Example 20 at C/20; and

FIG. 72C is a graph showing the specific capacities and Coulombic efficiency of G-PAN₁₅₀₀_from_Fe at different discharge rates.

### DETAILED DESCRIPTION

As noted above, the present disclosure is broadly concerned with methods of forming carbon aerogels from xerogel precursors. In one embodiment, the amorphous carbon aerogels are formed from polymer-modified silica xerogel precursors. In another embodiment, graphitic carbon aerogels are formed from polymer-modified metal oxide xerogel precursors.

### Methods of Making Silica Xerogels

### 1. Preparation of Silica Suspension

The preferred support in this embodiment comprises surface-modified silica particles, preferably as part of a suspension. This support is formed by preparing a suspension comprising silica particles, which can be prepared by hydrolysis (preferably base catalyzed, e.g., NH₄OH, Et₃N or pyridine) and condensation (preferably polycondensation) of a silicate such as tetramethylorthosilicate (TMOS) or tetraethylorthosilicate (TEOS). This is preferably accomplished by mixing a solution comprising the silicate (TMOS) in a solvent (e.g., CH₃OH, EtOH, DMF, acetonitrile, acetone, etc.) with a solution comprising the catalyst in a solvent (e.g., CH₃OH and water), preferably in hexane. The molar ratio of silicate to base catalyst is preferably about 10000:1 to about 5000:1, and more preferably about 7800:1 to about 7200:1. It is preferred that the two solutions are mechanically stirred at speeds of about 700 rpm to about 1,050 rpm, and more preferably about 770 rpm to about 950 rpm, for a time period of about 15 minutes to about 25 minutes, and preferably about 18 minutes to about 22 minutes, thus forming a suspension of the silica particles.

### 2. Surface Modification of Silica Particles

Next, the respective surfaces of the silica particles are modified with functional groups that are chosen based on the type of polymer that will ultimately be formed on the silica particle surfaces.

a. Functionalization of Silica Particle Surface with —NH₂

In one embodiment, an amination agent is utilized to introduce —NH₂ groups that functionalize the silica particle surfaces. The amination agent would typically be a compound that comprises one or more —NH₂ groups and at least one group capable of bonding with the oxide surface, leaving the one or more —NH₂ groups available for bonding with other compounds, as discussed below. Preferred such groups have the formula —Si(OR)₃, where R is C₁-C₃, and preferably C₂. Preferred amination agents have the formula NH₂—R—Si(OR)₃, where R is C₁-C₃. Preferred amination agents include 3-aminopropyl triethoxysilane (“APTES”) and/or 3-aminopropyl)trimethoxysilane.

The molar ratio of silicate (e.g., TMOS) to amination agent (e.g., APTES) mixed together in a solvent is preferably about 95:5 to about 80:20, and more preferably about 90:10 to about 70:30. The resulting suspension is preferably aged at room temperature and under vigorous stirring for about 22 hours to about 26 hours, and preferably about 24 hours, so as to form silica particles functionalized with —NH₂ groups. (It will be appreciated that the particles already include surface —OH groups as a result of water present during suspension preparation, while further surface —OH groups may be added by, for example, a water-saturated ethyl acetate wash before crosslinking as discussed below.)

b. Functionalization of Silica Particle Surface with Initiator

In another embodiment, the respective surfaces of the silica particles are modified to comprise a free-radical initiator immobilized on, or bonded to, those surfaces instead of the —NH₂ modification described above. Preferred initiators are azo-based free-radical initiators, such as azobisisobutyronitrile (AIBN), 4,4′-azobis(4-cyanopentanoic acid) (ABCVA), 3-(triethoxysilyl)propan-1-aminium 4,4′-azobis(4-cyanovalerate), and derivatives thereof.

One example of a derivative of the free-radical initiator is a bidentate thereof. The bidentate initiator is preferably a salt and preferably comprises a precursor free-radical initiator (e.g., ABCVA or other initiator as previously described) and a pair of “bridging” or linking compounds having functional groups that can react with the silica particle surfaces. In one embodiment, such functional groups include —Si(OR)₃, where R is C₁-C₃. One preferred bridging compound of this embodiment has the formula NH₂—R—Si(OR)₃, where R is C₁-C₃, with APTES being an exemplary bridging compound according to this embodiment. Thus, one preferred bidentate initiator is a bidentate salt of ABCVA and APTES, which has the structure:

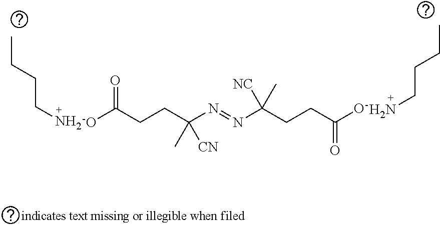

It will be appreciated that the bidentate of this embodiment can be formed by reacting the bridging compound and precursor initiator, preferably in a solvent system (e.g., tetrahydrofuran), at a molar ratio of bridging compound to precursor initiator of about 1.7:1 to about 2.3:1, preferably about 1.9:1 to about 2.1:1, and more preferably about 2:1. The preferred reaction temperature is about −5° C. to about 5° C., more preferably about −2.5° C. to about 2.5° C., and even more preferably about 0° C., with preferred reactions times being about 90 minutes to about 10 minutes, and preferably about 45 minutes to about 25 minutes.

Regardless of the initiator utilized, it is preferably introduced into the silica particle suspension as part of its own solution (e.g., in tetrahydrofuran). The combination of the initiator solution and silica particle suspension is then aged at a temperature of about −10° C. or greater, preferably greater than about 0° C., more preferably greater than about 10° C., and even more preferably at room temperature (i.e., about 20° C. to about 25° C.). This aging is preferably carried out under vigorous stirring and for about 22 hours to about 26 hours, and preferably about 24 hours, so as to form silica particles functionalized with the particular initiator. It is preferred that this initiator be included at a molar ratio of monomer (described below) to initiator about 70:1 to about 130:1, preferably from about 80:1 to about 120:1, more preferably from about 90:1 to about 110:1, and even more preferably about 100:1.

### 3. Forming Polymer Coating on Modified Silica Particle Surfaces and Drying to Form Coated Xerogel

Next, a polymer layer or coating is formed on the modified silica particle surfaces. The monomers utilized at this stage are selected to form carbonizable (e.g., can be turned into at least about 50% by weight, preferably at least about 70% by weight carbon by heating at temperatures of 700° C. or higher for 2 hours) polymers, such as those chosen from polyacrylonitrile, polyurea, polyaniline, polyvinylchloride, isocyanate derivatives (e.g., polyurethanes, polyimides, and polyamides), and combinations of the foregoing. As noted previously, the silica particle surface modification functional groups are selected based on the desired polymer coating to be formed.

a. Polymer Coating on Particles with —NH₂ Functionalization

In this embodiment, monomers are chosen to react with the available —NH₂ groups added to the silica particle surfaces and potentially with —OH groups inherently present on those particular surfaces along with the —NH₂ groups. One preferred such monomer type comprises multifunctional isocyanates. Triisocyanates are preferred, and aromatic triisocyanates are particularly preferred. (e.g., tris(4-isocyanatophenylmethane (“TIPM”), toluene diisocyanate (“TDI-trimer”)). Additionally, it will be appreciated that the monomers can be the same, or a mixture of two or more different monomer types can be utilized, if desired.

It is preferred that the monomers be utilized in an excess as compared to the silica particles, and preferably that excess is large. That is, the stoichiometric ratio of monomers to silica is from about 6:1 to about 14:1, preferably from about 8:1 to about 12:1, more preferably from about 9:1 to about 11:1, and even more preferably about 10:1.

The polymerization and/or crosslinking reaction is typically carried out by introducing a solution of the monomer (in, for example, dry ethyl acetate) into a suspension of the surface modified silica particles. The reaction is preferably carried out at temperatures of about 60° C. to about 70° C., more preferably about 65° C., and for a time period of about 60 hours to about 84 hours, preferably about 66 hours to about 78 hours, and more preferably about 72 hours. Ideally, the reaction solution is stirred approximately every 10 to 12 hours to redistribute the settled powder and increase the diffusion rate. After reaction, the solution is allowed to cool, rinsed with ethyl acetate, and dried to yield a polymer-coated silica xerogel powder. Typical drying temperatures range from about 30° C. to about 70° C., preferably about 40° C. to about 60° C., more preferably about 45° C. to about 55° C., and even more preferably about 50° C.

When TIPM is used as the monomer, the resulting polymer-coated silica can be represented as follows:

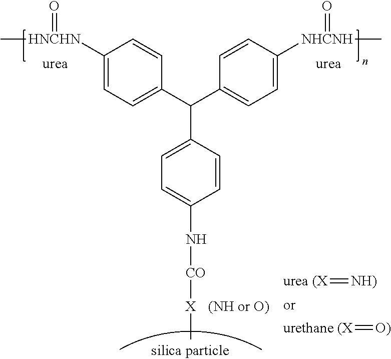

Because of the high monomer loading utilized relative to the silica, as described herein previously, the silica support will correspondingly have high polymer coating levels formed thereon. That is, the dried xerogel powder will comprise about 25% by weight to about 95% by weight of the carbonizable polymer, and preferably about 45% to about 85% by weight of the carbonizable polymer, based on the total weight of the dried xerogel powder taken as 100% by weight. Additionally, the dried xerogel powder will preferably comprise about 5% by weight to about 75% by weight silica, and more preferably about 15% to about 55% by weight silica, based on the total weight of the dried xerogel powder taken as 100% by weight.

b. Polymer Coating on Particles with Initiator Functionalization

In this embodiment, monomers are chosen to react with the free radical initiator added to the silica particle surfaces. One preferred such monomer type comprises those comprising a vinyl group, such as acrylonitrile and/or styrene. Additionally, it will be appreciated that the monomers can be the same, or a mixture of two or more different monomer types can be utilized, if desired.

As with the —NH₂ functionalized embodiment, it is preferred that the monomers be utilized in an excess as compared to the silica particles, and preferably that excess is large. That is, the stoichiometric ratio of monomers to silica is from about 6:1 to about 14:1, preferably from about 8:1 to about 12:1, more preferably from about 9:1 to about 11:1, and even more preferably about 10:1.

The polymerization and/or crosslinking reaction is typically carried out by introducing a solution of the monomer (in, for example, toluene) into a suspension of the surface modified silica particles. The reaction slurry is preferably heated at temperatures of about 50° C. to about 60° C., more preferably about 55° C., and for a time period of about 20 hours to about 30 hours, preferably about 22 hours to about 26 hours, and more preferably about 24 hours, preferably while stirring. After reaction, the solution is allowed to cool, rinsed, and dried to yield the polymer-coated silica xerogel powder. Typical drying temperatures range from about 30° C. to about 70° C., preferably about 40° C. to about 60° C., more preferably about 45° C. to about 55° C., and even more preferably about 50° C.

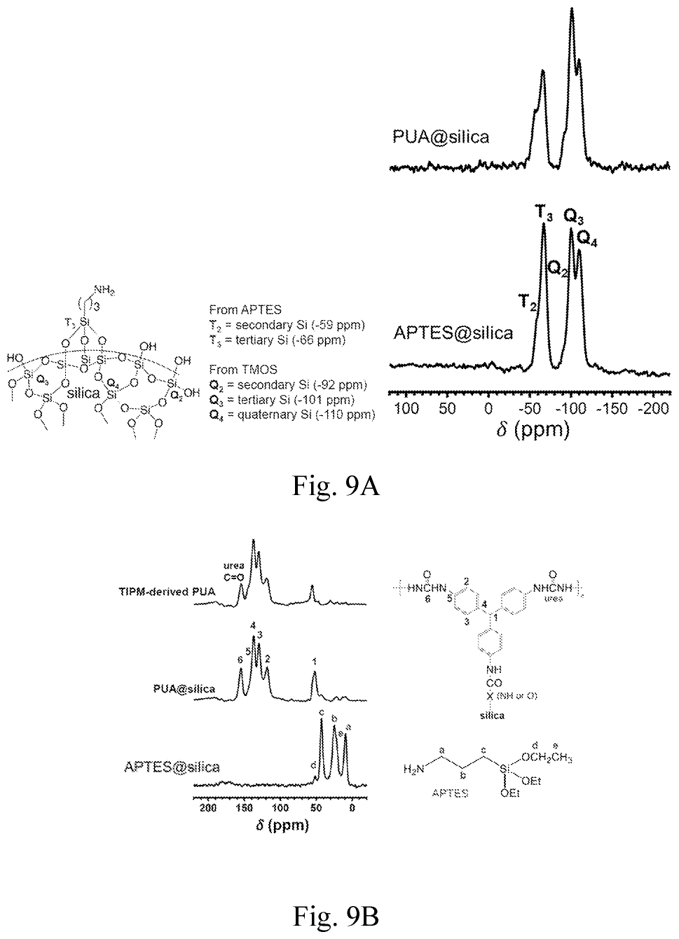

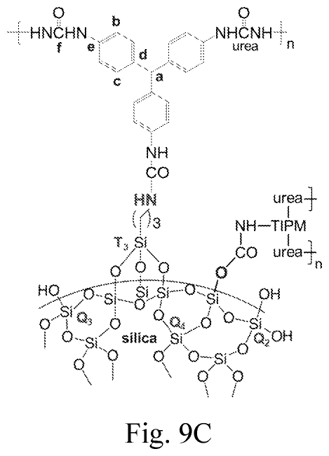

When acrylonitrile is used as the monomer, the resulting polymer-coated silica can be represented as shown in FIGS. 9A and 9C.

Because of the high monomer loading utilized relative to the silica, as described above, the silica support will correspondingly have high polymer coating levels formed thereon. That is, the dried xerogel powder of this embodiment will comprise about 25% by weight to about 95% by weight of the carbonizable polymer, and preferably about 45% to about 85% by weight of the carbonizable polymer, based on the total weight of the dried xerogel powder taken as 100% by weight. Additionally, the dried xerogel powder will preferably comprise about 5% by weight to about 75% by weight silica, and more preferably about 15% to about 55% by weight silica, based on the total weight of the dried xerogel powder taken as 100% by weight.

### 4. Forming of Xerogel Compacts

In one embodiment, the polymer-coated silica powders can be used in powder form. However, ideally, those powders will be formed into a monolithic or self-sustaining body or structure. This can be accomplished by placing the powder in a mold or die having the desired final shape and subjecting that powder to compression until the self-sustaining structure is formed. Exemplary pressures comprise about 5,000 psi (about 34.4 MPa) to about 15,000 psi (about 103.4 MPa), preferably about 8,000 psi (about 55.2 MPa) to about 12,000 psi (about 82.7 MPa), and more preferably about 10,000 psi (about 68.9 MPa). Typical compression times range from about 30 seconds to about 5 minutes, preferably about 1 minute to about 3 minutes, more preferably about 1 minute to about 2 minutes, and more preferably about 2 minutes.

### Methods of Making Metal Oxide Xerogels

### 1. Preparation of Metal Oxide Suspension or Paste

The preferred support in this embodiment comprises surface-modified metal oxide particles, preferably as part of a sol-gel metal oxide suspension. Suitable metal oxides for use in this embodiment include those chosen from oxides of iron, cobalt, nickel, vanadium, chromium, titanium, molybdenum, aluminum, manganese, tungsten, zirconium, hafnium, tin, copper, lithium, silver, gold, barium, boron, calcium, ruthenium, rare earth metals, and mixtures thereof.

In one embodiment, it is preferred that the support does not include silicon, zirconium, hafnium, and/or copper. That is, the support comprises less than about 1% by weight, and preferably about 0% by weight, of one or more of silicon, zirconium, hafnium, or copper. In another embodiment, the total weight of each of silicon, zirconium, hafnium, and/or copper present in the support is less than about 3% by weight, preferably less than about 1% by weight, and more preferably about 0% by weight of the total weight of the support taken as 100% by weight.

The preparation of this support begins with preparation of a solution comprising a metal oxide precursor. One such metal oxide precursor that is suitable for use herein is a metal chloride salt, where the metal is chosen from those listed above. The metal oxide precursor is preferably dissolved in a solvent (e.g., N,N-dimethylformamide) under vigorous stirring (e.g., about 500 rpm to about 700 rpm). Next, a proton acceptor (e.g., epichlorohydrin) is combined with the metal oxide precursor solution, preferably at a molar ratio of epichlorohydrin to metal chloride of about 5:1 to about 15:1, more preferably about 7:1 to about 12:1, and even more preferably about 10:1. The resulting solution is preferably vigorously stirred while heating at about 70° C. to about 90° C., more preferably about 75° C. to about 85° C., and even more preferably about 80° C., preferably for about 1 hour to about 3 hours, and more preferably about 2 hours. If the suspension begins to gel into a monolith rather than forming a suspension, hexane can be added and stirred into the gelling product to assist in formation of a suspension. Regardless of the metal oxide formed, conventional solvent exchange and washing steps can be carried out followed, thus forming the metal oxide suspension or paste.

### 2. Surface Modification of Metal Oxide Particles

Next, the respective surfaces of the metal oxide particles are modified to comprise a free-radical initiator immobilized on, or bonded to, those surfaces. Preferred initiators are azo-based free-radical initiators, such as azobisisobutyronitrile (AIBN), 4,4′-azobis(4-cyanopentanoic acid) (ABCVA), 3-(triethoxysilyl)propan-1-aminium 4,4′-azobis(4-cyanovalerate), and derivatives thereof.

One example of a derivative of the free-radical initiator is a bidentate thereof. The bidentate initiator is preferably a salt and preferably comprises a precursor free-radical initiator (e.g., ABCVA or other initiator as previously described) and a pair of “bridging” or linking compounds having functional groups that can react with the metal oxide particle surfaces. A preferred bridging compound in this embodiment is an alkyl (preferably C₁-C₃) chloroformate, such as ethyl chloroformate. When the initiator is a bidentate of ABCVA and ethyl chloroformate, the structure is:

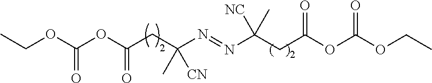

The bidentate initiator of this embodiment is formed by mixing the precursor initiator, bridging compound, and preferably a base (e.g., triethylamine) in a solvent (e.g., tetrahydrofuran) that has been cooled to about −5° C. to about 5° C., more preferably about −2.5° C. to about 2.5° C., and even more preferably about 0° C. These temperatures are preferably maintained for the reaction's duration, which will typically be about 20 minutes to about 25 minutes, or until salt formation is no longer observed. The molar ratio of bridging compound to precursor initiator is preferably about 1.7:1 to about 2.3:1, preferably about 1.9:1 to about 2.1:1, and more preferably about 2:1. The molar ratio of bridging compound to base is preferably about 0.7:1 to about 1.3:1, preferably about 0.9:1 to about 1.1:1, and more preferably about 1:1.

Regardless of the initiator utilized, it is preferably introduced into the metal oxide particle suspension or paste as part of its own solution (e.g., in tetrahydrofuran). Preferably, any residual water was removed from the metal oxide particle suspension before introducing the initiator to minimize and preferably avoid hydrolysis of the terminal anhydride groups. The preferred molar ratio of metal oxide particles to initiator is about 6:1 to about 14:1, preferably about 8:1 to about 12:1, more preferably about 9:1 to about 11:1, and even more preferably about 10:1.

The combination of the initiator solution and metal oxide particle suspension is then aged at a temperature of greater than about −10° C., preferably about −5° C. to about 5° C., more preferably about −2.5° C. to about 2.5° C., and even more preferably about 0° C., and under stirring (e.g., about 500 rpm to about 700 rpm) for about 22 hours to about 26 hours, and preferably about 24 hours, so as to form metal oxide particles functionalized with the particular initiator. It is preferred that this initiator be included at a molar ratio of monomer (described below) to initiator about 70:1 to about 130:1, preferably from about 80:1 to about 120:1, more preferably from about 90:1 to about 110:1, and even more preferably about 100:1.

### 3. Forming Polymer Coating on Modified Metal Oxide Particle Surfaces

Next, a polymer layer or coating is formed on the modified metal oxide particle surfaces. The monomers utilized at this stage are selected to form carbonizable polymers, such as those chosen from polyacrylonitrile, polyurea, polyaniline, polyvinylchloride, isocyanate derivatives (e.g., polyurethanes, polyimides, and polyamides), and combinations of the foregoing.

In this embodiment, monomers are chosen to react with the free radical initiator added to the metal oxide particle surfaces. One preferred such monomer type comprises those comprising a vinyl group, such as acrylonitrile and/or styrene. Additionally, it will be appreciated that the monomers can be the same, or a mixture of two or more different monomer types can be utilized, if desired.

It is preferred that the monomers be utilized in an excess as compared to the metal oxide particles, and preferably that excess is large. That is, the stoichiometric ratio of monomers to metal oxide is from about 6:1 to about 14:1, preferably from about 8:1 to about 12:1, more preferably from about 9:1 to about 11:1, and even more preferably about 10:1.

The polymerization and/or crosslinking reaction is typically carried out by introducing a solution of the monomer (in, for example, toluene) into a suspension of the surface modified metal oxide particles. The reaction slurry is preferably heated at temperatures of about 50° C. to about 60° C., more preferably about 55° C., and for a time period of about 5 hours to about 15 hours, preferably about 8 hours to about 12 hours, and more preferably about 10 hours, preferably while stirring. After reaction, the solution is allowed to cool, washed, and dried to yield the polymer-coated metal oxide xerogel powder. Typical drying temperatures range from about 50° C. to about 80° C., preferably about 55° C. to about 75° C., more preferably about 60° C. to about 70° C., and even more preferably about 65° C.

Because of the high monomer loading utilized relative to the metal oxide, as described previously, the metal oxide support will correspondingly have high polymer coating levels formed thereon. That is, the dried xerogel powder will comprise about 35% by weight to about 95% by weight of the carbonizable polymer, and preferably about 75% to about 92% by weight of the carbonizable polymer, based on the total weight of the dried xerogel powder taken as 100% by weight. Additionally, the dried xerogel powder will preferably comprise about 5% by weight to about 65% by weight metal oxide, and more preferably about 8% to about 25% by weight metal oxide, based on the total weight of the dried xerogel powder taken as 100% by weight.

### 4. Forming of Xerogel Compacts

In one embodiment, the polymer-coated metal oxide powders can be used in powder form. However, ideally, those powders will be formed into a monolithic or self-sustaining body or structure. This can be accomplished by placing the powder in a mold or die having the desired final shape and subjecting that powder to compression until the self-sustaining structure is formed. Exemplary pressures comprise about 5,000 psi (about 34.4 MPa) to about 15,000 psi (about 103.4 MPa), preferably about 8,000 psi (about 55.2 MPa) to about 12,000 psi (about 82.7 MPa), and more preferably about 10,000 psi (about 68.9 MPa). Typical compression times range from about 30 seconds to about 5 minutes, preferably about 1 minute to about 3 minutes, more preferably about 1 minute to about 2 minutes, and more preferably about 2 minutes.

### Methods of Forming Carbon Aerogels

1. Forming Amorphous Carbon Aerogels from Silica Xerogels

The silica xerogel powder or compact described previously is preferably subjected to further processing to convert it to an amorphous carbon aerogel.

a. Aromatization (if Needed)

The xerogel may be subjected to aromatization, depending on the polymer coating type. For example, the xerogel comprising a silica support coated with a polyacrylonitrile layer would be subjected to aromatization, while a silica support coated with a polyurea layer would not to be aromatized. Aromatization comprises pyrolysis of the xerogel at temperatures of about 250° C. to about 350° C., preferably from about 270° C. to about 330° C., more preferably from about 310° C. to about 320° C., and even more preferably about 300° C. This is preferably carried out under 02 flowing at a rate of about 225 mL/min to about 425 mL/min, more preferably about 275 mL/min to about 375 mL/min, and even more preferably about 315 mL/min to about 335 mL/min. Aromatization is generally carried about for about 12 hours to about 36 hours, preferably from about 18 hours to about 30 hours, more preferably from about 22 hours to about 26 hours, and even more preferably about 24 hours.

b. Carbonization

The xerogel (after aromatization, if applicable) is pyrolyzed to carbonization by subjecting the xerogel to heat treatment under argon at a flow rate of about 225 mL/min to about 425 mL/min, preferably about 275 mL/min to about 375 mL/min, and more preferably about 315 mL/min to about 335 mL/min. Heating is preferably carried out at temperatures of about 700° C. to about 950° C., preferably about 700° C. to about 900° C., more preferably about 750° C. to about 850° C., and even more preferably about 800° C. Preferred heating rates are about 1° C./min to about 4° C./min. The xerogel is preferably heated for a time period of about 2 hours to about 8 hours, preferably about 3 hours to about 7 hours, more preferably about 4 hours to about 6 hours, and even more preferably about 5 hours. This carbonization process yields a carbonized, amorphous aerogel.

c. Etching

In one embodiment, the carbonized aerogel is subjected to one or more etching processes. The two preferred etching processes utilize hydrofluoric acid (HF) etching (an aqueous HF solution preferably at room temperature) and/or CO₂ etching (CO₂ gas at about 1,000° C.). It is particularly preferred that each etching treatment be carried out sequentially, in either order.

For CO₂ etching, the aerogel is heated at a temperature of about 800° C. to about 1,200° C., preferably about 850° C. to about 1,100° C., more preferably about 950° C. to about 1,150° C., and even more preferably about 1,000° C., preferably at a heating rate of about 1° C./min to about 4° C./min. Once the desired temperature is reached, the aerogel is exposed to the CO₂ etchant, preferably at a flow rate of about 225 mL/min to about 425 mL/min, more preferably about 275 mL/min to about 375 mL/min, and even more preferably about 315 mL/min to about 335 mL/min, for a time period of about 1 hour to about 5 hours, preferably about 2 hours to about 4 hours, more preferably about 2.5 to about 3.5 hours, and even more preferably 3 hours.

For HF etching, the aerogel is treated at room temperature with the HF etchant (preferably about 48% to about 51% w/w in water), preferably until no bubbles are visible coming from the carbonized aerogel. The etched aerogels are then washed and dried.

2. Forming Graphitic Carbon Aerogels from Metal Oxide Xerogels

The metal oxide xerogel powder or compact described previously is preferably subjected to further processing to convert it to a graphitic carbon aerogel.

a. Aromatization (if Needed)

The metal oxide xerogel may be subjected to aromatization, depending on the polymer coating type. For example, the xerogel comprising a metal oxide support coated with a polyacrylonitrile (carbonizable thermoset polymer, e.g., soft-carbons) layer would be subjected to aromatization, while a metal oxide support coated with other types of layers (non-carbonizable polymer, eg. hard-carbons) would not be aromatized. Aromatization comprises pyrolysis of the xerogel at temperatures of about 200° C. to about 400° C., preferably about 250° C. to about 350° C., more preferably from about 270° C. to about 330° C., even more preferably from about 310° C. to about 320° C., and most preferably about 300° C. This is preferably carried out under O₂ flowing at a rate of about 225 mL/min to about 425 mL/min, more preferably about 275 mL/min to about 375 mL/min, and even more preferably about 315 mL/min to about 335 mL/min. Aromatization is generally carried about for about 12 hours to about 36 hours, preferably from about 18 hours to about 30 hours, more preferably from about 22 hours to about 26 hours, and even more preferably about 24 hours.

b. Graphitization

The metal oxide xerogel (after aromatization, if applicable) is pyrolyzed to graphitization by subjecting the xerogel to heat treatment under argon at a flow rate of about 225 mL/min to about 425 mL/min, preferably about 275 mL/min to about 375 mL/min, and more preferably about 315 mL/min to about 335 mL/min. Heating is carried out at temperatures of less than about 2,200° C., preferably less than about 2,000° C., and more preferably less than about 1,600° C. In a preferred embodiment, this heating is carried out at a temperature of about 700° C. to about 1,600° C., and preferably about 800° C. to about 1,500° C. Preferred heating rates are about 1° C./min to about 25° C./min. The xerogel is preferably heated for a time period of about 2 hours to about 8 hours, preferably about 3 hours to about 7 hours, more preferably about 4 hours to about 6 hours, and even more preferably about 5 hours. This graphitization process yields a graphitic carbon aerogel.

c. Etching

It is preferred that the graphitic aerogel is subjected to one or more etching processes, preferably using aqua-regia (conc. HCl. conc. HNO₃=3:1 v/v) etching. This etching is preferably carried out at room temperature until no bubbles are visible coming from the graphitic aerogel. The etched aerogels are then preferably washed and dried.

### Properties and Uses of Carbon Aerogels

As can be appreciated in light of the foregoing, the present disclosure presents significant advantages over the prior art, regardless of the embodiment. Some of those advantages include avoiding the need for solvent exchange or supercritical fluid drying (and preferably both are avoided), thus providing an energy- and material-efficient alternative to prior art methods. Each embodiment also presents its own advantages and potential uses. Regardless of the embodiment, it will be appreciated that the final carbon aerogels formed as described herein are not ceramics, metal carbides, metal borides, or metal aerogels, nor are they equivalent to those structures. Additionally, unless stated otherwise, all properties can be determined as described in the relevant Example.

### 1. Amorphous Carbon Aerogels

Generally, the amorphous carbon aerogel comprises at least about 40% by weight carbon, preferably about 45% to about 95% by weight carbon, more preferably about 55% to about 90% by weight carbon, and even more preferably about 45% to about 85% by weight carbon, based upon the total weight of the amorphous carbon aerogel. The amorphous carbon aerogels exhibit a BET multipoint surface area of about 30 m²/g to about 2,500 m²/g, preferably about 50 m²/g to about 2,300 m²/g, and more preferably about 200 m²/g to about 2,000 m²/g.

However, it will be appreciated that, depending upon the processing step performed, the amorphous carbon aerogels may possess a different set of properties. For instance, before any etching, the amorphous carbon aerogels typically exhibit a BET multipoint surface area of about 0.1 m²/g to about 25 m²/g, preferably about 0.5 m²/g to about 20 m²/g, and more preferably about 1 m²/g to about 15 m²/g, and/or typically have an average micropore surface area of about 0.01 m²/g to about 6 m²/g, preferably about 0.05 m²/g to about 5.5 m²/g, and more preferably about 0.1 m²/g to about 5 m²/g. Before etching, the amorphous carbon aerogels typically have a bulk density of about 0.01 g/cm³ to about 2.5 g/cm³, preferably about 0.09 g/cm³ to about 2 g/cm³, and more preferably about 0.5 g/cm³ to 1.5 about g/cm³, and/or a skeletal density of about 1.2 g/cm³ to about 3 g/cm³, preferably about 1.4 g/cm³ to about 2.6 g/cm³, and more preferably about 1.8 g/cm³ to about 2.2 g/cm³. In addition, before etching, the amorphous carbon aerogels have a porosity of about 10% to about 65%, preferably about 15% to about 60%, and more preferably about 20% to about 55%. Before etching, the amorphous carbon aerogels also typically have a specific pore volume of about 0.01 cm³/g to about 2 cm³/g, preferably about 0.05 cm³/g to about 1.5 cm³/g, and more preferably about 0.1 cm³/g to about 1 cm³/g and/or a typical average pore diameter of about 50 nm to about 2,200 nm, preferably about 150 nm to about 2,100 nm, and more preferably about 250 nm to about 2,000 nm. Finally, before etching, the amorphous carbon aerogels have a linear shrinkage of about 6.5% to about 40%, preferably about 9.5% to about 35%, and more preferably about 12.5% to about 30%.

After etching, the amorphous carbon aerogels typically exhibit a BET multipoint surface area of about 50 m²/g to about 1,000 m²/g, preferably about 100 m²/g to about 950 m²/g, and more preferably about 150 m²/g to about 900 m²/g, and/or an average micropore surface area of about 35 m²/g to about 750 m²/g, preferably about 70 m²/g to about 700 m²/g, and more preferably about 100 m²/g to about 650 m²/g. After etching, the amorphous carbon aerogels typically have a bulk density of about 0.05 g/cm³ to about 2.5 g/cm³, preferably about 0.1 g/cm³ to about 2 g/cm³, and more preferably about 0.5 g/cm³ to about 1.5 g/cm³, and/or a skeletal density of from about 0.5 g/cm³ to about 3.5 g/cm³, preferably about 1 g/cm³ to about 3 g/cm³, and more preferably about 1.5 g/cm³ to about 2.5 g/cm³. In addition, after etching, the amorphous carbon aerogels have a porosity of about 26% to about 69%, preferably about 28% to about 67%, and more preferably about 30% to about 65%. After etching, the amorphous carbon aerogels generally have a specific pore volume of about 0.01 cm³/g to about 2.5 cm³/g, preferably about 0.05 cm³/g to about 2 cm³/g, and more preferably about 0.1 cm³/g to about 1.5 cm³/g, and/or an average pore diameter of about 0.5 nm to about 25 nm, preferably about 1 nm to about 20 nm, and more preferably about 1.5 nm to about 15 nm. Finally, after etching, the amorphous carbon aerogels typically have a linear shrinkage of from about 9% to about 41%, preferably about 12% to about 38%, and more preferably about 15% to about 35%.

In some embodiments, these properties can be even further increased by more than one etch step, if desired. In such instances, the amorphous carbon aerogels can exhibit a BET multipoint surface area of from about 400 m²/g to about 2,500 m²/g, preferably about 600 m²/g to about 2,300 m²/g, and more preferably about 800 m²/g to about 2,000 m²/g, and/or have an average micropore surface area of about 200 m²/g to about 850 m²/g, preferably about 300 m²/g to about 800 m²/g, and more preferably about 400 m²/g to about 750 m²/g. The amorphous carbon aerogels, in these embodiments, also typically have a bulk density of about 0.01 g/cm³ to about 2 g/cm³, preferably about 0.05 g/cm³ to about 1.5 g/cm³, and more preferably about 0.1 g/cm³ to about 1 g/cm³, and/or a skeletal density of about 0.5 g/cm³ to about 3.5 g/cm³, preferably about 1 g/cm³ to about 3 g/cm³, and more preferably about 1.5 g/cm³ to about 2.5 g/cm³. In addition, the amorphous carbon aerogels, in these embodiments, have a porosity of about 55% to about 90%, preferably about 60% to about 87.5%, and more preferably about 65% to about 85%. The amorphous carbon aerogels, in these embodiments, also have a specific pore volume of about 0.05 cm³/g to about 3.5 cm³/g, preferably about 0.1 cm³/g to about 3 cm³/g, and more preferably about 0.5 cm³/g to about 2.5 cm³/g, and/or an average pore diameter of from about 0.01 nm to about 15 nm, preferably about 0.1 nm to about 12 nm, and more preferably about 1 nm to about 10 nm. The amorphous carbon aerogels, in these embodiments, generally have a linear shrinkage of from about 14% to about 41%, preferably about 17% to about 38%, and more preferably about 20% to about 35%.

In preferred embodiments, the amorphous carbon aerogel comprises at least about 70%, preferably at least about 75%, and more preferably at least about 80% by weight carbon, based upon the total weight of the aerogel taken as 100% by weight. In other preferred embodiments, the amorphous carbon aerogel comprises about 65% to about 88% by weight carbon, preferably about 70% to about 83% by weight carbon, and more preferably about 75% to about 80% by weight carbon, based upon the total weight of the aerogel taken as 100% by weight.

Additionally, the amorphous carbon aerogel comprises about 2% to about 8% by weight nitrogen, preferably about 2.5% to about 7.5% by weight nitrogen, and more preferably about 3% to about 7% by weight nitrogen, based upon the total weight of the aerogel taken as 100% by weight. The amorphous carbon aerogel comprises about 2% to about 10% by weight oxygen, preferably about 2.5% to about 8.5% by weight oxygen, and more preferably about 3% to about 7% by weight oxygen, based upon the total weight of the aerogel taken as 100% by weight.

It will be appreciated that, in preferred embodiments, the amorphous carbon aerogel also comprises less than about 10% by weight, preferably less than about 5% by weight, more preferably less than about 3% by weight, and even more preferably about 0% by weight of metal, based upon the total weight of the aerogel taken as 100% by weight. Furthermore, the amorphous carbon aerogel comprises less than about 3% by weight, preferably less than about 1% by weight, and more preferably about 0% by weight silica, based upon the total weight of the aerogel taken as 100% by weight. Finally, the amorphous carbon aerogel comprises less than about 7% by weight, preferably less than about 5% by weight, and more preferably less than about 3% by weight nitrogen, based upon the total weight of the aerogel taken as 100% by weight.

Though the above-described amorphous carbon aerogels can be used in many applications (e.g., thermal and acoustic insulation, electronic devices, battery electrodes, supercapacitors, imaging devices, catalyst substrates, pesticides, and cosmic dust collection), the aerogels are preferably used to sorb CO₂ from the environment, particularly used for pre-combustion CO₂ capture from the air and/or post-combustion CO₂ capture from flue gases. As used herein, the terms “sorb” and “sorption” mean to uptake or hold by adsorption, absorption, or a combination of adsorption and absorption. It will be appreciated that the amorphous carbon aerogels, especially those processed with more than one etching step, exhibit high CO₂ sorption (preferably adsorption) capacity at standard temperature and pressure (i.e., 273K (or 0° C.) at 1 bar) and/or at standard ambient temperature and pressure (i.e., 298K (or 25° C.), 1 bar). That is, the amorphous carbon aerogels typically have a CO₂ sorption capacity of about 1 mmol/g to about 14 mmol/g, preferably about 3 mmol/g to about 12 mmol/g, and more preferably about 5 mmol/g to about 10 mmol/g. The foregoing results are generally achieved by placing the amorphous carbon aerogel in a CO₂-containing environment, with it taking anywhere from about 2 seconds to about 2 hours, preferably about 2 seconds to about 1 hour, more preferably about 2 seconds to about 15 minutes, and even more preferably about 2 seconds to about 3 minutes to reach full sorption capacity.

### 2. Graphitic Carbon Aerogels

Generally, the graphitic carbon aerogel comprises at least about 55% by weight graphitic carbon, preferably about 55% to about 99.999% by weight graphitic carbon, more preferably about 75% to about 99.99% by weight graphitic carbon, and even more preferably about 95% to about 99.9% by weight graphitic carbon, based upon the total carbon content of the aerogel. That is, in most preferred embodiments, the graphitic carbon aerogel comprises less than about 6% by weight amorphous carbon, preferably less than about 3% by weight amorphous carbon, more preferably less than about 1% by weight amorphous carbon, and even more preferably about 0% by weight amorphous carbon, based upon the total carbon content of the aerogel. Furthermore, in most embodiments, the graphitic carbon aerogels exhibit a BET multipoint surface area of about 5 m²/g to about 800 m²/g, preferably about 15 m²/g to about 600 m²/g, and more preferably about 39 m²/g to about 400 m²/g. The graphitic carbon aerogels also typically possess an ultimate compressive strength of about 10 MPa to about 75 MPa, preferably about 25 MPa to about 65 MPa, and more preferably about 35 MPa to about 55 MPa, and/or an elastic modulus of from about 15 MPa to about 130 MPa, preferably about 45 MPa to about 115 MPa, and more preferably about 70 MPa to about 100 MPa.

Like the amorphous carbon aerogels, depending upon the processing step performed, the graphitic carbon aerogels may possess a different set of properties. For instance, the graphitic carbon aerogels (i.e., before etching) exhibit a BET multipoint surface area of about 1 m²/g to about 400 m²/g, preferably about 50 m²/g to about 350 m²/g, and more preferably about 100 m²/g to about 300 m²/g, and/or an average micropore surface area of about 0.05 m²/g to about 80 m²/g, preferably about 1 m²/g to about 75 m²/g, and more preferably about 5 m²/g to about 70 m²/g. The graphitic carbon aerogels in these embodiments also generally have a bulk density of about 0.01 g/cm³ to about 2 g/cm³, preferably about 0.09 g/cm³ to about 1.5 g/cm³, and more preferably about 0.5 g/cm³ to 1 about g/cm³, and/or a skeletal density of from about 1 g/cm³ to about 4.5 g/cm³, preferably about 1.5 g/cm³ to about 4 g/cm³, and more preferably about 2 g/cm³ to about 3.5 g/cm³. In addition, the graphitic carbon aerogels in these embodiments have a porosity of about 45% to about 85%, preferably about 50% to about 80%, and more preferably about 55% to about 75%, and/or a specific pore volume of about 0.05 cm³/g to about 2.5 cm³/g, preferably about 0.1 cm³/g to about 2 cm³/g, and more preferably about 0.5 cm³/g to about 1.5 cm³/g, and/or an average pore diameter of about 5 nm to about 2,500 nm, preferably about 50 nm to about 2,400 nm, and more preferably about 150 nm to about 2,300 nm. Finally, the graphitic carbon aerogels of these embodiments typically have a linear shrinkage of about 10% to about 50%, preferably about 15% to about 45%, and more preferably about 20% to about 40%, and/or a mass yield of about 20% w/w to about 65% w/w, preferably about 25% w/w to about 60% w/w, and more preferably about 30% w/w to about 55% w/w.

After etching, the graphitic carbon aerogels exhibit a BET multipoint surface area of 25 m²/g to about 350 m²/g, preferably about 75 m²/g to about 300 m²/g, and more preferably about 125 m²/g to about 250 m²/g, and/or an average micropore surface area of about 0.1 m²/g to about 120 m²/g, preferably about 10 m²/g to about 105 m²/g, and more preferably about 25 m²/g to about 90 m²/g. After etching, the graphitic carbon aerogels typically have a bulk density of about 0.04 g/cm³ to about 1.9 g/cm³, preferably about 0.09 g/cm³ to about 1.4 g/cm³, and more preferably about 0.4 g/cm³ to about 0.9 g/cm³, and/or a skeletal density of about 1 g/cm³ to about 3.5 g/cm³, preferably about 1.5 g/cm³ to about 3 g/cm³, and more preferably about 2 g/cm³ to about 2.5 g/cm³. In addition, after etching, the graphitic carbon aerogels generally have a porosity of about 55% to about 90%, preferably about 60% to about 85%, and more preferably about 70% to about 80%. After etching, the graphitic carbon aerogels also typically have a specific pore volume of about 0.05 cm³/g to about 3 cm³/g, preferably about 0.1 cm³/g to about 2.5 cm³/g, and more preferably about 0.5 cm³/g to about 2 cm³/g, and/or an average pore diameter of about 1 nm to about 195 nm, preferably about 25 nm to about 190 nm, and more preferably about 50 nm to about 180 nm. Finally, after etching, the graphitic carbon aerogels generally have a linear shrinkage of about 10% to about 50%, preferably about 15% to about 45%, and more preferably about 20% to about 40%, and/or a mass yield of about 10% w/w to about 60% w/w, preferably about 15% w/w to about 55% w/w, and more preferably about 20% w/w to about 50% w/w.

In preferred embodiments, the graphitic carbon aerogel comprises at least about 80%, preferably at least about 84%, and more preferably at least about 87% by weight carbon, based upon the total weight of the graphitic carbon aerogel taken as 100% by weight. In other preferred embodiments, the graphitic carbon aerogel comprises about 75% to about 99.9% by weight carbon, preferably about 80% to about 99% by weight carbon, and more preferably about 85% to about 98% by weight carbon, based upon the total weight of the aerogel taken as 100% by weight. Additionally, the graphitic carbon aerogel comprises about 2% to about 8% by weight nitrogen, preferably about 2.5% to about 7.5% by weight nitrogen, and more preferably about 3% to about 7% by weight nitrogen, based upon the total weight of the graphitic carbon aerogel taken as 100% by weight. The graphitic carbon aerogel comprises about 2% to about 10% by weight oxygen, preferably about 2.5% to about 8.5% by weight oxygen, and more preferably about 3% to about 7% by weight oxygen, based upon the total weight of the graphitic carbon aerogel taken as 100% by weight.

It will be appreciated that, in preferred embodiments, the graphitic carbon aerogel also comprises less than about 10% by weight, preferably less than about 5% by weight, more preferably less than about 3% by weight, and even more preferably about 0% by weight of metal, based upon the total weight of the graphitic carbon aerogel taken as 100% by weight. Furthermore, the graphitic carbon aerogel comprises less than about 3% by weight, preferably less than about 1% by weight, and more preferably about 0% by weight silica, based upon the total weight of the graphitic carbon aerogel taken as 100% by weight. Finally, the graphitic carbon aerogel comprises less than about 7% by weight, preferably less than about 5% by weight, and more preferably about 3% by weight nitrogen, based upon the total weight of the aerogel taken as 100% by weight.

Though the above-described graphitic carbon aerogels can be used in many applications (e.g., chemical energy generation and storage, battery electrodes, supercapacitors, catalysts for CO₂ reduction, catalysts for H₂ evolution and O₂ evolution using water splitting, solid superlubricants, water purification, heat removal materials in nanoelectronics, etc.), the graphitic carbon aerogels are preferably used as intercalation materials, preferably lithium-intercalation materials, in the anode and/or anodes of a battery, preferably a coin-cell battery, and more preferably a lithium-ion coin-cell battery.

The BET multipoint surface area (σ) for each type of aerogel is calculated from the N₂-sorption isotherm for the aerogel using the Brunauer-Emmett-Teller method, and the average micropore surface area is calculated from a t-plot analysis of the N₂-sorption isotherm for the aerogel using the Harkins and Jura model. Furthermore, the bulk density (ρ_{b}) for each type of aerogel is calculated by dividing the aerogel's weight by its physical dimensions (i.e., length×width×height), and the skeletal density (ρₛ) for each type of aerogel is determined using helium pycnometry with a Micromeritics AccuPyc Π1340 instrument. The porosity (H) for each type of aerogel is then calculated using the following equation: Π=100×(ρₛ−ρ_{b})/ρₛ. The specific pore volume (V) for each type of aerogel is calculated using the following equation: V_{Total}=(1/ρ_{b})−(1/ρₛ), and the average pore diameter for each type of aerogel is calculated using the following equation: 4×V/σ, where V=V_{Total}. The linear shrinkage for each type of aerogel is calculated by dividing the length of the resulting aerogel by its original length, and the mass yield for each type of aerogel is calculated by dividing the mass of the resulting aerogel by its original mass. Finally, the ultimate compressive strength is determined using a quasi-static compression test (at low strain rates), which was conducted on an Instron 4469 Universal Testing Machine using a 500 N load cell, and the elastic modulus is calculated from the early slopes of the stress-strain curves (at <3% strain) shown in FIG. 68.

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds). Also, all ranges can be “mixed and matched” with other ranges.

### EXAMPLES

The following examples set forth methods in accordance with the invention. It is to be understood, however, that these examples are provided by way of illustration, and nothing therein should be taken as a limitation upon the overall scope of the invention.

### Example 1

### Amorphous Carbon Aerogels

Examples 2-15 illustrate the synthesis of porous carbon aerogels derived from silica xerogels crosslinked with two different carbonizable polymers: an aromatic polyurea (PUA) and polyacrylonitrile (PAN), which are each shown in Scheme 2. In turn, the silica network was obtained by gelation of tetramethylorthosilicate (TMOS) followed by modification, respectively, with either 3-aminopropyltriethoxysilane (APTES) or with a free radical initiator, which was a derivative of APTES. PUA and PAN were selected to test the applicability of the aerogel-via-xerogel concept to the two major aerogel-crosslinking chemistries, namely with isocyanates or with surface-initiated free-radical polymerization. In general, PUA- and PAN-crosslinked silica powders, referred to as PUA@silica and PAN@silica, respectively, were compressed into compacts with a hydraulic press and were pyrolyzed at 800° C. under argon into materials referred to as C-PUA@silica and C-PAN@silica, respectively. C-PUA@silica & C-PAN@silica compacts were etched with HF solutions at room temperature and with CO₂ at 1000° C. The sequence of the two etching process on the properties of the final carbon aerogels was studied. PUA-derived carbon aerogels were over 80% porous after the HF/CO₂ etching sequence with surface areas in the range of 1275-1930 m² g⁻¹. Carbon aerogels obtained from PAN-crosslinked xerogel powders were 60-85% porous with surface areas in the 843-1433 m² g⁻¹ range.

### Example 2

### Materials

The materials used in Examples 3-15 were obtained from the sources described in this paragraph. Ammonium hydroxide (NH₄OH, ACS reagent), 3-aminopropyltriethoxysilane (APTES), sodium hydroxide pellets (NaOH), anhydrous sodium sulfate (Na₂SO₄, ACS certified), and hydrofluoric acid (HF, 48-51% solution in water, ACS reagent) were purchased from Fisher Scientific International, Inc. (Hampton, NH). Tetramethylorthosilicate (TMOS), 4,4′-azobis(4-cyanopentanoic acid) (ABCVA, ≥98%-trans), anhydrous tetrahydrofuran (THF), and acrylonitrile (≥99%, contains 35-45 ppm monomethyl ether hydroquinone (MEHQ) as inhibitor) were purchased from Sigma Aldrich Chemical Company (St. Louis, MO). Acrylonitrile was extracted three times with 3.0 M aqueous sodium hydroxide solution to remove the inhibitor and was dried using sodium sulfate. The inhibitor-free acrylonitrile was stored in a refrigerator at 0° C. and used within a month. HPLC grade solvents including hexane, methanol (CH₃OH), ethyl acetate (EtOAc), and toluene were purchased from Fisher Scientific International, Inc. (Hampton, NH). Technical grade acetone was purchased from Univar (St. Louis, MO). Tris(4-isocyanatophenyl)methane (TIPM) was donated by Covestro LLC (Pittsburgh, PA) as a 27% w/w solution in dry EtOAc under the trade name Desmodur RE. Ultra-high purity Ar (grade 5), N₂ (grade 4.8), O₂ (grade) and Ar (99.99999%) gases were purchased from AirGas (Rolla, MO).

### Example 3

### Preparation of Silica Microparticles Suspensions

The synthesis of PUA@silica compacts (Example 4) and PAN@silica compacts (Example 5) started with the preparation of sol-gel silica particle suspension as shown in Scheme 3. Under flowing dry (with a drying tube) Ar gas (99.99999%) at 325 mL min-1, 43 mL (3×the volume of the intended sol) of hexane was added to a three-neck round bottom flask equipped with a mechanical stirrer and a drying tube. To that flask, solution A (4.5 mL of CH₃OH and 3.85 mL (0.026 mol) of TMOS) and solution B (4.5 mL of CH₃OH, 1.5 mL (0.083 mol) of water, and 40 μL of NH₄OH) were added successively at room temperature and mixed under vigorous mechanical stirring at 770-950 rpm. As hydrolysis and condensation of TMOS progressed, the suspended silica particles turned the continuous phase (hexane) milky white (approximately 20 minutes).

### Example 4

### Preparation of PUA@silica Compacts

### 1. Methods

All washes and solvent exchanges were carried out in Parts 2 and 3 of this Example with centrifugation for 15-20 minutes at 2450 rpm. Each time, the supernatant solvent was removed, and the volume of the new solvent added was 2× the volume of the compacted slurry (paste) at the bottom of the centrifuge tubes. Before every new centrifugation step, the compacted slurry was re-suspended by vigorous agitation with a Vortex-Genie (Model no. K-550-G, Scientific Industries) and a glass rod.

### 2. Preparation of APTES@silica Powder

To prepare the APTES@silica powder, 1.28 mL (0.0065 mol) of APTES (1/3× the volume of TMOS or 5:1 TMOS:APTES mol/mol ratio) was added to the silica particle suspension synthesized in Example 3 above. The resulting composition, APTES@silica, is identical to the one obtained when APTES is premixed with TMOS, and that has been considered proof that hydrolysis and condensation of TMOS is faster than that of APTES.

The APTES@silica hexane suspension was aged and stirred under vigorous mechanical stirring at 770-950 rpm for 24 hours at room temperature. Conformal coating of the APTES@silica particles with PUA entails reaction of a multifunctional isocyanate with both the —NH₂ groups from the APTES moiety and gelation of water remaining adsorbed on the surface of silica. To remove excess solvent, the APTES@silica hexane suspension was transferred to 50 mL centrifuge tubes from Fisher Scientific (Cat. no. 06-443-18), and the solvent was exchanged twice with ethyl acetate and once with water-saturated ethyl acetate (EtOAc/H₂O). After standing for 15 hours in EtOAc/H₂O, the APTES@silica suspension was either processed to PUA@silica powder (discussed in Part 3 below) or dried under vacuum at 50° C. for further characterization.

### 3. Preparation of PUA@Silica Powder

To prepare the PUA@silica powder, the APTES@silica slurry (from the APTES@silica suspension prepared in Part 2 above) was crosslinked with three different concentrations of Desmodur RE, a commercially-available solution of TIPM, in dry ethyl acetate using 1.5×, 3×, or 4.5× mol:mol excess of TIPM relative to the total amount of silicon atoms in APTES@silica.

Specifically, a TIPM solution (4× the volume of the centrifuged paste) was added to the 50 mL centrifuge tubes containing the APTES@silica slurry from the last EtOAc/H₂O wash. Then, the tubes were sealed tightly with their caps, and the suspension was heated in an oven at 65° C. for 72 hours. For different formulations of PUA@silica powders, different amounts of TIPM solution 4.5×, 3×, and 1.5× mol (6×, 4×, and 2× v/v relative to 1× v/v of APTES@silica paste, respectively) were used for crosslinking relative to 1× mol of APTES@silica. The mixture was swirled slowly every 10 to 12 hours to re-distribute the settled powder and increase the diffusion rate. At the end of the 72-hour period, the tubes were allowed to cool to room temperature, and then the tubes were centrifuged for 15-20 minutes at 2450 rpm followed successively by three ethyl acetate washes. The wash solvent was always removed by centrifugation. After removing the solvent from the last ethyl acetate wash, the contents of the tubes were transferred with the aid of small portions of ethyl acetate and were combined in a round bottom flask. Ethyl acetate was removed, and the product was dried under reduced pressure (water aspirator connected via a drying tube) and vacuum at 50° C., forming a dry, freely flowing PUA@silica powder referred to as PUA-1.5×@silica, PUA-3×@silica or PUA-4.5×@silica depending on the amount of TIPM used for crosslinking. All three samples collectively are referred to as PUA@silica powder in Scheme 4.

The dry PUA-1.5×@silica, PUA-3×@silica, and PUA-4.5×@silica powders were compressed into various cylindrical monolithic objects using a stainless-steel die and a hydraulic press operated at 10,000 psi for 2 minutes. Placement of the powders in the die was carried out in small portions under continuous tapping.

### Example 5

### Preparation of PAN@silica Compacts

### 1. Methods

All washes and solvent exchanges were carried out in Parts 2 and 3 of this Example with centrifugation for 15-20 minutes at 2450 rpm. Each time, the supernatant solvent was removed, and the volume of the new solvent added was 2× the volume of the compacted slurry (paste) at the bottom of the centrifuge tubes. Before every new centrifugation step, the compacted slurry was re-suspended by vigorous agitation with a Vortex-Genie (Model no. K-550-G, Scientific Industries) and a glass rod.

### 2. Preparation of Initiator@Silica Powder

To prepare the initiator@silica powder, two initiator@silica suspensions were made. To make a first initiator@silica suspension, a solution consisting of 0.67 mL (0.0028 mol) of APTES (TMOS:APTES=9:1 mol/mol) and 0.4049 g (0.0014 mol) of ABCVA (APTES:ABCVA=2:1 mol/mol) was dissolved in 8.70 mL of anhydrous THF at 0° C. in an amber-glass Erlenmeyer flask. This solution was added to the silica particle suspension synthesized in Example 3 above. To make a second initiator@silica suspension, a solution consisting of 1.70 mL (0.0086 mol) of APTES (TMOS:APTES=7:3 mol/mol) and 1.2052 g (0.0043 mol) of ABCVA (APTES:ABCVA=2:1 mol/mol) was dissolved in 8.70 mL of anhydrous THF at 0° C. in an amber-glass Erlenmeyer flask. This solution was added to the silica particle suspension synthesized in Example 3 above, except that solution A of the silica particle suspension consisted of 2.99 mL (0.0202 mol) of TMOS.

The first and second initiator@silica suspensions were aged and stirred under vigorous mechanical stirring at 770-950 rpm for 24 hours at room temperature while the round bottom flasks were covered with aluminum foil. The resulting wet-silica suspensions were referred to as initiator@silica. To remove excess solvent, the resulting wet-initiator@silica suspensions were transferred to centrifuge tubes, and the solvents were exchanged once with methanol and three times with toluene. For characterization purposes, some of the initiator@silica paste in both suspensions was collected right before the first toluene wash and was dried under vacuum at 23° C. in the dark. After this solvent exchange, the remaining, toluene-washed initiator@silica slurry in both suspensions was either processed to PAN@silica powder (discussed in Part 3 below) or was washed with acetone three times and dried under vacuum at 50° C. for further characterization.

### 3. Preparation of PAN@Silica Powder

To prepare the PAN@silica powder, 13.5 mL of inhibitor-free acrylonitrile (AN) in 5 mL toluene (acrylonitrile:toluene=2.7:1 by v/v) was added in a round bottom flask containing the initiator@silica slurry (from the initiator@silica suspensions prepared in Part 2 above). To crosslink the slurry with PAN, the slurry was heated at 55° C. for 24 hours and stirred using a magnetic stirrer at 400 rpm using two different inhibitor-free AN-to-silicon ratios (AN:silicon=2 and 6 mol/mol). At the end of the 24-hour period, the mixture was allowed to cool to room temperature, and then the slurry was centrifuged for 15-20 minutes at 2450 rpm followed successively by three toluene washes and three acetone washes. The wash solvent was always removed by centrifugation. After removing the solvent from the last acetone wash, the contents of the tubes were transferred with the aid of small portions of acetone and were combined in a round bottom flask. Acetone was removed, and the product was dried under reduced pressure (water aspirator connected via a drying tube) at 50° C., forming a dry, freely flowing PAN@silica powder referred to as PAN-6×@silica(9:1), PAN-2×@silica(9:1), PAN-6×@silica(7:3), and PAN-2×@silica(7:3) depending on the molar excess of AN over total silicon in the crosslinking bath (2× or 6×) and the TMOS:APTES mol/mol ratio in the formulation of the silica backbone (9:1 or 7:3). All four samples collectively are referred to as PAN@silica powder in Scheme 5.

The dry PAN-6×@silica(9:1), PAN-2×@silica(9:1), PAN-6×@silica(7:3), and PAN-2×@silica(7:3) powders were compressed into various cylindrical monolithic objects using a stainless-steel die and a hydraulic press operated at 10,000 psi for 2 minutes. Placement of the powders in the die was carried out in small portions under continuous tapping.

### Example 6

### Processing of PUA@Silica Compacts into Carbon Aerogels

1. Processing of PUA@Silica Compacts into C-PUA@Silica Compacts

The compressed PUA@silica compacts (PUA-1.5×@silica, PUA-3×@silica, and PUA-4.5×@silica) prepared in Part 3 of Example 4 were pyrolytically converted to carbonized C-PUA@silica using a programmable MTI GSL1600X-80 tube furnace (outer and inner tubes both of 99.8% pure alumina; outer tube: 1022 mm×82 mm×70 mm; inner tube: 610 mm×61.45 mm×53.55 mm; heating zone at set temperature: 457 mm). Specifically, the compressed PUA@silica compacts were directly heated at 800° C. for 5 hours under flowing ultrahigh purity Ar gas at a flow rate of 325 mL min⁻¹, forming the resulting C-PUA@silica compacts referred to as C-PUA-1.5×@silica, C-PUA-3×@silica, and C-PUA-4.5×@silica compacts (collectively referred to as C-PUA@silica in Scheme 6).

2. Post-Carbonization Processing of C-PUA@Silica Compacts into C-PUA@Silica Aerogels

The C-PUA@silica compacts prepared in Part 1 above were subjected further to two etching processes: hydrofluoric acid (HF) etching (an aqueous HF solution at room temperature) and CO₂ etching (CO₂ gas at 1000° C.).

To carry out the HF etching process, the carbonized C-PUA@silica compacts were treated with HF (48-51% w/w in water) at room temperature in 20 mL high-density polyethylene (HDPE) vials (Cat. no. 03-337-23, Fisher Scientific) capped with rubber septa (Cat. no. CG-3024-03, ChemGlass Life Sciences) under reduced pressure using a water aspirator. The compacts were treated until no bubbles were observed coming out from the carbonized compacts. Subsequently, these treated compacts were washed three times with distilled water and three times with acetone in the same HDPE vials, under reduced pressure, for 15 minutes each time. Finally, the washed compacts were dried in a vacuum oven at 80° C. for 24 hours. The CO₂ etching process was carried out in a tube furnace at 1000° C. for 3 hours under flowing CO₂ at a flow rate of 325 mL min⁻¹.

A first batch of C-PUA@silica compacts were first subjected to the above-described HF etching process followed by the above-described CO₂ etching process, forming carbon aerogels referred to as C-PUA-1.5×@silica-HF—CO₂, C-PUA-3×@silica-HF—CO₂, and C-PUA-4.5×@silica-HF—CO₂ (collectively referred to in Scheme 6 as C-PUA@silica-HF—CO₂). A second batch of C-PUA@silica compacts were first subjected to the above-described CO₂ etching process followed by cooling to room temperature then carrying out the above-described HF etching process, forming carbon aerogels referred to as C-PUA-1.5×@silica-CO₂—HF, C-PUA-3×@silica-CO₂—HF, and C-PUA-4.5×@silica-CO₂—HF (collectively referred to in Scheme 6 as C-PUA@silica-CO₂—HF).

The HF treatment removed silica from the carbonized compacts, while etching with CO₂ increased the surface area and created microporosity by removing carbon. Notably, the two treatments, first with HF or first with CO₂, were not equivalent in terms of their final effect. Although HF and CO₂ etching were identical in terms of processing conditions, and both effective in terms of removing silica, the first batch of C-PUA@silica compacts treated first with HF displayed a much higher overall mass loss than the second batch of C-PUA@silica compacts treated first with CO₂ (Table 1). Given that the amount of silicon was the same in every pair of samples, the higher mass loss is attributed to a more efficient removal of carbon when silica was removed first.

TABLE 1
Mass loss after double etching of carbonized C-PUA@silica
(averages of three samples at every composition)

| | mass loss relative to the PUA@silica | | |
|---|---|---|---|
| | xerogel compacts [% w/w] | | |
| sample | 1.5× | 3× | 4.5× |
| C-PUA-n×@silica-HF—CO₂ | 88 ± 1 | 86 ± 1 | 87 ± 1 |
| C-PUA-n×@silica-CO₂—HF | 76 ± 2 | 79 ± 1 | 80 ± 2 |

### Example 7

### Processing of PAN@Silica Compacts into Carbon Aerogels

1. Processing of PAN@Silica Compacts into C-PAN@Silica Compacts

The compressed PAN@silica compacts (PAN-6×@silica(9:1), PAN-2×@silica(9:1), PAN-6×@silica(7:3), and PAN-2×@silica(7:3)) prepared in Part 3 of Example 5 were first aromatized to A-PAN@silica compacts pyrolytically at 300° C. for 24 hours under flowing O₂ at a flow rate of 325 mL min⁻¹, forming aromatized compacts referred to as A-PAN-6×@silica(9:1), A-PAN-2×@silica(9:1), A-PAN-6×@silica(7:3), and A-PAN-2×@silica(7:3) (collectively referred to as A-PAN@silica in Scheme 7). Then, in a programmable MTI GSL1600X-80 tube furnace, the A-PAN@silica compacts were pyrolytically converted to C-PAN@silica compacts at 800° C. for 5 hours under flowing ultrahigh purity Ar gas at a flow rate of 325 mL min⁻¹, forming the resulting C-PAN@silica compacts referred to as C-PAN-6×@silica(9:1), C-PAN-2×@silica(9:1), C-PAN-6×@silica(7:3), and C-PAN-2×@silica(7:3) (collectively are referred to as C-PAN@silica in Scheme 7). Notably, direct heating of PAN@silica compacts at 800° C. under Ar results in almost complete loss of the organic matter.

2. Post-Carbonization Processing of C-PAN@Silica Compacts into C-PAN@Silica Aerogels

The C-PAN@silica compacts prepared in Part 1 above were subjected further to two etching processes: hydrofluoric acid (HF) etching (an aqueous HF solution at room temperature) and CO₂ etching (CO₂ gas at 1000° C.).

To carry out the HF etching process, the carbonized C-PAN@silica compacts were treated with HF (48-51% w/w in water) at room temperature in 20 mL high-density polyethylene (HDPE) vials (Cat. no. 03-337-23, Fisher Scientific) capped with rubber septa (Cat. no. CG-3024-03, ChemGlass Life Sciences) under reduced pressure using a water aspirator. The compacts were treated until no bubbles were observed coming out from the carbonized compacts. Subsequently, these treated compacts were washed three times with distilled water and three times with acetone in the same HDPE vials, under reduced pressure, for 15 minutes each time. Finally, the washed compacts were dried in a vacuum oven at 80° C. for 24 hours. The CO₂ etching process was carried out in a tube furnace at 1000° C. for 3 hours under flowing CO₂ at a flow rate of 325 mL min⁻¹.

A first batch of C-PAN@silica compacts were first subjected to the above-described HF etching process followed by the above-described CO₂ etching process, forming carbon aerogels referred to as C-PAN-6×@silica(9:1)-HF—CO₂, C-PAN-2×@silica(9:1)-HF—CO₂, C-PAN-6×@silica(7:3)-HF—CO₂, and C-PAN-2×@silica(7:3)-HF—CO₂ (collectively referred to in Scheme 7 as C-PAN@silica-HF—CO₂). A second batch of C-PAN@silica compacts were first subjected to the above-described CO₂ etching process followed by cooling to room temperature then carrying out the above-described HF etching process, forming carbon aerogels referred to as C-PAN-6×@silica(9:1)-CO₂—HF, C-PAN-2×@silica(9:1)-CO₂—HF, C-PAN-6×@silica(7:3)-CO₂—HF, and C-PAN-2×@silica(7:3)-CO₂—HF (collectively referred to in Scheme 7 as C-PAN@silica-CO₂—HF).

The HF treatment removed silica from the carbonized compacts, while etching with CO₂ increased the surface area and created microporosity by removing carbon. Notably, the two treatments, first with HF or first with CO₂, were not equivalent in terms of their final effect. Although the HF and CO₂ etching were identical in terms of processing conditions, and both effective in terms of removing silica, the first batch of C-PAN@silica compacts treated first with HF displayed a much higher overall mass loss than the second batch of C-PAN@silica compacts treated first with CO₂ (Table 2). Given that the amount of silicon was the same in every pair of samples, the higher mass loss is attributed to a more efficient removal of carbon when silica was removed first.

TABLE 2
Mass loss after double etching of carbonized C-PAN@silica
(averages of three samples at every composition)

| | mass loss relative to the PAN@silica | | | |
|---|---|---|---|---|
| | xerogel compacts [% w/w] | | | |
| sample | 6×, (9:1) | 2×, (9:1) | 6×, (7:3) | 2×, (7:3) |
| C-PAN-n×@silica(x:y)-HF—CO₂ | 73 ± 3 | 90 ± 1 | 76 ± 2 | 90 ± 1 |
| C-PAN-n×@silica(x:y)-CO₂—HF | 64 ± 3 | 80 ± 2 | 74 ± 1 | 79 ± 2 |

### Example 8

### Thermal Characterization of PUA@silica System

### 1. Methods

Thermogravimetric Analysis (TGA) was conducted under air at 1000° C. using a heating rate of 10° C. min⁻¹ with a Fischer Scientific Isotemp muffle furnace. TGA was also conducted under 02 to 1000° C. using a heating rate of 5° C. min⁻¹ with a TA Instruments Model TGA Q50 analyzer.

### 2. Thermogravimetric Analysis of APTES@Silica Powder, PUA@Silica Compacts, and C-PUA@Silica Compacts

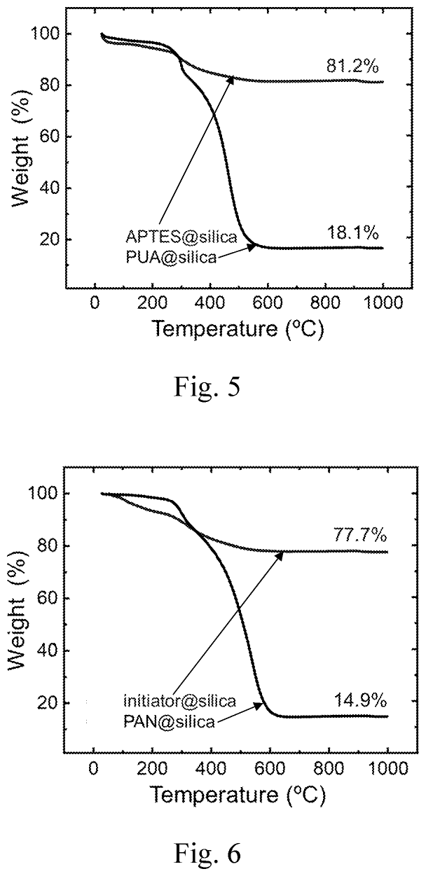

Using TGA under 02, at the high-temperature plateau (>600° C.), it was observed that the APTES@silica powder (prepared according to the methods described in Part 2 of Example 4) lost 18.8% of its mass (shown in FIG. 5), which was attributed to its organic component. The balance (81.2% w/w) was attributed to SiO₂.

Under the same conditions, it was also observed that PUA-1.5×@silica, PUA-3×@silica, and PUA-4.5×@silica (each prepared according to the methods described in Parts 2-3 of Example 4) lost 79.0%, 81.9%, and 87.1% of their masses, respectively, which was attributed to the sum of the organic component coming from both APTES and the TIPM-derived PUA. It was then calculated that PUA-2×@silica consisted of 21.0% w/w SiO₂ and 74.1% w/w of TIPM-derived polyurea, and so on as summarized in Table 3 below. Overall, the amount of PUA increased from 74.1% to 84.1% as the TIPM:silicon mol:mol ratio increased from 1.5 to 4.5.

Finally, using either TGA under O₂ or after heating in a tube furnace at 1000° C. under flowing O₂, it was observed that C-PUA-1.5×@silica, C-PUA-3×@silica, and C-PUA-4.5×@silica (each prepared according to the methods described in Part 1 of Example 6) lost 64.0%, 70.1%, and 75.5% of their mass, respectively, which corresponds to the amount of carbon in the composites, and the balance was attributed to SiO₂. The data, summarized in Table 3, agree well with the compositions expected from the parent PUA@silica compacts given the carbonization yield of the TIPM-derived PUA (56% w/w). Following the trend established by PUA in PUA@silica, the percent amount of carbon increased from 64% to 75.5% w/w with increasing the TIPM-to-silicon ratio in the crosslinking bath.

TABLE 3
Composition of PUA@silica and of carbonized C-PUA@silica xerogel
compacts prepared with different TIPM:silicon mol ratios (1.5×, 3×, 4.5×)

| | 1.5× | | 3× | | 4.5× | |
|---|---|---|---|---|---|---|
| | PUA or C | SiO₂ | PUA or C | SiO₂ | PUA or C | SiO₂ |
| sample | [% w/w] | [% w/w] | [% w/w] | [% w/w] | [% w/w] | [% w/w] |
| PUA@silica | 74.1 | 21.0 | 77.7 | 18.1 | 84.1 | 12.9 |
| C-PUA@silica | 66.4 | 33.6 | 70.6 | 29.4 | 78.5 | 21.5 |
| (expected)^{a} | | | | | | |
| C-PUA@silica | 64.0 | 36.0 | 70.1 | 29.9 | 75.5 | 24.5 |
| (found) | | | | | | |

^{a}Calculated based on the composition of PUA@silica and the carbonization yield of TIPM-derived polyurea (56%).

### Example 9

### Thermal Characterization of PAN@Silica System

### 1. Methods

Thermogravimetric Analysis (TGA) was conducted under the same methods described in Part 1 of Example 8.

Modulated Differential Scanning Calorimetry (MDSC) was conducted under N₂ from −30° C. to 350° C. using a heating rate of 5° C. min⁻¹ (modulation amplitude/frequency at 1° C. min⁻¹) with a TA Instruments Differential Scanning Calorimeter Model Q2000.

### 2. Thermogravimetric Analysis of Initiator@Silica Powder, PAN@Silica Compacts, and C-PAN@Silica Compacts

Using TGA under 02, at the high-temperature plateau (≥600° C.), it was observed that the initiator@silica powder (prepared according to the methods described in Part 2 of Example 5) had lost 22.3% of its mass (shown in FIG. 6), which is attributed to its organic component. The balance (77.7% w/w) was attributed to SiO₂.

Under the same conditions, it was observed that PAN-6×@silica(9:1), PAN-2×@silica(9:1), PAN-6×@silica(7:3), and PAN-2×@silica(7:3) (each prepared according to the methods described in Parts 2-3 of Example 5) lost 85.1%, 64.0%, 84.0%, and 69.9% of their masses, respectively, which was attributed to the sum of the organic component coming from both the initiator and PAN. It was then calculated that for example PAN-6×@silica(9:1) consisted of 14.9% w/w SiO₂ and 80.8% w/w of polyacrylonitrile, and so on as summarized in Table 4. Overall, for a given silica:initiator ratio (expressed as 9:1 or 7:3) the amount of PAN in PAN@silica increased as the monomer amount in the crosslinking bath increased. Interestingly, higher amounts of PAN had been uptaken in the PAN@silica composites with lower amounts of initiator, i.e., the percent amounts of PAN in the composites were higher when x:y=9:1 than when x:7=7:3.

Using either TGA in O₂ or after heating in a tube furnace at 1000° C. under flowing O₂, it was observed that C-PAN-6×@silica(9:1), C-PAN-2×@silica(9:1), C-PAN-6×@silica(7:3), and C-PAN-2×@silica(7:3) (each prepared according to the methods described in Part 1 of Example 7) lost 75.6%, 46.5%, 78.4%, and 49.3% of their masses, respectively, which corresponds to the amounts of carbon in the composites; the balance was SiO₂. Data are summarized in Table 4. The data, summarized in Table 4, agree well with the compositions expected from the parent PAN@silica compacts given the carbonization yield of PAN (70% w/w). The expected compositions of the C-PAN@silica samples are included in Table 4. Following the trend established by PAN in PAN@silica, the percent amount of carbon increased with increasing the monomer ratio in the crosslinking bath (see Table 4).

TABLE 4
Composition of PAN@silica and of carbonized C-PAN@silica xerogel compacts
prepared with different acrylonitrile:SiO₂ (n×) and TMOS:APTES (x:y) mol ratios sample

| | 6×, (9:1) | | 2×, (9:1) | | 6×, (7:3) | | 2×, (7:3) | |
|---|---|---|---|---|---|---|---|---|
| | PAN or C | SiO₂ | PAN or C | SiO₂ | PAN or C | SiO₂ | PAN or C | SiO₂ |
| sample | [% w/w] | [% w/w] | [% w/w] | [% w/w] | [% w/w] | [% w/w] | [% w/w] | [% w/w] |
| PAN@silica | 80.8 | 14.9 | 53.7 | 36.0 | 67.9 | 16.0 | 39.7 | 30.1 |
| C-PAN@silica | 79.1 | 20.9 | 51.1 | 48.9 | 73.8 | 26.2 | 48.0 | 52.0 |
| (expected)^{a} | | | | | | | | |
| C-PAN@silica | 75.6 | 24.4 | 46.5 | 53.5 | 78.4 | 21.6 | 49.3 | 50.7 |
| (found) | | | | | | | | |

^{a}Calculated based on the composition of PAN@silica and the carbonization yield of PAN (70%).

3. Modulated Differential Scanning Calorimetry of PAN@Silica Compacts into A-PAN@Silica Compacts

In addition to TGA, PAN@silica compacts (prepared according to the methods described in Example 5) were also analyzed using modulated differential scanning calorimetry (MDSC) and solid-state CPMAS ¹³C NMR spectra.

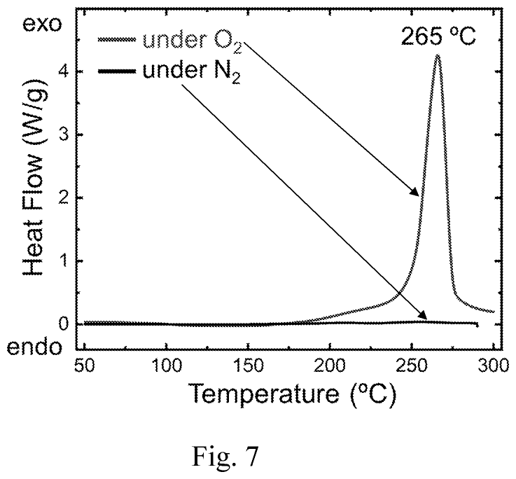

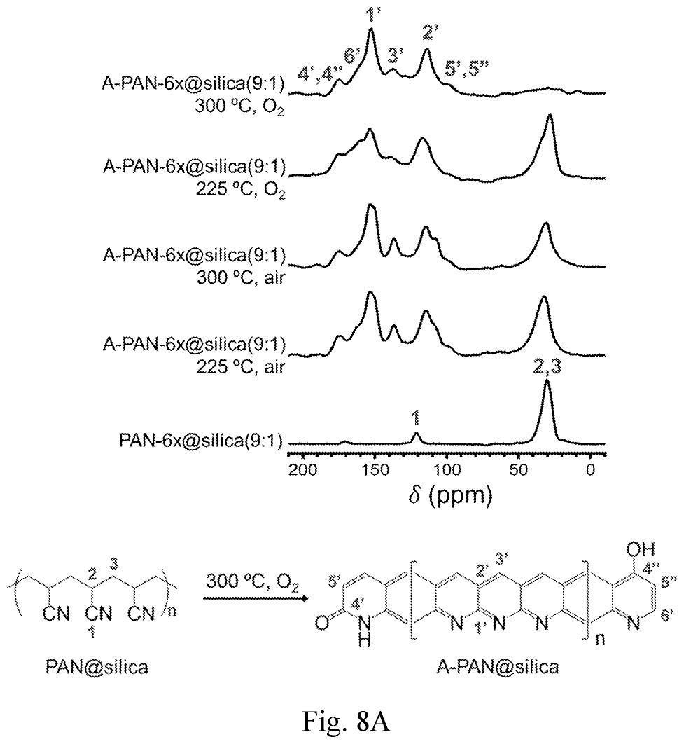

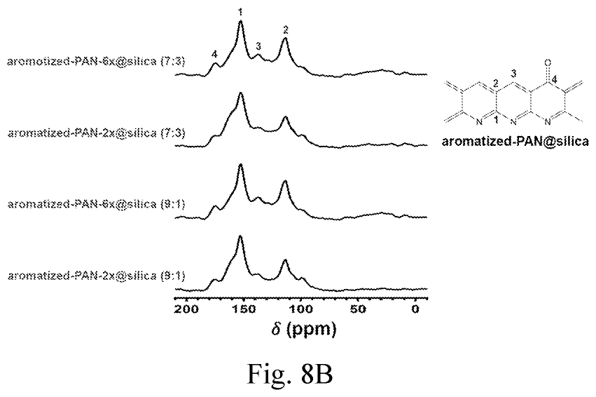

Specifically, MDSC of PAN@silica compacts was carried out under O₂ and N₂ using a heating rate of 5° C. min⁻¹. Notably, MDSC showed a strong exotherm in the 200-300° C. range with a maximum at 265° C. as demonstrated with PAN-6×@silica(9:1) in FIG. 7. Guided by the MDSC data, solid-state CPMAS ¹³C NMR spectra of PAN@silica compacts (treated under various oxidative conditions) showed that complete suppression of the aliphatic protons of PAN, which appear at around 30 ppm, (i.e., quantitative ring fusion aromatization) occurred only under prolonged treatment for 24 hours at 300° C. in flowing O₂ as demonstrated with PAN-6×@silica(9:1) in FIG. 8A. This is further demonstrated in FIG. 8B, which includes CPMAS ¹³C NMR spectra of all fully aromatized PAN@silica compacts (A-PAN-6×@silica(9:1), A-PAN-2×@silica(9:1), A-PAN-6×@silica(7:3), and A-PAN-2×@silica(7:3)).

### Example 10

### Chemical Characterization of PUA@Silica System

### 1. Methods

Solid-state CPMAS ²⁹Si NMR spectra were obtained on a Bruker Avance III 400 MHz spectrometer with a 59.624 MHz silicon frequency using a 7 mm Bruker MAS probe at a magic angle spinning rate of 5 kHz and a cross-polarization pulse sequence. The cross-polarization contact time and the relaxation delay were set at 3000 μs and 5 s, respectively. The number of scans was set at 16384. ²⁹Si NMR spectra were referenced externally to neat tetramethylsilane (TMS, 0 ppm).

Solid-state CPMAS ¹³C NMR spectra were also obtained on the Bruker Avance III 400 MHz spectrometer with a carbon frequency 100 MHz using a 7 mm Bruker MAS probe at a magic angle spinning rate of 5 kHz with broadband proton suppression and a cross-polarization total suppression of spinning side bands (TOSS) pulse sequence. The TOSS pulse sequence was applied by using a series of four properly timed 1800 pulses on the carbon channel at different points of a cycle before the acquisition of the free induction decay (FTD), after an initial excitation with a 900 pulse on the proton channel. The 900 excitation pulse on the proton and the 1800 excitation pulse on carbon were set to 4.2 and 10 s, respectively. The cross-polarization contact time and the relaxation delay were set at 3000 μs and 5 s, respectively. The number of scans was set at 2048. Spectra were referenced externally to glycine (carbonyl carbon at 176.03 ppm). Chemical shifts were reported versus TMS (0 ppm).

### 2. Chemical Characterization of APTES@Silica

APTES@silica (prepared according to the methods described in Part 2 of Example 4) was chemically characterized by solid-state CPMAS ²⁹Si NMR and solid-state CPMAS ¹³C NMR, with the spectra being shown in FIG. 9.

Specifically, latching of APTES on TMOS-derived silica particles was confirmed with solid-state CPMAS ²⁹Si NMR (FIG. 9A). The spectrum of APTES@silica shows a peak at −67 ppm with a shoulder at −59 ppm, which are assigned to the T3 and T2 silicon atoms from APTES, respectively, and two peaks at −110 ppm and at −101 ppm with a shoulder at −91 ppm, which are assigned to the Q₄, Q₃, and Q₂ silicon atoms of the TMOS-derived silica (see also FIG. 9C). The presence of the Q₃ and T2 silicon atoms points to dangling Si—OH groups, thereby APTES@silica offers two kinds of possible sites for reaction with the isocyanate groups of TIPM: —OH and —NH₂. It is further noted that the Q₃:Q₄ peak intensity ratio in PUA@silica is enhanced relative to its value in the spectrum of APTES@silica, which is interpreted as that the triisocyanate (TIPM) being attached to the surface of the silica particles not only via the dangling —NH₂ groups of APTES, but also through the innate —OH groups of silica resulting in urethane group formation.

The solid-state CPMAS ¹³C NMR spectrum of the APTES@silica powder (FIG. 9B) shows the three CH₂ resonances from APTES of about equal intensity at 43, 24, and 9.5 ppm. The spectrum of the PUA@silica powder was similar to the spectrum of pure TIPM-derived polyurea (also included in FIG. 9B for comparison). Due to massive polymer uptake in PUA@silica, the relative intensity of the CH₂ groups from APTES are suppressed.

### 3. Chemical Characterization of PUA-1.5×@Silica, PUA-3×ΕSilica, and PUA-4.5×@Silica

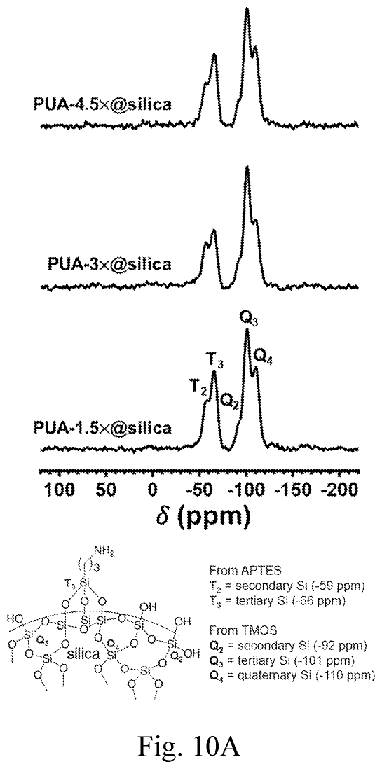

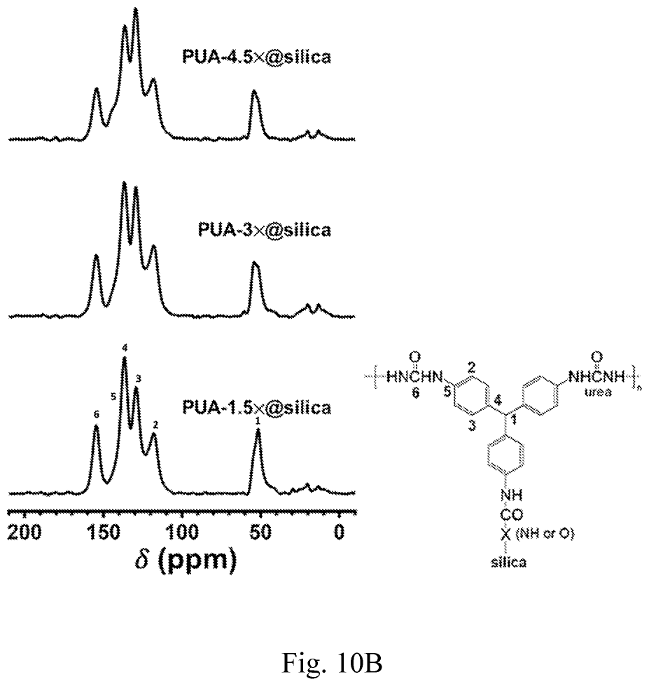

PUA-1.5×@silica, PUA-3×@silica, and PUA-4.5×@silica compacts (prepared according to the methods described in Part 3 of Example 4) were chemically characterized by solid-state CPMAS ²⁹Si NMR and solid-state CPMAS ¹³C NMR, with the spectra being shown in FIGS. 10A and 10B, respectively.

### Example 11

### Chemical Characterization of PAN@Silica System

### 1. Methods

Solid-state CPMAS ²⁹Si NMR and solid-state CPMAS ¹³C NMR spectra were obtained under the same methods described in Part 1 of Example 10.

Liquid ¹³C NMR spectra in THF-d₈ were also obtained and recorded with a 400 MHz Varian Unity Inova NMR instrument (100 MHz carbon frequency).

### 2. Chemical Characterization of the APTES/ABCVA Reaction Mixture

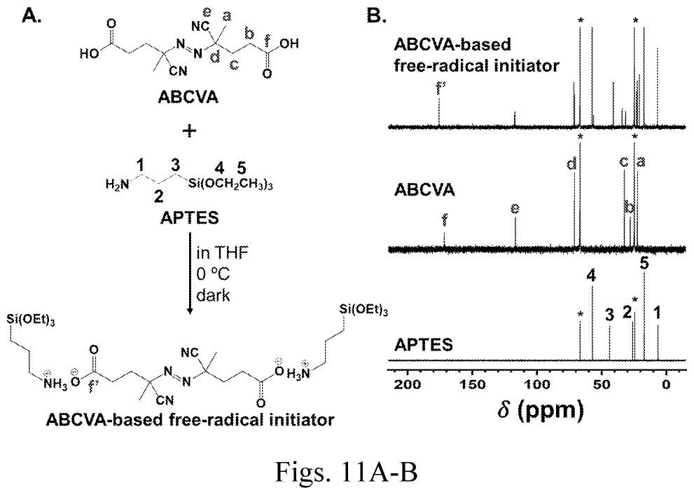

Polyacrylonitrile was coated conformally on the surface of sol-gel derived silica particles via surface-initiated free-radical polymerization of acrylonitrile. As shown in FIG. 11A, the surface-confined initiator was the product of the room-temperature, acid-base reaction in anhydrous THF of 4,4′-azobis(4-cyanovaleric acid) (ABCVA), which is a —COOH group modified derivative of azobisisobutyronitrile (AIBN), and APTES in an APTES:ABCVA mol/mol ratio of 2:1. In turn, FIG. 11B compares the liquid ¹³C NMR spectra in THF-d₈ of the APTES/ABCVA reaction mixture (prepared according to the methods described in Part 2 in Example 5) with the spectra of the two components. Complete neutralization was confirmed by the conversion of the —COOH group to the carboxylate reflected in the downfield shift of the carboxylic carbon of ABCVA (f: 171 ppm) to 176 ppm (f′: carboxylate). As a bidentate species, the ABCVA-APTES salt attaches itself on silica from both ends, so that the polymer produced by homolysis of the central —N═N— group remains surface-bound. Notably, the formation and use of the ABCVA-APTES salt comprises a significant simplification over the previous initiator design by realizing that linking the —COOH functionality of ABCVA and the —NH₂ functionality of APTES as an amide is not necessary because the simple —NH₃⁺⁻OOC— salt will remain surface-bound as long as APTES remains surface bound and the ionic strength of the solution is zero.

### 3. Chemical Characterization of Initiator@Silica and PAN@Silica

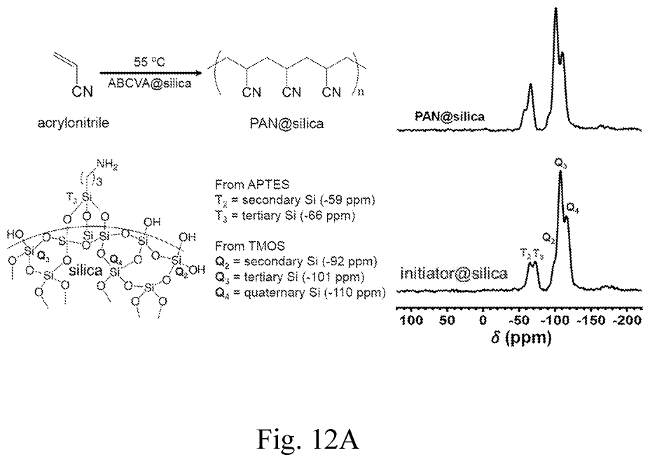

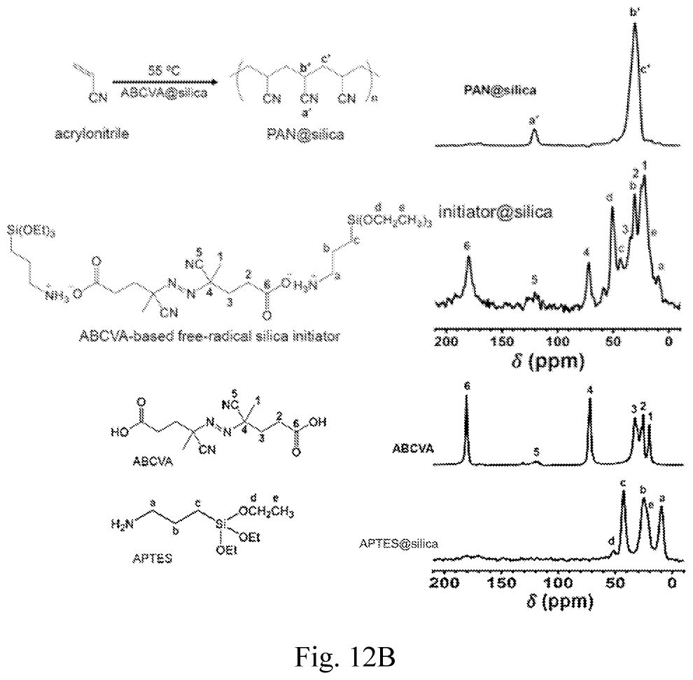

Initiator@silica (prepared according to the methods described in Part 2 of Example 5) was chemically characterized by solid-state CPMAS ²⁹Si NMR and solid-state CPMAS ¹³C NMR, with the spectra being shown in FIG. 12.

Specifically, in addition to the Q₂, Q₃, and Q₄ peaks from silica, the CPMAS ²⁹Si NMR spectrum of initiator@silica (bottom of FIG. 12A) shows peaks from the T3 and T2 silicon atoms of the APTES part of the initiator. Since the samples shown in FIG. 12 were prepared with a TMOS:APTES mol ratio equal to 9:1, the relative intensity of the T-manifold in initiator@silica was lower than its intensity in APTES@silica (FIG. 10A). Notably, the T3 peak is enhanced relative to its intensity in the spectrum of initiator@silica. This is attributed to the fact that the surface-bound radicals produced by homolytic cleavage of the initiator are still bound at the APTES sites as designed, and thereby, the polymer extends from those points outward. The resulting close vicinity of the T3 Si atoms to the protons of the developing polymer enhances cross-polarization, and therefore, the intensity of these silicon atoms increases due to more efficient excitation.

The solid-state CPMAS ¹³C NMR spectrum of the initiator@silica powder (FIG. 12B) includes the resonances from both APTES and ABCVA. Due to the massive polymer uptake, the solid-state ¹³C NMR spectrum of the PAN@silica powder showed only the resonances assigned to PAN.

### 4. Chemical Characterization of PAN-6×@Silica(9:1), PAN-2×@Silica(9:1), PAN-6×@Silica(7:3), and PAN-2×@Silica(7:3)

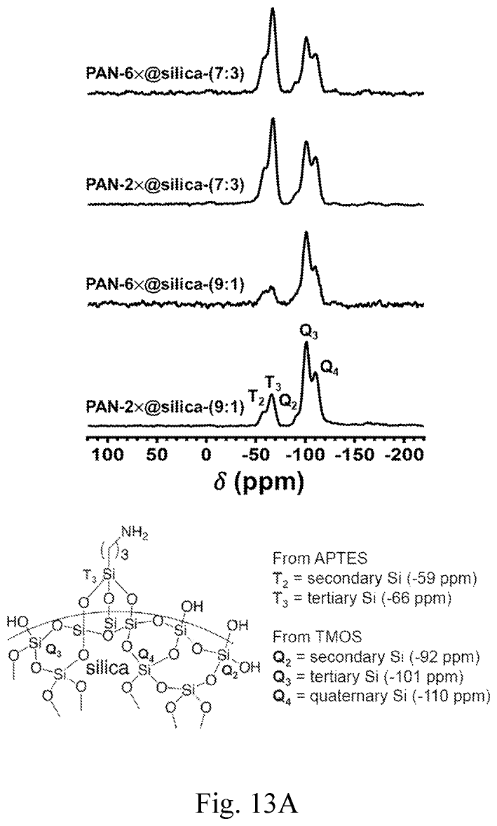

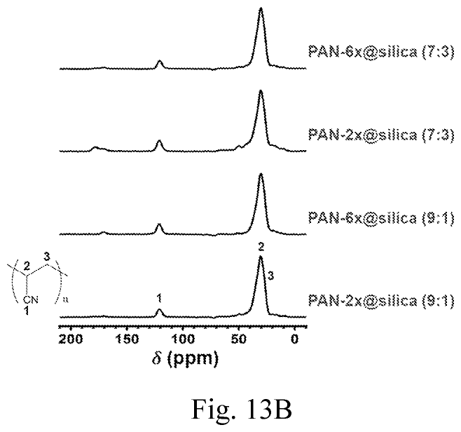

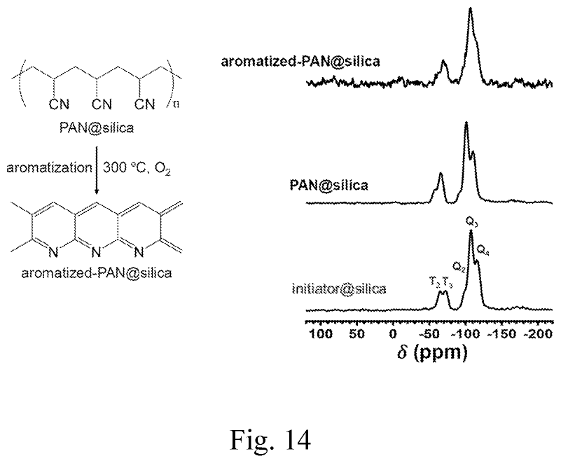

PAN-6×@silica(9:1), PAN-2×@silica(9:1), PAN-6×@silica(7:3), and PAN-2×@silica(7:3) compacts (each prepared according to the methods described in Part 3 of Example 5) were chemically characterized by solid-state CPMAS ²⁹Si NMR and solid-state CPMAS ¹³C NMR, with the spectra being shown in FIGS. 13A and 13B, respectively.

### 5. Chemical Characterization of A-PAN@Silica

A-PAN@silica compacts (prepared according to the methods described in Part 1 of Example 7) were chemically characterized by solid-state CPMAS ²⁹Si NMR and solid-state CPMAS ¹³C NMR. Oxidative aromatization of PAN@silica was expected to leave the topographic relationship between the polymer and its anchoring sites more-or-less unperturbed, and indeed the ²⁹Si NMR spectra of A-PAN@silica and PAN@silica were practically identical.

As shown in FIG. 8B, the solid-state ¹³C NMR spectra of the PAN@silica samples (treated at 300° C. for 24 hours under 02) are dominated by the resonances that correspond to the idealized structure of fully aromatized PAN. Some lower-intensity resonances that showed up were assigned to pyridonic carbonyls (4′ and 4″ at around 170 ppm) and to sp² carbons on terminal rings (at around 102 ppm-).

### Example 12

### Chemical Characterization of C-PUA@Silica and C-PAN@Silica Systems

### 1. Methods

Energy dispersive x-ray spectroscopy (EDS) was conducted with Au/Pd (60/40) coated samples on a Hitachi Model S-4700 field-emission microscope. Samples were placed on the stub using C-dot. Thin sticky copper strips were cut and placed on the edges and top of the sample, leaving space for the analysis.

X-ray photoelectron spectroscopic analysis (XPS) was carried out with a ThermoFischer Scientific Nexsa X-ray Photoelectron Spectrometer System. Samples were mixed and ground together with Au powder (5% w/w) as an internal reference. Deconvolution of the spectra was performed with Gaussian function fitting using the OriginPro 9.7 software package.

### 2. Chemical Characterization of C-PUA@Silica and C-PAN@Silica Systems by EDS

C-PUA-3×@silica, C-PUA-3×@silica-HF, C-PAN-6×@silica(9:1), and C-PAN-6×@silica(9:1)-HF samples (prepared according to the methods described in Examples 6 and 7 and prepared as sample according to the method described in Part 1 of this Example) were chemically characterized by EDS.

According to EDS (see FIG. 15 and Table 5), in addition to C and N, carbonized C-PUA@silica and C-PAN@silica contained significant amounts of silicon and oxygen. For example, C-PUA-3×@silica and C-PAN-6×@silica(9:1) contained 13% (Si)/15% (O) w/w, and 17% (Si)/16% (O) w/w, respectively. After treatment with HF, the amount of oxygen in C-PUA-3×@silica-HF and in C-PAN-6×@silica(9:1)-HF was reduced drastically to 2.3% and 2.7% w/w, respectively, and neither sample contained any silicon. Thus, treatment with HF removes silica completely. Both etched samples, C-PUA-3×@silica-HF and C-PAN-6×@silica(9:1)-HF, consisted of C, N and O (no analysis was conducted for H).

TABLE 5
Percent elemental composition via EDS of C-PUA-3 × @silica,
C-PUA-3 × @silica-HF, C-PAN-6 × @silica(9:1),
and C-PAN-6 × @silica(9:1)-HF samples

| sample | C | N | O | Si | Au | Total |
|---|---|---|---|---|---|---|
| | weight % | | | | | |
| C-PUA-3 × @silica | 59.95 | 7.95 | 14.69 | 12.36 | 5.05 | 100.00 |
| C-PUA-3 × @silica-HF | 87.95 | 7.05 | 2.27 | 0.00 | 2.73 | 100.00 |
| C-PAN-6 × @silica(9:1) | 55.32 | 8.15 | 15.59 | 16.50 | 4.44 | 100.00 |
| C-PAN-6 × @silica(9:1)-HF | 89.36 | 4.62 | 2.62 | 0.00 | 3.40 | 100.00 |
| | atomic % | | | | | |
| C-PUA-3 × @silica | 71.60 | 8.14 | 13.17 | 6.31 | 0.78 | 100.00 |
| C-PUA-3 × @silica-HF | 94.71 | 3.09 | 1.90 | 0.00 | 0.29 | 100.00 |
| C-PAN-6 × @silica(9:1) | 68.01 | 8.60 | 14.39 | 8.67 | 0.33 | 100.00 |
| C-PAN-6 × @silica(9:1)-HF | 95.51 | 2.01 | 2.12 | 0.00 | 0.36 | 100.00 |

### 3. Chemical Characterization of C-PUA@Silica and C-PAN@Silica Systems by XPS Analysis

High resolution XPS for C, N, and O was conducted with carbonized samples, C-PUA-4.5×@silica and C-PAN-6×@silica(9:1) (prepared according to the methods described in Examples 6 and 7), to elucidate the functional groups those elements are expressed with on the internal surfaces of the samples.

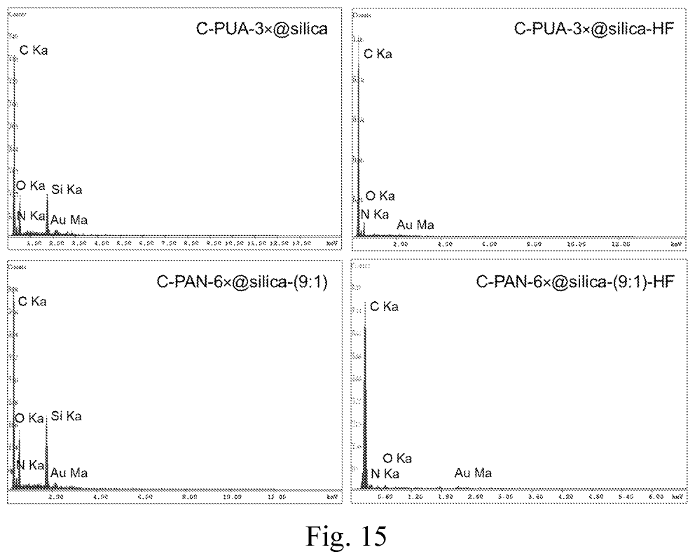

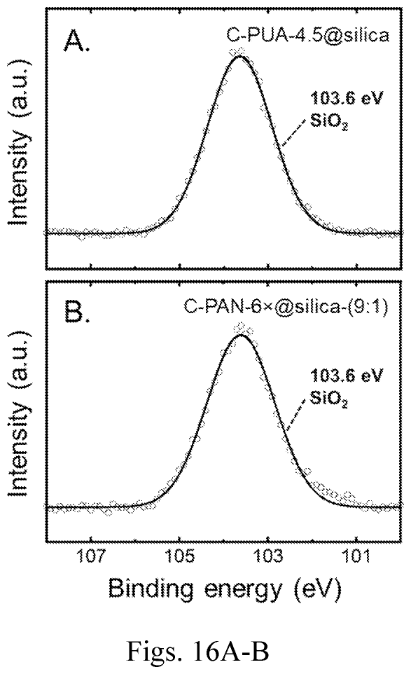

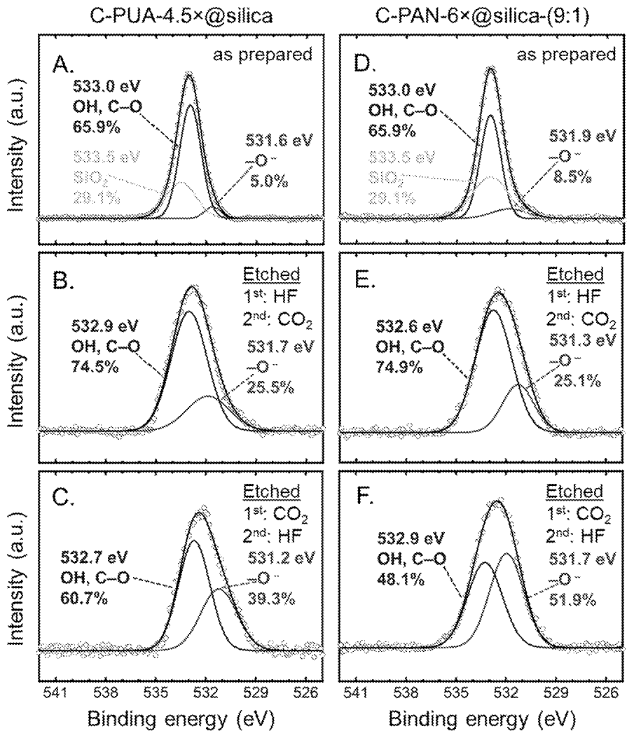

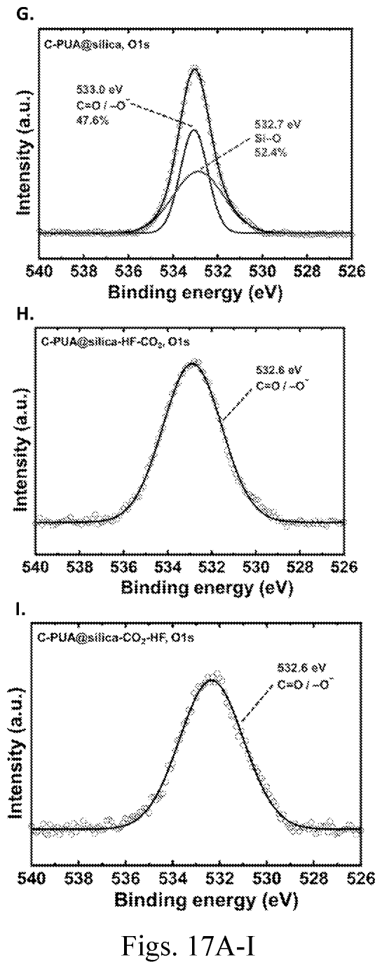

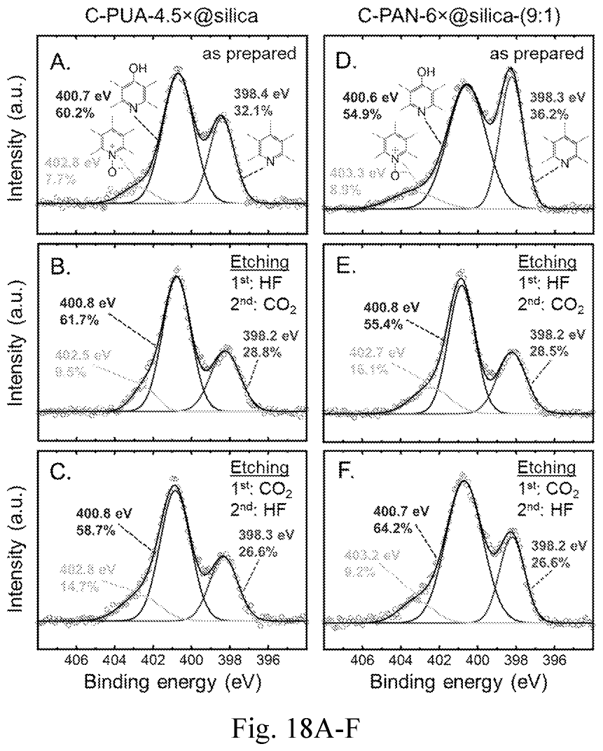

FIGS. 17, 18, and 19 show the 0 is, N is, and C 1s spectra of as-prepared C-PUA-4.5×@silica and C-PAN-6×@silica(9:1), respectively, and include the spectra of the corresponding double-etched C-PUA-4.5×@silica and C-PAN-6×@silica(9:1). The XPS 0 is spectra of both as-prepared C-PUA-4.5×@silica and C-PAN-6×@silica(9:1) included a peak at 533.5 eV (see FIGS. 17A and 17D), and a peak at 103.6 eV (see Si 2p spectra in FIG. 16). Both of those features are assigned to SiO₂. Consistent with the EDS data, the Si 2p peak and the 0 is peak of silica were absent from the spectra of all samples, double-etched in either sequence (see FIGS. 17B and 17E).

Also, the O is spectra of as-prepared C-PUA-4.5×@silica and C-PAN-6×@silica(9:1) (FIGS. 17A and 17D) contained a strong peak at 533.0 eV that falls in the middle of the range (which can be assigned to either OH (e.g., from pyridone) or ether or ester C—O) and weak peaks at 531.6 eV and 531.9 eV, respectively (which can be assigned to C═O, but can be also attributed to —O⁻). The latter assignment was chosen because of the presence of nitroxide in the N 1s spectra. Indeed, the N 1s spectra of C-PUA-4.5×@silica and C-PAN-6×@silica(9:1) (see FIGS. 18A and 18D) showed N mainly in pyridinic (398.3-398.4 eV), and pyridonic positions (400.6-400.7 eV; more pyridonic in C-PUA-4.5×@silica than in C-PAN-6×@silica(9:1)), and small amounts of nitroxide at 402.8 eV (case of C-PUA-4.5×@silica), or at 403.3 eV (case of C-PAN-6×@silica(9:1)).

The O is spectra of double-etched carbon samples contained the same OH/C—O, and —O⁻ peaks, but the intensity of the —O⁻peak at −532 eV increased significantly relative to before etching from 5% to 25.5% (case of C-PUA-4.5×@silica-HF—CO₂), and from 8.5% to 25.1% (case of C-PAN-6×@silica(9:1)-HF—CO₂). Simultaneously, the intensity of the N 1s peaks attributed to pyridonic and nitroxide (—N⁺—O⁻) also increased; the first marginally, the second significantly. For example, the intensity of the N is assigned to nitroxide went from 7.7% to 9.5% (case of C-PUA-4.5×@silica-HF—CO₂— compare FIGS. 18A and 18B), and from 8.9% to 16.1% (case of C-PAN-6×@silica(9:1)-HF—CO₂— compare FIGS. 18D and 18E).

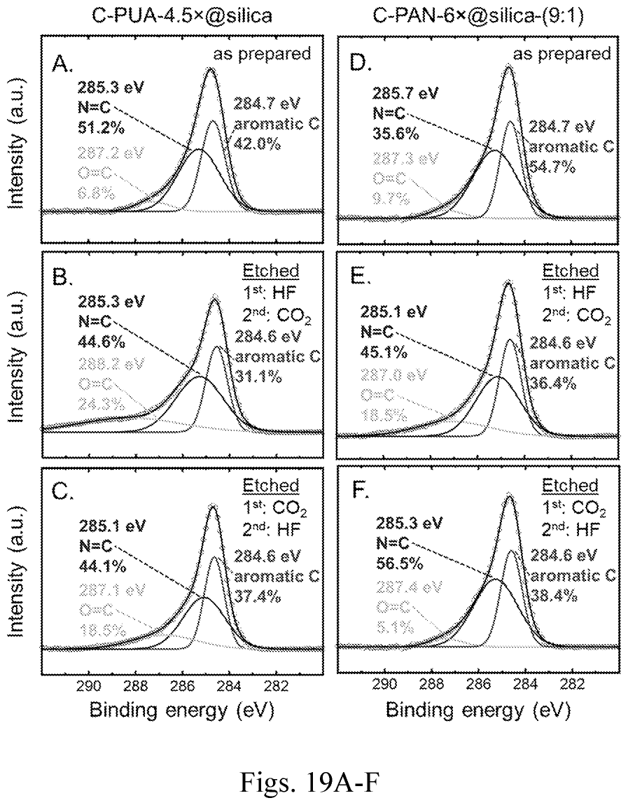

Similar evolutions in the O 1s and N 1s spectra were observed in double-etched C-PUA-4.5×@silica and C-PAN-6×@silica(9:1) samples (see FIGS. 17B-C, 17E-F, 18B-C, and 18E-F). The C 1s spectra (see FIG. 19) were consistent with the functional groups identified from the 0 is and N 1s spectra showing peaks at 284.5 eV (aromatic C), 285.3 eV (C═N) and at 287-288 eV (very broad) for carbon in straight C═O groups, or in C═O groups participating in a keto/enol equilibrium (e.g., as in the pyridonic groups).

TABLE 6
Elemental quantification data with XPS

| | atomic % | | | | |
|---|---|---|---|---|---|
| sample | C | O | N | Au | O/N |
| C-PUA-4.5×@silica-HF—CO₂ | 89.61 | 6.44 | 3.48 | 0.47 | 1.85 |
| C-PUA-4.5×@silica-CO₂—HF | 91.57 | 3.11 | 4.50 | 0.82 | 0.69 |
| C-PAN-2×@silica(7:3)-HF—CO₂ | 89.95 | 2.95 | 6.86 | 0.24 | 0.43 |
| C-PAN-2×@silica(7:3)-CO₂—HF | 86.44 | 6.22 | 6.09 | 1.25 | 1.02 |

### Example 13

### Physical and Structural Characterization of PUA@Silica, PAN@Silica, C-PUA@Silica, and C-PAN@Silica Systems 1. Physical Characterization Methods

Bulk densities (ρ_{b}) were calculated from the weight and physical dimensions of the samples. Skeletal densities (ρₛ) were measured using helium pycnometry on a Micromeritics AccuPyc II 1340 instrument. Samples for skeletal density measurements were outgassed for 24 hours at 80° C. under vacuum before analysis. Percent porosities (17) were determined from the ρ_{b} and ρₛ values via Π=100×[(ρₛ−ρ_{b})/ρₛ].

### 2. Structural Characterization Methods

Scanning electron microscopy (SEM) was conducted with Au/Pd (60/40) coated samples on a Hitachi Model S-4700 field-emission microscope. Samples were placed on an SEM stub using a C-dot. Thin sticky copper strips were cut and placed on the edges and top of the sample, leaving space for the analysis.

### 3. Macroscopic Properties of PUA@Silica, PAN@Silica, C-PUA@Silica, and C-PAN@Silica Systems

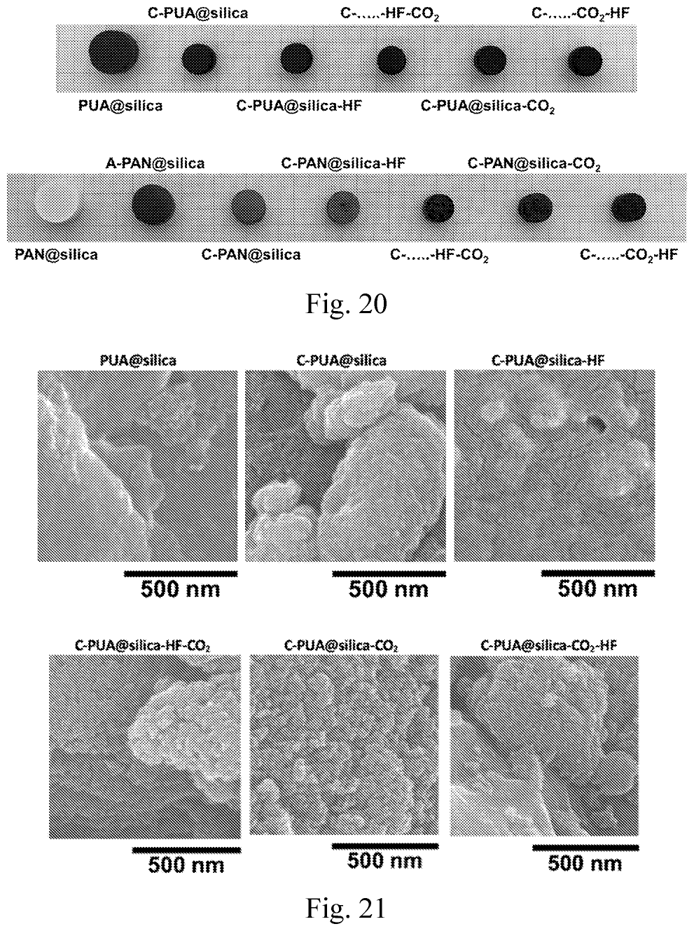

FIG. 20 shows PUA-3×@silica and PAN-6×@silica(9:1) compacts (abbreviated as PUA@silica and PAN@silica, respectively), along carbonization and etching. The compacts were prepared according to Examples 4 and 5 using the same die and had the same dimensions. The photographs show that the compacts developed no defects, and the two series were practically indistinguishable at the various stages. Relevant property characterization data for all materials and all formulations are summarized in Tables 7 and 8.

TABLE 7
Materials characterization data along processing of PUA-n×@silica xerogel compacts with n× = 1.5×, 3×, 4.5×

| | linear | bulk | skeletal | porosity, | | |
|---|---|---|---|---|---|---|
| sample | shrinkage | density, ρ_{b} | density, ρₛ | Π | specific pore volume [cm³ g⁻¹] | |
| n× | [%] ^{a,b} | [g cm⁻³] ^{a} | [g cm⁻³] ^{c} | [% v/v] ^{d} | V_{Total}^{e} | V_{1.7-300}_{_{—}}ₙₘ ^{f} |
| PUA-@silica | | | | | | |
| 1.5× | — | 1.007 ± 0.002 | 1.369 ± 0.001 | 26 | ^{k} | ^{k} |
| 3× | — | 0.967 ± 0.022 | 1.363 ± 0.002 | 29 | ^{k} | ^{k} |
| 4.5× | — | 0.894 ± 0.010 | 1.332 ± 0.001 | 33 | ^{k} | ^{k} |
| C-PUA@silica | | | | | | |
| 1.5× | 28.37 ± 0.10 | 1.201 ± 0.015 | 1.934 ± 0.012 | 38 | 0.32 | 0.01 |
| 3× | 28.02 ± 0.41 | 1.082 ± 0.021 | 1.953 ± 0.021 | 45 | 0.41 | 0.03 |
| 4.5× | 28.45 ± 0.34 | 0.937 ± 0.014 | 1.901 ± 0.011 | 51 | 0.54 | 0.03 |
| C-PUA@silica-HF | | | | | | |
| 1.5× | 28.58 ± 0.13 | 0.828 ± 0.016 | 1.781 ± 0.016 | 54 | 0.65 | 0.32 |
| 3× | 28.46 ± 0.85 | 0.730 ± 0.013 | 1.755 ± 0.009 | 58 | 0.80 | 0.13 |
| 4.5× | 28.74 ± 0.55 | 0.654 ± 0.018 | 1.788 ± 0.003 | 63 | 0.97 | 0.33 |
| C-PUA@silica-HF-CO₂ | | | | | | |
| 1.5× | 32.85 ± 0.83 | 0.411 ± 0.022 | 2.353 ± 0.078 | 83 | 2.01 | 0.72 |
| 3× | 34.08 ± 0.67 | 0.334 ± 0.026 | 1.943 ± 0.031 | 83 | 2.48 | 0.65 |
| 4.5× | 34.76 ± 0.47 | 0.380 ± 0.024 | 2.133 ± 0.048 | 82 | 2.16 | 1.09 |
| C-PUA@silica-CO₂ | | | | | | |
| 1.5× | 29.79 ± 0.20 | 1.197 ± 0.003 | 1.959 ± 0.005 | 39 | 0.33 | 0.02 |
| 3× | 30.09 ± 0.87 | 1.079 ± 0.092 | 2.154 ± 0.007 | 50 | 0.46 | 0.11 |
| 4.5× | 32.30 ± 0.46 | 0.876 ± 0.023 | 1.985 ± 0.002 | 56 | 0.64 | 0.10 |
| C-PUA@silica-CO₂-HF | | | | | | |
| 1.5× | 29.93 ± 0.16 | 0.749 ± 0.027 | 1.953 ± 0.017 | 62 | 0.82 | 0.51 |
| 3× | 31.15 ± 0.61 | 0.558 ± 0.035 | 1.846 ± 0.029 | 70 | 1.25 | 0.76 |
| 4.5× | 33.62 ± 0.39 | 0.510 ± 0.033 | 1.982 ± 0.013 | 74 | 1.46 | 0.68 |

| | | | | | average |
|---|---|---|---|---|---|
| | | | BET surface | | pore |
| sample | specific pore volume [cm³ g⁻¹] | | area, σ | | diameter |
| n× | V_{micropore}^{g} | V_{>300 nm} ^{h} | [m² g⁻¹] ⁱ | | [nm] ^{j} |
| PUA-@silica | | | | | |
| 1.5× | ^{k} | ^{k} | ^{k} | | ^{k} |
| 3× | ^{k} | ^{k} | ^{k} | | ^{k} |
| 4.5× | ^{k} | ^{k} | ^{k} | | ^{k} |
| C-PUA@silica | | | | | |
| 1.5× | 0.0 ^{l} | 0.31 | 1.3 | (1.1) | 954 |
| 3× | 0.0 ^{l} | 0.38 | 11 | (3.4) | 151 |
| 4.5× | 0.0 ^{l} | 0.51 | 6.7 | (0.6) | 324 |
| C-PUA@silica-HF | | | | | |
| 1.5× | ^{k} | ^{m} | 394 | (82) | 6.6 |
| 3× | ^{k} | ^{m} | 353 | (70) | 9.1 |
| 4.5× | ^{k} | ^{m} | 285 | (47) | 14 |
| C-PUA@silica-HF-CO₂ | | | | | |
| 1.5× | 0.74 | 0.55 | 1275 | (628) | 6.3 |
| 3× | 0.75 | 1.08 | 1724 | (708) | 6.2 |
| 4.5× | 0.86 | 0.21 | 1930 | (708) | 4.5 |
| C-PUA@silica-CO₂ | | | | | |
| 1.5× | ^{k} | ^{m} | 170 | (149) | 7.9 |
| 3× | ^{k} | ^{m} | 404 | (345) | 4.7 |
| 4.5× | 0.25 | 0.29 | 845 | (598) | 3.1 |
| C-PUA@silica-CO₂-HF | | | | | |
| 1.5× | 0.21 | 0.10 | 1149 | (669) | 2.9 |
| 3× | 0.42 | 0.07 | 1220 | (630) | 4.1 |
| 4.5× | 0.62 | 0.16 | 1331 | (611) | 4.8 |

^{a} Average of three samples.
^{b} Shrinkage relative to the PUA@silica xerogel compact.
^{c} Single sample, average of 50 measurements.
^{d} Porosity, Π = 100 × (ρₛ − ρ_{b})/ρₛ.
^{e} V_{Total} was calculated via V_{Total} = (1/ρ_{b}) − (1/ρₛ).
^{f} V_{1.7-300}_{_{—}}ₙₘ was calculated via the BJH desorption cumulative pore volume.
^{g} V_{micropore} was calculated with N₂-sorption data at P/Pₒ ≤ 0.1 using a low-pressure N₂ dosing routine at 77 K and the Dubinin-Radushkevich (DR) method for data analysis.
^{h} V_{>300 nm} = V_{Total} − (V_{micropore} + V_{1.7-300}_{_{—}}ₙₘ).
ⁱ Numbers in (parentheses): Micropore surface areas calculated via t-plot method.
^{j} Average pore diameters were calculated via the 4 × V/σ method by setting V = V_{Total} = (1/ρ_{b}) − (1/ρₛ).
^{k} Too small - could not be measured.
^{l} Presumed.
^{m} Was not calculated because of ^{h} and ^{k}.

TABLE 8
Materials characterization data along processing of PAN-n×@silica(x:y)
xerogel compacts with n× = 2× and 6×, and (x:y) = (9:1) and (7:3)

| | linear | bulk | skeletal | porosity, | specific pore volume | |
|---|---|---|---|---|---|---|
| sample | shrinkage | density, ρ_{b} | density, ρₛ | Π | [cm³ g⁻¹] | |
| n×, (x:y) | [%] ^{a,b} | [g cm⁻³] ^{a} | [g cm⁻³] ^{c} | [% v/v] ^{d} | V_{Total} ^{e} | V_{1.7-300}_{_{—}}ₙₘ ^{f} |
| PAN@silica | | | | | | |
| 6×, (9:1) | — | 1.143 ± 0.012 | 1.223 ± 0.003 | 7 | ^{k} | ^{k} |
| 2×, (9:1) | — | 1.122 ± 0.004 | 1.182 ± 0.002 | 5 | ^{k} | ^{k} |
| 6×, (7:3) | — | 1.202 ± 0.029 | 1.288 ± 0.002 | 7 | ^{k} | ^{k} |
| 2×, (7:3) | — | 1.282 ± 0.003 | 1.373 ± 0.002 | 7 | ^{k} | ^{k} |
| A-PAN@silica | | | | | | |
| 6×, (9:1) | 9.87 ± 0.51 | 1.314 ± 0.016 | 1.504 ± 0.002 | 13 | ^{k} | ^{k} |
| 2×, (9:1) | 6.14 ± 0.25 | 1.426 ± 0.016 | 1.554 ± 0.005 | 8 | ^{k} | ^{k} |
| 6×, (7:3) | 9.60 ± 0.12 | 1.294 ± 0.018 | 1.548 ± 0.003 | 17 | ^{k} | ^{k} |
| 2×, (7:3) | 12.00 ± 0.16 | 1.351 ± 0.005 | 1.773 ± 0.001 | 24 | ^{k} | ^{k} |
| C-PAN@silica | | | | | | |
| 6×, (9:1) | 20.67 ± 0.74 | 1.339 ± 0.011 | 1.918 ± 0.007 | 30 | 0.23 | 0.00 |
| 2×, (9:1) | 14.56 ± 0.15 | 1.443 ± 0.025 | 1.851 ± 0.019 | 22 | 0.15 | 0.01 |
| 6×, (7:3) | 20.87 ± 0.34 | 1.289 ± 0.013 | 1.905 ± 0.010 | 32 | 0.25 | 0.01 |
| 2×, (7:3) | 22.25 ± 0.56 | 1.463 ± 0.025 | 1.997 ± 0.004 | 27 | 0.18 | 0.00 |
| C-PAN@silica-HF | | | | | | |
| 6×, (9:1) | 21.01 ± 0.37 | 1.139 ± 0.027 | 1.761 ± 0.009 | 35 | 0.31 | 0.18 |
| 2×, (9:1) | 15.54 ± 0.24 | 0.679 ± 0.013 | 1.781 ± 0.006 | 62 | 0.91 | 0.57 |
| 6×, (7:3) | 21.79 ± 0.28 | 0.778 ± 0.018 | 1.783 ± 0.004 | 56 | 0.73 | 0.60 |
| 2×, (7:3) | 23.35 ± 0.62 | 0.639 ± 0.013 | 1.753 ± 0.008 | 64 | 1.00 | 0.56 |
| C-PAN@silica-HF-CO₂ | | | | | | |
| 6×, (9:1) | 25.57 ± 0.70 | 0.725 ± 0.025 | 1.878 ± 0.018 | 61 | 0.85 | 0.34 |
| 2×, (9:1) | 26.45 ± 0.44 | 0.339 ± 0.029 | 1.814 ± 0.040 | 81 | 2.40 | 1.49 |
| 6×, (7:3) | 27.15 ± 1.47 | 0.630 ± 0.024 | 2.180 ± 0.022 | 71 | 1.13 | 0.44 |
| 2×, (7:3) | 34.34 ± 0.14 | 0.413 ± 0.030 | 2.340 ± 0.017 | 82 | 2.00 | 1.39 |
| C-PAN@silica-CO₂ | | | | | | |
| 6×, (9:1) | 23.92 ± 0.68 | 1.258 ± 0.025 | 2.132 ± 0.013 | 41 | 0.33 | 0.01 |
| 2×, (9:1) | 19.62 ± 0.70 | 1.305 ± 0.026 | 2.193 ± 0.007 | 40 | 0.31 | 0.02 |
| 6×, (7:3) | 28.45 ± 0.84 | 1.030 ± 0.012 | 2.099 ± 0.025 | 51 | 0.50 | 0.01 |
| 2×, (7:3) | 26.67 ± 1.16 | 1.452 ± 0.016 | 2.036 ± 0.004 | 29 | 0.20 | 0.02 |
| C-PAN@silica-CO₂-HF | | | | | | |
| 6×, (9:1) | 24.02 ± 0.64 | 0.778 ± 0.055 | 1.799 ± 0.001 | 57 | 0.73 | 0.24 |
| 2×, (9:1) | 20.19 ± 0.45 | 0.506 ± 0.019 | 1.968 ± 0.014 | 74 | 1.47 | 0.77 |
| 6×, (7:3) | 26.60 ± 0.89 | 0.621 ± 0.010 | 1.919 ± 0.013 | 68 | 1.09 | 0.46 |
| 2×, (7:3) | 28.01 ± 1.20 | 0.576 ± 0.014 | 1.846 ± 0.005 | 69 | 1.19 | 0.72 |

| | | | BET | | average |
|---|---|---|---|---|---|
| | specific pore volume | | surface | | pore |
| sample | [cm³ g⁻¹] | | area, σ | | diameter |
| n×, (x:y) | V_{micropore} ^{g} | V_{>300 nm} ^{h} | [m² g⁻¹] ⁱ | | [nm] ^{j} |
| PAN@silica | | | | | |
| 6×, (9:1) | ^{k} | ^{k} | ^{k} | | ^{k} |
| 2×, (9:1) | ^{k} | ^{k} | ^{k} | | ^{k} |
| 6×, (7:3) | ^{k} | ^{k} | ^{k} | | ^{k} |
| 2×, (7:3) | ^{k} | ^{k} | ^{k} | | ^{k} |
| A-PAN@silica | | | | | |
| 6×, (9:1) | ^{k} | ^{k} | ^{k} | | ^{k} |
| 2×, (9:1) | ^{k} | ^{k} | ^{k} | | ^{k} |
| 6×, (7:3) | ^{k} | ^{k} | ^{k} | | ^{k} |
| 2×, (7:3) | ^{k} | ^{k} | ^{k} | | ^{k} |
| C-PAN@silica | | | | | |
| 6×, (9:1) | 0.0 ^{l} | 0.23 | 0.47 | (0.42) | 1938 |
| 2×, (9:1) | 0.0 ^{l} | 0.14 | 7.9 | (4.8) | 76.6 |
| 6×, (7:3) | 0.0 ^{l} | 0.24 | 6.3 | (2.3) | 159 |
| 2×, (7:3) | 0.0 ^{l} | 0.18 | 3.0 | (1.9) | 368 |
| C-PAN@silica-HF | | | | | |
| 6×, (9:1) | ^{k} | ^{m} | 193 | (41) | 6.5 |
| 2×, (9:1) | ^{k} | ^{m} | 474 | (69) | 7.7 |
| 6×, (7:3) | ^{k} | ^{m} | 442 | (39) | 5.6 |
| 2×, (7:3) | ^{k} | ^{m} | 618 | (119) | 6.5 |
| C-PAN@silica-HF-CO₂ | | | | | |
| 6×, (9:1) | 0.37 | 0.14 | 843 | (491) | 4.0 |
| 2×, (9:1) | 0.60 | 0.91 | 1433 | (323) | 6.7 |
| 6×, (7:3) | 0.42 | 0.27 | 1024 | (535) | 4.4 |
| 2×, (7:3) | 0.56 | 0.05 | 1419 | (369) | 5.6 |
| C-PAN@silica-CO₂ | | | | | |
| 6×, (9:1) | ^{k} | ^{m} | 226 | (187) | 5.8 |
| 2×, (9:1) | ^{k} | ^{m} | 267 | (124) | 4.7 |
| 6×, (7:3) | ^{k} | ^{m} | 169 | (98) | 11.9 |
| 2×, (7:3) | ^{k} | ^{m} | 465 | (361) | 1.7 |
| C-PAN@silica-CO₂-HF | | | | | |
| 6×, (9:1) | 0.29 | 0.20 | 416 | (214) | 7.0 |
| 2×, (9:1) | 0.42 | 0.28 | 1167 | (264) | 5.0 |
| 6×, (7:3) | 0.44 | 0.19 | 994 | (451) | 4.4 |
| 2×, (7:3) | 0.43 | 0.04 | 1142 | (263) | 4.2 |

^{a} Average of three samples.
^{b} Shrinkage relative to the PAN@silica xerogel compact.
^{c} Single sample, average of 50 measurements.
^{d} Porosity, Π = 100 × (ρₛ − ρ_{b})/ρₛ.
^{e} V_{Total} was calculated via V_{Total} = (1/ρ_{b}) − (1/ρₛ).
^{f} V_{1.7-300}_{_{—}}ₙₘ was calculated via the BJH desorption cumulative pore volume.
^{g} V_{micropore} was calculated with N₂-sorption data at P/Pₒ ≤ 0.1 using a low-pressure N₂ dosing routine at 77 K and the Dubinin-Radushkevich (DR) method for data analysis.
^{h} V_{>300}_{_{—}}ₙₘ = V_{Total} − (V_{micropore} + V_{1.7-300}_{_{—}}ₙₘ).
ⁱ Numbers in (parentheses): Micropore surface areas calculated via t-plot method.
^{j} Average pore diameters were calculated via the 4 × V/σ method by setting V = V_{Total} = (1/ρ_{b}) − (1/ρₛ).
^{k} Too small - could not be measured.
^{l} Presumed.
^{m} Was not calculated because of ^{h} and ^{k}.

As shown in Table 7, the bulk density (ρ_{b}) of PUA@silica xerogel compacts (prepared as a sample according to the method described in Part 1 of this Example) was in the range of 0.894-1.007 g cm⁻³, and the skeletal density (ρₛ) was in the range of 1.332-1.369 g cm⁻³. Notably, both ρ_{b} and ρₛ decreased as the amount of PUA in the composite increased. As shown in Table 8, the bulk density (ρ_{b}) of PAN@silica xerogel compacts (prepared as a sample according to the method described in Part 1 of this Example) was in the range of 1.282-1.441 g cm⁻³ while the skeletal density (ρₛ) was in the range of 1.182-1.373 g cm⁻³. The trends in ρ_{b} and ρs as a function of the amount of PAN were similar to those in PUA@silica.

The operation of squeezing the void space out of PAN@silica compacts was more effective than in PUA@silica. The percent open porosity, Π calculated from bulk and skeletal density data via Π=100×(ρₛ−ρ_{b}) ρₛ, and was in the range of 26-33% v/v for PUA@silica xerogel compacts and 5-7% v/v for PAN@silica xerogel compacts.

The carbonization process of PUA@silica xerogel compacts (carried out according to the methods described in Example 6) brought about a linear shrinkage of about 28% for all samples, yet because of the mass loss, the porosity increased into the 38-51% v/v range. For the PAN@silica xerogel compacts (carried out according to the methods described in Example 7), the aromatization process brought about a linear shrinkage of 9±3% and a slight-to-moderate increase in porosity into the range of 8-24% v/v. The subsequent carbonization of the A-PAN@silica compacts resulted in a total linear shrinkage of up to 22% and an increase in porosity into the 22%-32% v/v range. Overall, although the loss of mass due to the carbonization process did create some void space, the porosity never exceeded 51% v/v (case of C-PUA@silica), while in C-PAN@silica the porosity was significantly lower, never exceeded 32% v/v.

In contrast, the subsequent etching processes with HF and CO₂, and especially their sequence, had a profound effect on the porosity, surface areas and pore size distribution.

After etching C-PUA@silica compacts with HF, ρ_{b} and ρₛ decreased due to the fact that silica was removed. Samples did not shrink further, and the porosities of C-PUA@silica-HF were higher (in the 54%-63% v/v range) relative to those of C-PUA@silica (38%-51% v/v). On the other hand, when C-PUA@silica samples were etched with CO₂ first, linear shrinkage increased slightly, which apparently compensated for the mass loss, and ρ_{b} remained about the same. ρₛ, however, increased consistent with removing carbon while silica stayed behind. The porosities of C-PUA@silica-CO₂ were slightly higher (39%-56% v/v) than those of C-PUA@silica (38%-51% v/v) and slightly lower than those of C-PUA@silica-HF (54%-63% v/v).

Notably, further etching of C-PUA@silica-HF with CO₂ propelled the porosity of the resulting C-PUA-silica-HF—CO₂ into the 82%-83% v//v range. On the contrary, the porosity of the C-PUA-CO₂—HF samples remained significantly lower (in the 62%-74% v/v range). Meanwhile, the shrinkages of all double-etched samples converged to the level noted for the samples etched first with CO₂ (i.e., of C-PUA@silica-CO₂).

Similarly, after HF-etching, C-PAN@silica compacts shrank by about an additional 5% in linear dimensions, and both ρ_{b} and ρₛ decreased due to the mass ensuing loss (Table 8). The porosities of C-PAN@silica-HF were higher (in the 35%-64% v/v range) relative to those of C-PAN@silica (22%-32% v/v). Consistent with what was found with etching of C-PUA@silica, when C-PAN@silica was etched with CO₂ first, the shrinkage was higher (about an additional 25%) and the porosity was lower (in the 29%-51% v/v range) than the porosity of the carbon samples etched first with HF (in the 35%-64% v/v range). A second etching with CO₂ or HF, respectively, equalized the shrinkages, and consistent with what was found with double etching of the C-PUA@silica samples, the porosities of the samples etched with HF first (i.e., of C-PAN@silica-HF—CO₂) were significantly higher (in the range of 61%-82% v/v) than the porosities of the C-PAN@silica-CO₂—HF (in the 57%-74% v/v range).

The differences in the porosities of the terminal carbons as a function of the sequence of treatment with HF versus CO₂ were also accompanied by differences in the pore structure and surface areas.

### 4. Microscopic Properties of PUA@Silica, PAN@Silica, C-PUA@Silica, and C-PAN@Silica Systems

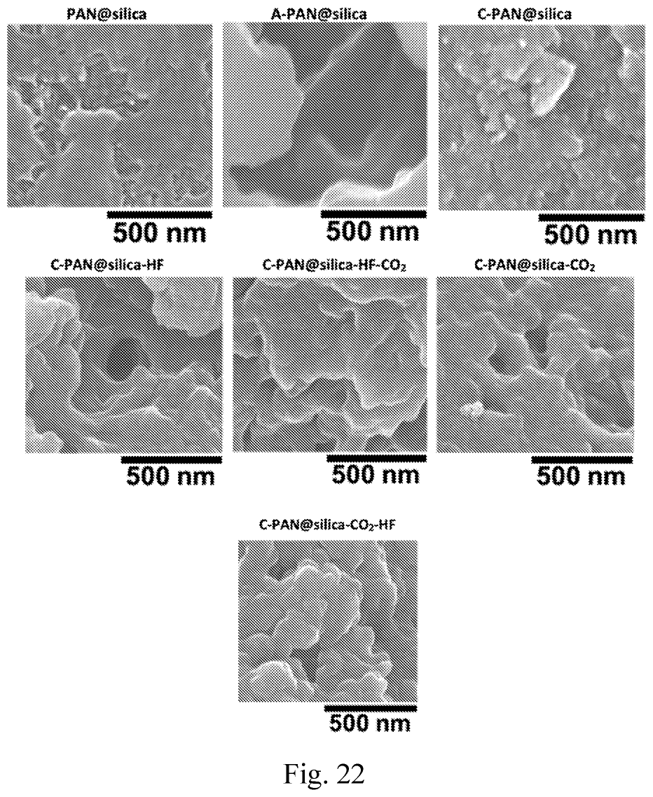

FIGS. 21 and 22 show SEM images of PUA-4×@silica and PAN-6×@silica(9:1) compacts (prepared according to the methods described in Examples 4 and 5 and prepared as a sample according to the method described in Part 2 of this Example), abbreviated as PUA@silica and PAN@silica, respectively, along carbonization and etching (carried out according to the methods described in Examples 6 and 7).

Microscopically, internal cleaved surfaces of all PUA@silica and PAN@silica compacts were smooth. Some roughness appeared after carbonization, yet the materials remained compact. Void space and some structure at the sub-micron level were generated after etching with HF and CO₂, but the new surfaces still appeared smooth (FIGS. 21 and 22). One conclusion from SEM imaging is that the etching processes generated some microporosity, but owing to the apparent smoothness of the macroporous surfaces, N₂ sorption was also conducted (discussed in Example 14).

### Example 14

### Porosity Studies of C-PUA@Silica and C-PAN@Silica Systems

### 1. Methods

The pore structure of C-PUA@silica and C-PAN@silica samples (prepared according to the methods described in Examples 6 and 7) was probed with N₂-sorption porosimetry at 77 K using either a Micromeritics ASAP 2020 or a TriStar II 3020 surface area and porosimetry analyzer. Before porosimetry, samples were outgassed for 24 hours under vacuum at 120° C. Data were reduced to standard conditions of temperature and pressure (STP). Total surface areas were determined via the Brunauer-Emmett-Teller (BET) method from the N₂-sorption isotherms. Micropore analysis was conducted with low-pressure N₂-sorption at 77 K using a Micromeritics ASAP 2020 instrument equipped with a low-pressure transducer or with CO₂ adsorption up to 760 Torr (relative pressure P/P₀=0.03) at 273 K using the Micromeritics TriStar II 3020 system mentioned above. Micropore surface areas were calculated via t-plot analysis of the isotherms using the Harkins and Jura Model. Pore size distributions were determined with the Barret-Joyne-Halenda (BJH) equation applied to the desorption branch of the N₂-sorption isotherms.

### 2. N₂-Sorption Isotherms of C-PUA@Silica and C-PAN@Silica Systems

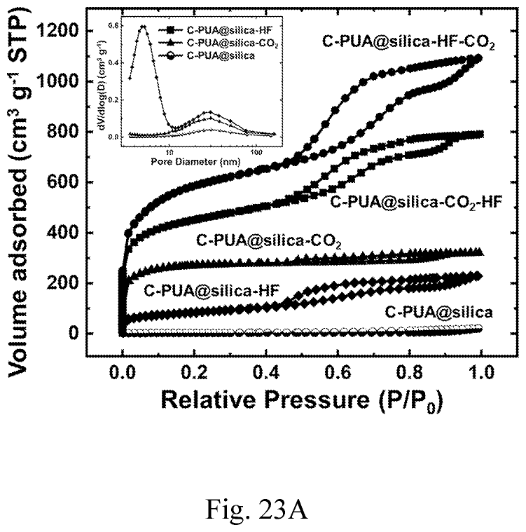

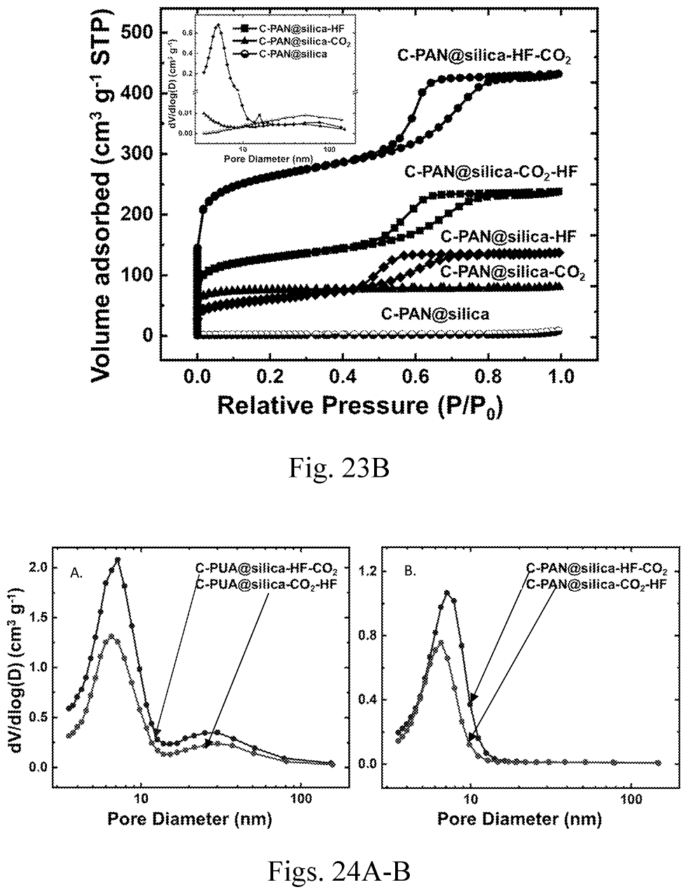

The evolution of the N₂-sorption isotherms of C-PUA-4.5×@silica and C-PAN-6×@silica(9:1) compacts, abbreviated as C-PUA@silica and C-PAN@silica, respectively, C-PUA@silica and C-PAN@silica upon further treatment with HF and then CO₂, or with CO₂ and then HF, is shown in FIGS. 23A and 23B, respectively. Both systems follow the same pattern. To begin with, the adsorption of N₂ by either C-PUA@silica or C-PAN@silica was negligibly small, suggesting that the porosities reported above (38%-51% v/v, and 22%-32% v/v, respectively) corresponded to macropores with >300 nm in diameter. The N₂-sorption isotherms also illustrated differences between a first treatment with HF and a first treatment with CO₂. In both cases, the N₂ uptake increased, but only the isotherms of C-PUA@silica-HF and C-PAN@silica-HF showed the characteristic hysteresis loops of mesoporosity. Furthermore, a first treatment with CO₂ yielded a sharp rise of the isotherms at low pressures, characterizing microporosity (cases of C-PUA@silica-CO₂ and C-PAN@silica-CO₂). Indeed, BJH analysis of the desorption branches of the isotherms of all four carbons (i.e., C-PUA@silica-HF or —CO₂ and C-PAN@silica-HF or —CO₂) yielded meaningful pore size distributions in the mesopore range only for C-PUA@silica-HF and C-PAN@silica-HF (see Insets in FIGS. 23A and 23B). Subsequent treatment with the second etching agent resulted in materials with N₂-sorption isotherms indicating the presence of both mesopores and micropores, irrespective of their origin. The BJH plots of all four terminal doubly etched materials show similar pore size distributions centered at similar pore diameters, which is a little less than 10 nm. The distribution maxima were slightly larger in materials etched first with HF (see FIG. 24). Notably, the shape of the desorption branches of all C-PAN@silica-HF, —HF—CO₂ and —CO₂—HF indicates ink-bottle types of mesopores. This type of shape was not as well-defined in the corresponding cases of the PUA-derived samples.

Consistently, the total volume of N₂ uptaken by C-PUA@silica-HF—CO₂ and C-PAN@silica-HF—CO₂ was significantly higher than that of C-PUA@silica-CO₂—HF and C-PAN@silica-CO₂—HF. That behavior matched the trends in the porosity as described in Example 13 and is also reflected on the corresponding surface areas (Tables 7 and 8). Specifically, the BET surface areas of C-PUA@silica and C-PAN@silica were very low (1.3-11.0 m² g⁻¹, and 0.47-7.9 m² g⁻¹, respectively). Upon treatment with HF, the BET surface area of C-PUA@silica-HF jumped in the 285-394 m² g⁻¹ range (20% assigned to micropores), while the BET surface area of C-PAN@silica-HF jumped in the 193-618 m² g⁻¹ range (only 5% to 20% was assigned to micropores). On the other hand, a first etch with CO₂ increased the surface areas of the corresponding samples roughly up to the same ranges as the HF treatment did. However, in the case of C-PUA@silica-CO₂, over 70% of the new surface area was assigned to micropores and 50%-80% in the case of C-PAN@silica-CO₂.

As shown in Tables 7 and 8, treatment with the second etching agent propelled BET surface areas up to 1930 m² g⁻¹ (case of C-PUA-4.5×@silica-HF—CO₂), 37% of which was assigned to micropores, and up to 1433 m² g⁻¹, 22% of which was assigned to micropores (case of C-PAN-2×@silica(9:1)-HF—CO₂).

The pore structure of the double-etched samples was also probed with low-pressure N₂-sorption using a low-pressure transducer. The derived micropore volumes, V_{micropore}, are included in Tables 7 and 8, and in all cases V_{1.7-300_nm}+V_{micropore}<V_{Total} (the latter calculated from bulk and skeletal density data via V_{Total}=(1/ρ_{b})−(1/ρₛ)), meaning that, in agreement with conclusions arrived from SEM, all samples included a certain amount of macropores with sizes >300 nm. A second observation is that, in general, V_{micropore} were lower in samples etched first with CO₂.

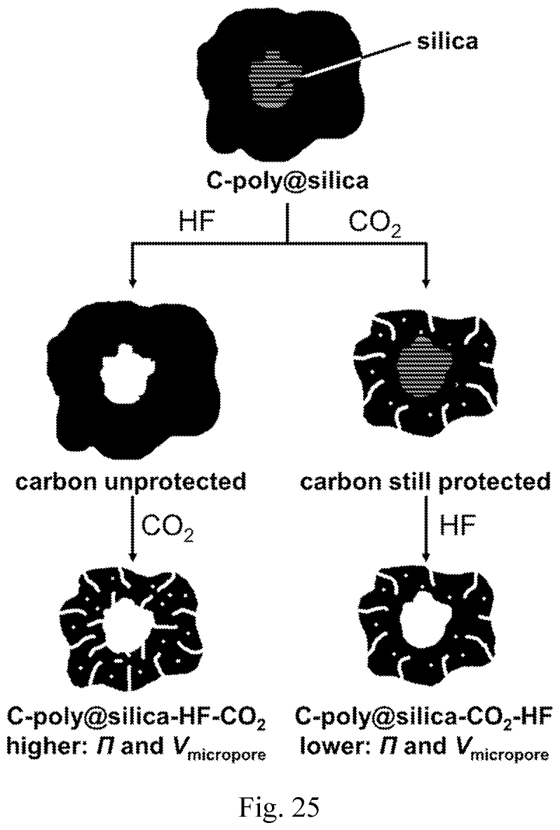

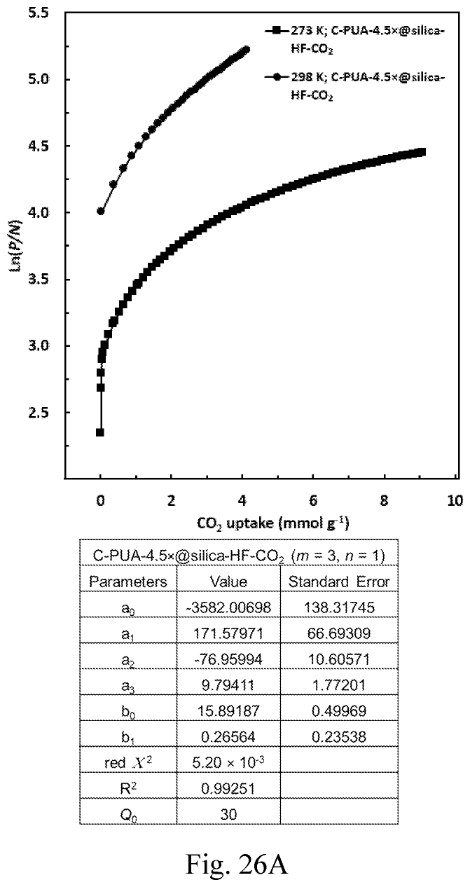

Overall, percent mass loss, porosity values (Π), specific pore volumes V_{Total} and V_{micropore}, and BET surface areas were higher in double-etched samples that were treated first with HF. Since the mechanism of action of CO₂ is via a comproportionation reaction with C to CO, it is reasonable to suggest that silica protects the carbon is in contact with. As illustrated in FIG. 25, if silica is removed first, more surface area of carbon becomes accessible to the etching effect of CO₂.

### Example 15

### Gas Sorption Studies of C-PUA@Silica and C-PAN@Silica Systems

### 1. CO₂ Adsorption for C-PUA@Silica and C-PAN@Silica Systems

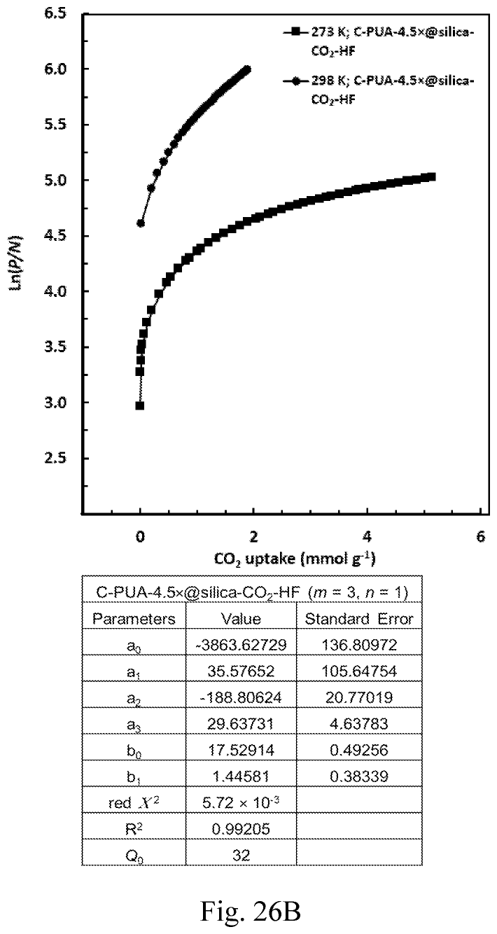

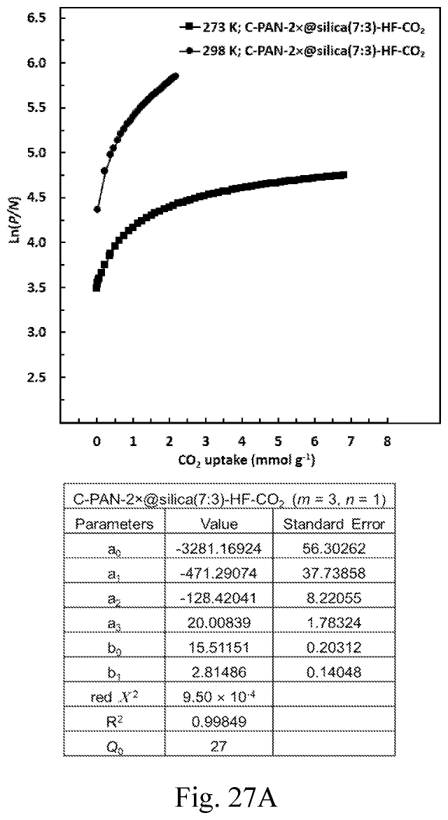

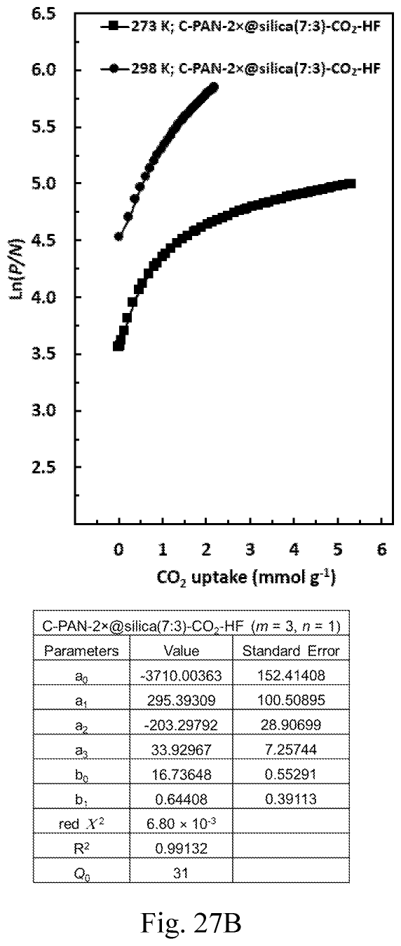

CO₂ adsorption (Qₛₜ) values were calculated using the Virial fitting method. As shown in FIGS. 26 and 27, the CO₂ adsorption isotherms at 273 K and 298 K for C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF (prepared according to the methods described in Examples 6 and 7) were fitted simultaneously with a Virial-type Equation (1) using the OriginPro 2020 9.7.0 software package:

$$ln P = ln N + \frac{1}{T} {\sum }_{i = 0}^{m} {a}_{i} {N}^{i} + {\sum }_{i = 0}^{n} {b}_{i} {N}^{i} \qquad ( 1 )$$

[P is pressure in Torr, Nis the adsorbed amount in mmol g⁻¹, T is the absolute temperature, aᵢ and bi are the Virial coefficients, and m and n are the number of coefficients needed in order to fit the isotherms adequately]. Using the least squares method, the values of m and n were gradually increased until the sum of the squared deviations of the experimental points from the fitted isotherm was minimized. All data were fitted well with m=3 and n=1 and are shown in the tables accompanying FIGS. 26 and 27.

The values of aₒ to am were introduced into Equation (2), and the isosteric heats of adsorption (Qₛₜ) were calculated as a function of the surface coverage (N).

$${Q}_{st} = - R {\sum }_{i = 0}^{m} {a}_{i} {N}^{i} \qquad ( 2 )$$

[R is the gas constant (8.314 J mol⁻¹ K⁻¹) and Qₛₜ is given in kJ mol⁻¹]. The common term in Equation (2) for all N, Q₀, corresponds to i=0 and is given by Equation (3).

Q₀=−Ra₀ (3)
Q₀ is the heat of adsorption as coverage goes to zero and is a sensitive evaluator of the affinity of the adsorbate for the surface. Q₀ values are shown in the tables accompanying FIGS. 26 and 27 and summarized in Table 10 (produced below).

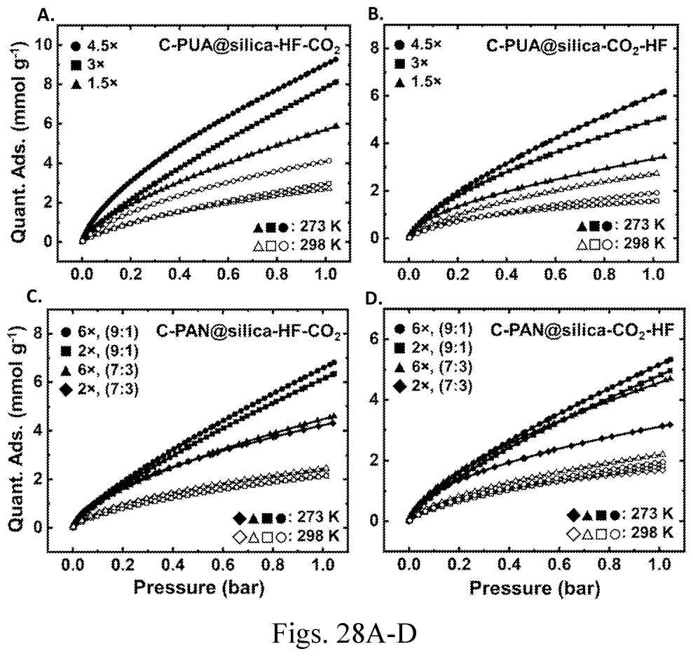

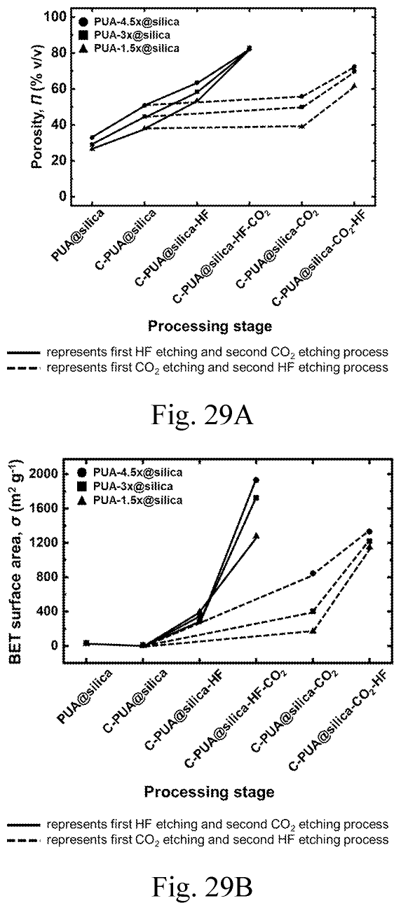

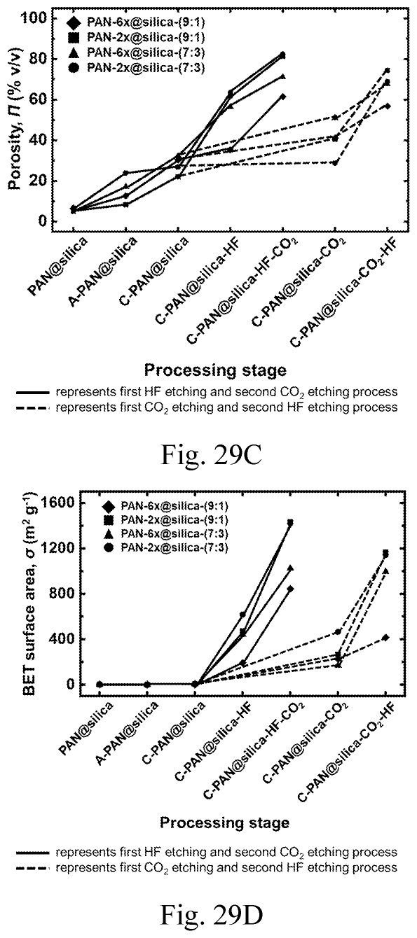

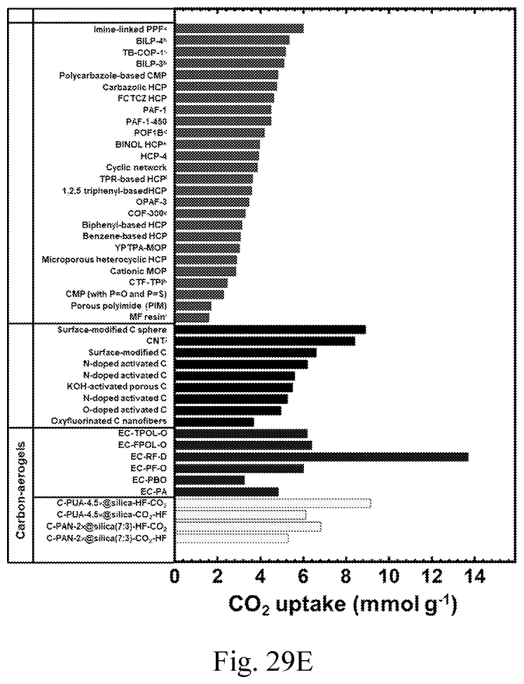

Fully reversible, with no hysteresis, CO₂ adsorption isotherms at two different temperatures (273 K and 298 K) and up to 1 bar (corresponding to partial pressure P/Pₒ=0.03) of all carbon samples double-etched in either sequence are shown in FIG. 28. Cross-referencing with Tables 7 and 8, maximum CO₂ uptake (FIG. 28) of both the PUA- and PAN-derived and double-etched (in either sequence) carbon aerogel systems was observed with the lower-density, higher-porosity, higher micropore volume, and lower micropore surface area samples-namely with C-PUA-4.5×@silica-HF—CO₂ (9.15 mmol g⁻¹) and C-PUA-4.5×@silica-CO₂—HF (6.13 mmol g⁻¹) as well as with C-PAN-2×@silica(7:3)-HF—CO₂ (6.56 mmol g⁻¹) and C-PAN-2×@silica(7:3)—CO₂—HF (5.30 mmol g⁻¹). PAN-derived carbon aerogels adsorbed lower amounts of CO₂ than their PUA-derived analogues. Consistently, a lower CO₂ uptake was observed with samples obtained through the CO₂/HF etching sequence compared with their counterparts obtained through the HF/CO₂ sequence. As shown in FIG. 29, most samples displayed levels of CO₂ uptake that were amongst what has been observed before with other carbon aerogels (around 5-6 mmol g⁻¹). By the same token, however, the best performer, C-PUA-4.5×@silica-HF—CO₂ (9.15 mmol g⁻¹), was above the best performers in the literature (e.g., phenolic resin-based activated carbon microspheres, or carbon nanotube superstructures), yet lower than certain CO₂-etched carbon aerogels from pyrolysis of low-density resorcinol-formaldehyde aerogels, which have shown CO₂ uptake up to 14.8±3.9 mmol g⁻¹.

The involvement of the micropores in the CO₂ uptake was investigated by comparing the experimental CO₂ uptake with values calculated by assuming: (a) monolayer coverage of the BET surface area with CO₂ (0.17 nm² per molecule); (b) monolayer coverage of only the micropore surface area; and (c) micropore volume filling with CO₂ in a state that resembles liquid CO₂ (density of the state=1.023 g cm⁻³). Micropore volumes were calculated using the Dubinin-Radushkevich (DR) method on low-pressure N₂-sorption data at 77 K and on CO₂ adsorption data at 0° C., or the micropore volumes were calculated using the Density Functional Theory (DFT) method on the CO₂ adsorption data at 0° C. All relevant data are summarized in Table 9. It is noted, however, that since the DR(CO₂) data are not independent of the CO₂ uptake, the data were not considered in pore filling with CO₂. Instead, the data were used for cross checking the consistency of the pore volumes calculated via the DR(N₂) method, and it is noted that, in general, the two micropore volumes agree with one another. Subsequently, both DR(N₂) and DR(CO₂) were used for calculating average micropore sizes.

TABLE 9
Micropore analysis and CO₂ uptake at 0° C.
by all carbonized and double-etched xerogel compacts

| | | | | Micropore diameter [nm] via | | |
|---|---|---|---|---|---|---|
| | Specific micropore volume | | | 4 × V/(micropore area)^{d} | | |
| | [cm³ g⁻¹] | | | V from | V from | |
| sample | DR(N₂)^{a} | DR(CO₂)^{b} | DFT(CO₂)^{c} | DR(N₂) | DR(CO₂) | average^{e} |
| C-PUA@silica-HF-CO₂ | | | | | | |
| 1.5× | 0.74 | 0.43 ± 0.01 | 0.11 ± 0.01 | 4.71 | 2.74 ± 0.07 | 3.73 |
| 3× | 0.75 | 0.64 ± 0.03 | 0.12 ± 0.01 | 4.24 | 3.64 ± 0.15 | 3.93 |
| 4.5× | 0.86 | 0.69 ± 0.01 | 0.18 ± 0.01 | 4.86 | 3.91 ± 0.05 | 4.38 |
| C-PUA@silica-CO₂-HF | | | | | | |
| 1.5× | 0.21 | 0.23 ± 0.01 | 0.08 ± 0.01 | 1.26 | 1.49 ± 0.04 | 1.32 |
| 3× | 0.42 | 0.38 ± 0.01 | 0.12 ± 0.01 | 2.67 | 2.27 ± 0.03 | 2.54 |
| 4.5× | 0.62 | 0.48 ± 0.02 | 0.08 ± 0.03 | 4.06 | 2.74 ± 0.17 | 3.60 |
| C-PAN@silica-HF-CO₂ | | | | | | |
| 6×, (9:1) | 0.37 | 0.30 ± 0.01 | 0.11 ± 0.01 | 3.01 | 2.46 ± 0.07 | 2.73 |
| 2×, (9:1) | 0.60 | 0.52 ± 0.02 | 0.10 ± 0.01 | 7.43 | 6.39 ± 0.05 | 6.93 |
| 6×, (7:3) | 0.42 | 0.35 ± 0.01 | 0.11 ± 0.01 | 3.14 | 2.58 ± 0.04 | 2.88 |
| 2×, (7:3) | 0.56 | 0.50 ± 0.02 | 0.10 ± 0.01 | 6.07 | 5.43 ± 0.22 | 5.75 |
| C-PAN@silica-CO₂-HF | | | | | | |
| 6×, (9:1) | 0.29 | 0.30 ± 0.01 | 0.08 ± 0.01 | 5.42 | 5.65 ± 0.16 | 5.51 |
| 2×, (9:1) | 0.42 | 0.38 ± 0.02 | 0.08 ± 0.01 | 6.36 | 5.78 ± 0.35 | 6.06 |
| 6×, (7:3) | 0.44 | 0.33 ± 0.01 | 0.10 ± 0.01 | 3.90 | 2.95 ± 0.06 | 3.41 |
| 2×, (7:3) | 0.43 | 0.39 ± 0.01 | 0.09 ± 0.01 | 6.54 | 5.86 ± 0.020 | 6.24 |

| | CO₂ uptake [mmol g⁻¹] at 273 K, 1 bar | | | | |
|---|---|---|---|---|---|
| | | calculated from | | | |
| | | | | specific | |
| | measured | surface | | micropore | |
| | experi- | areas | | volumes | |
| sample | mentally | BET^{f} | Micropore^{g} | DR(N₂)^{h} | DFT(CO₂)ⁱ |
| C-PUA@silica-HF-CO₂ | | | | | |
| 1.5× | 5.75 ± 0.17 | 12.5 | 6.1 | 17.2 | 2.6 ± 0.1 |
| 3× | 7.98 ± 0.15 | 16.8 | 6.9 | 17.4 | 2.7 ± 0.1 |
| 4.5× | 9.15 ± 0.10 | 18.9 | 6.9 | 20.0 | 4.2 ± 0.1 |
| C-PUA@silica-CO₂-HF | | | | | |
| 1.5× | 3.34 ± 0.10 | 11.2 | 6.5 | 4.9 | 1.8 ± 0.1 |
| 3× | 5.13 ± 0.09 | 11.9 | 6.2 | 9.8 | 2.7 ± 0.1 |
| 4.5× | 6.13 ± 0.07 | 13.0 | 6.0 | 14.4 | 2.0 ± 0.4 |
| C-PAN@silica-HF-CO₂ | | | | | |
| 6×, (9:1) | 4.34 ± 0.11 | 8.2 | 4.8 | 8.6 | 2.6 ± 0.1 |
| 2×, (9:1) | 6.68 ± 0.29 | 14.0 | 3.2 | 14.0 | 2.3 ± 0.1 |
| 6×, (7:3) | 4.78 ± 0.14 | 10.0 | 5.2 | 9.8 | 2.5 ± 0.1 |
| 2×, (7:3) | 6.82 ± 0.12 | 13.9 | 3.6 | 13.0 | 2.4 ± 0.1 |
| C-PAN@silica-CO₂-HF | | | | | |
| 6×, (9:1) | 3.05 ± 0.09 | 4.1 | 2.1 | 6.7 | 1.9 ± 0.1 |
| 2×, (9:1) | 5.11 ± 0.27 | 11.4 | 2.6 | 9.8 | 1.9 ± 0.1 |
| 6×, (7:3) | 4.60 ± 0.08 | 9.7 | 4.4 | 10.2 | 2.3 ± 0.1 |
| 2×, (7:3) | 5.30 ± 0.12 | 11.2 | 2.6 | 10.0 | 2.1 ± 0.1 |

^{a}Via the Dubinin-Radushkevich (DR) method from N₂-sorption data obtained at 77 K using a low-pressure transducer (P/Pₒ ≤ 0.01). Single experiment;
^{b}Via the DR method from CO₂ adsorption data at 273 K up to relative pressure of 0.015;
^{c}Using the same data as in footnote (^{b}) and applying the DFT method. Pore volumes correspond to pores <1 nm in size;
^{d}Calculated as indicated using the micropore surfaces areas obtained from N₂-sorption data via the t-plot method;
^{e}Calculated via 4 × V/(micropore area), where V = [V_{DR(N}_{₂}₎ + V_{DR(CO}_{₂}₎]/2;
^{f}Calculated by dividing the BET surface area over the CO₂ cross sectional area (0.17 nm²), over the Avogadro's number;
^{g}Calculated by dividing the micropore surface area obtained from N₂-sorption data via the t-plot method over the CO₂ cross sectional area (0.17 nm²), over Avogadro's number;
^{h,i}Calculated by assuming that micropore volumes (via the DR(N₂) and the DFT(CO₂) methods - see footnotes ^{a} and ^{c}, respectively) are filled with liquid CO₂ (the density of liquid CO₂ at 273 K, was taken equal to the density of adsorbed CO₂ (1.023 g cm⁻³). Errors were calculated by applying rules of propagation of error.

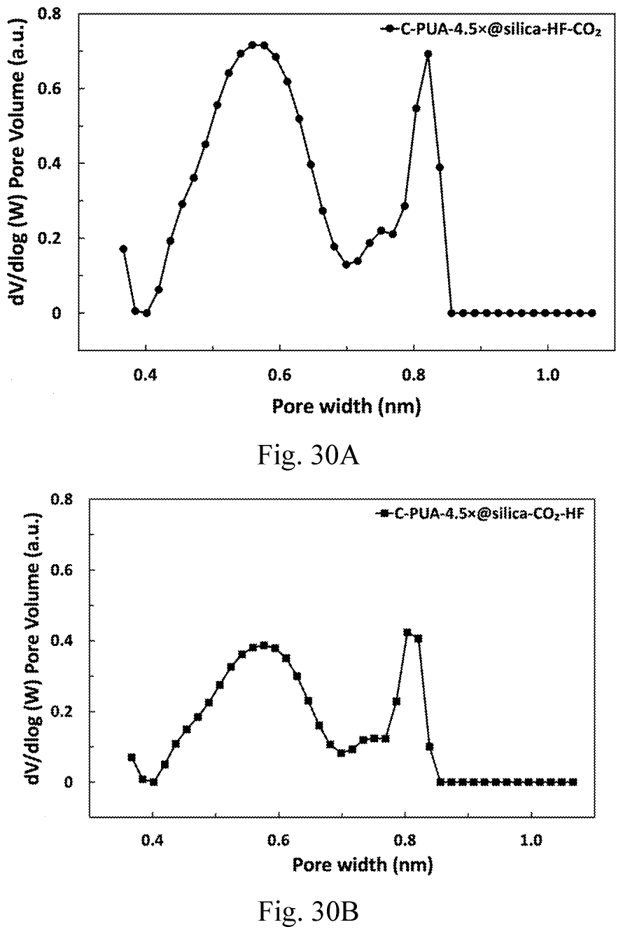

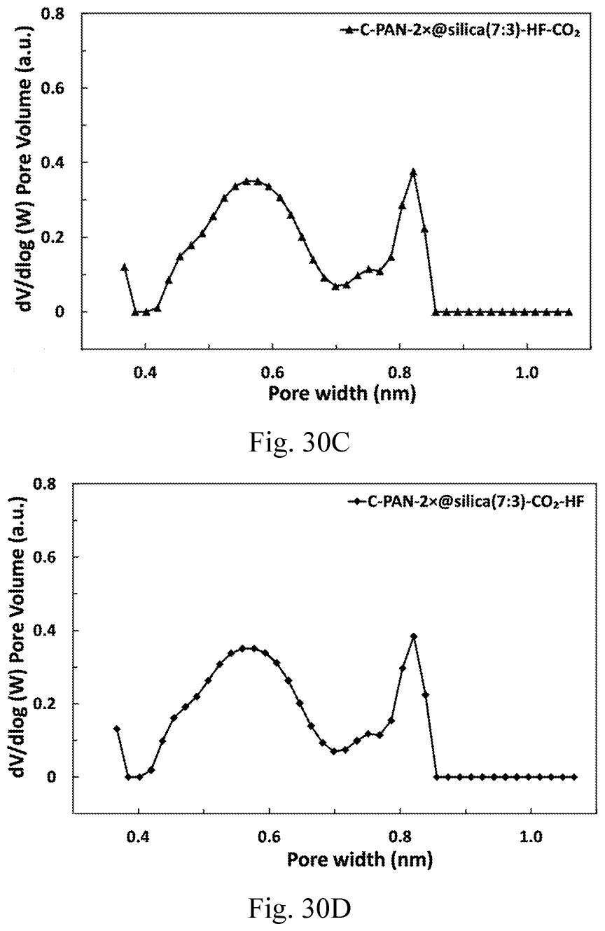

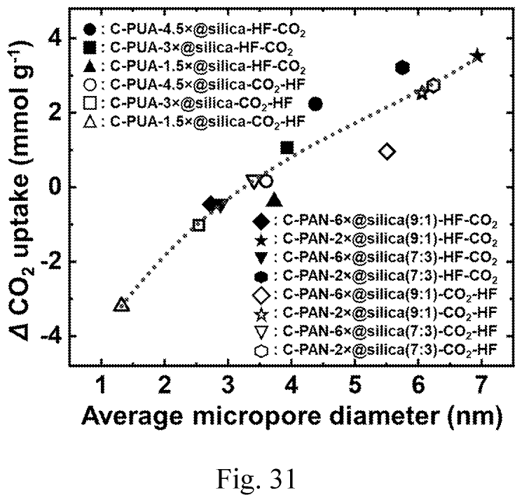

The amounts of CO₂ uptaken at the highest points of the isotherms of FIG. 28 were lower than the amounts of CO₂ that would provide monolayer coverage of the corresponding BET surface areas. On the other hand, independently of the polymer system or the etching sequence, C-PUA-4.5×@silica-HF—CO₂, C-PUA-4.5×@silica-CO₂—HF, C-PAN-2×@silica(7:3)-HF—CO₂, and C-PAN-2×@silica(7:3)—CO₂—HF compacts showed similar micropore size distributions by the DFT method applied on the CO₂ adsorption isotherms (see FIG. 30) and showed similar specific micropore volumes (all around 0.08-0.12 cm³ g⁻¹). Filling those DFT-derived micropore volumes with CO₂ typically requires only 2-3 mmol g⁻¹ of CO₂ (except for C-PUA-4.5×@silica-HF—CO₂, which requires 4.2 mmol g⁻¹), yet, in all cases, the amount of CO₂ required to fill those micropore volumes was much below the experimentally observed values of CO₂ uptake (Table 9). Then, as summarized in FIG. 31, it was observed that, whenever the average micropore diameter from the DR(N₂) and the DR(CO₂) methods was approximately 3-4 nm, the amount of CO₂ uptaken was found near the amount required for monolayer coverage of the micropores. When the average micropore diameter was <3 nm, the amount of CO₂ uptaken was less to significantly less than what was required for monolayer coverage of the micropores. When the average micropore diameter was >4 nm, the CO₂ uptaken was more to significantly more than the amount required for monolayer coverage of the micropores, yet it always remained less than the amount of CO₂ required to fill the “micropore” volumes that were calculated with the DR(N₂) method. In other words, CO₂ seems to fill all sub-nanometer micropores (accounted for by the DFT(CO₂) method) and continues to cover the surfaces of small pores falling in the region between what is still defined formally as micropores and the small end of mesopores. In that region, there appears to be a pore-size threshold (in the 3-4 nm range)-below which micropores are not coated with CO₂ completely and above which CO₂ accumulates on already adsorbed CO₂, but never fills those small mesopores completely. It is speculated that in both cases the ultimate amount of CO₂ uptaken is controlled by the fact that the entropic penalty of new CO₂ molecules entering the small pores can no longer be ignored.

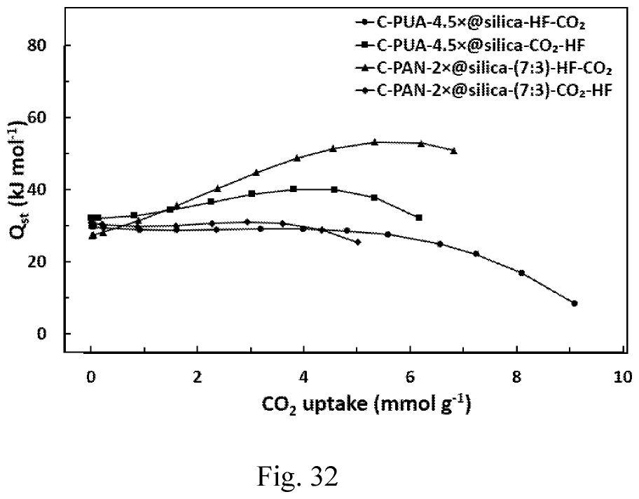

Furthermore, the interaction of CO₂ with the surface of the carbon aerogels was obtained by calculating the isosteric heat of adsorption of CO₂ (Qₛₜ) by the four doubly etched-carbon aerogels with the highest CO₂ uptake capacities amongst their peers: C-PUA-4.5×@silica-HF—CO₂, C-PUA-4.5×@silica-CO₂—HF, C-PAN-2×@silica(7:3)-HF—CO₂, and C-PAN-2×@silica(7:3)-CO₂—HF. As previously discussed, Qₛₜ is defined as the negative of the differential change in the total enthalpy of a closed system, and values were calculated as a function of the CO₂ uptake using Virial fitting on the CO₂ adsorption isotherms at two different temperatures at 273 K and 298 K (see FIGS. 26 and 27). The plots of the Qₛₜ values of the four materials versus the CO₂ uptake are shown in FIG. 32. The intercept of any Qₛₜ plot at zero CO₂ uptake is referred to as Q₀ and is the energy of interaction of CO₂ with the surface of the adsorber. In general, Q₀ values >40 kJ mol-1 are generated by chemisorption while lower values by physisorption.

The Q₀ values of the four double-etched samples were in the range of 27-32 kJ mol-1 (see Table 10).

TABLE 10
Maximum CO₂ adsorption at 1 bar at 273 K and 298 K for
C-PUA-4.5x@silica and C-PAN-2x@silica (7:3) samples

| | CO₂ uptake [mmol g⁻¹] ^{a} | | |
|---|---|---|---|
| sample | at 273 K | at 298 K | Q₀ ^{b} |
| C-PUA-4.5×@silica-HF—CO₂ | 9.15 ± 0.10 | 4.13 ± 0.01 | 30 |
| C-PUA-4.5×@silica-CO₂—HF | 6.13 ± 0.07 | 1.91 ± 0.01 | 32 |
| C-PAN-2×@silica(7:3)-HF—CO₂ | 6.82 ± 0.12 | 2.17 ± 0.04 | 27 |
| C-PAN-2×@silica(7:3)-CO₂—HF | 5.30 ± 0.12 | 1.95 ± 0.01 | 31 |

^{a} Average of at least three measurements.
^{b} Isosteric heats of adsorption at zero coverage, Q₀ (kJ mol⁻¹), using Virial fitting from CO₂ adsorption data at 273 K and 298 K from tables accompanying FIGS. 26 and 27.

These values can be attributed to either weak chemisorption or strong physisorption, and their numerical proximity reflects the fact that, irrespective of the polymeric origin of the carbons implemented or their etching sequence, the surfaces of all systems are lined with the same functional groups (refer to the XPS data in Part 3 of Example 12 and FIGS. 17-19). Physisorption may involve quadrupolar interactions between quadrupolar CO₂ and quadrupolar nitrogen-rich sites. Those interactions are favored in smaller micropores (yielding higher Q₀ values) where quadrupolar fields come closer to one another and may interact better with the adsorbate. On the other hand, a special kind of weak chemisorption of CO₂ on the surface of carbon may involve nucleophilic attack of surface —O⁻ (for example from nitroxide) and —N: (for example, from pyridinic and pyridonic sites) onto CO₂ toward surface-bound carbonate or carbamate, respectively. The reaction of CO₂ with surface —O⁻ is nearly isoenthalpic, while its reaction with —N: is slightly endothermic.

Beyond initial interaction with the surface walls, it is noted from FIG. 31 that, in the cases of C-PUA-4.5×@silica-HF—CO₂ and C-PAN-2×@silica(7:3)—CO₂—HF, the isosteric heats, Qₛₜ, remain about flat until about monolayer coverage (˜6 mmol g⁻¹) and afterwards curve downwards, which means that pore filling starts becoming less favorable. Incidentally, those are also the samples with the highest CO₂ uptake amongst all the PUA- and PAN-derived carbons, respectively (Table 9). On the other hand, at first the Qₛₜ values of the other two samples, C-PUA-4.5×@silica-CO₂—HF and C-PAN-2×@silica(7:3)-HF—CO₂, take upward trends as the CO₂ uptake increases, but again the values both turn downwards as pore filling progresses. Interestingly, the former two samples, whose Qₛₜ plots remain substantially flat, happen to have surfaces O-rich, while the latter two samples, whose Qₛₜ plots curve upwards, are N-rich. By XPS, the O:N ratios of the HF—CO₂ etched C-PUA and C-PAN are 1.85 versus 0.43, respectively, while the O:N ratio of CO₂—HF etched C-PUA and C-PAN are 0.69 versus 1.02, respectively (see Table 6).

A CO₂ uptake model consistent with all data suggests that in the case of O-rich C-PUA-4.5×@silica-HF—CO₂ and C-PAN-2×@silica(7:3)—CO₂—HF, CO₂ is mostly adsorbed via energy-neutral Equation (4) with surface —O—, and continues for sometime

—O⁻+CO₂→surface-O—CO—O⁻ (4)
beyond monolayer coverage according to also energy neutral Equation (5).

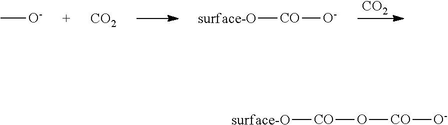

Since the micropore volume of C-PUA-4.5×@silica-HF—CO₂ according to the DR(N₂) method is larger (0.86 cm³ g⁻¹) than the micropore volume of C-PAN-2×@silica(7:3)—CO₂—HF (0.43 cm³ g⁻¹), eventually filling of the former proceeds beyond filling of the latter, resulting in 9.15 mmol g⁻¹ versus 5.30 mmol g⁻¹ of CO₂ uptake, respectively.

On the other hand, in the case of double-etched carbon aerogels with N-rich surfaces, C-PUA-4.5×@silica-CO₂—HF and C-PAN-2×@silica(7:3)-HF—CO₂, the micropore volume of the latter material is less (0.37 cm³ g⁻¹) than that of the former (0.62 cm³ g⁻¹). Therefore, because C-PAN-2×@silica(7:3)-HF—CO₂ gets filled faster, the favorable quadrupole interactions increase as the free space decreases, and consequently the Qₛₜ curve moves upward. In fact, the CO₂ uptake by C-PAN-2×@silica(7:3)-HF—CO₂ (6.82 mmol g⁻¹) is well above what is needed for monolayer coverage of its micropores (3.6 mmol g⁻¹) and close to what is needed for filling them completely (8.6 mmol g⁻¹).

Overall, the lining of the pores is important for increased CO₂ uptake, and O-lining is as important as N, or even more so. Coverage starts with filling smaller (<1 nm) micropores and continues with monolayer coverage of small mesopores. Depending on the pore size, multilayer coverage continues until smaller mesopores (those probed with CO₂ adsorption and low-pressure N₂ sorption) are partially filled.

2. Relative Adsorption Selectivities for CO₂, CH₄, N₂, and H₂ of C-PUA@Silica and C-PAN@Silica Systems

Relative adsorption studies for CO₂, CH₄, N₂, and H₂ were done on Micromeritics TriStar II 3020 surface area and porosimetry analyzer at 273 K up to 1 bar. Adsorption selectivities for one gas versus another were calculated as the ratios of the respective Henry's constants, K_{H}. The latter were calculated via another type of a Virial model, whereas the single-component adsorption isotherms for each gas at 273 K were fitted according to Equation (6).

$$ln N = ln P + {K}_{1} + {K}_{2} N + {K}_{3} {N}^{2} + … = ln P + {\sum }_{i = 1}^{m} {K}_{i} {N}^{i - 1} \qquad ( 6 )$$

Fitting was carried out using the least squares method by varying the number of terms until a suitable number of terms, m, described the isotherms adequately. Coefficients K₁, K₂, . . . Kₘ are characteristic constants for a given gas-solid system and temperature. The Henry's constant for each gas, K_{H}, is the limiting value of N/P as P→O and is given by Equation (7).

$${K}_{H} = {lim}_{P \to 0} ( \frac{N}{P} ) ≅ {e}^{{K}_{i}} \qquad ( 7 )$$

To calculate standard deviations, all isotherms obtained experimentally for each component were fitted individually. The K_{H} values from all isotherms were averaged, and the average values were used to calculate selectivities by taking the ratios. Standard deviations for the ratios were calculated using rules for propagation of error.

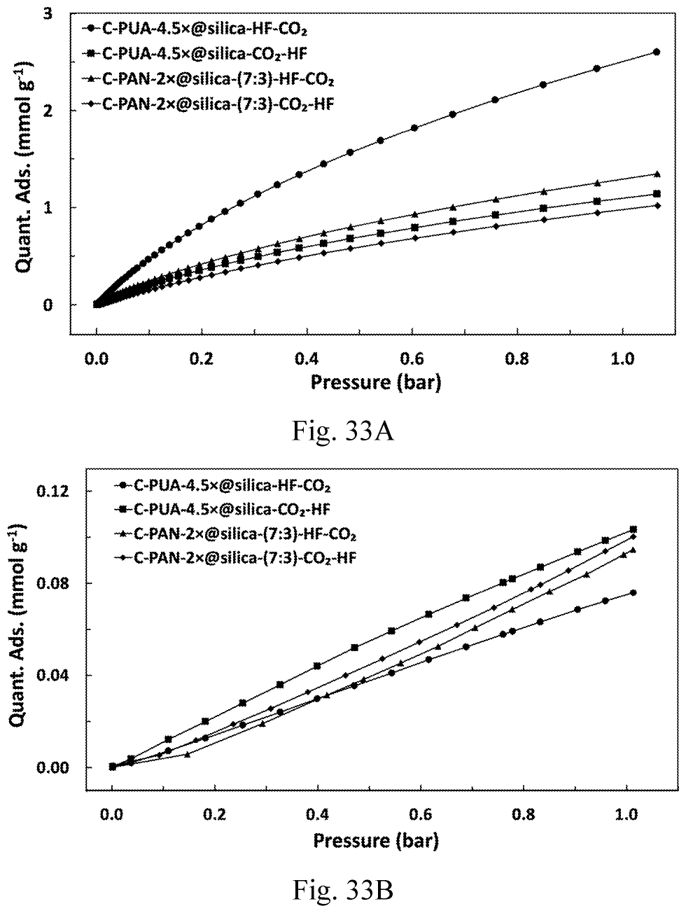

The adsorption isotherms of CH₄ and H₂ at 273 K, 1 bar for both double-etched C-PUA-4.5×@silica and C-PAN-2×@silica(7:3) are shown in FIG. 33. The maximum gas uptake values are summarized in Table 11.

TABLE 11
Maximum gas adsorption data for CO₂, H₂, N₂ and CH₄ at 273 K/1 bar.^{a}

| | CO₂ | H₂ | CH₄ | N₂ |
|---|---|---|---|---|
| sample | [mmol g⁻¹] | [mmol g⁻¹] | [mmol g⁻¹] | [mmol g⁻¹] |
| C-PUA-4.5×@silica-HF—CO₂ | 9.15 ± 0.10 | 0.08 ± 0.01 | 2.57 ± 0.04 | 0.28 ± 0.05 |
| C-PUA-4.5×@silica-CO₂—HF | 6.13 ± 0.07 | 0.11 ± 0.07 | 1.14 ± 0.01 | 0.20 ± 0.01 |
| C-PAN-2×@silica(7:3)-HF—CO₂ | 6.82 ± 0.12 | 0.11 ± 0.03 | 1.34 ± 0.01 | 0.19 ± 0.03 |
| C-PAN-2×@silica(7:3)-CO₂—HF | 5.30 ± 0.12 | 0.09 ± 0.01 | 1.03 ± 0.05 | 0.16 ± 0.01 |

^{a}Average of at least three measurements.

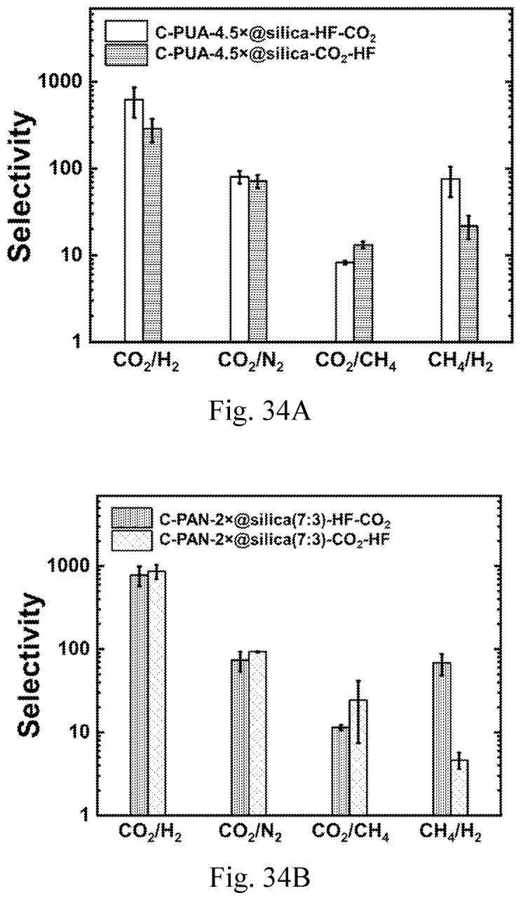

The isotherms were fitted with a Virial-type equation that allowed calculation of the Henry's constants, K_{H}, for each gas and material. Then, selectivities were calculated as the ratios of the K_{H} values (see Table 12), and are compared in bar-graph forms in FIG. 34.

TABLE 12
Henry's constants and relative selectivity data for CO₂, H₂, N₂ and CH₄ at 273 K/1 bar

| | Henry's constants [mmol g⁻¹ mbar⁻¹] ^{a,b} | | | | Relative selectivities ^{a,c} | | | |
|---|---|---|---|---|---|---|---|---|
| sample | K_{H}_{_{—}}_{CO}_{₂} | K_{H}_{_{—}}_{H}_{₂} | K_{H}_{_{—}}_{N}_{₂} | K_{H}_{_{—}}_{CH}_{₄} | CO₂/H₂ | CO₂/N₂ | CO₂/CH₄ | CH₄/H₂ |
| C-PUA-4.5 × @silica-HF-CO₂ | 42.2 ± 1.4 | 0.068 ± 0.026 | 0.53 ± 0.08 | 5.1 ± 0.17 | 624 ± 238 | 80 ± 13 | 8.2 ± 0.4 | 76 ± 29 |
| C-PUA-4.5 × @silica-CO₂-HF | 24.6 ± 1.7 | 0.085 ± 0.025 | 0.34 ± 0.05 | 1.9 ± 0.12 | 288 ± 86 | 72 ± 12 | 13 ± 1.2 | 22 ± 6.5 |
| C-PAN-2 × @silica(7:3)-HF-CO₂ | 30.3 ± 1.2 | 0.039 ± 0.011 | 0.41 ± 0.07 | 2.7 ± 0.18 | 780 ± 212 | 73 ± 19 | 11 ± 0.8 | 68 ± 19 |
| C-PAN-2 × @silica(7:3)-CO₂-HF | 22.3 ± 4.4 | 0.026 ± 0.005 | 0.24 ± 0.02 | 0.12 ± 0.02 | 863 ± 167 | 92 ± 1.7 | 25 ± 17 | 4.6 ± 1.1 |

^{a} Average of at least three measurements.
^{b} Henry's constants (K_{H}) were obtained by applying Virial-type fitting to the isotherms at 273 K (see Experimental Section in the main article).
^{c} Adsorption selectivities were calculated by taking the ratios of the corresponding K_{H} values. Errors in selectivities were calculated by applying propagation of error rules to the ratios of the K_{H} values.

The uptake of H₂ and N₂ was quite low as compared to CO₂ adsorption for carbon aerogels derived from PUA and PAN. The selectivity of C-PUA-4.5×@silica aerogels toward CO₂ versus H₂ was 624±238 and 288±86 for the HF—CO₂ and the CO₂—HF varieties of the material, respectively. The corresponding selectivity toward CO₂ versus N₂ was in the range of 70-80 for both varieties of the material. The significant difference in the CO₂/H₂ selectivities of C-PUA-4.5×@silica carbon aerogels from the two etching processes is attributed to the fact that the CO₂ adsorption of the HF—CO₂ variety was 50% higher than that of the CO₂—HF material (9 vs 6 mmol g⁻¹, respectively), while the H₂ adsorption was similar (0.06-0.08 mmol g⁻¹) for all the double-etched PUA-derived carbon aerogels. The selectivities of the C-PAN-2×@silica-(7:3) samples toward CO₂ versus H₂ were in the range of 780-863, while the CO₂/N₂ selectivities were in the range of 73-92 for materials from both etching processes. On the other hand, the adsorption of CH₄ was high compared to N₂ and H₂ (up to 2.6 mmol g⁻¹—see Table 11), which has been attributed to the high polarizability of CH₄. As a result, selectivities of CO₂ toward methane for both PUA- and PAN-derived carbon aerogels, by both etching processes, were low, typically less than 25.

Overall, all PUA- and PAN-derived carbon aerogels prepared by the method described in Examples 6 and 7 showed high selectivities towards H₂, which is favorable for pre-combustion CO₂ capture. Relevant to post-combustion applications (CO₂—N₂ separation), selectivities in the range of 71-97 were at par with those from amide networks, organic cages, certain conjugated organic polymers, and other microporous carbon derived from phenolic aerogels.

### Example 16

### Graphitic Carbon Aerogels

The materials used in Examples 17-27 were obtained from the sources described in this paragraph. All reagents and solvents were used as received, unless noted otherwise. Iron(III) chloride hexahydrate (FeCl₃·6H₂O, 97%, ACS reagent), cobalt(II) chloride hexahydrate (COCl₂·6H₂O, 98%, ACS reagent), ethyl chloroformate (EtOCOCl, 99%, ACS reagent), sodium hydroxide pellets (NaOH), anhydrous sodium sulfate (Na₂SO₄, ACS certified), concentrated nitric acid (HNO₃, 70% solution in water, ACS reagent), and concentrated hydrochloric acid (HCl, 12 M in water, ACS reagent) were purchased from Fisher Scientific International, Inc. (Hampton, NH). Anhydrous triethylamine (Et₃N, ≥99.5%), anhydrous inhibitor-free tetrahydrofuran (THF, ≥99.9%), (±)-epichlorohydrin (EPH, ≥99%, GC-grade), 4,4′-azobis(4-cyanopentanoic acid) (ABCVA), anhydrous tetrahydrofuran (THF), and acrylonitrile (≥99%, containing 35-45 ppm monomethyl ether hydroquinone (MEHQ) as inhibitor) were purchased from Sigma Aldrich Chemical Company (St. Louis, MO). Reference graphitic carbon (graphite, CAS No. 7782-42-5) and amorphous carbon (carbon black, CAS No. 7440-44-0) were purchased from Sigma Aldrich Chemical Company. Acrylonitrile was extracted three times with three portions of aqueous sodium hydroxide solution to remove the inhibitor, washed three times with distilled water, and dried using anhydrous sodium sulfate. This inhibitor-free acrylonitrile was stored at 0° C. and was used within a month. HPLC grade solvents including hexane, dimethylformamide (DMF), ethyl acetate (EtOAc), and toluene were purchased from Fisher Scientific International, Inc. Technical grade acetone was purchased from Univar (St. Louis, MO). Ultra-high purity argon (grade 5), 02, CO₂ and liquid N₂ were purchased from AirGas (Rolla, MO). For electrochemical experimentation, lithium ribbon (0.75 mm thickness, 99.9% trace metal basis), 1-methyl-2-pyrrolidinone (NMP, 99.5% anhydrous), and lithium hexafluorophosphate solution (1.0 M LiPF₆ in ethylene carbonate (EC) and dimethyl carbonate (DMC) 1:1 v/v, battery grade) were purchased from Sigma Aldrich Chemical Company. Poly(vinylidene fluoride) (PVDF, polymer binder for Li-ion battery electrodes) was purchased from Alfa Aesar (Stoughton, MA). Carbon-black (super P conductive, 99+%) and Celgard 2325 film were purchased from MTI Corporation (Richmond, CA).

### Example 17

### Preparation of Sol-Gel Suspensions

1. Preparation of Sol-Gel Iron Oxide (FeOx) Suspensions

As shown in Scheme 8A, in a round bottom flask, 17.8398 grams (0.0666 mol) of FeCl₃·H₂O was dissolved in 100 mL of DMF under vigorous magnetic stirring at 500-700 rpm. To that flask, 51.6 mL (0.66 mol) of EPH (10:1 mol/mol ratio of EPH to FeCl₃·6H₂O) was added while stirring, and the resulting brown solution was heated to reflux at 80° C. for ˜15-20 minutes using a condenser fitted with a tube (10-15 cm) filled with Drierite™. Notably, the reaction of FeCl₃.6H₂O with EPH, which acts as a proton acceptor (see Equations 8 and 9 below), leads to a Fe—O—Fe bridge formation, and eventually to FeOx. As a result, a FeOx suspension started forming in ˜15-20 minutes.

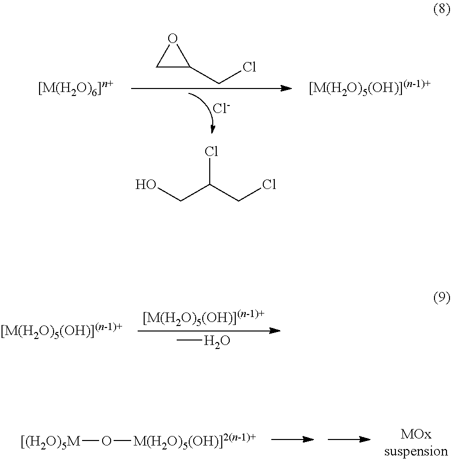

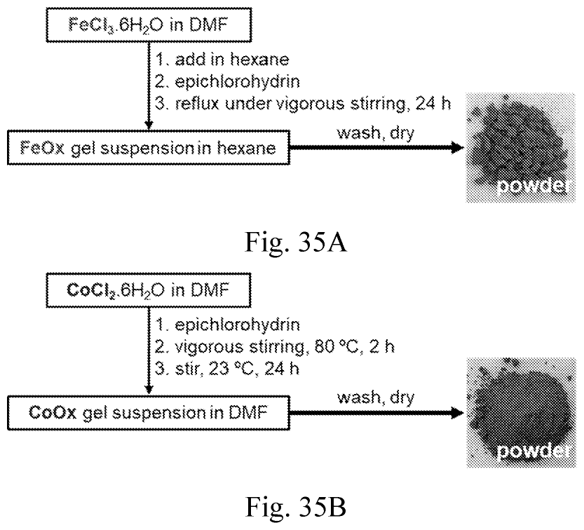

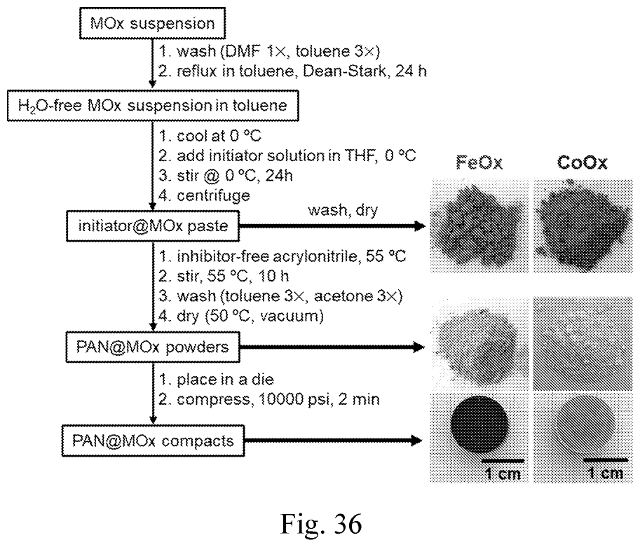

Then, 100 mL of hexane was added to the forming FeOx suspension, and the suspension was refluxed under vigorous stirring was continued for 24 hours at 80° C. After the 24-hour period, the suspension was allowed to cool to room temperature. By vigorously stirring the sol in a non-solvent (hexane), gelation was diverted from monoliths to wet-gel suspension. The resulting FeOx suspension was transferred to 50 mL centrifuge tubes (Fischer Scientific, Cat. no. 06-443-18), and the solvent of the suspension was exchanged one time with DMF and three times with toluene. All centrifugations were carried out for 15-20 minutes at 2450 rpm. For each solvent exchange/washing step, the volume of the new solvent added was twice the volume of the compacted paste at the bottom of the centrifuge tubes. Before each new centrifugation step, the compacted FeOx paste was resuspended by stirring with a glass rod. After the last exchange/wash, the FeOx paste was either processed to initiator@FeOx paste (discussed in Part 2 of Example 18 below) or was washed with acetone (rather than toluene) three times and dried under reduced pressure at 80° C. (forming a dry, freely flowing FeOx powder as shown in FIG. 35A) for characterization purposes.

2. Preparation of Sol-Gel Cobalt Oxide (CoOx) Suspensions

As shown in Scheme 8B, in a round bottom flask, 15.756 grams (0.0662 mol) of CoCl₂·6H₂O was dissolved in 100 mL of DMF under vigorous magnetic stirring at 500-700 rpm. To that flask, 55 mL (0.632 mol) of EPH (10:1 mol/mol ratio of EPH to CoCl₂·6H₂O) was added while stirring, and the resulting blue solution was heated at 80° C. for 2 hours using a condenser fitted with a tube (10-15 cm) filled with Drierite™. Notably, the reaction of CoCl₂·6H₂O with EPH, which acts as a proton acceptor (see Equations 8 and 9 above in Part 1), leads to a Co—O—Co bridge formation, and eventually to CoOx. As a result, a CoOx suspension started forming in ˜15-20 minutes. After the two-hour heating period, the mixture was allowed to cool to room temperature, then stirring was continued for 24 hours. Unlike FeCl₃·6H₂O, COCl₂·6H₂O does not generally gel into monoliths and rather forms suspensions of wet CoOx gel particles, so stirring with a non-solvent (hexane) was not needed. The resulting CoOx suspension was transferred to 50 mL centrifuge tubes (Fischer Scientific, Cat. no. 06-443-18), and the solvent of the suspension was exchanged one time with DMF and three times with toluene. All centrifugations were carried out for 15-20 minutes at 2450 rpm. For each solvent exchange/washing step, the volume of the new solvent was twice the volume of the compacted paste at the bottom of the centrifuge tubes. Before every new centrifugation step, the compacted CoOx paste was resuspended by stirring with a glass rod. After the last exchange/wash, the CoOx paste was either processed to initiator@CoOx paste (discussed in Part 2 of Example 18 below) or was washed with acetone (rather than toluene) three times and dried under reduced pressure at 80° C. (forming a dry, freely flowing CoOx powder as shown in FIG. 35B) for characterization purposes.

### Example 18

### Preparation of Polyacrylonitrile-Crosslinked (PAN) Metal Oxide (MOx) Xerogel Compacts

### 1. Preparation of Initiator-Modified MOx Paste (Initiator@MOx)

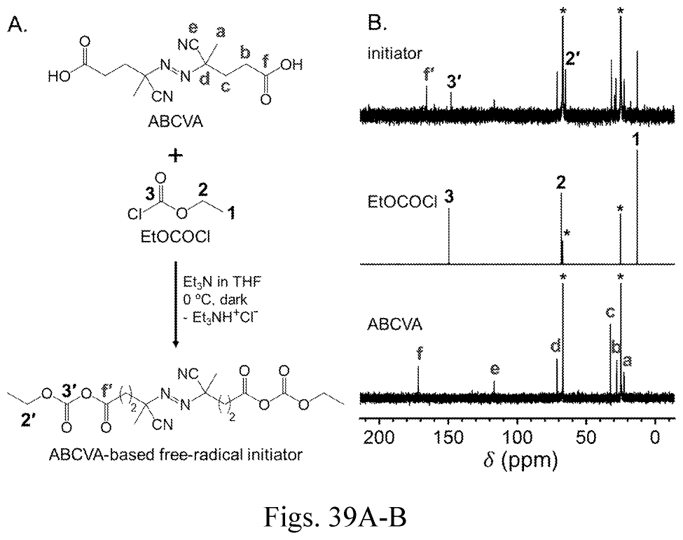

Using 100 mL of toluene, the FeOx and CoOx paste synthesized in Example 17 above (collectively referred to as MOx paste) was transferred to a round bottom flask. The suspension was refluxed at 160° C. for 24 hours using a Dean-Stark (situated between the round bottom flask and the condenser) to collect and remove residual water from the MOx suspensions. After the 24-hour period, the reaction mixture was allowed to cool to room temperature while being protected from light by aluminum foil wrapped around the flask. Once the mixture cooled to room temperature, the round bottom flask was placed in an ice-bath for 1 hour. Then, in an amber-glass Erlenmeyer flask equipped with a seal stopper, 60 mL of anhydrous, inhibitor-free THF was cooled to 0° C. using an ice-bath. As shown in FIG. 39, to the cold THF, 1.8499 grams (0.0066 mol) of ABCVA, 1.2747 mL (0.0133 mol) of ethyl chloroformate (EtOCOCl:ABCVA=2:1 mol/mol ratio), and 1.8582 mL (0.0133 mol) of anhydrous triethylamine (EtOCOCl:Et₃N=1:1 mol/mol) were dissolved sequentially, while the flask was kept at 0° C. using an ice-bath (initiator:MOx=1:10 mol/mol).

The progress of the reaction was followed visually via the formation of a precipitate (triethylammonium chloride salt (Et₃NH⁺Cl⁻)), which formed within 20-25 minutes. After this period, the initiator suspension in THF was transferred into centrifuge tubes wrapped with aluminum foil. The THF suspension was centrifuged for 2 minutes, and the supernatant liquid containing the activated ABCVA-based free-radical initiator in THF was added to the round bottom flask (wrapped with aluminum foil) containing the cold, water-free MOx suspension in toluene. Notably, if all residual water had not been removed from the MOx suspension before introducing the free radical initiator, hydrolysis of the terminal anhydride groups may have occurred, resulting in PAN formation in the interparticle space within the MOx particles.

The resulting MOx suspension was stirred (500-700 rpm) at 0° C. for 24 hours in the ice-bath. The initiator uptake by MOx was monitored periodically with ¹³C liquid NMR of the supernatant liquid, and the uptake was considered complete when the initiator resonances disappeared (after −24 hours). After the 24-hour period, the suspension was transferred into centrifuge tubes wrapped with aluminum foil and was centrifuged for 5 minutes. The supernatant solvent of the suspension was discarded, forming an initiator@FeOx or initiator@CoOx paste (collectively referred to as initiator@MOx paste in Scheme 9).

### 2. Preparation of Crosslinked PAN@MOx Powders

The initiator@MOx paste synthesized in Part 1 above was added to a round bottom flask containing 45 mL of inhibitor-free acrylonitrile (MOx:acrylonitrile=1:10 mol/mol; initiator:MOx:acrylonitrile=1:10:100 mol/mol/mol). The resulting suspension was magnetically stirred at 400 rpm and heated to 55° C. for 10 hours to induce surface-initiated polymerization.

After the 10-hour period, the continuous phase (inhibitor-free acrylonitrile) remained liquid, and the off-white PAN@MOx suspension was allowed to cool to room temperature and transferred to 50 mL centrifuge tubes (Fischer Scientific, Cat. no. 06-443-18). Then, the suspension was washed three times with toluene and three times with acetone. All washes were carried out with centrifugation for 15-20 minutes at 2450 rpm. For each wash, the volume of the new solvent was twice the volume of the compacted paste at the bottom of the centrifuge tubes. Before every new centrifugation step, the compacted PAN@MOx paste was resuspended with vigorous agitation using a Vortex-Genie (Model no. K-550-G, Scientific Industries) and a glass rod. After the last acetone wash, the paste was dried under reduced pressure at 65° C. Once dried, the powder was kept in vacuum oven at 80° C. for 24 hours, forming a dry, freely flowing PAN@FeOx or PAN@CoOx powder (collectively referred to as PAN@MOx powder in Scheme 9).

The dry PAN@MOx powder was compressed into cylindrical monolithic objects using a stainless-steel die and a hydraulic press operated at 10,000 μsi for 2 minutes. Placement of the powder in a die was carried out in small portions under continuous tapping.

### Example 19

### Processing of PAN@MOx Compacts to Graphitic Carbon Aerogels (G-PAN_{Temp}_from_M)

### 1. Methods

Pyrolytic aromatization and graphitization of PAN@FeOx and PAN@CoOx (PAN@MOx) compacts to A-PAN@FeOx and A-PAN@CoOx (A-PAN@MOx) compacts and further to G-PAN_{Temp}@Fe and G-PAN_{Temp}@CO (G-PAN_{Temp}@M) graphitic carbon aerogels was carried out in a programmable MTI GSL1600X-80 tube furnace (outer and inner tubes both of 99.8% pure alumina; outer tube: 1022 mm×82 mm×70 mm; inner tube: 610 mm×61.45 mm×53.55 mm; length of the heating zone at the temperature: 457 mm). The rate of heating and cooling was always maintained at 2.5° C. min-. All gas flow rates were set at 325 mL min-.

### 2. Processing of PAN@MOx Compacts to A-PAN@MOx Compacts and of A-PAN@MOx Compacts to G-PAN_{Temp}@M Compacts

The compressed PAN@MOx compacts prepared in Part 2 of Example 18 were aromatized pyrolytically at 300° C. for 24 hours under flowing O₂ in the programmable tube furnace, forming A-PAN@FeOx or A-PAN@CoOx compacts (collectively referred to as A-PAN@MOx compacts in Scheme 10).

Then, the aromatized A-PAN@MOx compacts were graphitized pyrolytically at either 800° C., 1000° C., 1100° C., 1200° C., 1400° C., or 1500° C. for 5 hours under flowing ultrahigh purity Ar, forming G-PAN_{Temp}@Fe or G-PAN_{Temp}@CO compacts (collectively referred to as G-PAN_{Temp}@M in Scheme 10). Depending on the pyrolysis temperature, the G-PAN_{Temp}@M compacts are specifically referred to as G-PAN₈₀₀@M, G-PAN₁₀₀₀@M, G-PAN₁₁₀₀@M, G-PAN₁₂₀₀@M, G-PAN₁₄₀₀@M, and G-PAN₁₅₀₀@M.

3. Processing of G-PAN_{Temp}@M Compacts to G-PAN_{Temp}_from_M Aerogels

The G-PAN_{Temp}@M compacts prepared in Part 2 above were subjected to an etching process using aqua-regia. Specifically, the G-PAN_{Temp}@M compacts were treated with aqua-regia acid (conc. HCl: conc. HNO₃=3:1 v/v) in 20 mL high-density polyethylene (HDPE) vials (Cat. no. 03-337-23, Fisher Scientific) capped with rubber septa (Cat. no. CG-3024-03, ChemGlass Life Sciences) under reduced pressure using a water aspirator. The compacts were treated until no bubbles were observed coming out from the graphitized compacts. Subsequently, these treated compacts were washed three times with distilled water and three times with acetone in the HDPE vials, under reduced pressure, for 15 minutes each time. Finally, the washed compacts were dried in a vacuum oven at 80° C. for 24 hours, forming pure G-PAN_{Temp}_from_Fe or pure G-PAN_{Temp}_from_Co graphitic carbon aerogels (collectively referred to as G-PAN_{Temp}_from_M in Scheme 10).

### Example 20

### Preparation of Coin-Cell Batteries Containing G-PAN₁₅₀₀_from_Fe

CR2032 type coin-cell batteries were assembled in an argon-filled glove box (O₂<0.1 ppm and H₂O<0.1 ppm). The working electrode composition was set equal to 75:15:10% w/w of G-PAN₁₅₀₀_from_Fe, carbon-black, and PVDF. The three components were mixed with NMP to make a slurry. The amount of PVDF was fixed at 0.0444 grams mL⁻¹ relative to NMP. The slurry was ball-milled for 10 minutes, coated on the copper foil uniformly using a glass-rod, and the casted film was dried in vacuum at 80° C. for 12 hours. Disks (9.5 mm in diameter) were punched off the dry, coated electrodes using a hole puncher. The active-mass loading of C-PAN₁₅₀₀_from_Fe on the copper foil disk was ˜1-2 milligrams. The Li-ion half-cell was assembled with a Li metal foil (0.75-mm thickness, cut into 12 mm in diameter circular disks) as a reference/counter electrode, 1M LiPF₆ in EC/DMC as the electrolyte, and a Celgards 2325 circular sheet (19 mm in diameter) as a separator. All cells were sealed using a coin cell crimper. The newly prepared cells were aged for equilibration for about 12 hours before electrochemical testing.

### Example 21

### Thermal Characterization of Initiator@MOx and PAN@MOx Systems

### 1. Methods

Thermogravimetric Analysis (TGA) was conducted under O₂ up to 800° C. with a TA Instruments Model Q50 instrument using a heating rate of 10° C. min⁻¹. Modulated Differential Scanning Calorimetry (MDSC) was conducted under O₂ and N₂ from −30° C. to 350° C. using a heating rate of 5° C. min⁻¹ (modulation amplitude/frequency at ±1° C. min⁻¹) with a TA Instruments Differential Scanning Calorimeter Model Q2000.

### 2. TGA and MDSC Analysis of Initiator@MOx and PAN@MOx Systems

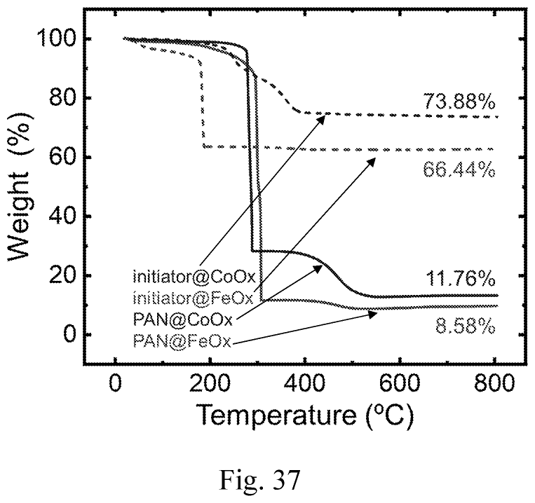

Using TGA up to 800° C. under 02, initiator@FeOx and initiator@CoOx powder (prepared according to the methods described in Part 1 of Example 18) exhibited mass losses of 33.56% and 26.12%, respectively, as shown in FIG. 37. Similarly, PAN@FeOx and PAN@CoOx xerogel powder (prepared according to the methods described in Part 2 of Example 18) lost 92.42% and 88.24% of their masses, respectively. The residues were analyzed with powder X-ray diffraction (XRD) and consisted of Fe₂O₃ and CO₃O₄, respectively. Based on these mass losses and the fact that the initiator (bound on the surface of MOx) stays together with the polymer in the PAN@MOx compacts, it was calculated that PAN@FeOx and PAN@CoOx contained PAN at 87.09% w/w and 84.08% w/w, respectively. The PAN:FeOx:initiator mass ratio was 87.09:8.58:4.33, and the PAN:CoOx:initiator mass ratio was 84.08:11.76:4.16.

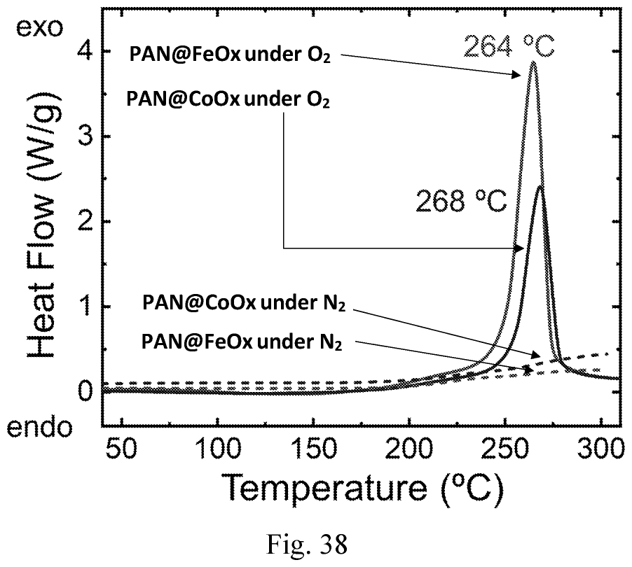

In addition to TGA, PAN@silica compacts (prepared according to the methods described in Example 5) were also analyzed using MDSC. Notably, as shown in FIG. 38, MDSC showed a sharp exotherm at 264° C. and 268° C. for PAN@FeOx and PAN@CoOx powders, respectively, heated under 02.

### Example 22

### Chemical Characterization of ABCVA-Based Free-Radical Initiator, PAN@MOx System, and A-PAN@MOx System

### 1. Methods

Liquid ¹³C NMR spectra in THF-d₈ were recorded with a 400 MHz Varian Unity Inova NMR instrument (100 MHz carbon frequency).

The cross-linked polymer was identified as polyacrylonitrile with solid-state CPMAS ¹³C NMR on a Bruker Avance III 400 MHz spectrometer with a carbon frequency 100 MHz using 7 mm Bruker MAS probe at a magic angle spinning rate of 5 kHz with broadband proton suppression and CP total suppression of spinning side bands (TOSS) pulse sequence. The TOSS pulse sequence was applied by using a series of four properly timed 1800 pulses on the carbon channel at different points of a cycle before the acquisition of the free induction decay (FID), after an initial excitation with a 90° pulse on the proton channel. The 90° excitation pulse on the proton and the 180° excitation pulse on the carbon were set to 4.2 and 10 s, respectively. The cross-polarization contact time and the relaxation delay were set at 3000 μs and 5 s, respectively. The number of scans was set at 2048. Spectra were referenced externally to glycine (carbonyl carbon at 176.0300 ppm). Chemical shifts are reported versus tetramethylsilane (TMS, 0 ppm). For this, the sample preparation was carried out as follows. Dry PAN@MOx powder was treated for 30 minutes with concentrated HCl (12 M). At the end of the period, the suspension was washed several times with distilled water and several times with acetone. The final paste was dried in vacuum oven at 80° C. for 24 hours. Before treatment with concentrated HCl, the PAN@MOx powders were attracted by magnets. However, after removal of the MOx component with concentrated HCl, the powders were not. The NMR spectrum of the residue powder was compared with the NMR spectrum of PAN@silica.

### 2. Chemical Characterization of the ABCVA-Based Free-Radical Initiator

As shown in FIG. 39, the identity of the bidentate, ABCVA-based free-radical initiator (prepared according to the method described in Part 1 of Example 18) was confirmed with liquid ¹³C NMR spectrum (at the top) in THF-d₈, which supports quantitative reaction from both of the initiator's ends. Upon reaction with ethyl chloroformate (EtOCOCl), the carbonyl (C═O) resonance of ABCVA moved up field from 171 ppm (f) to 165 ppm (f). The carbonyl resonance of EtOCOCl also moved up field from 149.5 ppm (3) to 147.9 (3′). Finally, the methylene carbon of EtOCOCl, CH₃CH₂—, also moved up field from 68.1 ppm (2) to 65.0 (2′).

### 3. Chemical Characterization of PAN@MOx and A-PAN@MOx Systems

As mentioned in Part 2 of Example 18, the acrylonitrile suspensions of initiator@MOx remained liquid during the course of the free-radical polymerization process, pointing to the fact that no free radicals were formed in solution, thereby both radical fragments formed across —N═N— of the initiator remained surface-bound, as designed. The resulting PAN@MOx powders had uptaken large amounts of polymer. The identity of the polymer uptaken by the initiator@MOx suspensions was investigated with solid-state CPMAS ¹³C NMR. Due to the paramagnetic properties of the metal-oxide frameworks of this study (FeOx and CoOx) and the intimate proximity of PAN and MOx at the nanoscopic level (the process was designed so that PAN would coat conformally the MOx nanoparticles), PAN@MOx and A-PAN@MOx gave only very broad resonances in ¹³C NMR.

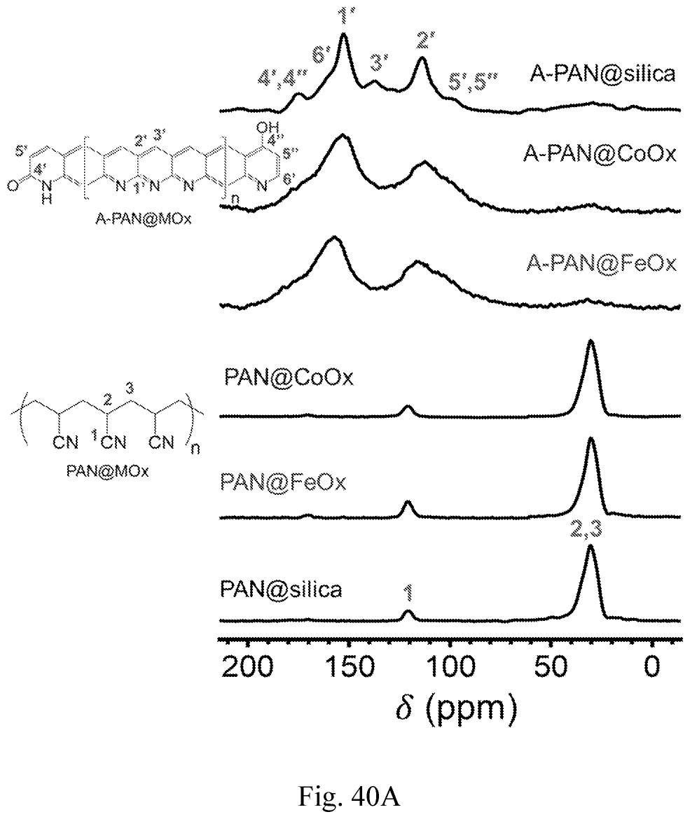

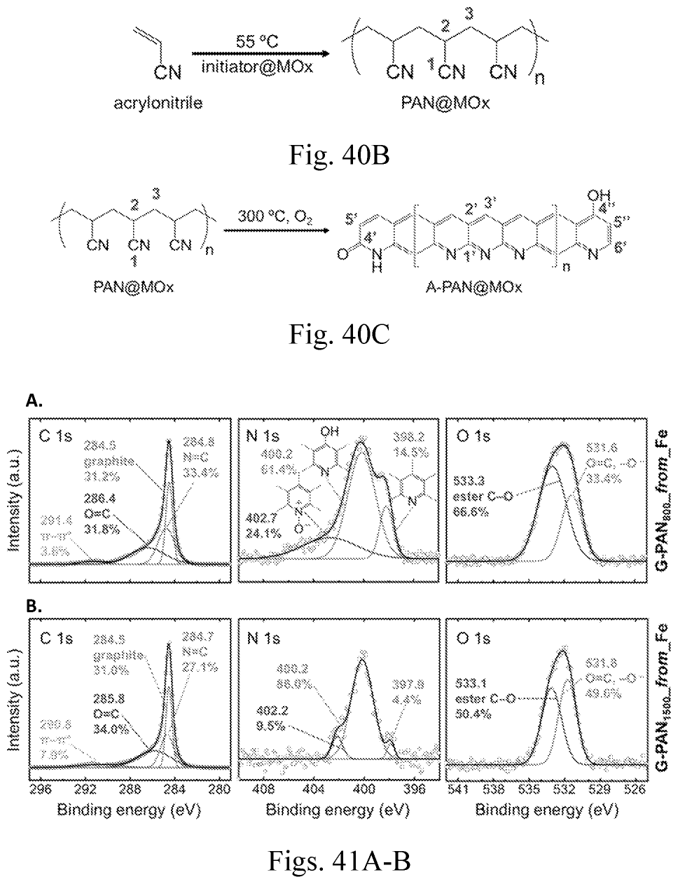

However, treatment with dilute HCl removed the oxides, and the solid-state ¹³C NMR spectra of the residues from PAN@FeOx and PAN@CoOx (prepared according to the method described in Part 2 of Example 18 and prepared as sample according to the method described in Part 1 of this Example) were identical to the spectrum of PAN@silica (see FIG. 40). The energy dispersive x-ray spectroscopy (EDS) data of PAN@FeOx and PAN@CoOx after metal removal is shown in Table 13 below.

TABLE 13A
EDS Data of PAN@FeOx After Fe Removal with Dilute HCl

| Element | Wt % | At % |
|---|---|---|
| C | 61.40 | 93.17 |
| N | 4.74 | 1.96 |
| O | 1.22 | 1.38 |
| Au | 18.78 | 1.11 |
| Pd | 13.86 | 2.37 |
| Total | 100.00 | 100.00 |

TABLE 13B
EDS Data of PAN@CoOx After Co Removal with Dilute HCl

| Element | Wt % | At % |
|---|---|---|
| C | 56.09 | 90.58 |
| N | 5.01 | 2.39 |
| O | 2.19 | 2.65 |
| Au | 20.47 | 1.41 |
| Pd | 16.24 | 2.96 |
| Total | 100.00 | 100.00 |

Similar treatment of A-PAN@FeOx and A-PAN@CoOx (prepared according to the method described in Part 2 of Example 19 and prepared as sample according to the method described in Part 1 of this Example) rendered solid-state ¹³C NMR of those materials possible (included in FIG. 40). The spectra showed that the treatment at 300° C./O₂ oxidized aliphatic carbons completely, moving them in the aromatic region. As in the case of PAN@silica (shown in FIG. 40 for comparison), the presence of additional oxidation products was noted: pyridonic carbonyls (at around 170 ppm: 4′,4″, & 6′) and sp² carbons on the terminal rings (at around 100 ppm: 5′ & 5″). By the same token, however, it is also pointed out that generally the ¹³C resonances in both A-PAN@FeOx and A-PAN@CoOx were broader than the resonances were in the case of A-PAN@silica (shown in FIG. 40 for comparison), and therefore, the signature-peaks of the oxidized end-groups in A-PAN@FeOx and A-PAN@CoOx were less pronounced.

### Example 23

### Chemical Characterization of G-PAN_{Temp}@M and G-PAN_{Temp}_from_M Systems

### 1. Methods

CHN elemental analysis was conducted with an Exeter Analytical Model CE440 elemental analyzer and calibrated with acetanilide and glycine. The combustion furnace was operated at 925° C. The calibration standards and samples were run three times, and results were provided as averages.

X-ray photoelectron spectroscopic analysis (XPS) was carried out with a ThermoFischer Scientific Nexsa X-ray Photoelectron Spectrometer System. Samples were mixed and ground together with Au powder (5% w/w) as an internal reference. Deconvolution of the spectra was performed with Gaussian function fitting using the OriginPro 9.7 software package.

Powder X-ray diffraction (XRD) analysis was performed with dried powders using a PANalytical X'Pert Pro multipurpose diffractometer (MPD) with Cu Kα radiation (λ=1.54 Å) and a proportional counter detector equipped with a flat graphite monochromator. Crystallite domain sizes (L_{c}) were calculated using the Scherrer equation (Equation 11) from the full-width-at-half-maxima of (002) reflection plane. A Gaussian correction was applied utilizing NIST SRM 660a LaB₆ to determine the instrumental broadening.

Transmission Electron Microscopy (TEM) was conducted with a FEI Tecnai F20 instrument employing a Schottky field emission filament operating at a 200 kV accelerating voltage. Graphitic carbon aerogels were finely ground by hand in a mortar with a pestle and placed in 5 mL glass vials. To these vials, isopropanol was added, and then the vials were ultrasonicated in an ultrasonic bath for 20 minutes to disperse the small particles in the solvent. After removing from the ultrasonic bath and just before particle settling was complete, a single drop of the mixture was taken and placed on a 200-mesh copper grid bearing a lacey Formvar/carbon film. Each grid was allowed to air-dry before being used for microscopy. At least six different areas/particles were examined on each sample to ensure that the results were uniform over the whole sample. Images were processed with Image J, a freely available software that allows the distance between the graphitic carbon layers to be measured.

Raman spectroscopy of graphitic carbons was conducted with a Horiba Jobin-Yvon LabRAM ARAMIS micro-Raman spectrometer with a 17 mW He—Ne laser at 632.8 nm as the excitation source. A silicon wafer was used as calibration standard. A total of 20 scans, lasting 10 seconds each, with a 1200 grating at 10× magnification was acquired for all samples.

2. Chemical Characterization of G-PAN_{Temp}@M and G-PAN_{Temp}_from_M Systems by CHN and XPS Analysis

CHN elemental analysis of G-PAN₁₅₀₀_from_Fe and G-PAN₁₅₀₀_from_Co (prepared according to the method described in Part 3 of Example 19) showed that G-PAN₁₅₀₀_from_Fe contained more than 98% w/w of carbon and that G-PAN₁₅₀₀_from_Co contained more than 97% w/w (see Table 14).

TABLE 14
CHN elemental analysis data for G-PAN₁₅₀₀_{_{—}}from_Fe and
G-PAN₁₅₀₀_{_{—}}from_Co

| sample | C [% w/w] | H [% w/w] | N [% w/w] | O [% w/w]^{a} |
|---|---|---|---|---|
| G-PAN₁₅₀₀_{_{—}}from_Fe | 98.64 | 0.69 | 0.30 | 0.37 |
| G-PAN₁₅₀₀_{_{—}}from_Co | 97.04 | 0.66 | 0.59 | 1.71 |

^{a}The amount of oxygen was calculated as the difference from 100%.

Next, XPS confirmed that, after aqua-regia treatment, these samples contained no metals or metallic compounds. By the same token, however, XPS painted a different elemental picture for the surface of G-PAN₁₅₀₀_from_Fe and G-PAN₁₅₀₀_from_Co. Notably, the percent weight of carbon dropped to about 95% w/w in G-PAN₁₅₀₀_from_Fe and to about 88% w/w in G-PAN₁₅₀₀_from_Co. In that regard, XPS also showed that, in addition to C, the surfaces of all pyrolytic samples included N and O.

Tables 15 and 16 present the evolution of the surface elemental composition by providing data from XPS surveys for samples pyrolyzed at a low (800° C.), a medium (1100° C.), and a high temperature (1500° C.), before and after treatment with aqua regia (prepared according to the method described in Part 3 of Example 19 and prepared as sample according to the method described in Part 1 of this Example).

TABLE 15
Atomic composition of G-PAN_{Temp}@Fe
and G-PAN_{Temp}_{_{—}}from_Fe

| | atomic % from XPS data | | | | |
|---|---|---|---|---|---|
| sample | C | O | N | Fe | Au |

before aqua-regia treatment

| | | | | | |
|---|---|---|---|---|---|
| G-PAN₈₀₀@Fe | 85.64 | 5.67 | 7.10 | 0.72 | 0.87 |
| G-PAN₁₁₀₀@Fe | 95.59 | 2.11 | 1.67 | 0.48 | 0.15 |
| G-PAN₁₅₀₀@Fe | 91.25 | 4.48 | 2.15 | 1.46 | 0.66 |

after aqua-regia treatment

| | | | | | |
|---|---|---|---|---|---|
| G-PAN₈₀₀_{_{—}}from_Fe | 90.10 | 4.83 | 4.21 | — | 0.86 |
| G-PAN₁₁₀₀_{_{—}}from_Fe | 94.69 | 2.80 | 1.61 | — | 0.90 |
| G-PAN₁₅₀₀_{_{—}}from_Fe | 94.98 | 2.55 | 1.57 | — | 0.90 |

TABLE 16
Atomic composition of G-PAN_{Temp}@Co
and G-PAN_{Temp}_{_{—}}from_Co

| | atomic % from XPS data | | | | |
|---|---|---|---|---|---|
| sample | C | O | N | Co | Au |

before aqua-regia treatment

| | | | | | |
|---|---|---|---|---|---|
| G-PAN₈₀₀@Co | 89.03 | 4.12 | 5.74 | 0.96 | 0.15 |
| G-PAN₁₁₀₀@Co | 92.69 | 3.88 | 1.98 | 0.59 | 0.86 |
| G-PAN₁₅₀₀@Co | 93.68 | 3.12 | 1.53 | 0.34 | 1.33 |

after aqua-regia treatment

| | | | | | |
|---|---|---|---|---|---|
| G-PAN₈₀₀_{_{—}}from_Co | 92.56 | 2.97 | 3.49 | — | 0.98 |
| G-PAN₁₁₀₀_{_{—}}from_Co | 91.31 | 3.87 | 3.54 | — | 1.28 |
| G-PAN₁₅₀₀_{_{—}}from_Co | 88.82 | 5.97 | 2.57 | — | 2.64 |

As shown, the amount of carbon generally increased with increasing pyrolysis temperature. The variation was occasionally non-monotonic, but the amount of carbon was always less than the amount found by CHN elemental analysis (Table 14). By the same token, the amounts of both O and N decreased with increasing pyrolysis temperature, but the reduction in N was more drastic.

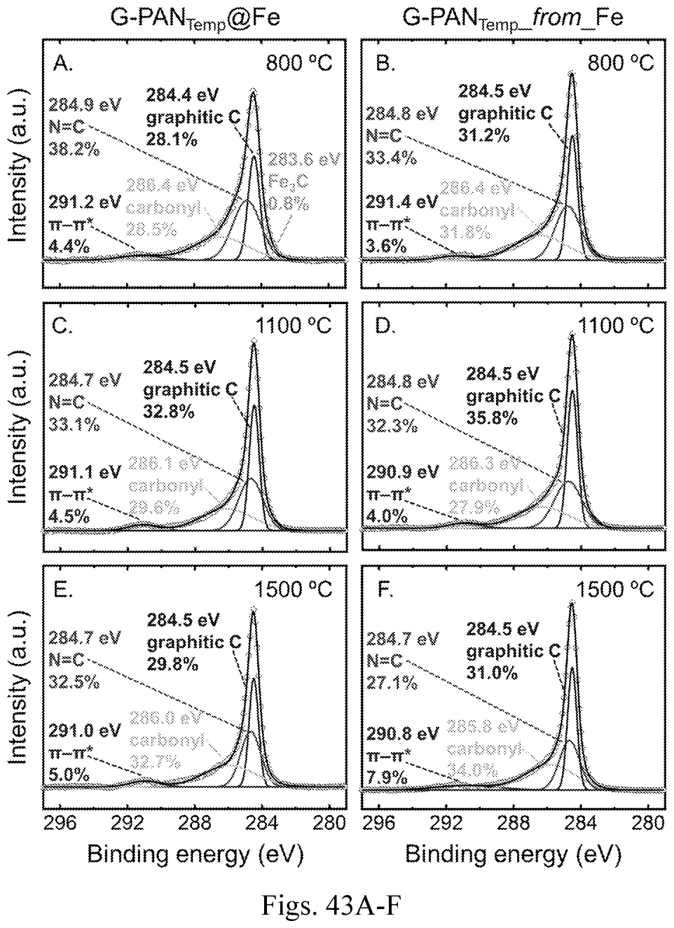

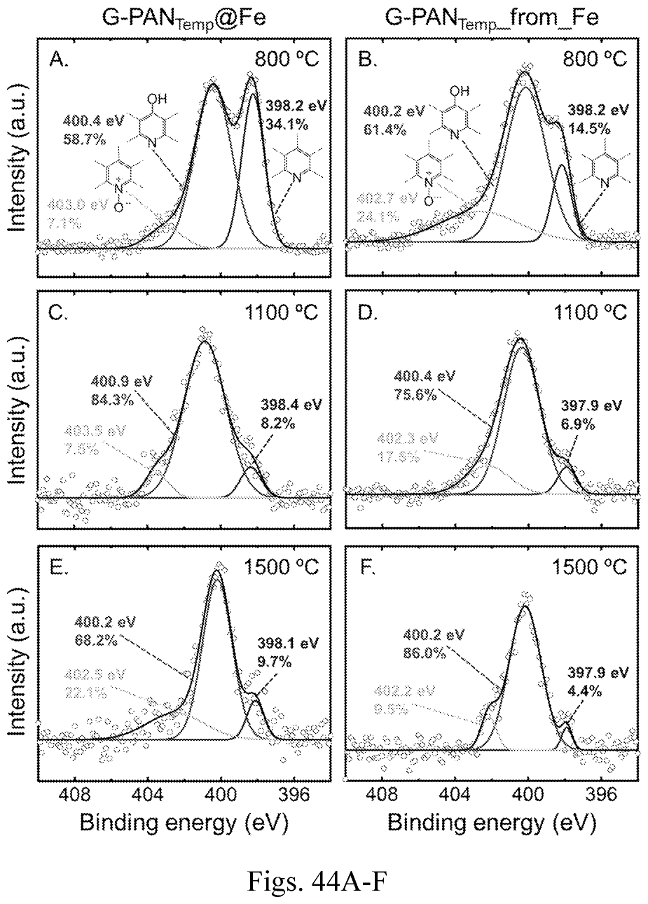

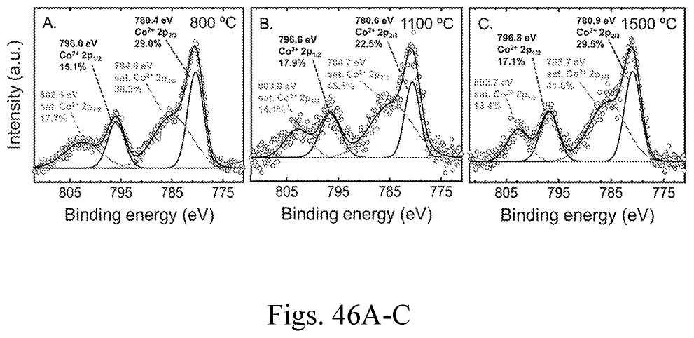

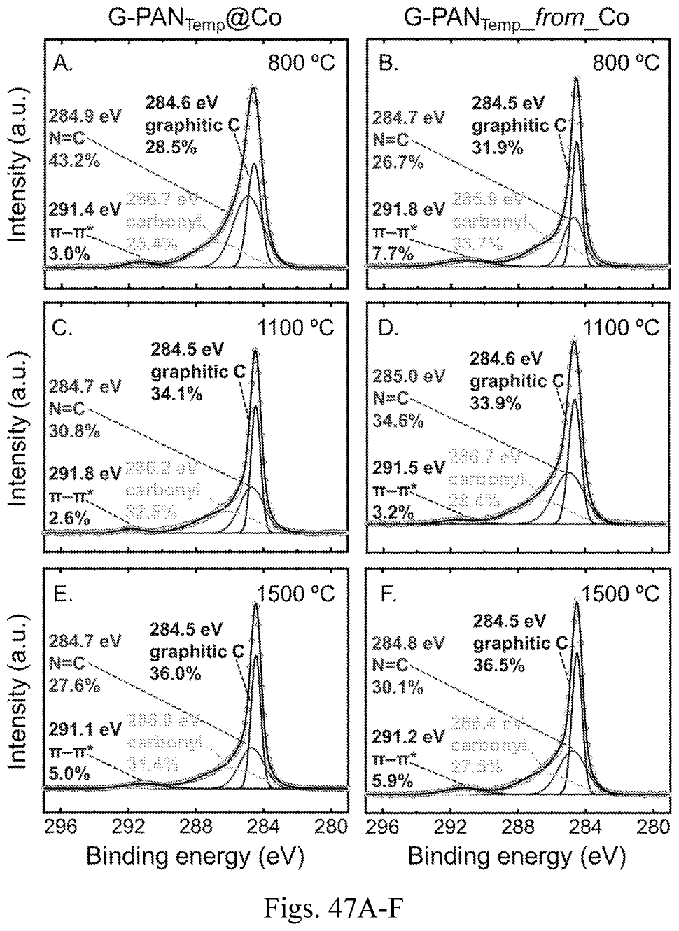

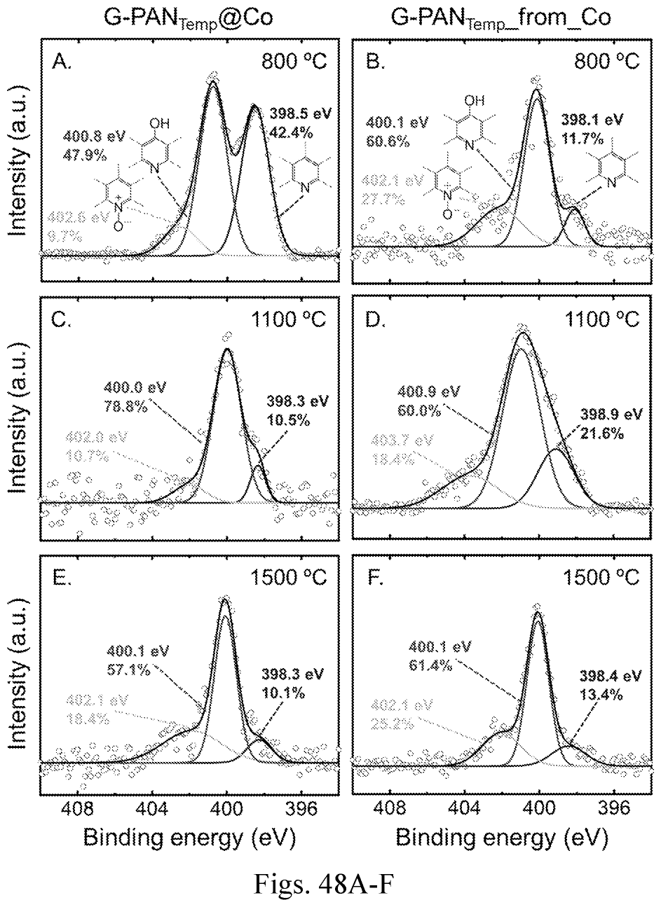

FIGS. 41-49 include a comparison of high-resolution XPS spectra of all samples obtained at all three temperatures above before and after aqua-regia treatment. A highlight of that data is presented in FIG. 41, which shows the high-resolution C 1s, N 1s, and O 1s spectra of aqua-regia treated G-PAN_{Temp}_from_Fe obtained by pyrolysis at 800° C. and 1500° C. (i.e., the two extreme temperatures of this study). The broad peak at −286 eV in the C 1s spectra is assigned to both a straight carbonyl and C in keto/enol equilibrium and is consistent with the pyridonic groups in the N 1s spectra. Similarly, the peak at ˜531.7 eV in the O is spectra is attributed to both a carbonyl and —O⁻, and the latter is consistent with the nitroxide group in the N 1s spectra.

High-resolution XPS spectra elucidate the allocation of surface atoms into various types of bonding situations and functional groups, and this information is provided in Tables 17 and 18.

TABLE 17
Deconvoluted binding energies and atomic compositions of G-PAN_{Temp}@Fe and G-PAN_{Temp}_{_{—}}from_{_{—}}Fe

| | binding energy | atomic % of at G-PAN_{Temp}@Fe | | | atomic % of at G-PAN_{Temp}_{_{—}}from_{_{—}}Fe | | |
|---|---|---|---|---|---|---|---|
| species | [eV] | 800° C. | 1100° C. | 1500° C. | 800° C. | 1100° C. | 1500° C. |

C 1s

| | | | | | | | |
|---|---|---|---|---|---|---|---|
| Carbide (Fe—C) | 283.6 ± 0.1 | 0.8 | — | — | — | — | — |
| Graphitic C—C/C═C | 284.5 ± 0.1 | 28.1 | 32.8 | 29.8 | 31.2 | 35.8 | 31.0 |
| C═N | 284.8 ± 0.1 | 38.2 | 33.1 | 32.5 | 33.4 | 32.3 | 27.1 |
| C═O & C═O in keto/enol | 286.3 ± 0.1 | 28.5 | 29.6 | 32.7 | 31.8 | 27.9 | 34.0 |
| Plasmon loss (π − π*) | 291.2 ± 0.1 | 4.4 | 4.5 | 5.0 | 3.6 | 4.0 | 7.9 |

N 1s

| | | | | | | | |
|---|---|---|---|---|---|---|---|
| Pyridinic N | 398.3 ± 0.1 | 34.1 | 8.2 | 9.7 | 14.5 | 6.9 | 4.4 |
| Pyridonic N | 400.3 ± 0.1 | 58.7 | 84.3 | 68.2 | 61.4 | 75.6 | 86.0 |
| Pyridine Oxide | 402.5 ± 0.2 | 7.1 | 7.5 | 22.1 | 24.1 | 17.5 | 9.5 |

O 1s

| | | | | | | | |
|---|---|---|---|---|---|---|---|
| Metal oxide (Fe—O) | 530.1 ± 0.2 | 0.8 | 4.2 | 18.6 | — | — | — |
| C═O & Phenoxide (—O⁻) | 531.6 ± 0.2 | 79.8 | 36.4 | 14.8 | 33.4 | 70.6 | 49.6 |
| Ester C—O | 533.0 ± 0.2 | 19.4 | 59.5 | 66.6 | 66.6 | 29.4 | 50.4 |

Fe 2p

| | | | | | | | |
|---|---|---|---|---|---|---|---|
| Fe³⁺ 2p_{2/3} | 710.9 ± 0.2 | 33.0 | 24.4 | 29.5 | — | — | — |
| satellite of Fe³⁺ 2p_{2/3} | 715.4 ± 0.5 | 29.3 | 41.5 | 29.9 | — | — | — |
| Fe³⁺ 2p_{1/2} | 724.7 ± 0.5 | 31.5 | 30.4 | 31.7 | — | — | — |
| satellite of Fe³⁺ 2p_{1/2} | 732.0 ± 1.0 | 6.1 | 3.7 | 8.9 | — | — | — |

TABLE 18
Deconvoluted binding energies and atomic compositions of G-PAN_{Temp}@Co and G-PAN_{Temp}_{_{—}}from_{_{—}}Co

| | binding energy | atomic % of at G-PAN_{Temp}@Co | | | atomic % of at G-PAN_{Temp}_{_{—}}from_{_{—}}Co | | |
|---|---|---|---|---|---|---|---|
| species | [eV] | 800° C. | 1100° C. | 1500° C. | 800° C. | 1100° C. | 1500° C. |

C 1s

| | | | | | | | |
|---|---|---|---|---|---|---|---|
| Graphitic C—C/C═C | 284.5 ± 0.1 | 28.5 | 34.1 | 36.0 | 31.9 | 33.9 | 36.5 |
| C═N | 284.8 ± 0.1 | 43.2 | 30.8 | 27.6 | 26.7 | 34.6 | 30.1 |
| C═O & C═O in keto/enol | 286.3 ± 0.1 | 25.4 | 32.5 | 31.4 | 33.7 | 28.4 | 27.5 |
| Plasmon loss (π − π*) | 291.2 ± 0.1 | 3.0 | 2.6 | 5.0 | 7.7 | 3.2 | 5.9 |

N 1s

| | | | | | | | |
|---|---|---|---|---|---|---|---|
| Pyridinic N | 398.3 ± 0.1 | 42.4 | 10.5 | 10.1 | 11.7 | 21.6 | 13.4 |
| Pyridonic N | 400.3 ± 0.1 | 47.9 | 78.8 | 57.1 | 60.6 | 60.0 | 61.4 |
| Pyridine Oxide | 402.5 ± 0.2 | 9.7 | 10.7 | 18.4 | 27.7 | 18.4 | 25.2 |

O 1s

| | | | | | | | |
|---|---|---|---|---|---|---|---|
| Metal oxide (Co—O) | 530.1 ± 0.2 | 13.6 | 17.0 | 5.9 | — | — | — |
| C═O & Phenoxide (—O⁻) | 531.6 ± 0.2 | 50.4 | 42.8 | 24.7 | 42.0 | 31.1 | 12.2 |
| Ester C—O | 533.0 ± 0.2 | 36.0 | 40.2 | 69.4 | 58.0 | 68.9 | 87.8 |

Co 2p

| | | | | | | | |
|---|---|---|---|---|---|---|---|
| Co³⁺ 2p_{2/3} | 780.7 ± 0.2 | 29.0 | 22.5 | 29.5 | — | — | — |
| satellite of Co³⁺ 2p_{2/3} | 785.1 ± 0.5 | 38.2 | 45.5 | 41.6 | — | — | — |
| Co³⁺ 2p_{1/2} | 796.5 ± 0.4 | 15.1 | 17.9 | 17.1 | — | — | — |
| satellite of Co³⁺ 2p_{1/2} | 802.7 ± 0.3 | 17.7 | 14.1 | 13.4 | — | — | — |

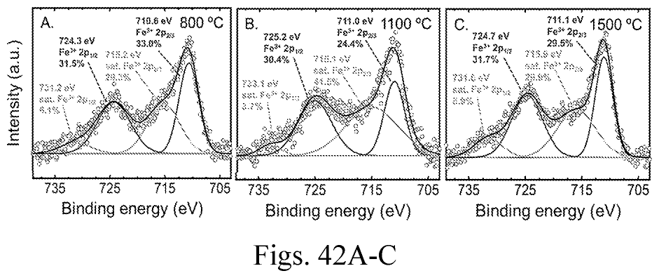

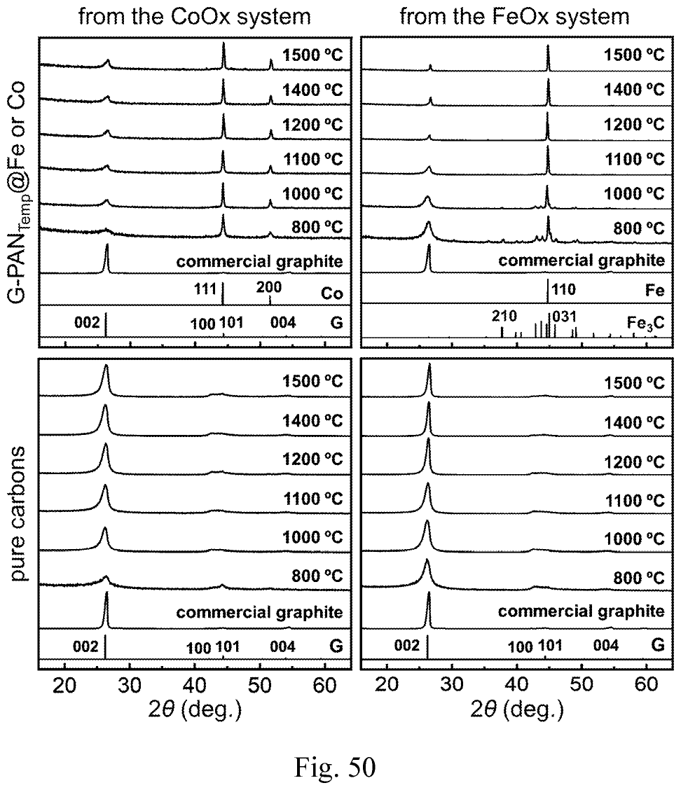

Thus, as shown in FIG. 42 (XPS spectra of Fe 2p) and 43 (XPS spectra of carbons), before treatment with aqua regia, G-PAN₈₀₀@Fe showed a strong Fe 2p signal and carbon bonded to Fe, which is in agreement with XRD that shows formation of Fe₃C at temperatures ≤1100° C. (FIG. 50). The absence of carbon bonded to metal in FIG. 41 suggests that the carbide was removed by aqua regia quantitatively.

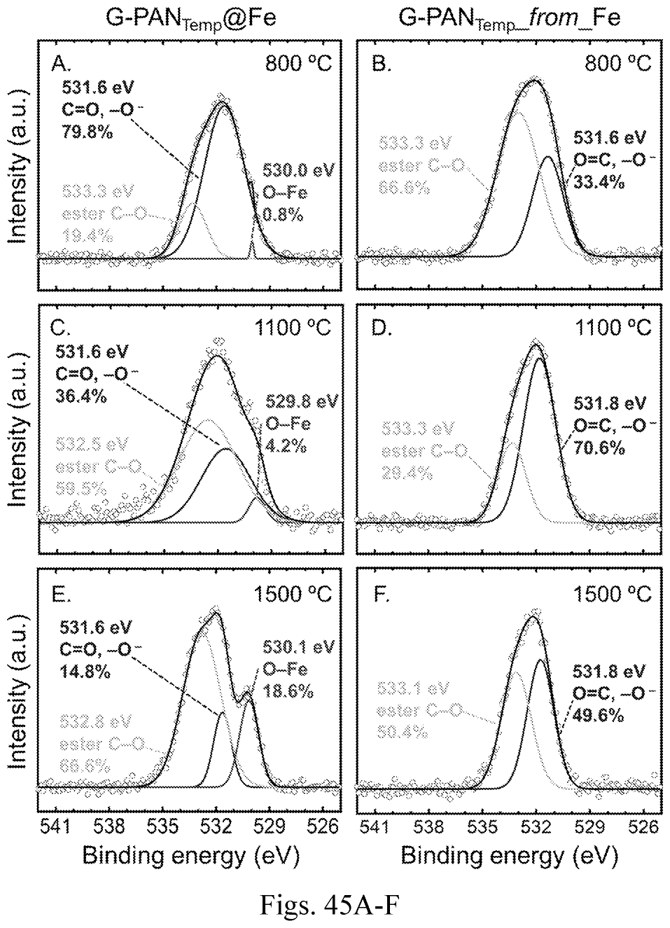

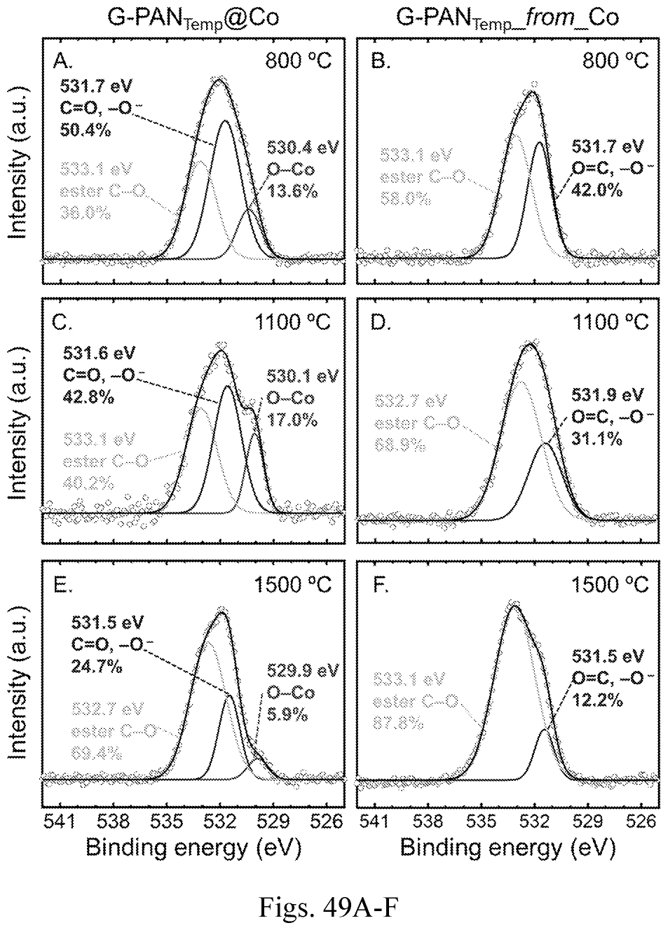

The high-resolution N is XPS spectra (see FIGS. 41, 44, and 48; Tables 17 and 18) show that nitrogen on the surface of all samples exists as part of pyridinic, pyridonic, and nitroxide groups. Similarly, from the O is XPS spectra (see FIGS. 41, 45, and 49; Tables 17 and 18), oxygen on the surface of the samples exists as part of ester C—O and as part of carbonyl overlapping with phenoxide. Before treatment with aqua regia, some metal-coordinated oxygen could be also detected (see FIGS. 45 and 49; Tables 17 and 18). Upon treatment with aqua regia, there was a quantitative decrease in pyridinic nitrogen and a combined increase in pyridonic and pyridine oxide nitrogen, which could be attributed to surface-group oxidation by aqua regia. The pyrolysis temperature also had a similar effect on the N is XPS spectra of some samples (see FIG. 41, for example). Similarly, the distribution of oxygen between ester C—O and carbonyl/phenoxide groups was also a function of both the pyrolysis temperature and treatment with aqua regia, albeit the relationship appeared to be more complicated.

3. Chemical Characterization of G-PAN_{Temp}@M and G-PAN_{Temp}_from_M Systems by XRD, TEM, and Raman Analysis

G-PAN_{Temp}@M and G-PAN_{Temp}_from_M systems (prepared according to the methods described in Parts 2-3 of Example 19 and prepared as sample according to the methods described in Part 1 of this Example) were chemically characterized by powder XRD, TEM, and Raman spectroscopy.

To begin, powder XRD of G-PAN_{Temp}@Fe showed the presence of Fe(0) from pyrolysis of A-PAN@FeOx and the (110) diffraction at 2θ=44.8° at all pyrolysis temperatures (see FIG. 50). In addition, powder XRD of G-PAN_{Temp}@CO showed the presence of Co(0) from pyrolysis of A-PAN@CoOx and the (111) and (2θ0) diffractions at 2θ=44.2° and 51.5° at all pyrolysis temperatures. Fe(0) and Co(0) were formed carbothermally from the reduction of their corresponding metal oxides (MOx) by carbonized PAN. In the case of A-PAN@FeOx, small amounts of Fe₃C formed from pyrolyses at ≤1100° C. Fe₃C was absent at higher temperatures (≥1200° C.), which agrees with previous findings.

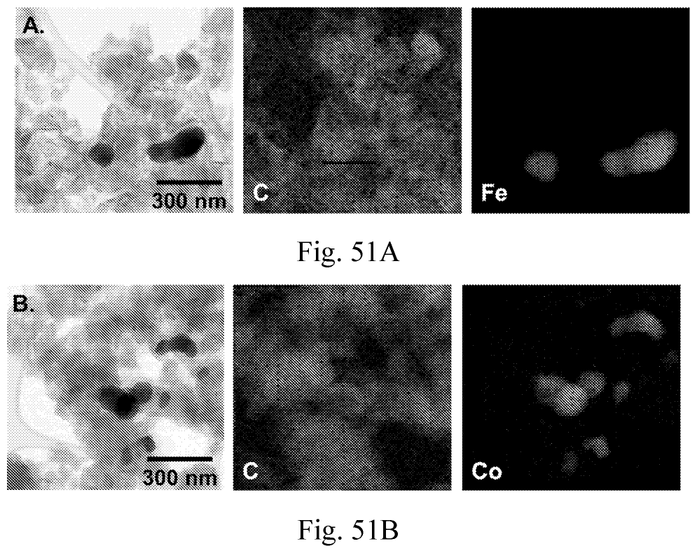

As shown in FIG. 51, the in situ-formed Fe and Co metallic phases of G-PAN₁₅₀₀@Fe and G-PAN₁₅₀₀@Co, respectively, became clearly visible in TEM. Individual and clusters of the metal nanoparticles from about 30 nm to up to 100 nm in size were randomly distributed in a carbon matrix. Concurrently with the metallic phases in XRD (FIG. 50), peaks at 20 equal to 26°, 42.5° and 540 correspond to the (002), (101), and (004) diffractions, respectively, of hexagonal 2H graphite. After removal of Fe(0), Fe₃C, and Co(0) with aqua regia, those graphite diffractions were the only remaining diffractions in the XRD data (FIG. 50). The 20 angles of the (002) reflections of all pure graphite G-PAN_{Temp}_from_Fe and G-PAN_{Temp}_from_Co samples are cited in Table 19 below. Those values were used to calculate the interlayer spacings, d₀₀₂ (via d=λ/(2 sin θ)), which are also included in Table 19.

TABLE 19
XRD, TEM and Raman data of samples as shown, including commercial graphite and commercial carbon black

| | 2θ | interlayer spacing from: | | L_{c} | graphitic C | D | G | G′ | | | |
|---|---|---|---|---|---|---|---|---|---|---|---|
| | for (002) | [Å] | | from (002) | from XRD | peak | peak | peak | | | Lₐ |
| sample | [deg]^{c} | XRD (d₀₀₂)^{d} | TEM^{e} | [Å]^{f} | [% w/w]^{g} | [cm⁻¹] | [cm⁻¹] | [cm⁻¹] | I_{D}/I_{G}^{h} | I_{G′}/I_{G}ⁱ | [nm]^{j} |
| commercial graphite^{a} | 26.40 | 3.37 | 3.34 | 187.1 | 99.21 | 1311 | 1567 | 2648 | 0.46 | 0.98 | 83.63 |
| commercial carbon black^{b} | 25.20 | 3.53 | — | 12.2 | — | 1321 | 1579 | — | 2.85 | — | 13.49 |

Fe-derived pure graphitic carbon aerogels obtained at pyrolysis
temperatures (Temp) after aqua-regia treatment: G-PAN_{Temp}_{_{—}}from_{_{—}}Fe

| | | | | | | | | | | | |
|---|---|---|---|---|---|---|---|---|---|---|---|
| Temp (° C.) | | | | | | | | | | | |
| 800° C. | 26.18 | 3.40 | 3.50 | 52.7 | 60.68 | 1324 | 1584 | 2645 | 1.86 | 0.62 | 20.71 |
| 1000° C. | 26.20 | 3.40 | 3.48 | 66.1 | 77.58 | 1322 | 1576 | 2645 | 1.83 | 1.79 | 20.99 |
| 1100° C. | 26.33 | 3.38 | 3.43 | 78.5 | 91.01 | 1338 | 1582 | 2645 | 1.28 | 0.15 | 30.12 |
| 1200° C. | 26.40 | 3.37 | 3.44 | 126.7 | 94.96 | 1322 | 1585 | 2655 | 0.70 | 0.50 | 54.71 |
| 1400° C. | 26.45 | 3.37 | 3.39 | 161.7 | 97.65 | 1318 | 1567 | 2645 | 0.66 | 0.66 | 58.27 |
| 1500° C. | 26.58 | 3.35 | 3.38 | 168.0 | 99.82 | 1330 | 1584 | 2654 | 0.55 | 0.59 | 70.10 |

Co-derived pure graphitic carbon aerogels obtained at pyrolysis
temperatures (Temp) after aqua-regia treatment: G-PAN_{Temp}_{_{—}}from_{_{—}}Co

| | | | | | | | | | | | |
|---|---|---|---|---|---|---|---|---|---|---|---|
| Temp (° C.) | | | | | | | | | | | |
| 800° C. | 26.35 | 3.38 | 3.51 | 33.1 | 56.9 | 1327 | 1580 | 2642 | 2.35 | 0.07 | 16.39 |
| 1000° C. | 26.20 | 3.40 | 3.48 | 66.6 | 72.93 | 1330 | 1580 | 2640 | 2.19 | 0.13 | 17.60 |
| 1100° C. | 26.23 | 3.40 | 3.46 | 62.0 | 79.92 | 1325 | 1590 | 2655 | 1.25 | 0.32 | 30.81 |
| 1200° C. | 26.33 | 3.38 | 3.43 | 71.8 | 86.55 | 1321 | 1579 | 2646 | 1.09 | 0.87 | 35.19 |
| 1400° C. | 26.20 | 3.40 | 3.44 | 73.1 | 89.57 | 1322 | 1580 | 2646 | 0.89 | 0.97 | 43.46 |
| 1500° C. | 26.38 | 3.38 | 3.41 | 77.9 | 94.11 | 1325 | 1582 | 2650 | 0.74 | 0.75 | 51.73 |

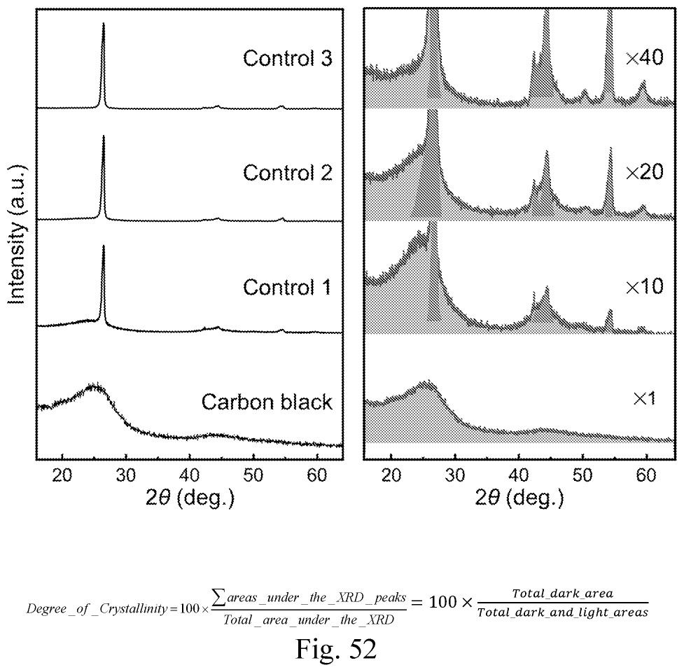

^{a}From Sigma Aldrich Item No. 808067.
^{b}From Sigma Aldrich Item No. 05105.
^{c}Obtained from powder XRD data.
^{d}Calculated using Bragg's law with Cu Kα wavelength of 1.54056 Å.
^{e}Calculated from HR-TEM images using the ImageJ software, average of 5 values at different areas.
^{f}Calculated using the Scherrer equation (Equation 11) with shape factor (k) of 0.9.
^{g}Calculated as described in FIG. 52 and Equation 10.
^{h,i}Calculated from Raman data using integral peak intensities (all peaks (average value): D (1323), G (1579), D′ (1615), and G′ (2647) were deconvoluted).
^{j}Calculated from Raman data via Knight's empirical formula (Equation 12).

As shown in Table 19, the interlayer spacings of the G-PAN_{Temp}_from_Fe samples decreased with increasing pyrolysis temperature, eventually converging at 1500° C. to the graphite spacing (3.35 Å). The d₀₀₂ spacing of the G-PAN_{Temp}_from_Co samples was rather insensitive to the pyrolysis temperature, hovering around 3.38 Å even after pyrolysis at 1500° C.

Quantitative evaluation of the ratio of the graphitic versus amorphous carbon in the final, post-aqua-regia-treated samples was carried out by calculating the Degree of Crystallinity of all G-PAN_{Temp}_from_Fe or _from_Co aerogels from powder XRD data using Equation 10.

$$Degree\_of \_Crystallinity = 100 \times \frac{\sum areas\_under \_the \_ XRD \_peaks}{Total\_area \_under \_the \_ XRD} \qquad ( 10 )$$

This method was validated with three controls prepared by mixing commercial graphite (graphitic carbon) and commercial carbon black (amorphous carbon) with a mortar and pestle at three predetermined ratios, which are shown in Table 2θ. The expanded version of the XPD data shown in FIG. 52 (on the right) illustrates the relevant areas that were used to calculate the percent of crystalline carbon.

TABLE 20
Graphitization yield (%) calculated from
XRD data in FIG. 52 using Equation 10

| | Prepared at the following ratios | | Calculated from XRD | |
|---|---|---|---|---|
| | Commercial | Commercial | Graphitic | Amorphous |
| | graphite | carbon black | C | C |
| Control | [% w/w] | [% w/w] | [% w/w] | [% w/w] |
| Control 1 | 20 | 80 | 20.18 | 79.82 |
| Control 2 | 50 | 50 | 50.64 | 49.36 |
| Control 3 | 80 | 20 | 78.01 | 21.99 |

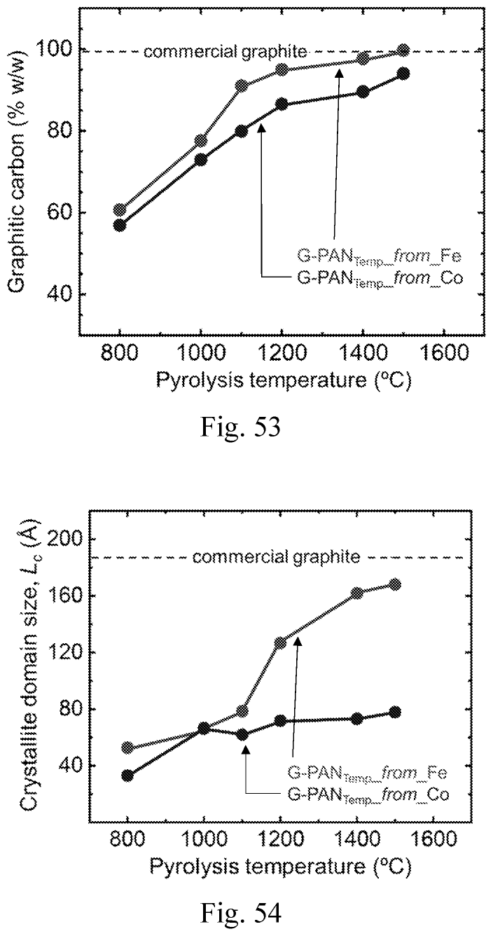

The weight percent values of graphitic carbon for all G-PAN_{Temp}_from_Fe and all G-PAN_{Temp}_from_Co are cited in Table 19 and are plotted versus the pyrolysis temperature in FIG. 53. The content in graphitic carbon increased continuously with the pyrolysis temperature. A maximum in the graphitic carbon content was observed in G-PAN₁₅₀₀_from_Fe (99.8% w/w), which is within error from the graphitic content of commercial graphite (99.2% w/w). The graphite content of G-PAN₁₅₀₀_from_Co was 94.1% w/w. The dashed horizontal line marks the value for commercial graphite.

Next, the crystallite dimensions within the graphitic carbons were evaluated from XRD and Raman data. The topology and growth of graphitic C was evaluated from TEM data. From XRD, the mean crystallite domain size, L_{c} (along the c-axis) was calculated from the line broadening using the Scherrer's equation (Equation 11) along the (002) diffraction peak:

$${L}_{C} = \frac{K λ}{β cos θ} \qquad ( 11 )$$

[K is a dimensionless shape factor (0.9 in this case), A is the wavelength of the X-ray source (1.54056 Å for Cu Kα), β is the line broadening at half-maximum intensity after subtracting the instrumental line broadening (in radians), and θ is the Bragg's angle (in radians)]. As shown in FIG. 54, L_{c} values increased continuously with increasing pyrolysis temperature. The maximum crystallite domain size of 168 Å was observed in G-PAN₁₅₀₀_from_Fe, while the maximum crystalline domain in the G-PAN₁₅₀₀_from_Co samples reached only 77.9 Å. For comparison, the crystallite domain size in the c-direction of commercial graphite was found equal to 187 Å, which is represented by a dashed horizontal line in FIG. 54.

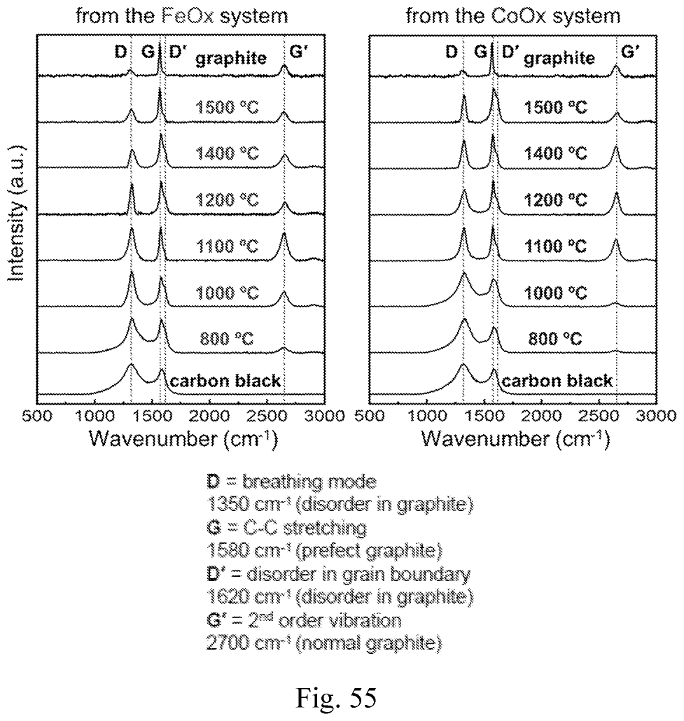

The Raman spectra of all pyrolyzed samples after aqua-regia treatment, G-PAN_{Temp}_from_Fe and G-PAN_{Temp}_from_Co, are shown in FIG. 55. All samples show the three bands referred to as G, D and G′, which are associated with the honeycomb-like structure of fused aromatic sp² carbons. The G band at around 1580 cm⁻¹ is due to cross-plane vibrations that involve symmetric C—C bond stretching of E_{2g} symmetry. Notably, the G band is present in graphite but absent from graphene. The D peak around 1350 cm⁻¹ is due to a propagating breathing mode of A_{1g} symmetry of individual graphene sheets and is not Raman active in infinite sheets of perfect sp² carbons. However, in the presence of disorders (e.g., finite edges) that reflect back propagating breathing impulses, the oscillation effectively obtains a zero momentum and becomes Raman active. Finally, the overtone G′ (also referred to as 2D₁) at around 2700 cm⁻¹ is a second-order, two-phonon process: one phonon goes to the right, and the other one moves to the left. As a result, the total momentum is always zero. It is always Raman-allowed, and no disorder is needed for this band, which becomes the main band of graphene. Interestingly, in the samples, this band becomes a prominent one at intermediate pyrolysis temperatures (see samples G-PAN₁₁₀₀_from_Fe and G-PAN₁₁₀₀₋ₜₒ₋₁₄₀₀_from_Co in FIG. 55), and then, at 1500° C., the G′-band's intensity decreases again, suggesting formation of metastable graphene sheets at intermediate temperatures.

As the pyrolytic graphitization temperature increases, the D-band intensity decreases while the G-band becomes narrower and its intensity increases. The shoulder of the G band at around 1620 cm⁻¹ is labeled as D′. It is assigned to a lattice vibration (like the one responsible for the G band), but it involves the top and bottom graphene sheets in a stack. Therefore, the D′ band is present in all graphites and is absent from single graphene sheets. Notably, the D′ shoulder is present in all samples, and curiously, the intensity of D′ reaches a minimum (relative to G) when the intensity of G′ reaches its maximum. Then, the intensity of the D′ shoulder increases again, becoming comparable to the intensity of G in G-PAN₁₅₀₀_from_Co. However, in the case of G-PAN_{Temp}_from_Fe, the intensity of D′ first increases from its minimum and then decreases again. D′ reaches a new minimum in G-PAN₁₅₀₀_from_Fe (always relative to G) comparable in size to that of commercial graphite. If the variation of the intensity of D′ is considered together with the variation of G′, this consideration leans toward the accumulation of graphene in the intermediate temperature range, i.e., 1100-1400° C., with the details depending on the specific catalyst.

Reasonably, the major disorder in the graphitic carbons should be attributed to grain boundaries. Therefore, the ratio of the integrated intensities of the Raman D- and G-band (I_{D}/I_{G}), which is related to the degree of disorder, is related to the grain (crystallite) size. As the pyrolysis temperature increased, the I_{D}/I_{G} ratio decreased, reaching the values of 0.55 (in C-PAN₁₅₀₀_from_Fe) and 0.74 (in C-PAN₁₅₀₀_from_Co) as shown in Table 19. For comparison, the I_{D}/I_{G} ratio of commercial graphite was 0.46.

Usually, the crystallite length, Lₐ (i.e., the crystallite domain size along the a-axis), is calculated from the (100) diffraction peak in the XRD spectra via the Scherrer equation. Since the (100) diffraction peak is not prominent in the powder-XRD spectra of the samples, Lₐ was calculated from the Raman spectra using Knight's empirical formula (Equation 12), where λ_{L} is the laser wavelength in nm (632.8 nm for the He—Ne laser) and I_{D} and I_{G} are the integrated peak intensities.

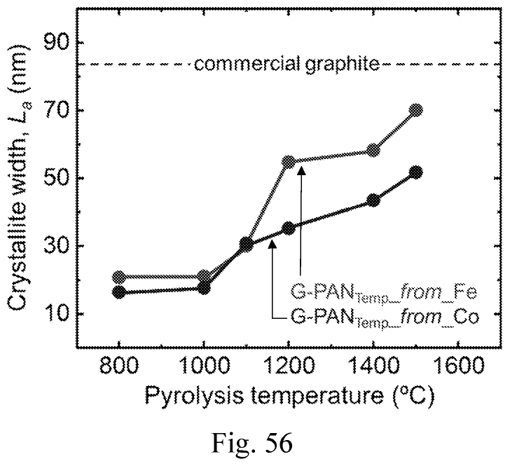

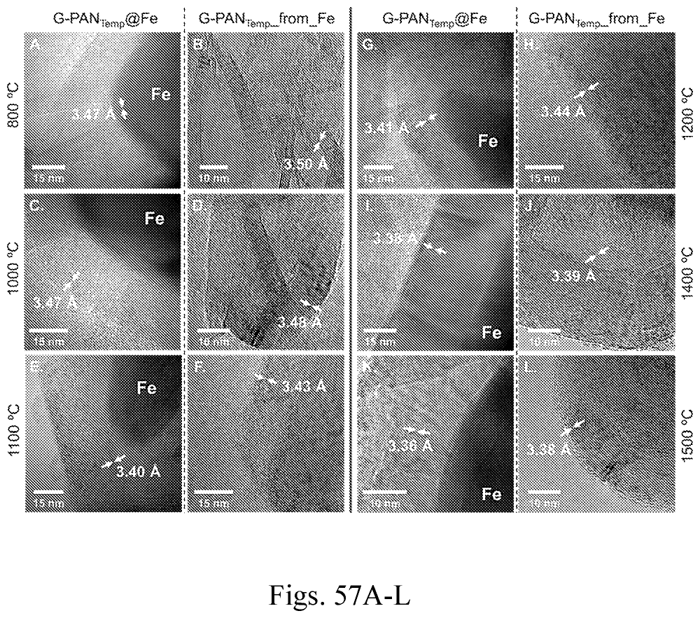

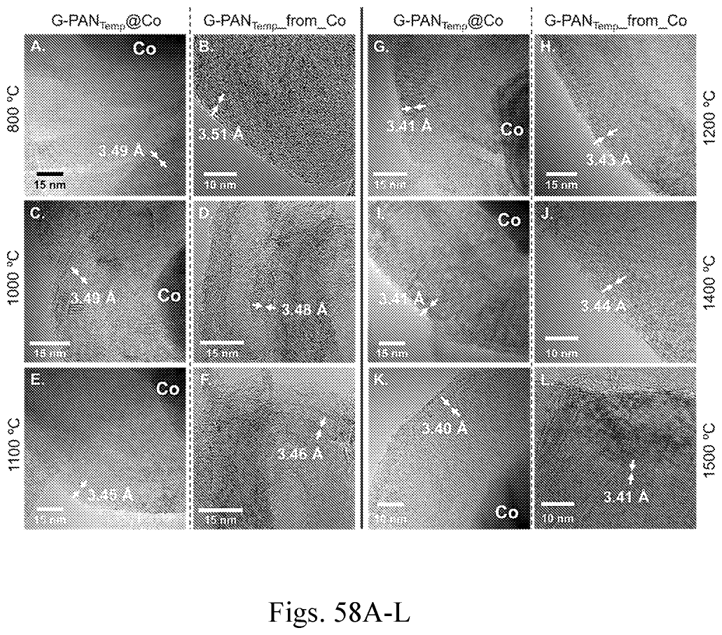

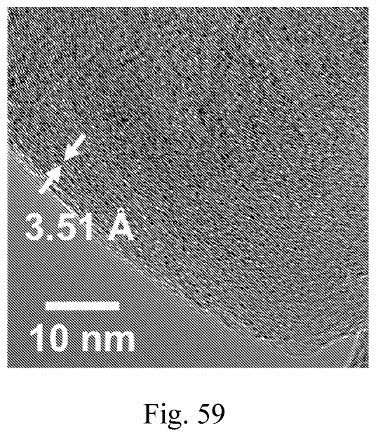

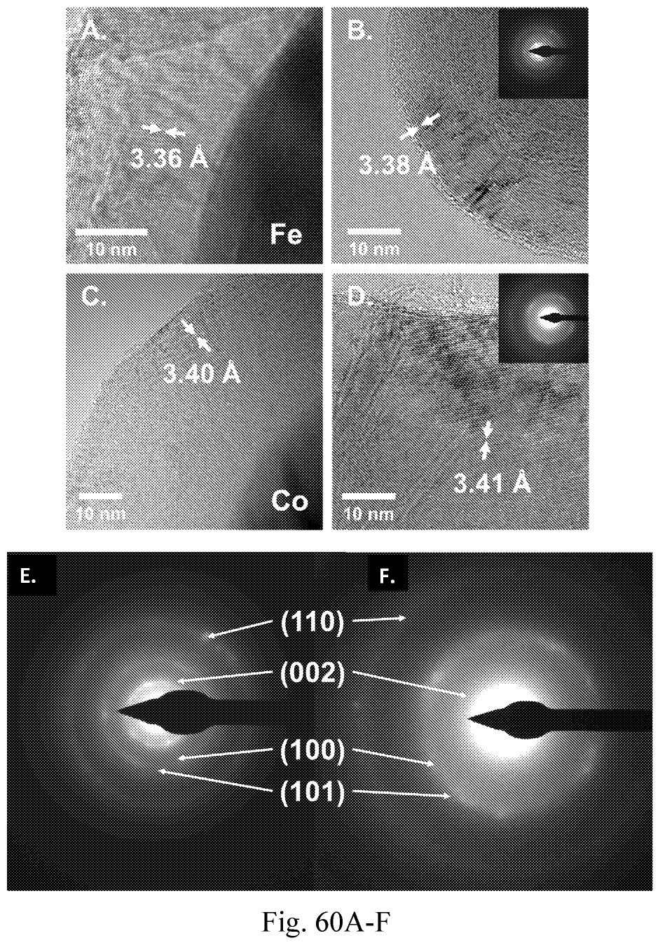

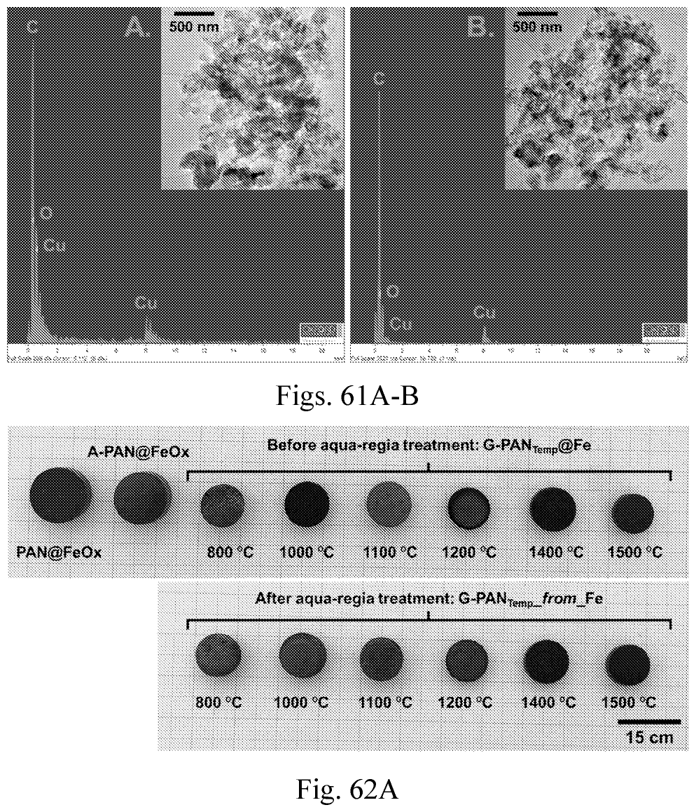

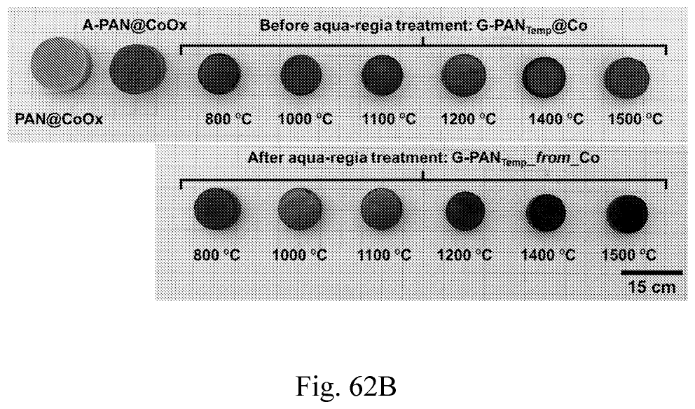

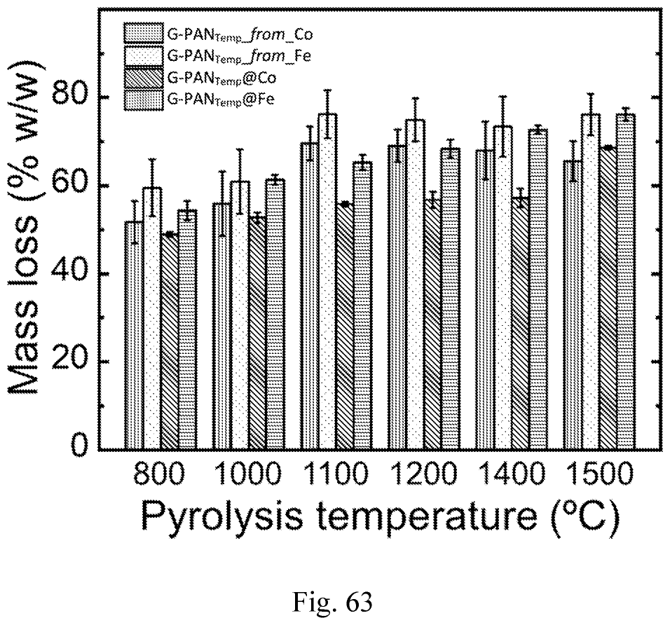

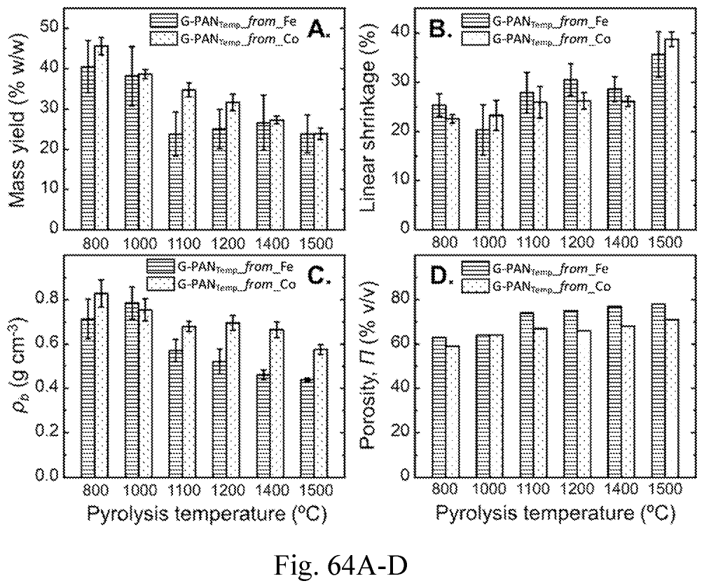

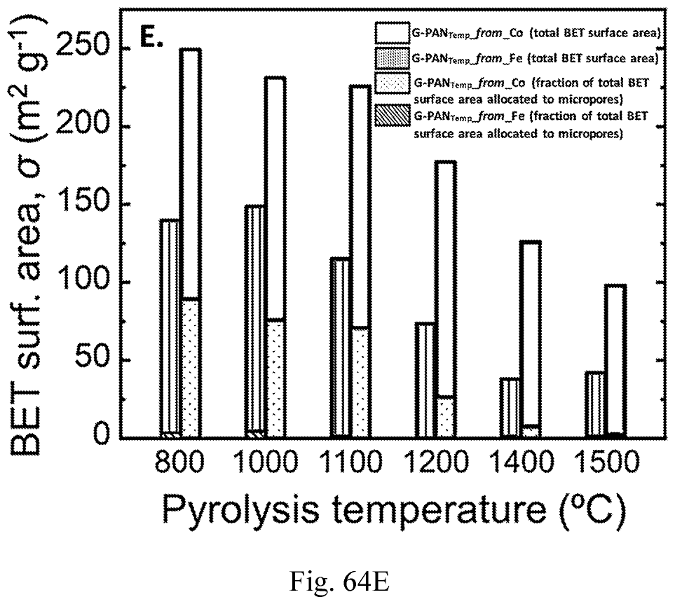

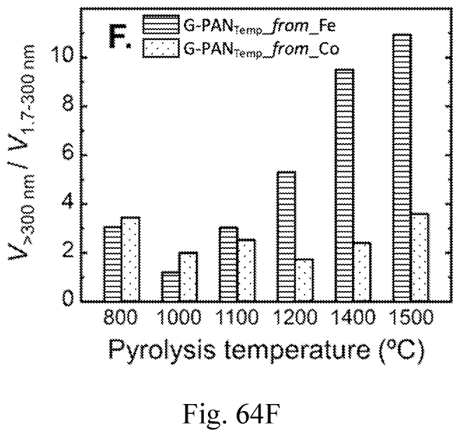

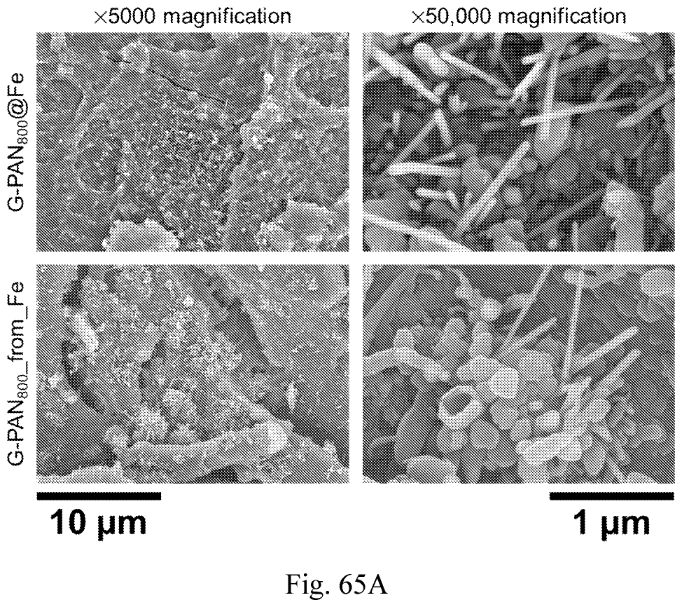

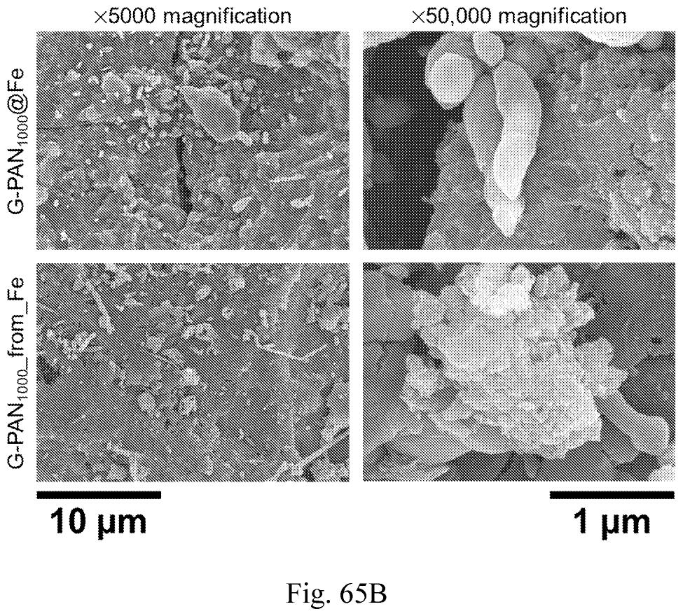

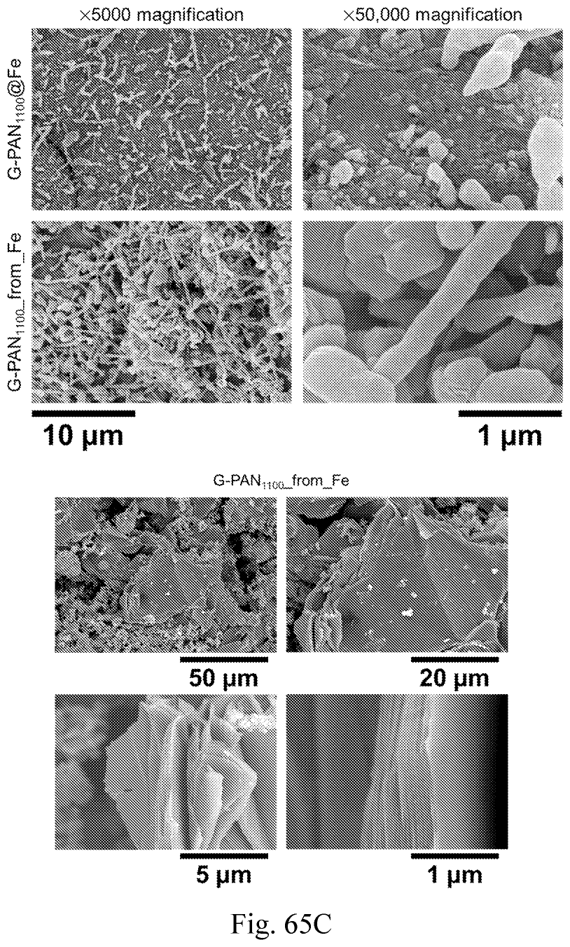

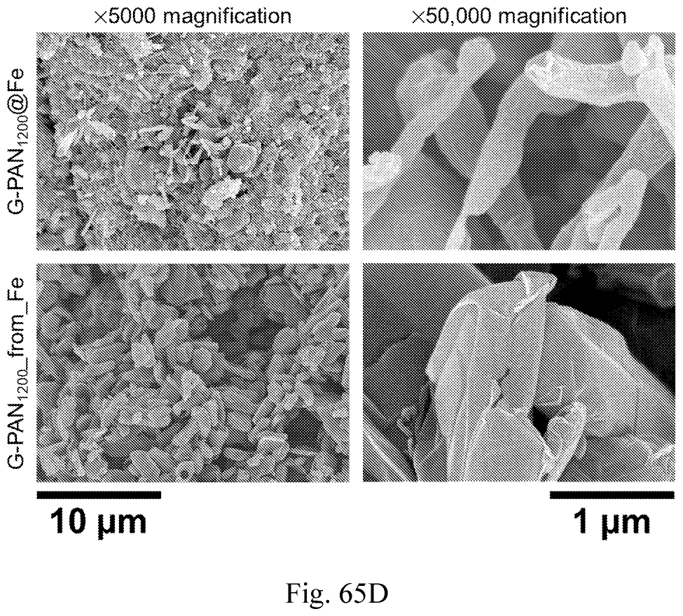

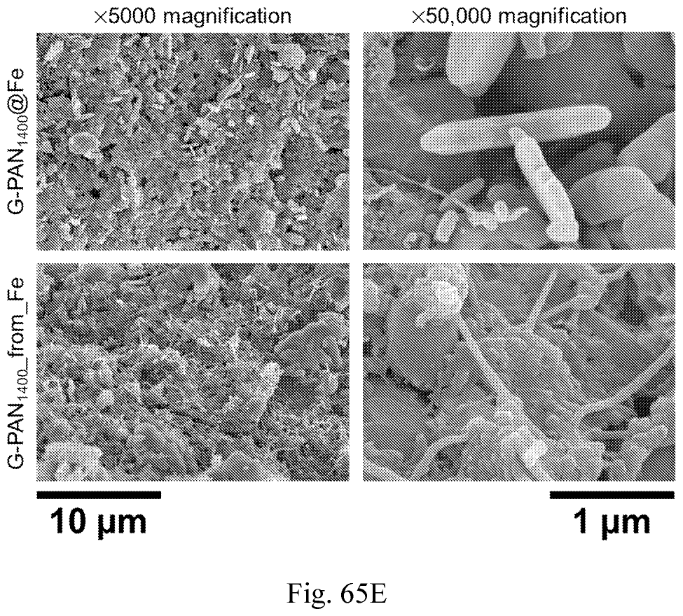

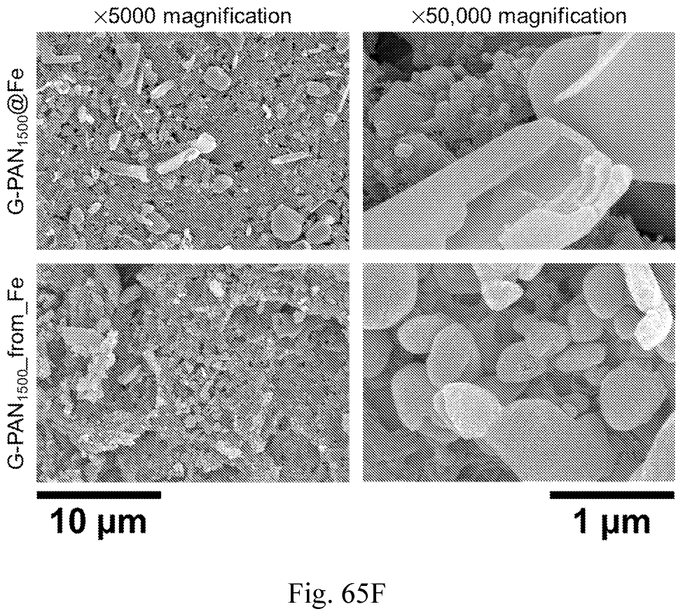

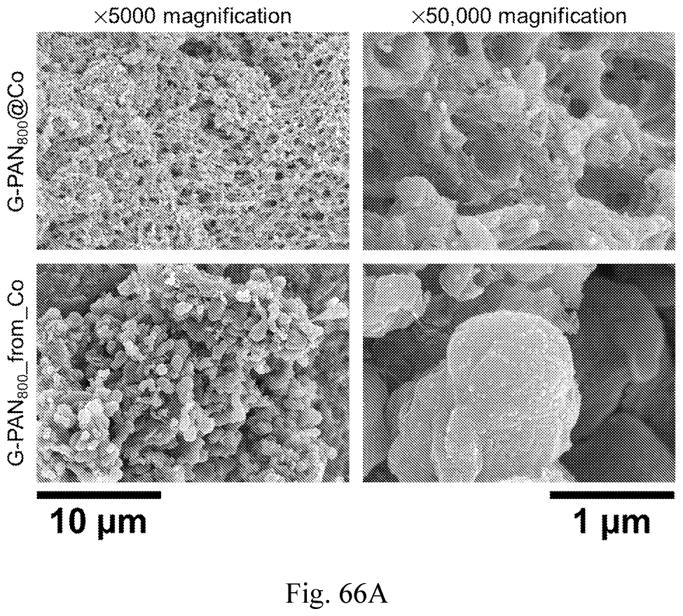

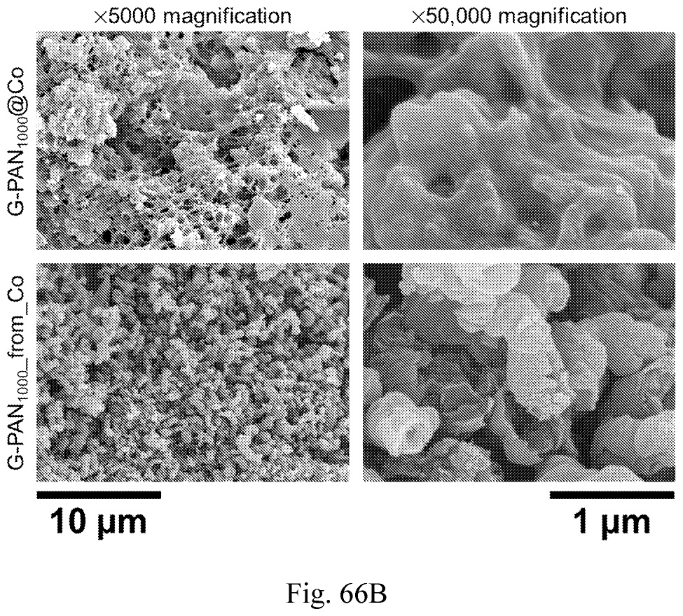

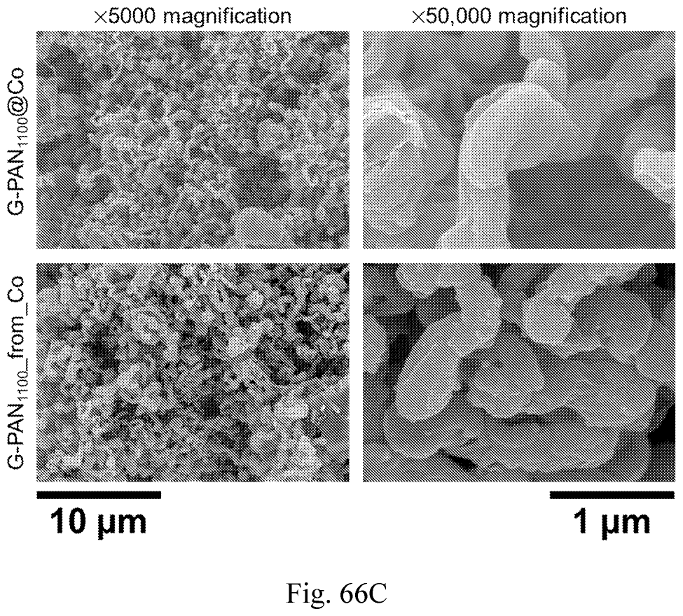

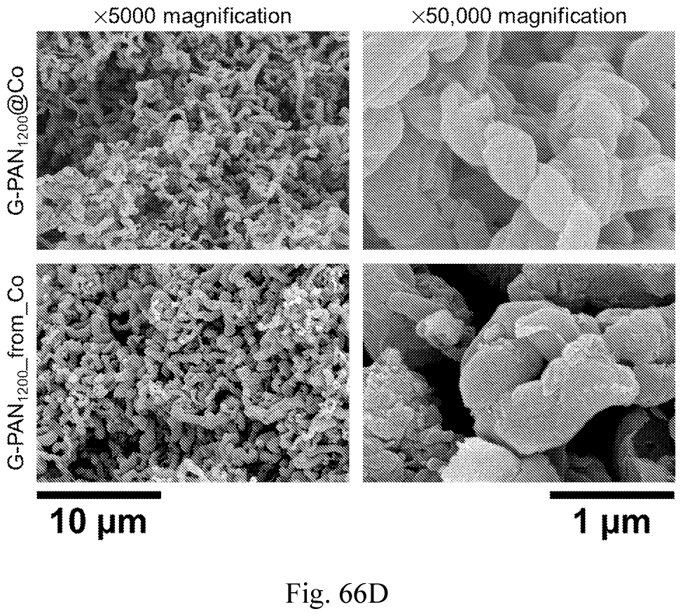

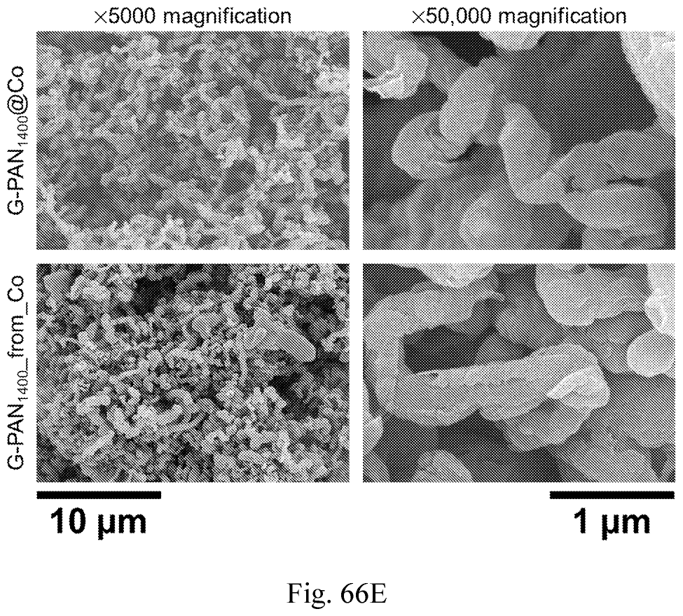

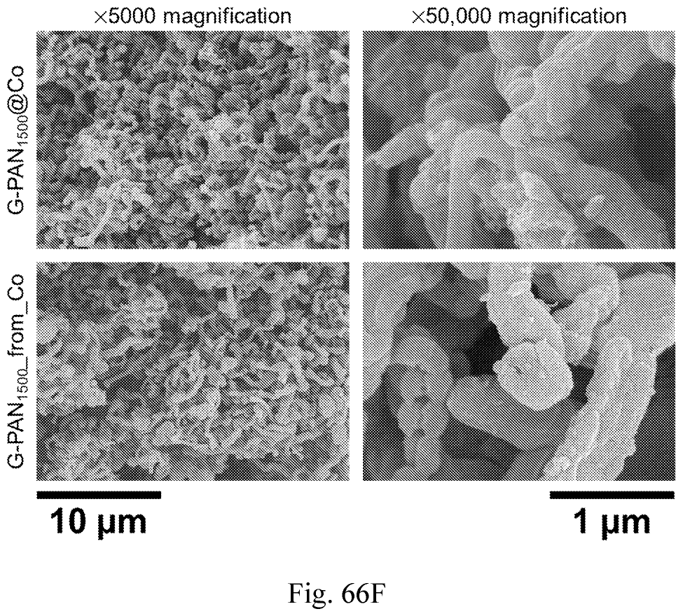

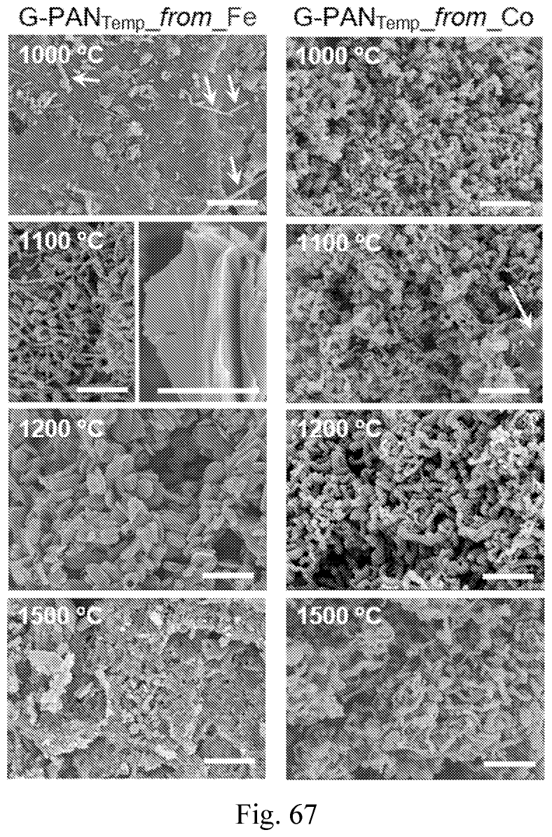

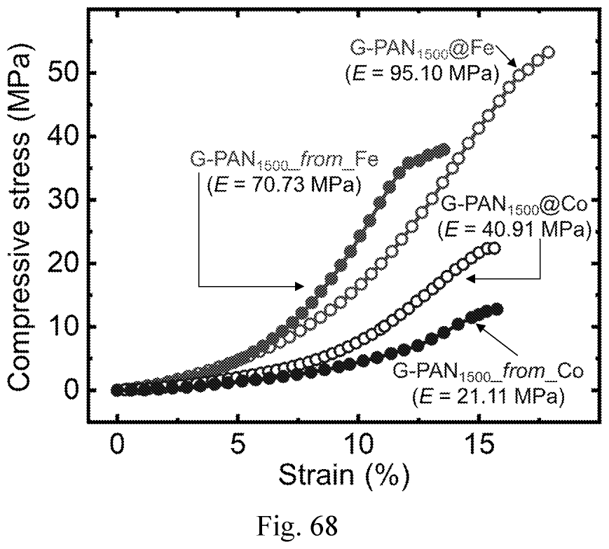

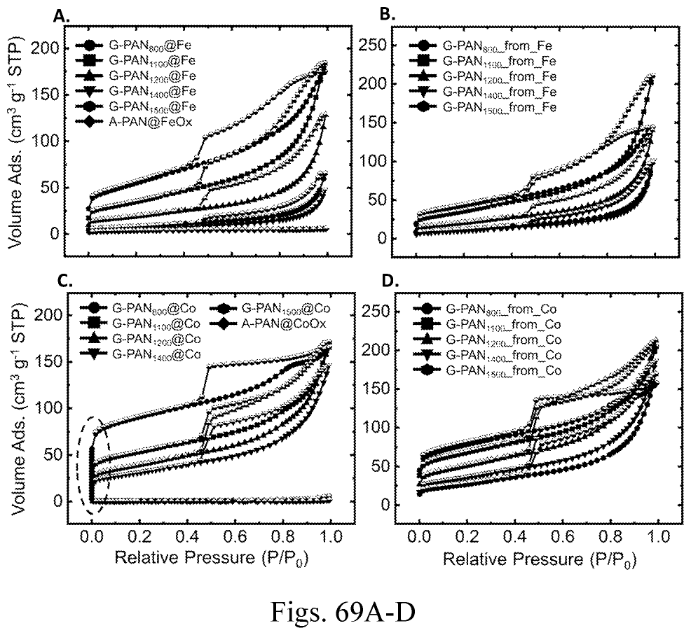

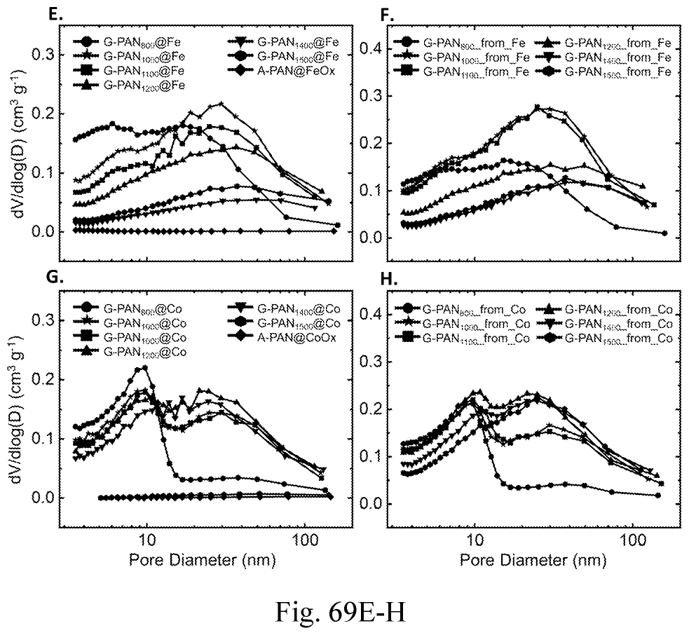

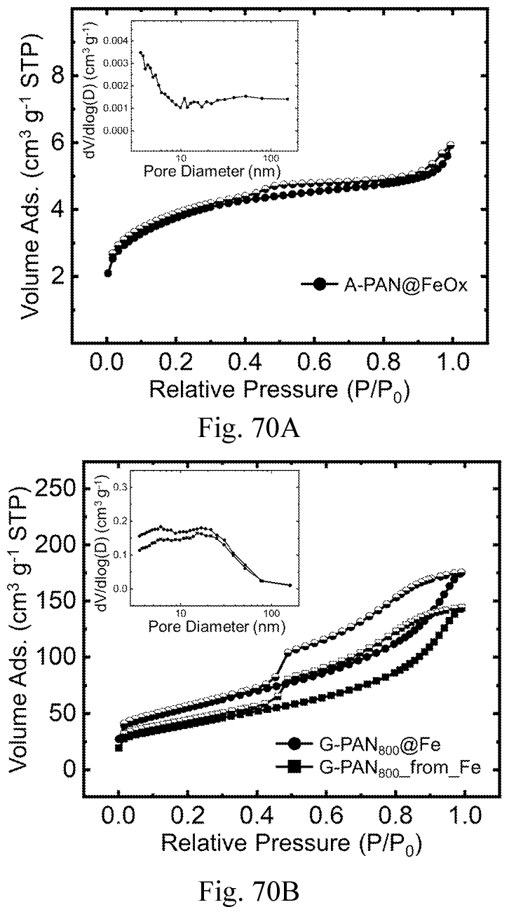

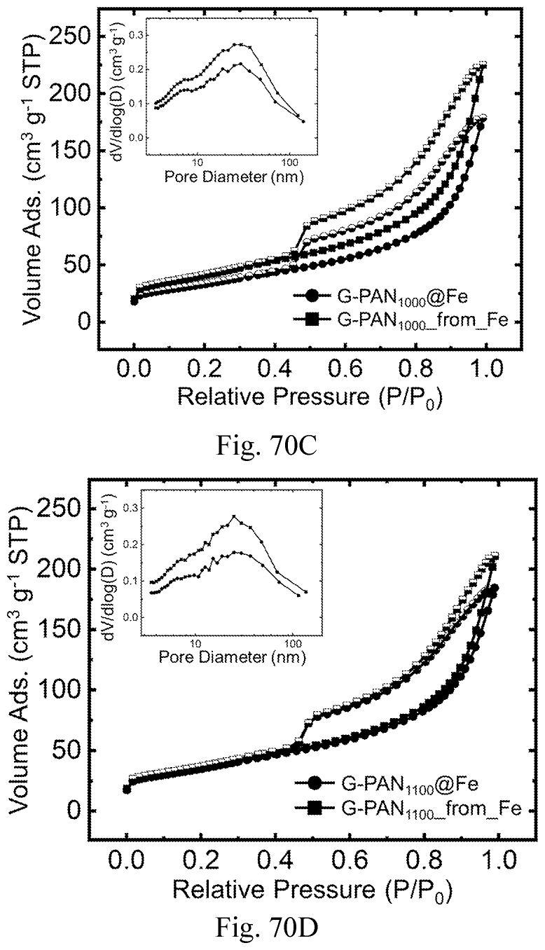

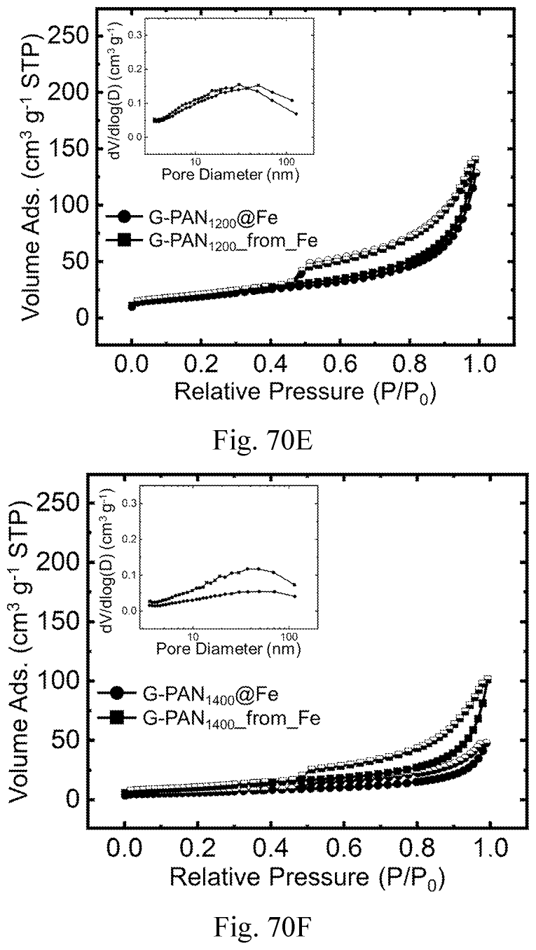

Lₐ=(2.4×10⁻¹⁰)λ_{L}⁴(I_{D}/I_{G})⁻¹ (12)
Irrespective of a catalyst, Lₐ increased continuously with increasing pyrolysis temperature as shown in FIG. 56. A maximum crystallite length of 70 nm was reached in G-PAN₁₅₀₀_from_Fe. In G-PAN₁₅₀₀_from_Co, the length of the crystallites reached only 52 nm. By comparison, the Lₐ value in commercial graphite (dashed horizontal line) was 84 nm, and only 14 nm in carbon black.

Overall, XRD and Raman data together suggest that longer (larger Lₐ), and thicker (larger L_{c}), crystallites were formed by pyrolysis at 1500° C. with either catalyst. Notably, the properties of G-PAN₁₅₀₀_from_Fe in terms of graphite content (via the degree of crystallinity), crystallite size (via Lₐ and L_{c}), and the overall quality of graphite (via the I_{D}/I_{G} ratio) approached those of commercial graphite.

An insight into the evolution of the graphitization process as a function of the temperature and catalyst was obtained from TEM images before and after treatment with aqua regia as shown in FIGS. 57 and 58. These figures also include interlayer spacing data. A representative image of samples derived at 800° C. is illustrated in FIG. 59, using G-PAN₈₀₀_from_Co as the example. Representative images of all G-PAN₁₅₀₀@M and G-PAN₁₅₀₀_from_M samples are shown in FIG. 60. The common theme in FIGS. 57-58 is that the metallic particles are surrounded by stacks of layers in a core-shell fashion. The shell thickness around the Fe and Co particles of G-PAN₁₅₀₀@Fe and G-PAN₁₅₀₀@Co was estimated from low-magnification TEM images at about 157 nm and 122 nm, respectively.

As shown in FIG. 59, layered structures around the Fe and Co nanoparticles were already present at 800° C. However, it is also noted that, despite the general orientation and stucking at that temperature, the individual layers within the stacks were interrupted randomly and frequently. As the pyrolysis temperature was increased, the interruptions became less frequent (see FIGS. 57 and 58), and the layered segments became longer. Notably, by 1500° C., those layers were practically continuous with few or no defects (FIGS. 60A and 60C).

Furthermore, as shown in FIG. 61, TEM-EDX analysis also confirmed that treatment with aqua regia removed the metallic components completely from all samples. The electron diffraction patterns of post-aqua regia G-PAN₁₅₀₀_from_Fe and G-PAN₁₅₀₀_from_Co showed only the (002), (100), (101), and (110) diffractions from graphite (see Insets in FIGS. 60B, 60D, and 61). Post aqua regia treated samples consisted only of intertwined graphitic ribbons with pockets reminiscent of the metallic particles.

The interlayer spacing within the graphitic ribbons, d₀₀₂, decreased with increasing pyrolysis temperature, just as it was noted in XRD. For example, the d₀₀₂ spacing in pure G-PAN₈₀₀_from_Fe was found equal to 3.40 Å and 3.50 Å with XRD and TEM, respectively. The same spacing in pure G-PAN₁₅₀₀_from_Fe was found equal to 3.35 and 3.38 Å from XRD and TEM, respectively. The corresponding values for the Co system were 3.38 Å/3.51 Å at 800° C. and 3.38 Å/3.51 Å at 1500° C. (see Table 19). Consistently, TEM tended to slightly overestimate the interlayer spacing, but the trends were the same as in XRD. Based on the corresponding d₀₀₂ spacing values and the thickness of the graphitic shells around the metallic particles, those graphitic carbon shells consisted of approximately 465 and 358 graphene layers, respectively.

When the XRD, TEM, and Raman data are considered together, graphitization within the samples seems to proceed in stages. The first stage, which actually sets the tone for the subsequent events, occurs at around 800° C. to 1000° C. and comprises the formation of small fused aromatic units that accumulate on the metallic particles and subsequently on themselves. Although those basic units are short and the resulting layers on the metallic particles have many and frequent interruptions, it is still remarkable to note the orienting role of the metallic particles: as these layers became thicker, they remained conformal to the metal surface. The second stage of graphitization occurs at intermediate temperatures, around 1000° C. to 1200° C., and comprises the reduction of defects and distortions within the stacks on top of the particles. The individual layers within the stacks become more continuous, but the thickness of the stacks does not necessarily increase. A pyrolysis temperature of 1400° C. or higher is the stage of annealing with quantitative removal of defects and distortions. Stacks become thicker, and layers within stacks become continuous and more compact with practically no defects. Based on the high degree of graphitization above 1200° C. (refer to FIG. 54), it is assumed that the microscopic features observed in SEM (discussed below in Example 24) all consist of entangled graphitic ribbons like those left behind all over the observable area when the metal was removed (see, for example, FIGS. 57, 58, 60B, 60D).

### Example 24

### Physical and Structural Characterization of PAN@MOx, A-PAN@MOx, G-PAN_{Temp}@M, and G-PAN_{Temp}_from_M Systems

### 1. Physical Characterization Methods

Bulk densities (ρ_{b}) were calculated from weight and physical dimensions of the samples. Skeletal densities (ρₛ) were measured using helium pycnometry on a Micromeritics AccuPyc II 1340 instrument. Samples for skeletal density measurements were outgassed for 24 hours at 80° C. under vacuum before analysis. Percent porosities (17) were determined from the ρ_{b} and ρₛ values via Π=100×[(ρₛ−ρ_{b})/ρₛ].

### 2. Structural Characterization Methods

Scanning electron microscopy (SEM) was conducted with Au/Pd (60/40) coated samples on a Hitachi Model S-4700 field-emission microscope. Samples were placed on a SEM stub using a C-dot. Thin sticky copper strips were cut and placed on the edges and top of the sample, leaving space for the analysis.

3. Macroscopic Properties of PAN@MOx, A-PAN@MOx, G-PAN_{Temp}@M, and G-PAN_{Temp}_from_MS Ystems

FIG. 62 shows PAN@MOx, A-PAN@MOx, G-PAN_{Temp}@M, and G-PAN_{Temp}_from_M compacts along aromatization, graphitization, and etching (prepared according to the methods described in Examples 18-19). The material properties of these compacts are presented in Tables 21 and 22 below.

TABLE 21
Materials characterization data along processing of PAN@FeOx xerogel compacts
at different pyrolysis temperatures (Temp), before and after treatment with aqua regia

| | mass | linear | bulk | skeletal | |
|---|---|---|---|---|---|
| | yield | shrinkage | density | density | porosity |
| sample | [% w/w]^{a,b} | [%]^{a,c} | ρ_{b} [g cm⁻³]^{a} | ρₛ [g cm⁻³]^{d} | Π [% v/v]^{e} |
| PAN@FeOx | — | — | 1.228 ± 0.004 | 1.304 ± 0.005 | 6 |
| A-PAN@FeOx | 67.61 ± 1.28 | 16.44 ± 1.68 | 1.107 ± 0.025 | 1.859 ± 0.010 | 40 |

Graphitic carbon compacts processed at different
temperatures (Temp) BEFORE aqua regia treatment (i.e.,
before removal of iron): G-PAN_{Temp}@Fe

| | | | | | |
|---|---|---|---|---|---|
| Temp | | | | | |
| 800° C. | 48.27 ± 4.78 | 25.24 ± 2.80 | 0.801 ± 0.054 | 2.129 ± 0.006 | 62 |
| 1000° C. | 44.11 ± 7.32 | 20.32 ± 5.09 | 0.949 ± 0.009 | 2.529 ± 0.004 | 63 |
| 1100° C. | 30.44 ± 3.85 | 27.83 ± 4.15 | 0.717 ± 0.038 | 2.535 ± 0.035 | 72 |
| 1200° C. | 30.98 ± 3.71 | 30.78 ± 2.72 | 0.763 ± 0.013 | 2.566 ± 0.005 | 70 |
| 1400° C. | 32.05 ± 6.54 | 28.04 ± 3.81 | 0.762 ± 0.039 | 2.453 ± 0.006 | 69 |
| 1500° C. | 34.45 ± 4.49 | 34.25 ± 2.27 | 0.748 ± 0.013 | 2.426 ± 0.008 | 69 |

Graphitic carbon compacts processed at different
temperatures (Temp) AFTER aqua regia treatment (i.e.,
after removal of iron): G-PAN_{Temp}_{_{—}}from_{_{—}}Fe

| | | | | | |
|---|---|---|---|---|---|
| Temp | | | | | |
| 800° C. | 40.50 ± 6.46 | 25.37 ± 2.29 | 0.713 ± 0.089 | 1.937 ± 0.007 | 63 |
| 1000° C. | 38.19 ± 7.29 | 20.35 ± 5.08 | 0.785 ± 0.073 | 2.143 ± 0.009 | 64 |
| 1100° C. | 23.81 ± 5.46 | 27.88 ± 4.11 | 0.570 ± 0.050 | 2.145 ± 0.024 | 74 |
| 1200° C. | 25.08 ± 4.88 | 30.51 ± 3.25 | 0.520 ± 0.056 | 2.099 ± 0.053 | 75 |
| 1400° C. | 26.62 ± 6.85 | 28.62 ± 2.48 | 0.461 ± 0.022 | 2.020 ± 0.006 | 77 |
| 1500° C. | 23.86 ± 4.70 | 35.64 ± 4.63 | 0.439 ± 0.007 | 2.021 ± 0.009 | 78 |

| | | | | | | average |
|---|---|---|---|---|---|---|
| | | | | BET surface | | pore |
| | specific pore volume [cm³ g⁻¹] | | | area | | diameter |
| sample | V_{Total}^{f} | V_{1.7-300}_{_{—}}ₙₘ^{g} | V_{>300 nm}^{h} | σ [m² g⁻¹]ⁱ | | [nm]^{j} |
| PAN@FeOx | — | — | — | — | | — |
| A-PAN@FeOx | 0.37 | 0.00 | 0.37 | 13.03 | (3.26) | 112 |
| | Graphitic carbon compacts processed at different | | | | | |
| | temperatures (Temp) BEFORE aqua regia treatment (i.e., | | | | | |
| | before removal of iron): G-PAN_{Temp}@Fe | | | | | |
| Temp | | | | | | |
| 800° C. | 0.78 | 0.23 | 0.55 | 190.9 | (19.12) | 16.3 |
| 1000° C. | 0.66 | 0.28 | 0.38 | 119.0 | (7.84) | 22.2 |
| 1100° C. | 1.00 | 0.26 | 0.74 | 105.3 | (3.99) | 38.7 |
| 1200° C. | 0.92 | 0.18 | 0.74 | 61.07 | (3.24) | 60.9 |
| 1400° C. | 0.90 | 0.09 | 0.81 | 25.66 | (0.68) | 150 |
| 1500° C. | 0.93 | 0.09 | 0.84 | 23.60 | (1.05) | 183 |
| | Graphitic carbon compacts processed at different | | | | | |
| | temperatures (Temp) AFTER aqua regia treatment (i.e., | | | | | |
| | after removal of iron): G-PAN_{Temp}_{_{—}}from Fe | | | | | |
| Temp | | | | | | |
| 800° C. | 0.89 | 0.22 | 0.67 | 139.9 | (3.36) | 25.4 |
| 1000° C. | 0.81 | 0.37 | 0.44 | 149.0 | (4.23) | 21.7 |
| 1100° C. | 1.29 | 0.32 | 0.97 | 115.1 | (1.06) | 45.1 |
| 1200° C. | 1.45 | 0.23 | 1.22 | 73.60 | (0.21) | 78.6 |
| 1400° C. | 1.68 | 0.16 | 1.52 | 38.23 | (0.72) | 175 |
| 1500° C. | 1.79 | 0.15 | 1.64 | 42.22 | (1.28) | 170 |

^{a}Average of three samples.
^{b}Mass yields relative to the PAN@FeOx xerogel compacts.
^{c}Shrinkages relative to the PAN@FeOx xerogel compacts.
^{d}Single sample, average of 50 measurements.
^{e}Porosity, Π = 100 · (ρₛ − ρ_{β})/ρₛ.
^{f} V_{Total} was calculated via V_{Total} = (1/ρₚ) − (1/ρₛ).
^{g}Cumulative pore volume V_{1.7-300}_{_{—}}ₙₘ was calculated via the Barrett-Joyner-Halenda (BJH) desorption method.
^{h}V_{>300 nm} = V_{Total} − V_{1.7-300}_{_{—}}ₙₘ.
ⁱSurface areas were calculated from N₂-sorption data via the Brunauer-Emmett-Teller (BET) equation; numbers in (parentheses): Micropore surface areas calculated via the t-plot method.
^{j}Average pore diameters were calculated via the 4 × V/σ method by setting V = V_{Total} = (1/ρ_{b}) − (1/ρₛ).

TABLE 22
Materials characterization data along processing of PAN@CoOx xerogel compacts
at different pyrolysis temperatures (Temp), before and after treatment with aqua regia

| | | linear | bulk | skeletal | |
|---|---|---|---|---|---|
| | mass loss | shrinkage | density | density | porosity |
| sample | [% w/w]^{a,b} | [%]^{a,c} | ρ_{b} [g cm⁻³]^{a} | ρ_{σ} [g cm⁻³]^{d} | Π [% v/v]^{e} |
| PAN@CoOx | — | — | 1.239 ± 0.028 | 1.412 ± 0.003 | 12 |
| A-PAN@CoOx | 71.70 ± 0.90 | 14.28 ± 0.52 | 1.228 ± 0.025 | 1.773 ± 0.004 | 31 |

Graphitic carbon compacts processed at different
temperatures (Temp) BEFORE aqua regia treatment (i.e.,
before removal of cobalt): G-PAN_{Temp}@Co

| | | | | | |
|---|---|---|---|---|---|
| Temp | | | | | |
| 800° C. | 51.05 ± 0.55 | 22.49 ± 0.29 | 0.953 ± 0.052 | 2.220 ± 0.004 | 57 |
| 1000° C. | 47.23 ± 1.16 | 22.17 ± 2.86 | 0.913 ± 0.050 | 2.436 ± 0.005 | 63 |
| 1100° C. | 44.19 ± 0.49 | 25.78 ± 2.39 | 0.847 ± 0.010 | 2.496 ± 0.009 | 66 |
| 1200° C. | 43.25 ± 1.87 | 25.21 ± 1.32 | 0.917 ± 0.021 | 2.613 ± 0.005 | 65 |
| 1400° C. | 42.79 ± 2.12 | 25.90 ± 1.91 | 0.914 ± 0.025 | 2.493 ± 0.007 | 63 |
| 1500° C. | 31.40 ± 0.41 | 38.05 ± 1.52 | 0.740 ± 0.053 | 3.304 ± 0.017 | 66 |

Graphitic carbon compacts processed at different
temperatures (Temp) AFTER aqua regia treatment (i.e.,
after removal of cobalt): G-PAN_{Temp}_{_{—}}from_{_{—}}Co

| | | | | | |
|---|---|---|---|---|---|
| Temp | | | | | |
| 800° C. | 45.64 ± 2.16 | 22.61 ± 0.87 | 0.828 ± 0.062 | 2.030 ± 0.010 | 59 |
| 1000° C. | 38.68 ± 1.16 | 23.29 ± 3.06 | 0.754 ± 0.050 | 2.073 ± 0.006 | 64 |
| 1100° C. | 34.73 ± 1.72 | 25.96 ± 3.21 | 0.679 ± 0.023 | 2.060 ± 0.004 | 67 |
| 1200° C. | 31.66 ± 2.08 | 26.23 ± 1.67 | 0.695 ± 0.034 | 2.061 ± 0.008 | 66 |
| 1400° C. | 27.31 ± 0.98 | 26.12 ± 1.03 | 0.664 ± 0.036 | 2.068 ± 0.006 | 68 |
| 1500° C. | 23.89 ± 1.42 | 38.69 ± 1.49 | 0.575 ± 0.022 | 2.009 ± 0.005 | 71 |

| | | | | BET | | average |
|---|---|---|---|---|---|---|
| | | | | surface | | pore |
| | specific pore volume [cm³ g⁻¹] | | | area | | diameter |
| sample | V_{Total}^{f} | V_{1.7-300}_{_{—}}ₙₘ^{g} | V_{>300 nm}^{h} | σ [m² g⁻¹]ⁱ | | [nm]ⁱ |
| PAN@CoOx | — | — | — | — | | — |
| A-PAN@CoOx | 0.25 | 0.00 | 0.25 | 0.93 | (0.65) | 1081 |
| | Graphitic carbon compacts processed at different | | | | | |
| | temperatures (Temp) BEFORE aqua regia treatment (i.e., | | | | | |
| | before removal of cobalt): G-PAN_{Temp}@Co | | | | | |
| Temp | | | | | | |
| 800° C. | 0.60 | 0.17 | 0.43 | 291.8 | (134.1) | 8.21 |
| 1000° C. | 0.68 | 0.24 | 0.44 | 197.1 | (66.84) | 13.9 |
| 1100° C. | 0.78 | 0.23 | 0.55 | 184.8 | (60.67) | 16.9 |
| 1200° C. | 0.71 | 0.27 | 0.44 | 136.9 | (22.99) | 20.7 |
| 1400° C. | 0.69 | 0.24 | 0.45 | 109.6 | (15.26) | 25.3 |
| 1500° C. | 1.04 | 0.01 | 1.03 | 1.96 | (0.83) | 2254 |
| | Graphitic carbon compacts processed at different | | | | | |
| | temperatures (Temp) AFTER aqua regia treatment (i.e., | | | | | |
| | after removal of cobalt): G-PAN_{Temp}_{_{—}}from_{_{—}}Co | | | | | |
| Temp | | | | | | |
| 800° C. | 0.71 | 0.16 | 0.55 | 249.5 | (89.18) | 11.5 |
| 1000° C. | 0.84 | 0.28 | 0.56 | 231.5 | (75.76) | 14.6 |
| 1100° C. | 0.99 | 0.28 | 0.71 | 225.9 | (70.84) | 17.5 |
| 1200° C. | 0.95 | 0.35 | 0.60 | 177.6 | (26.61) | 21.7 |
| 1400° C. | 1.02 | 0.30 | 0.72 | 126.2 | (7.70) | 32.4 |
| 1500° C. | 1.24 | 0.27 | 0.97 | 98.06 | (2.32) | 50.6 |

^{a}Average of three samples.
^{b}Mass yields relative to the PAN@CoOx xerogel compacts.
^{c}Shrinkages relative to the PAN@CoOx xerogel compacts.
^{d}Single sample, average of 50 measurements.
^{e}Porosity, Π = 100 · (ρₛ − ρ_{β})/ρₛ
^{f}V Total was calculated via V_{Total} = (1/ρ_{b}) − (1/ρₛ).
^{g}Cumulative pore volume V_{1.7-300}_{_{—}}ₙₘ was calculated via the Barrett-Joyner-Halenda (BJH) desorption method.
^{h}V_{>300 nm} = V_{Total} − V_{1.7-300}_{_{—}}ₙₘ.
ⁱSurface areas were calculated from N₂-sorption data via the Brunauer-Emmett-Teller (BET) equation; numbers in (parentheses): Micropore surface areas calculated via the t-plot method.
^{j}Average pore diameters were calculated via the 4 × V/σ method by setting V = V_{Total} = (1/ρ_{b}) − (1/ρₛ).

The bulk densities (ρ_{b}) of PAN@FeOx and PAN@CoOx xerogel compacts were very close to one another at 1.228 g cm⁻³ and 1.239 g cm⁻³, respectively, reflecting the similar formulation and processing of the two types of compacts. However, the corresponding skeletal densities (ρₛ) were different due the different metal oxides (1.304 g cm⁻³ and 1.412 g cm⁻³, respectively). The open porosity (17), calculated as percent of empty space via Π=100×(ρₛ−ρ_{b})/ρₛ, was found to be very low at 6% v/v and 12% v/v for PAN@FeOx and PAN@CoOx xerogel compacts, respectively. Considering these property values as the point of departure, aromatization of the PAN@FeOx and PAN@CoOx xerogel compacts brought about similar mass losses in the two materials (32% w/w and 28% w/w, respectively) that were matched by similar linear shrinkages (16% and 14%, respectively-refer also to FIG. 62), and the densities of A-PAN@FeOx and A-PAN@CoOx were somewhat reduced (1.11 g cm⁻³ and 1.23 g cm⁻³, respectively) relative to those of the starting PAN@FeOx and PAN@CoOx compacts. At the same time, the skeletal densities were increased to 1.858 g cm⁻³ and 1.773 g cm⁻³, respectively, and the porosities of the aromatized samples were increased to 40% w/w and 31% w/w.

Further pyrolysis of A-PAN@MOx at temperatures ranging from 800° C. to 1500° C. resulted in further mass losses, all falling roughly in the range of 50-75% w/w for both as-prepared and samples treated with aqua regia (see FIG. 63). It is noted that, relative to as-prepared samples, treatment with aqua regia caused an additional 5-10% of mass loss, owing to removal of the inorganic components. However, similarities not-withstanding, the mass-loss profiles were different in the two series of materials from Fe and Co (see FIG. 63). Specifically, the mass losses by G-PAN_{Temp}@Fe, and consequently by G-PAN_{Temp}_from_Fe, leveled off at 1100° C., while G-PAN_{Temp}@CO kept on losing more mass all the way to the maximum pyrolysis temperature, 1500° C. The origin of this discrepancy might be related to the formation of iron carbide at ≤1100° C., as well as to the different activity of the two metals as graphitization catalysts.

Turning to the final metal-free carbon aerogels, G-PAN_{Temp}_from_M, FIG. 64 summarizes several of their general material properties. For the original data, as well as the corresponding properties before treatment with aqua regia, refer to Tables 21 and 22. The mass yield of G-PAN_{Temp}_from_M (FIG. 64A) follows a reverse trend from the mass loss data of FIG. 63. The yield of G-PAN_{Temp}_from_Fe initially decreases with the pyrolysis temperature, but it levels off at around 24-27% w/w at ≥1100° C. The yield of G-PAN_{Temp}_from_Co decreases continuously with the pyrolysis temperature from 46% at 800° C. to 24% at 1500° C.

Consistently with the perception created by the photographs of FIG. 61, FIG. 64B confirms that, along aromatization and beyond, all G-PAN_{Temp}_from_Fe and G-PAN_{Temp}_from_Co samples shrank uniformly in a similar fashion: in the 20-31% range up to 1400° C., with a final boost up to 36% by G-PAN₁₅₀₀_from_Fe, and in the 23-26% range up to 1400° C., with a final boost up to 39% by G-PAN₁₅₀₀_from_Co.

The effect of increasing mass loss (FIG. 63) and decreasing mass yield with increasing pyrolysis temperature (FIG. 64A) was stronger than the effect of shrinkage, and the bulk density of both systems, ρ_{b}, decreased with increasing pyrolysis temperature (FIG. 64C). Within that framework, above 1100° C., the bulk densities of G-PAN_{Temp}_from_Fe were 0.12-0.18 g cm⁻³ lower than the densities of the corresponding G-PAN_{Temp}_from_Co.

The skeletal densities, ρₛ, of all G-PAN_{Temp}_from_M carbons (ranging from 1.94-2.15 g cm⁻³ for both Fe and Co—see Tables 21 and 22) were lower than those of pure graphite (2.26 g cm⁻³), but significantly higher than the density of glassy carbon (1.5 g cm⁻³). Within that overall range of ρₛ values, there was a higher variation in the ρₛ values of G-PAN_{Temp}_from_Fe (2.021±0.009 g cm⁻³ at 1500° C. versus 2.143±0.009 g cm⁻³ at 1000° C.) than in the ρₛ values of G-PAN_{Temp}_from_Co (2.009±0.005 to 2.073±0.006 g cm⁻³ at corresponding temperatures). The subtle, yet unilateral, decline in the ρₛ values of both systems as the pyrolysis temperature increased is the opposite from what is expected from the temperature dependence of graphitization of amorphous carbon. A plausible reason is creation of closed porosity. At any rate, the combination of the decline in both the ρ_{b} and ρₛ values as the pyrolysis temperature increased yielded a shallow climb in the porosities of both systems from 63% to 78% v/v in the G-PAN_{Temp}_from_Fe series of samples and from 59% to 71% v/v in the G-PAN_{Temp}_from_Co series (FIG. 64D). Interestingly, the porosities of the corresponding samples before removal of the inorganic components were in the same ranges: 62-72% v/v in the case of G-PAN_{Temp}@Fe and 57-66% v/v in the case of G-PAN_{Temp}@CO, which agrees with the small amounts of FeOx and CoOx in PAN@FeOx and PAN@CoOx.

4. Microscopic Properties of PAN@MOx, A-PAN@MOx, G-PAN_{Temp}@M, and G-PAN_{Temp}_from_M Systems

Macroscopically, G-PAN_{Temp}_from_Fe and G-PAN_{Temp}_from_Co evolved similarly as the pyrolysis temperature increased and appeared similar in all aspects. Microscopically, however, the picture was different. FIGS. 66 and 67 show SEM images of G-PAN_{Temp}_from_Fe and G-PAN_{Temp}_from_Co (prepared according to the method described in Part 3 of Example 19 and prepared as sample according to the method described in Part 1 of this Example) after graphitization and etching, respectively. The morphology of post-aqua regia G-PAN_{Temp}_from_Fe differed at different pyrolysis temperatures. As shown FIG. 67 (which shows representative SEMs of samples), the morphology varied from an almost featureless landscape up to 1000° C. (sprinkled, here and there, with some up-to-5 micron long rods (pointed at by arrows)), to a structure consisting partially of rods with beads (partially of strings-of-beads and partially of stacks of thin sheets at 1100° C.), to a random distribution of platelets at 1400° C., and to a hard-to-describe mixture of the above features at 1500° C. On the other hand, post aqua regia G-PAN_{Temp}_from_Co consisted uniformly of similar structures that, albeit their different length scales, all were reminiscent of the interior of a fig (FIG. 67—right column). Occasionally, at intermediate temperatures, one may distinguish flat features like the one pointed at with an arrow in the image of the G-PAN₁₁₀₀_from_Co sample. Another interesting feature is that practically all samples were clearly macroporous, with the majority of pores at sizes >300 nm.

### Example 25

### Mechanical Characterization of G-PAN₁₅₀₀@M and G-PAN₁₅₀₀_from_M Systems

### 1. Methods

Quasi-static compression testing at low strain rates (2.5 mm/mm) was conducted on an Instron 4469 Universal Testing Machine using a 500 N load cell. Testing procedures and specimen length/diameter ratios per ASTM D1621-04a (Standard Test Method for Compressive Properties of Rigid Cellular Plastics) were followed. The specimens had a nominal diameter of 1.1 cm and a length/diameter ratio of 0.5. The recorded force as a function of displacement (machine-compliance corrected) was converted into stress as a function of strain.

2. Mechanical Characterization of G-PAN₁₅₀₀@M and G-PAN₁₅₀₀_from_M Systems

Due to the macroscopic similarity of the Fe- and Co-derived samples (FIG. 61) and their microscopic differentiation, the mechanical properties of graphitic carbon aerogels obtained at 1500° C., before and after aqua regia treatment (prepared according to the methods described in Parts 2-3 of Example 19 and prepared as sample according to the method described in Part 1 of this Example), were investigated under quasi-static compression, following ASTM D1621-04a, using cylindrical monolithic specimens with thickness:diameter ratio of about 0.4. At low compressive strains (below 8-10%), the stress-strain curves showed typical elastomeric behavior, and the materials eventually failed at around 13-18% strain as shown in FIG. 68. For G-PAN₁₅₀₀@Fe and G-PAN₁₅₀₀@Co with comparable bulk densities (0.748 g cm⁻³ versus 0.740 g cm⁻³, respectively), the ultimate compressive strengths were 53.24 MPa and 22.38 MPa, respectively. After treatment with aqua regia, the ultimate compressive strengths of G-PAN₁₅₀₀_from_Fe and G-PAN₁₅₀₀_from_Co (with bulk densities equal to 0.439 g cm⁻³ and 0.575 g cm⁻³, respectively) were lower: 37.88 MPa and 12.77 MPa, respectively. The elastic moduli, E, (also referred to as Young's modulus) of these materials were calculated from the early slopes of the stress-strain curves (at <3% strain) and were found equal to 95.10 MPa, 70.73 MPa, 40.91 MPa, and 21.11 MPa for G-PAN₁₅₀₀@Fe, G-PAN₁₅₀₀_from_Fe, G-PAN₁₅₀₀@Co, and G-PAN₁₅₀₀_from_Co, respectively, following exactly the same trend as the ultimate compressive strength. In view of this data, although all samples appeared sturdy as mentioned in Example 24, under formal conditions, Fe-derived samples were clearly stronger and stiffer.

### Example 26

### Porosity Studies of A-PAN@MOx, G-PAN_{Temp}@M, and G-PAN_{Temp}_from_M Systems

### 1. Methods

N₂-sorption porosimetry at 77 K was conducted using a Micromeritics TriStar II 3020 surface area and porosity analyzer. Before porosimetry, samples were outgassed for 24 hours under vacuum at 120° C. Data were reduced to standard conditions of temperature and pressure (STP). Total surface areas were determined via the Brunauer-Emmett-Teller (BET) method from the N₂-sorption isotherms.

2. N₂-Sorption Isotherms of A-PAN@MOx, GPAN_{Temp}@M, and GPAN_{Temp}_from_M Systems

A more detailed view of the skeletal framework and the porous structure of all aromatized and further-pyrolyzed products was obtained with N₂-sorption porosimetry at 77 K. PAN@FeOx and PAN@CoOx xerogel compacts were not analyzed for N₂-sorption due to their negligible porosity. The evolution of isotherms for FeOx-derived compacts (A-PAN@FeOx to G-PAN₈₀₀₋₁₅₀₀@Fe to G-PAN₈₀₀₋₁₅₀₀_from_Fe) and for CoOx-derived compacts (A-PAN@CoOx to G-PAN₈₀₀₋₁₅₀₀@Co to G-PAN₈₀₀₋₁₅₀₀_from_Co) (each prepared according to the methods described in Parts 2-3 of Example 19 and prepared as sample according to the method described in Part 1 of this Example) is shown in FIG. 69. Surface area and pore volume comparisons of all post-aqua regia samples obtained by pyrolysis of fully aromatized samples in the 800-1500° C. range are presented in FIGS. 64E and 64F, respectively. All individual isotherms and pore size distributions for all samples before and after treatment with aqua regia are presented in FIGS. 70 and 71. Data extracted from those isotherms are summarized in Tables 21 and 22.

A-PAN@FeOx and A-PAN@CoOx compacts showed very low levels of N₂-sorption, and the BET surface areas (σ) were 13 m² g⁻¹ and 1 m² g⁻¹, respectively. Upon pyrolysis at 800° C., the maximum quantity of N₂ adsorbed by both G-PAN₈₀₀@Fe and G-PAN₈₀₀@Co jumped into the vicinity of 170 cm³ g⁻¹ and in the 140-250 m² g⁻¹ range, respectively, as P/P₀→1. The isotherms were Type IV, with Type B hysteresis loops characterized by a sharp decrease in the desorption branch at around P/P₀˜0.45, which indicates multiple pore types with broad distributions of diameters typically associated with slit-like pores formed by parallel plates. Upon pyrolysis at 1000° C. and higher, the maximum amount of N₂ adsorbed kept on decreasing with increasing temperature. This decrease was quite drastic in the case of G-PAN₈₀₀@Fe and was accompanied by a change in the shape of the hysteresis loop into Type C indicating open wedge-like pores. While, in the case of G-PAN₈₀₀@Co, the isotherms retained their Type B shape, and the reduction in the total volume of N₂ adsorbed was associated with decreasing microporosity (indicated by a dashed oval in the frame describing G-PAN_{Temp}@Co). Incidentally, decreasing microporosity with increasing pyrolysis temperature might be the source of the close porosity that was implied by skeletal density considerations, as discussed above in Example 25.

After treatment with aqua regia (right-hand side frames in FIG. 69), the total volume of N₂ adsorbed was increased uniformly throughout all samples, but the shapes of the isotherms remained unchanged. The pore size distributions calculated via the BJH method were broad (extending typically up to 100 nm). In the case of all Co-derived samples, the pore size distribution was also bimodal. The pore size distributions of all pyrolyzed samples before and after treatment with aqua regia are shown as inset graphs in FIGS. 70 and 71. Finally, except for G-PAN₈₀₀_from_Fe or G-PAN₈₀₀_from_Co, the BET surface areas of all the rest of the samples (i.e., those at temperatures ≥1000° C.) were consistently higher than the surface areas of their immediate precursors (i.e., of G-PAN_{Temp}@Fe or G-PAN_{Temp}@Co). However, similarities of the two systems seem to end there. As shown in FIG. 64E, the BET surface areas of G-PAN_{Temp}_from_Fe did not include any substantial portion that could be assigned to micropores. While, in the case of G-PAN_{Temp}_from_Co, for temperatures ≤1200° C., up to ⅓ of the BET surface area was in fact assigned to micropores. Qualitatively, although the surface areas of the Co-system declined, the portion that seemed to go away first was the fraction allocated to micropores so that, at the end, the surface areas of G-PAN₁₅₀₀_from_Co was 2.3× higher than the BET surface area of G-PAN₁₅₀₀_from_Fe (98 m² g⁻¹ versus 42 m² g⁻¹, respectively—see Tables 21 and 22).

Closing the discussion of the N₂-sorption data, it should be noted that, though the Type IV shape of all isotherms obtained by pyrolysis of samples at ≥800° C. suggests mesoporous materials, referring to FIG. 64F, the total pore volume of pores with diameters >300 nm was always a multiple of times higher than the volume of pores sampled by N₂ (i.e., with pore sizes in the 1.7-to-300 nm range). This indicates that all G-PAN_{Temp}_from_M (and for this matter G-PAN_{Temp}@M as well) were mostly macroporous materials and in agreement with SEM (FIG. 67).

Overall, if a single conclusion is reached about the Fe- versus the Co-catalyzed systems from their bulk material properties (FIG. 64) and their microscopy (FIG. 67), the conclusion would be that there is less variation in the density, porosity, external surface area, pore volume, and microscopic appearance of the G-PAN_{Temp}_from_Co samples than in the corresponding properties of the G-PAN_{Temp}_from_Fe samples (for 800° C. <temperatures ≤1500° C.). That is, the properties of G-PAN_{Temp}_from_Co depart less from the properties of the lowest-temperature sample in the series, G-PAN₈₀₀_from_Co, than the properties of the corresponding samples in the G-PAN_{Temp}_fom_Fe system. In turn, this can be attributed to Co being a less effective graphitization catalyst than Fe in the PAN@MOx systems.

### Example 27

### Electrochemical Properties of G-PAN₁₅₀₀_from_Fe in Anodes of Li-Ion Batteries

### 1. Methods

Cyclic Voltammograms (CV) were obtained using a PAR EG&G Potentiostat/Galvanostat Model 273 in the potential range of 0.05-1.8 V (versus Li⁺/Li) with a scan rate of 0.05 mV s⁻¹. All the galvanostatic measurements were carried out using a Neware Dual Range Battery tester (BTS-4008-5V6 Å-8) in the same potential limits as the CV. The current was applied in terms of C-rates. The “C-rate” was calculated based on the amount of the active component, G-PAN₁₅₀₀_from_Fe, in the cell and assuming the theoretical capacity of graphite as 372 mAh g⁻¹. All electrochemical experiments were conducted at room temperature.

2. Evaluation of the Electrochemical Properties of G-PAN₁₅₀₀ from_Fe in Anodes of Li-Ion Batteries

G-PAN₁₅₀₀_from_Fe powder (prepared according to the method described in Part 3 of Example 19 and prepared as sample according to the method described in Part 1 of this Example) was evaluated as lithium-intercalation materials in anodes of coin-cell batteries assembled in Example 20. Cyclic voltametric (CV) scans were carried out 3 times between 1.8 V and 0.05 V versus Li⁺/Li at a slow sweep rate (0.05 mV s⁻¹) (see FIG. 72A). It was observed that the first reduction sweep included a sizable cathodic wave at around 0.5 V versus Li⁺/Li, which was attributed to irreversible formation of a solid-electrolyte interface (SEI). SEI is formed by reduction of the electrolyte on the surface of anode. SEI is ionically conducting, allowing Li⁺ to diffuse/migrate through it, but electronically insulating. Therefore, its growth stops at a thickness where electrons can no longer tunnel through. The open-pore framework of graphitic carbon aerogels provides access to the electrolyte to its internal surface area (42 m² g⁻¹) where SEI formation results in a sizable reduction wave at around 0.5 V versus Li⁺/Li. The lithiation and de-lithiation waves of graphitic carbon occur at around 0.05-0.15 and 0.15-0.30 V, respectively. The oxidation wave shows a shoulder after the first cycle (see arrows in FIG. 72A), which can be attributed to re-stacking of graphitic sheets during step-wise oxidative de-lithiation of G-PAN₁₅₀₀_from_Fe. The immediate consequence of consuming electrolyte to form the SEI is reflected in a noticeably low coulombic efficiency of the first cycle (47%) of the charge-discharge process. However, once a stable SEI was formed, the coulombic efficiency kept on improving in the subsequent charge/discharge cycles, eventually reaching values in the 95-100% range.

The durability of G-PAN₁₅₀₀_from_Fe as an anode material was tested over 16 cycles at various discharge C-rates (C/2θ, C/10, and C/5). FIG. 72B shows the voltage/capacity curves for the first 4 cycles. All charging processes were voltage-limited at 50 mV above the thermodynamic potential of Li⁺ reduction on Li metal (0 V vs. Li⁺/Li). After the first charging cycle, the subsequent charge-discharge curves practically coincided suggesting that the SEI layer is fairly stable allowing facile Li-ion migration. As a consequence of the stability of the charge/discharge curves after the first cycle, their intersection remained stable at 0.3 V versus Li⁺/Li throughout cycling, which is the electrochemical potential of Li⁺ intercalation in graphite. The specific capacity did decrease with increasing C-rate (FIG. 72C). The highest charge capacity at the slowest C-rate attempted here (˜100 mAh g⁻¹) was lower than the theoretical capacity of lithium intercalation in graphite. It is quite possible that the extended internal surface area that is wetted by the electrolyte and subsequently coated with SEI deactivates a significant portion of the graphite making it difficult to achieve its full capacity.

1. A method of forming a xerogel comprising polymerizing a plurality of monomers on the surface of a support, so as to form a polymer layer on said surface, wherein the monomers can be the same or different, and the stoichiometric ratio of monomers to support is from about 6:1 to about 14:1.

2. The method of claim 1, wherein said polymerizing yields polymers chosen from polyacrylonitrile, polyurea, polyaniline, polyvinylchloride, isocyanate derivatives, or combinations thereof.

3. The method of claim 1, wherein said support comprises a metal oxide, silica, or both.

4. The method of claim 1, wherein said support comprises an oxide of a metal chosen from iron, cobalt, nickel, vanadium, chromium, titanium, molybdenum, aluminum, manganese, tungsten, zirconium, hafnium, tin, copper, lithium, silver, gold, barium, boron, calcium, ruthenium, rare earth metals, or mixtures thereof.

5. The method of claim 1, wherein said support comprises one or more of the following bound to said surface: —OH groups, —NH₂ groups, or a free radical initiator.

6. The method of claim 5, wherein said free radical initiator comprises an azo-based free-radical initiator, a bidentate of an azo-based free-radical initiator, or mixtures thereof.

7. The method of claim 1, wherein the resulting xerogel comprises one or more of polyurea-coated silica, polyacrylonitrile-coated silica, or polyacrylonitrile-coated metal oxide.

8. The method of claim 1, wherein said polymerizing is carried out in a suspension and forms a wet gel, and further comprising drying said wet gel to yield the xerogel.

9. The method of claim 8, wherein said xerogel is a powder and further comprising compressing said xerogel powder to form a self-sustaining xerogel body.

10. The method of claim 9, further comprising subjecting said xerogel powder or xerogel body to oxidative aromatization so as to form an aromatized xerogel.

11. The method of claim 9, further comprising pyrolyzing said xerogel body to form a graphitic carbon aerogel.

12. The method of claim 10, further comprising pyrolyzing said xerogel body to form an amorphous carbon aerogel.

13. The method of claim 11, further comprising etching said carbon aerogel.

14. The method of claim 13, wherein said etching comprises exposing said carbon aerogel to an etchant chosen from HF, CO₂, aqua regia, or combinations thereof.

15. The method of claim 1, wherein said carbon aerogel is formed without supercritical drying.

16. A gel formed according to claim 1.

17. The gel of claim 16, said gel being a graphitic carbon aerogel and having a BET surface area of about 5 m²/g to about 800 m²/g.

18. The gel of claim 16, said gel being an amorphous carbon aerogel and having a BET surface area of about 30 m²/g to about 2,500 m²/g.

19. (canceled)

20. A method of forming a carbon aerogel, said method comprising heating a xerogel comprising carbon and non-carbon material at temperatures of about 700° C. to 1,600° C. so as to remove the majority of said non-carbon material and form the carbon aerogel.

21. The method of claim 20, wherein said carbon aerogel is formed without supercritical drying.

22. The method of claim 20, wherein said xerogel comprises a carbonizable polymer on a support.

23. The method of claim 22, wherein:
said carbonizable polymer is present in said xerogel at a level of about 25% by weight to about 95% by weight, based on the wait of the xerogel taken as 100% by weight; and
said support is chosen from silica, metal oxides, and mixtures thereof.

24. The method of claim 20, further comprising etching said carbon aerogel.

25. The method of claim 20, said carbon aerogel being a graphitic carbon aerogel.

26. The method of claim 20, said carbon aerogel being an amorphous carbon aerogel.

27. (canceled)

28. A graphitic carbon aerogel comprising:
at least about 80% by weight total carbon;
less than about 10% by weight metal; and
less than about 3% by weight silicon, said % by weight being based on the total weight of the graphitic carbon aerogel taken as 100% by weight;
at least about 55% by weight graphitic carbon, said % by weight being based on the weight of total carbon in the graphitic carbon aerogel taken as 100% by weight;
a BET multipoint surface area of 25 m²/g to about 350 m²/g; and
an average micropore surface area of about 0.1 m²/g to about 120 m²/g.

29. An amorphous carbon aerogel comprising:
at least about 70% by weight carbon;
less than about 10% by weight metal;
less than about 3% by weight silicon, said % by weight being based on the total weight of the amorphous carbon aerogel taken as 100% by weight;
a BET surface area of 400 m²/g to about 2,500 m²/g; and
an average micropore surface area of about 2θ0 m²/g to about 850 m²/g.

30. (canceled)

31. A battery comprising an anode comprising the carbon aerogel of claim 28.

32. (canceled)

33. A method of functionalizing the surfaces of particles, said method comprising reacting a bidentate free radical initiator salt with said surfaces at a temperature of about −10° C. or greater so as to cause said bidentate free radical initiator salt to bond to said surfaces.

34. The method of claim 33, wherein said particle are inorganic particles.

35. The method of claim 33, wherein said particles are chosen from silica particles, metal oxide particles, and mixtures thereof.

36. The method of claim 33, wherein said bidentate free radical initiator salt comprises a salt of a precursor free radical initiator and a pair of bridging compounds.

37. The method of claim 36, wherein said precursor free radical initiator is chosen from azobisisobutyronitrile, 4,4′-azobis(4-cyanopentanoic acid), 3-(triethoxysilyl)propan-1-aminium 4,4′-azobis(4-cyanovalerate), or mixtures thereof.

38. The method of claim 36, wherein said bridging compounds are chosen from:
compounds having one or more —Si(OR)₃ groups, where R is an alkyl; and
alkyl chloroformates.
